(19) United States
(12) Patent Application Publication
(10) Pub. No.: US 2025/0012724 A1
(43) Pub. Date: Jan. 9, 2025

(54) SYSTEMS AND METHODS FOR TISSUE CHARACTERIZATION

(71) Applicants: Black Light Surgical, Inc., Sunny Isles Beach, FL (US); CEDARS-SINAI MEDICAL CENTER, Los Angeles, CA (US)

(72) Inventors: Bartosz BORTNIK, Los Angeles, CA (US); Pramod BUTTE, Los Angeles, CA (US); Mike O'BRIEN, Los Angeles, CA (US); Ruo YU GU, Los Angeles, CA (US); Augustus P. LOWELL, Durham, NH (US); Todd L. HARRIS, Fremont, CA (US); Russell B. FORD, Palo Alto, CA (US); Edward G. SOLOMON, Menlo Park, CA (US); Mark LEVATICH, San Francisco, CA (US); Dominic V. SHARMA, Sunny Isles Beach, FL (US); Steven MOORE, Los Angeles, CA (US)

(21) Appl. No.: 18/660,140

(22) Filed: May 9, 2024

Related U.S. Application Data
(63) Continuation of application No. PCT/US2022/079771, filed on Nov. 11, 2022.
(60) Provisional application No. 63/278,255, filed on Nov. 11, 2021.

(51) Int. Cl. G01N 21/64; G01N 21/13

(52) U.S. Cl. CPC G01N 21/6456; G01N 21/13; G01N 21/6486

(57) ABSTRACT

Provided herein are systems and methods for tissue characterization that may be utilized for intraoperative cancer margin assessment. A tissue sample is resected from a patient and then placed in a system where it is imaged for autofluorescence characteristics to help identify regions of interest such as cancerous tissue margins. Based on the imaging results and tissue characterization, the resection of tissue in the subject can be adjusted.

### CROSS-REFERENCE

This application is a continuation application of PCT International Application No. PCT/US2022/079771 filed Nov. 11, 2022, which claims benefit of U.S. Provisional Patent Application No. 63/278,255 filed Nov. 11, 2021, which are entirely incorporated by reference.

### BACKGROUND

The present disclosure relates to medical systems, devices, and methods, particularly for facilitating the treatment of cancer.

Cancer may develop to an extent where the most appropriate treatment is surgical resection of the tumor that has metastasized or is negatively impacting neighboring organ systems. Often times during a surgical dissection or resection of the cancerous tissues, the surgeon will dissect a small segment of tissue to be provided as a frozen biopsy sample. The frozen biopsy samples are then analyzed by a frozen histology microtome and interpreted by an expert pathologist reader. This process is imprecise and may impose substantial increases in operative time for the patient, putting the patient at greater risk of complications. In view of this, there is an unmet need for a comprehensive and rapid approach for the intraoperative analysis of resected cancer samples.

The following references may be of interest: U.S. Pat. Nos. 10,980,420, 10,983,060, 10,656,089, 10,605,736, 10,325,366, 10,094,784, 9,677,869, 9,451,882, 8,649,849, 7,890,157, 6,641,835, 6,427,082, 6,405,070, 6,174,291, 5,601,087; U.S. Publication Nos. 2020/0319108, 2020/0367818, 2020/0096447, 2019/0223728, 2019/0378292, 2017/0367583, 2017/0290515, 2013/0237842, 2007/0093703, 2002/0007122; and, PCT Publication Nos. WO 2020/148724 A1, WO 2017/177194 A1, WO 2017/173315 A1, WO 2017/075176 A1, WO 2005/019800 A2.

### SUMMARY

Provided herein are systems and methods that addressed the aforementioned unmet need for a systems and methods capable of comprehensive and rapidly analysis and characterization of sub-tissue types in a tissue.

In some aspects, the invention disclosed herein comprises a device for determining the presence of tissue or cell type of interest in a resected tissue sample. In some embodiments, the device comprises: (a) a surface to receive a tissue sample resected from a subject; (b) a light source configured to emit an excitation signal; (c) an optical assembly in optical communication with the light source to direct the excitation signal to the tissue sample received on the surface and collect autofluorescent light emitted from the tissue sample in response; (d) a detector in communication with the optical assembly configured to capture the autofluorescent light emitted from the tissue sample; and/or (e) a processor in communication with the detector to generate at least one image of the autofluorescence light emitted from the tissue sample. In some embodiments, the subject is suffering from or suspected of suffering from a disease. In some embodiments, the pulse signal from the laser is detected. In some embodiments, the signal timing jitter is reduced by using the detecting a laser signal to trigger the digitizer collecting the autofluorescence signal. In some embodiments, the subject needs surgical intervention whereby the surgeon needs to be able to discriminate between different types of tissues. In some embodiments, the tissue or cell type of interest comprise diseased tissues or cells. In some embodiments, the diseased tissues or cells comprise cancerous tissues or cells. In some embodiments, the processor is configured to determine the presence of disease in the resected tissue sample based on the generated at least one image. In some embodiments, the processor is configured to determine the presence of disease in the resected tissue sample based one or more autofluorescent characteristics of the generated at least one image. In some embodiments, the one or more autofluorescent characteristics comprise an autofluorescence lifetime characteristic. In some embodiments, the autofluorescence lifetime characteristic comprises a plurality of fluorescent exponential decay characteristics of a plurality of regions the resected tissue. In some embodiments, the processor is configured to use a probability model to determine the presence of the disease in the tissue sample based on the multifluorescent light emitted from the tissue sample. In some embodiments, the processor is configured to determine the presence of disease in a plurality of margins of the resected tissue sample based on the generated at least one image. In some embodiments, the device further comprises a mechanical stage. In some embodiments, the device further comprises a scanning controller in electrical communication with the mechanical stage, detector, optical scanning element (e.g., one or more galvanic scanning mirrors), and the light source to operably control the mechanical stage, detector, one or more galvanic scanning mirrors and/or the light source. In some embodiments, the scanning controller may be electrically coupled and/or in communication with a galvanic scanning mirror driver configured to actuate and scan the light source using the one or more galvanic scanning mirrors. In some embodiments, the galvanic scanning mirror driver may comprise a linear and/or analog motor driver to prevent coupling noise into the sensitive electrical amplification, attenuation, analog to digital signal conversion, and/or signal digitization. In some embodiments, the scanning controller may be configured to synchronize a driving signal to actuate the one or more galvanic scanning mirrors and translate the motorized stages e.g., the motorized stages driving the scanning motion of the optical scanning element. In some embodiments, the scanning controller may be configured to synchronize the gain controller (e.g., gain micro-controller) with clock and/or trigger synchronizing signal of the pulse controller and/or seed laser of the light source.

In some embodiments, the mechanical stage is coupled to the surface or the light source. In some embodiments, the mechanical stage is configured to move in three-dimensions. In some embodiments, the device further comprises a scanning element coupled to the optical assembly to scan the excitation signal across a plurality of locations on the tissue sample. In some embodiments, the device further comprises a scanning element coupled to the optical assembly to scan the excitation signal across a plurality of locations on the tissue sample. In some embodiments, the resected tissue sample has not been stained prior to imaging. In some embodiments, the tissue sample has been exposed to a cross-linking agent prior to imaging. In some embodiments, the tissue sample comprises breast tissue. In some embodiments, the surface comprises a disposable tray. In some embodiments, the disposable tray is sterile. In some embodiments, the light source is a pulsed laser. In some embodiments, the pulsed laser comprises a fiber laser. In some embodiments, the pulsed laser is a Q-switched laser. In some embodiments, the light source is a mode-locked laser. In some embodiments, the pulsed laser is a two-photon. In some embodiments, the pulsed laser emits a wavelength of about 300 nanometers (nm) to about 400 nm. In some embodiments, the pulsed laser comprises a pulse energy of about 1 microjoule (μJ) to about 3 μJ. In some embodiments, the pulsed laser comprises a pulse rate of about 10 kilohertz (kHz) to about 1 MHz. In some embodiments, the pulse width may comprise 100 femtoseconds and 2 nanoseconds. In some embodiments, the optical assembly comprises a partially reflective mirror, a plurality of optical elements, wherein the plurality of optical elements comprises one or more of plano-convex, bi-convex, bi-concave, plano-concave, or any combination thereof lenses. In some embodiments, the plurality of optical elements comprises fused silica optics. In some embodiments, the detector comprises one or more photo-multiplier tubes, semiconductor (e.g., GaAs, InGaAs, or silicon) based sensors, or avalanche photodiodes. In some embodiments, the detector comprises one or more dichroic filters. In some embodiments, the device further comprises one or more amplifiers electrically coupled to the detector, configured to amplify an electrical signal generated when the detector detects the autofluorescent light emitted from the tissue sample. In some embodiments, the one or more amplifiers comprise a programmable attenuator, radio frequency amplifier, fixed attenuator, or any combination hereof. In some embodiments, the processor comprises a field programmable gate array (FPGA).

In some aspects, the disclosure provided herein comprises a method for determining the presence of a tissue or cell type of interest in a tissue sample. In some embodiments, the method comprises the steps of: (a) receiving a tissue sample resected from a subject in a fluorescence imaging system; (b) imaging the resected tissue sample to determine one or more autofluorescent characteristics of the resected tissue sample; and/or (c) determining the presence of the tissue or cell type of interest in the resected tissue sample based on the image resected tissue. In some embodiments, the resected tissue sample has not been stained prior to imaging. In some embodiments, the one or more autofluorescent characteristics comprise an autofluorescence lifetime characteristic. In some embodiments, the resected tissue sample has been exposed to a cross-linking agent prior to imaging. In some embodiments, the autofluorescence lifetime characteristic comprises a plurality of fluorescent exponential decay characteristics of a plurality of regions of the resected tissue sample. In some embodiments, the tissue or cell type of interest comprise diseased tissues or cells. In some embodiments, the diseased tissues or cells comprise cancerous tissues or cells. In some embodiments, the tissue sample comprises tissue from colon, breast, prostate, skin, vasculature, or any combination thereof. In some embodiments, determining the presence of disease in the resected tissue comprises characterizing one or more margins in the resected tissue sample as diseased or non-diseased. In some embodiments, the fluorescence imaging system comprises a pulsed fluorescence light source. In some embodiments, imaging comprises detecting autofluorescent light emitted from the tissue sample in response to the pulsed fluorescence light source providing an excitation signal to the tissue sample. In some embodiments, the pulsed fluorescence light source is a pulsed fiber laser fluorescence light source. In some embodiments, the method further comprises informing a surgeon to resect a second tissue sample from the subject. In some embodiments, informing comprises sound, visual display, or any combination thereof directed towards the surgeon. In some embodiments, steps (b) and (c) of the method are completed in up to 5 minutes. In some embodiments, determining the presence of disease in the tissue sample is completed by a probability-based model. In some embodiments, the probability-based model comprises clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. In some embodiments, the subject is suffering from or suspected of suffering from a disease. In some embodiments, the tissue sample is placed on a surface of a tissue sample carrier of the fluorescence imaging system prior to imaging. In some embodiments, the tissue sample carrier is configured to mechanically couple to a tissue sample barrier. IN some embodiments, the tissue sample carrier and the tissue sample barrier mechanically couple to fix at least two degrees of freedom of the tissue sample carrier.

In some aspects, the disclosure provided herein comprises a method for determining the presence of a tissue or cell type of interest in a tissue sample. In some embodiments, the method comprises the steps of: (a) resecting a tissue sample from a subject; (b) placing the tissue sample into a fluorescence imaging system; (c) imaging, with the aid of the fluorescence imaging system, the resected tissue sample to determine one or more autofluorescent characteristics of the resected tissue sample; and/or (d) receiving, from the fluorescence imaging system, a determination of the presence of the tissue or cell type of interest in the resected tissue sample based on the imaged resected tissue. In some embodiments, the resected tissue sample has not been stained prior to imaging. In some embodiments, the tissue sample has been exposed to a cross-linking agent prior to imaging. In some embodiments, the one or more autofluorescent characteristics comprise an autofluorescence lifetime characteristic. In some embodiments, the autofluorescence lifetime characteristic comprises a plurality of fluorescent exponential decay characteristics of a plurality of regions of the resected tissue sample. In some embodiments, the tissue or cell type of interest comprise diseased tissues or cells. In some embodiments, the diseased tissues or cells comprise cancerous tissues or cells. In some embodiments, the tissue sample comprises tissue from colon, breast, prostate, skin, vasculature, or any combination thereof. In some embodiments, the determination of the presence of disease in the resected tissue comprises a characterization of one or more margins in the resected tissue sample as diseased or non-diseased. In some embodiments, the fluorescence imaging system comprises a pulsed fluorescence light source. In some embodiments, the pulsed fluorescence light source comprises a pulsed fiber laser. In some embodiments, imaging comprises detecting autofluorescent light emitted from the tissue sample in response to the pulsed fluorescence light source providing an excitation signal to the tissue sample. In some embodiments, the method further comprises informing a surgeon to resect a second tissue sample from the subject. In some embodiments, informing comprises sound, visual display, or any combination thereof directed towards the surgeon. In some embodiments, steps (c) and (d) of the method are completed in up to 5 minutes. In some embodiments, the determination of the presence of disease in the tissue sample is completed by a probability-based model. In some embodiments, the probability-based model comprises clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. In some embodiments, the subject is suffering from or suspected of suffering from a disease. In some embodiments, the tissue sample is placed on a surface of a tissue sample carrier of the fluorescence imaging system prior to imaging. In some embodiments, the tissue sample carrier is configured to mechanically couple to a tissue sample barrier. In some embodiments, the tissue sample carrier and the tissue sample barrier mechanically couple to fix at least two degrees of freedom of the tissue sample carrier.

Aspects of the disclosure provided herein comprise a device for determining the presence of a tissue or cell type of interest in a resected tissue sample. In some embodiments, the device comprises: (a) a surface to receive a tissue sample resected from a subject; (b) a light source configured to emit an excitation signal; (c) an optical assembly in optical communication with the light source to direct the excitation signal to the tissue sample received on the surface and collect fluorescent light emitted from the tissue sample in response; (d) a detector in optical communication with the optical assembly configured to collect the fluorescent light emitted from the tissue sample; and/or (e) a processor in communication with the detector to characterize at least a portion of the tissue sample for the tissue or cell type of interest based on a fluorescent lifetime characteristic of the collected fluorescent light. In some embodiments, the processor is configured to determine the presence of disease in the resected tissue sample based on the generated at least one image. In some embodiments, the autofluorescence lifetime characteristic comprises a plurality of fluorescent exponential decay characteristics of a plurality of regions the resected tissue. In some embodiments, the processor is configured to use a probability model to determine the presence of the disease in the tissue sample based on the fluorescent light emitted from the tissue sample. In some embodiments, the processor is configured to determine the presence of disease in a plurality of margins of the resected tissue sample based on the generated at least one image. In some embodiments, the device further comprises a mechanical stage. In some embodiments, the device further comprises a scanning controller in electrical communication with the mechanical stage, detector, and the light source to operably control the mechanical stage, detector, and the light source. In some embodiments, the mechanical stage is coupled to the surface or the light source. In some embodiments, the mechanical stage is configured to move in three-dimensions. In some embodiments, the device further comprises a scanning element coupled to the optical assembly to scan the excitation signal across a plurality of locations on the tissue sample. In some embodiments, the device further comprises a scanning element coupled to the optical assembly to scan the excitation signal across a plurality of locations on the tissue sample. In some embodiments, the resected tissue sample has not been stained prior to imaging. In some embodiments, the tissue has been exposed to a cross-linking agent prior to imaging. In some embodiments, the tissue sample comprises breast tissue. In some embodiments, the tissue or cell type of interest comprises diseased tissues or cells. In some embodiments, the diseased tissues or cells comprise cancerous tissues or cells. In some embodiments, the surface comprises a disposable tray. In some embodiments, the disposable tray is sterile. In some embodiments, the light source is a pulsed laser. In some embodiments, the pulsed laser is a Q-switched laser. In some embodiments, the pulsed laser is a passively Q-switched laser. In some embodiments, the pulsed laser is a two-photon laser. In some embodiments, the pulsed laser emits a wavelength of about 300 nanometers (nm) to about 400 nm. In some embodiments, the pulsed laser comprises a pulse energy of about 1 microjoules (μJ) to about 3μJ. In some embodiments, the pulsed laser comprises a pulse rate of about 10 kilohertz (kHz) to about 50 kHz. In some embodiments, the optical assembly comprises a partially reflective mirror, a plurality of optical elements, wherein the plurality of optical elements comprises one or more of plano-convex, bi-convex, bi-concave, plano-concave, or any combination thereof lenses. In some embodiments, the plurality of optical elements comprises fused silica optics. In some embodiments, the detector comprises one or more photo-multiplier tube. In some embodiments, the detector comprises one or more dichroic filters. In some embodiments, the device further comprises one or more amplifiers electrically coupled to the detector, configured to amplify an electrical signal generated when the detector detects the fluorescent light emitted from the tissue sample. In some embodiments, the one or more amplifiers comprise a programmable attenuator, radio frequency amplifier, fixed attenuator, or any combination thereof. In some embodiments, the processor comprises a field programmable gate array (FPGA). In some embodiments, the subject is suffering from or suspected of suffering from a disease.

Aspects of the disclosure provided herein comprise a method for determining the presence of a tissue or cell type of interest in a tissue sample. In some embodiments, the method comprises the steps of: (a) receiving a tissue sample resected from a subject in a fluorescence imaging system; (b) directing an excitation signal to the tissue sample; (c) collecting fluorescent light emitted from the tissue sample in response to the excitation signal; and (d) characterizing at least a portion of the tissue sample for the tissue or cell type of interest based on a fluorescent lifetime characteristic of the collected fluorescent light. In some embodiments, the resected tissue sample has not been stained prior to imaging. In some embodiments, the tissue sample has been exposed to a cross-linking agent prior to imaging. In some embodiments, the autofluorescence lifetime characteristic comprises a plurality of fluorescent exponential decay characteristics of a plurality of regions of the resected tissue sample. In some embodiments, the tissue or cell type of interest comprise diseased tissues or cells. In some embodiments, the diseased tissues or cells comprise cancerous tissues or cells. In some embodiments, the tissue sample comprises tissue from colon, breast, prostate, skin, vasculature, or any combination thereof. In some embodiments, characterizing comprises characterizing one or more margins in the resected tissue sample as diseased or non-diseased. In some embodiments, the fluorescence imaging system comprises a pulsed fluorescence light source. In some embodiments, the pulsed fluorescence light source comprises a pulsed fiber laser. In some embodiments, collecting comprises detecting fluorescent light emitted from the tissue sample in response to the pulsed fluorescence light source providing the excitation signal to the tissue sample. In some embodiments, method further comprises informing a surgeon to resect a second tissue sample from the subject. In some embodiments, informing comprises sound, visual display, or any combination thereof directed towards the surgeon. In some embodiments, steps (c) and (d) are completed in up to 5 minutes. In some embodiments, characterization is completed by a probability-based model. In some embodiments, the probability-based model comprises clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. In some embodiments, the subject is suffering from or suspected of suffering from a disease. In some embodiments, the tissue sample is placed on a surface of a tissue sample carrier of the fluorescence prior to directing the excitation signal to the tissue sample. In some embodiments, the tissue sample carrier is configured to mechanically couple to a tissue sample barrier. In some embodiments, the tissue sample carrier and the tissue sample barrier mechanically couple to fix at least two degrees of freedom of the tissue sample carrier.

Aspects of the disclosure provided herein comprise a method for determining the presence of a tissue or cell type of interest in a tissue sample. In some embodiments, the method comprises the steps of: (a) resecting a tissue sample from a subject; (b) placing the tissue sample into a fluorescence imaging system, wherein the fluorescent imaging system directs an excitation signal to the tissue sample and collects fluorescent light emitted from the sample in response; and (c) receiving, from the fluorescence imaging system, a characterization of at least a portion of the tissue sample for the tissue or cell type of interest based on a fluorescent lifetime characteristic of the collected fluorescent light. In some embodiments, the resected tissue sample has not been stained prior to imaging. In some embodiments, the tissue sample has been exposed to a cross-linking agent prior to placing the tissue sample into the fluorescence imaging system. In some embodiments, the autofluorescence lifetime characteristic comprises a plurality of fluorescent exponential decay characteristics of a plurality of regions of the resected tissue sample. In some embodiments, the tissue or cell type of interest comprise diseased tissues or cells. In some embodiments, the diseased tissues or cells comprise cancerous tissues or cells. In some embodiments, the tissue sample comprises tissue from colon, breast, prostate, skin, vasculature, or any combination thereof. In some embodiments, characterization comprises a characterization of one or more margins in the resected tissue sample as diseased or non-diseased. In some embodiments, the fluorescence imaging system comprises a pulsed fluorescence light source. In some embodiments, the pulsed fluorescence light source comprises a pulsed fiber laser. In some embodiments, receiving comprises detecting fluorescent light emitted from the tissue sample in response to the pulsed fluorescence light source providing the excitation signal to the tissue sample. In some embodiments, the method further comprises informing a surgeon to resect a second tissue sample from the subject. In some embodiments, informing comprises sound, visual display, or any combination thereof directed towards the surgeon. In some embodiments, steps (b) and (c) are completed in up to 5 minutes. In some embodiments, characterization is completed by a probability-based model. In some embodiments, the probability-based model comprises clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. In some embodiments, the subject is suffering from or suspected of suffering from a disease. In some embodiments, the tissue sample is placed on a surface of a tissue sample carrier of the fluorescence prior to placing the tissue sample into the fluorescence imaging system. In some embodiments, the tissue sample carrier is configured to mechanically couple to a tissue sample barrier. In some embodiments the tissue sample carrier and the tissue sample barrier mechanically couple to fix at least two degrees of freedom of the tissue sample carrier.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a block diagram of an exemplary system to analyze resected tissue, as described in some embodiments herein.

FIG. 2 illustrates a block diagram of an exemplary system to analyze resected tissue, detailing sub-system optical, opto-electronic, and signal processing controllers, as described in some embodiments herein.

FIGS. 3A-3B illustrate a representative drawing (FIG. 3A) and show an image (FIG. 3B) of an example of a system for intraoperative imaging of surgically resected cancer samples, as described in some embodiments herein.

FIGS. 4A-4B illustrate a representative schematic (FIG. 4A) and show an image (FIG. 4B) of an example system user interface for the intraoperative imaging system, as described in some embodiments herein.

FIG. 5 provides a graph showing the various fluorescence lifetime signal of the plurality of time-resolved fluorescence imaging channels of the system, as described in some embodiments herein.

FIGS. 6A-6B illustrate a workflow diagram for a method of determining the presence or lack thereof cancer by analyzing the autofluorescent signals emitted by a resected tissue sample using the systems, as described in some embodiments herein.

FIGS. 7A-7B illustrate a workflow diagram for a method of determining the presence or lack thereof cancer by analyzing the fluorescent lifetime signals emitted by a resected tissue sample using the systems, as described in some embodiments herein.

FIG. 8 illustrates a system diagram of a computer system comprising a processor configured to acquire and analyze autofluorescence and/or fluorescence lifetime data of a tissue sample, as described in some embodiments herein.

FIGS. 9A-9C illustrate workflow diagrams for system setup and/or preparation operations comprising: device power on (FIG. 9A), password authorization (FIG. 9B), and tray installation (FIG. 9C), as described in some embodiments herein.

FIGS. 10A-10C illustrate workflow diagrams for sample preparation and/or placement operations comprising: preparing a tissue sample (FIG. 10A), placing a tissue sample (FIG. 10B), and selecting a new patient (FIG. 10C), as described in some embodiments herein.

FIGS. 11A-11D illustrate workflow diagrams for sample scanning operations comprising: scan area selection (FIG. 11A), starting a sample scan (FIG. 11B), repositioning and/or replacing a sample (FIG. 11C), and interrupting a scan (FIG. 11D), as described in some embodiments herein.

FIGS. 12A-12B illustrate workflow diagrams for result viewing operations comprising: selecting scan results (FIG. 12A), and reviewing a scan (FIG. 12B), as described in some embodiments herein.

FIG. 13 illustrates a workflow diagram for sample removal operation, as described in some embodiments herein.

FIG. 14 illustrates a workflow diagram for a system time-out operation, as described in some embodiments herein.

FIGS. 15A-15B illustrate a workflow diagram for system shut down operation, as described in some embodiments herein.

FIG. 16 illustrates a workflow diagram for chamber cleaning operations, as described in some embodiments herein.

FIG. 17 illustrates a workflow diagram for device transport operations, as described in some embodiments herein.

FIGS. 18A-18C show image data acquired with the devices and systems described in some embodiments herein. Specifically, images of visible light sample images, fluorescence map images, and corresponding histopathology are shown for resected tissue samples are shown.

FIGS. 19A-19B illustrate a schematic of a data processing workflow, as described in some embodiments herein.

FIGS. 20A-20B illustrate a scanning pattern implemented by the methods and systems, as described in some embodiments herein.

FIGS. 21A-21D illustrate a carrier (FIGS. 21A-21B) and barrier (FIGS. 21C-21D) of the fluorescence imaging system, as described in some embodiments herein.

FIGS. 22A-22B illustrate an exploded view of a drawer, carrier, barrier, and linear actuator in a retracted and expanded state, as described in some embodiments herein.

FIG. 23 illustrates a depth sensor and placement with respect to the scanning optics of the fluorescence imaging system, as described in some embodiments herein.

FIGS. 24A-24C illustrate the fluorescence imaging system drawer, system displays, working surface, and system component storage (i.e., carrier and/or barrier storage), as described in some embodiments herein.

FIG. 25 illustrates a block diagram of an imaging system to analyze samples, as described in some embodiments herein.

FIG. 26 illustrates a block diagram of an amplification-attenuation electronic elements and their interaction with other imaging system components, as described in some embodiments herein.

FIG. 27 illustrates a workflow diagram for system transport and startup operations, as described in some embodiments herein.

FIG. 28 illustrates a workflow diagram of imaging operations for imaging a sample placed on a carrier and barrier within a fluorescence imaging system, as described in some embodiments herein.

FIG. 29 illustrates a workflow diagram of cleaning and system shut down operations for the fluorescence imaging system, as described in some embodiments herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Overview

The disclosure provided herein comprises systems, methods, and devices capable of characterizing tissue, pharmaceutical, agricultural, industrial (e.g., oil and gas), raw material, or any combination thereof samples. Tissue samples may comprise solid tissue and/or liquid biopsy (e.g., blood and/or other bodily fluid). The systems, methods, and devices described herein may be used for one or more applications. In some cases, the application may comprise characterizing a tissue sample intraoperatively, for example, classifying tissue resected from a subject undergoing cancer resection surgery. In some instances, the systems, methods, and devices herein may be configured to determine the extent of the presence of a tissue or cell of interest in tissue margin. In some cases, the tissue or cell of interest may comprise diseased tissues or cells. In some instances, the diseased tissues or cells may comprise cancerous tissues or cells. The tissue sample may comprise cancerous tissue, suspected cancerous tissue, dysplastic tissue, or any combination thereof.

In some instances, the systems, methods, and devices may provide an indication of the presence or lack thereof a tissue or cell of interested in a resected tissue specimen to inform health care personal directing or guiding the course of the surgery. In some cases, the tissue or cell of interest may comprise diseased tissues or cells. In some instances, the diseased tissues or cells may comprise cancerous tissues or cells. In some cases, the application may comprise determining the presence or lack thereof cancer in a dermatologic skin biopsy or surgical resected sample. In some instances, the application may comprise screening intravascular atherosclerotic plaque and determining the classification of the plaque (e.g., stable, unstable, type of lipid content, etc.). The application may comprise differentiating various tissue types (e.g., musculoskeletal tissues, ligaments, etc.).

The various aspects of the disclosure provided herein may provide an advantage of being able to analyze an entirety of a resected tissue sample specimen minutes after (e.g., 5 minutes or less) resecting the specimen posing several advantages over traditional frozen section biopsy. For example, typically, the resected tissue sample sent for frozen section processing may not be analyzed in entirety. Often, due to time and resource limitations in a pathology processing laboratory, up to 3 sections of the entire tissue sample may be taken for analysis. In this regard, sampling error of inadequately sampling the resected tissue to analyze all aspects of the tissue may lead to inaccurate diagnosis of the presence or lack thereof cancer in the tissue sample. Such inaccuracies may lead cancerous tissue not being fully resected from the body of the subject and instead being left in the body post-surgery, which may lead to cancer reoccurrence and metastasis that may bring about further health complications (e.g., poor oxygenation, jaundice, etc.). Aspects of the disclosure provided herein comprise systems, methods, and device that address such shortcomings.

Additionally, aspects of the disclosure provided herein may comprise devices and systems configured to detect fluorescence or autofluorescence emission at real-time imaging speeds. In some cases, the systems and devices described herein may acquire one or more points of fluorescence or autofluorescence data across the entirety of a tissue sample. In some cases, the one or more points of fluorescence or autofluorescence data may comprise one or more fluorescent or multifluorescent lifetime data measurements. In some cases, the devices and systems described herein may process, classify, and false color the one or more points of fluorescence or autofluorescence data to display to the user or operator of the device and/or systems where the presence of a tissue or cells of interest may reside. In some cases, the tissue or cells of interest may comprise diseased tissues or cells. In some instances, the diseased tissues or cells may comprise cancerous tissues or cells. In some cases, real-time imaging speeds may comprise at least 30 μmaging frames per second. The real-time imaging speeds may be enabled by the use of a filter wheel in the system. By incorporating a filter wheel that is intended to physically change the position of a filter into the path of an emitted fluorescence beam it may be believed that the system would not be able to achieve real-time imaging speed. Aspects of the disclosure provided herein may comprise optical elements that are arranged together that provide an unexpected result of signal to noise ratios and imaging speeds. To offset the otherwise long imaging times typically associated with the mechanical process of moving filters in-out of the optical path of the emitted fluorescence, the disclosure provided herein may provide a detector with a numerical aperture that may comprise at least about 30% collection efficiency of the emitted fluorescence emission.

In some cases, the detector may comprise a collection efficiency of about 10% to about 50%. In some cases, the detector may comprise a collection efficiency of about 10% to about 15%, about 10% to about 20%, about 10% to about 25%, about 10% to about 30%, about 10% to about 35%, about 10% to about 40%, about 10% to about 45%, about 10% to about 50%, about 15% to about 20%, about 15% to about 25%, about 15% to about 30%, about 15% to about 35%, about 15% to about 40%, about 15% to about 45%, about 15% to about 50%, about 20% to about 25%, about 20% to about 30%, about 20% to about 35%, about 20% to about 40%, about 20% to about 45%, about 20% to about 50%, about 25% to about 30%, about 25% to about 35%, about 25% to about 40%, about 25% to about 45%, about 25% to about 50%, about 30% to about 35%, about 30% to about 40%, about 30% to about 45%, about 30% to about 50%, about 35% to about 40%, about 35% to about 45%, about 35% to about 50%, about 40% to about 45%, about 40% to about 50%, or about 45% to about 50%. In some cases, the detector may comprise a collection efficiency of about 10% about 15% about 20%, about 25%, about 30%, about 35%, about 40%, about 45%, or about 50%. In some cases, the detector may comprise a collection efficiency of at least about 10%, about 15%, about 20%, about 25%, about 30%, about 35%, about 40%, or about 45%. In some cases, the detector may comprise a collection efficiency of at most about 15% about 20%, about 25%, about 30%, about 35%, about 40%, about 45%, or about 50%.

In some cases, the collection efficiency may enable a short dwell time for a filter of the one or more filters housed within the filter wheel present in the emitted fluorescence beam optical path.

Aspects of the disclosure provided herein may comprise methods, systems, and devices configured to analyze a sample (e.g., a tissue sample). In some instances, the tissue sample may be tissue resected from a subject undergoing an operation to remove a suspected tumor from the subject. In some cases, the systems and devices disclosed herein may analyze the tissue resected from a subject within an operating theater.

The systems and devices of the disclosure provided herein may analyze a plurality of tissue samples. The tissue samples may be a solid or semi-solid tissue sample. The tissue samples may comprise tissue from the prostate, lung, kidney, brain, mucosa, skin, liver, colon, bladder, muscle, breast, eye, mouth, muscle, lymph node, ureters, urethra, esophagus, trachea, stomach, gallbladder, pancreas, intestines, heart, spleen, thymus, thyroid, ovaries, uterus, lungs, appendix, blood vessel, bone, rectum, testicle, or cervix, or any combination thereof. The tissue sample may be any tissue or organ that is accessible through non-surgical or surgical techniques. The tissue sample may be collected from a subject or patient and characterized during a surgical procedure to resect the tissue sample. For example, the tissue sample may be a biopsy that is analyzed in the operating room during surgery or in a pathology lab to provide a preliminary diagnosis prior to immunohistochemical analysis.

In some cases, the system (300, 2300) may comprise an imaging system, user-interface, processor, non-transitory computer readable storage medium including software, dedicated power supply or any combination thereof. In some instances, the system may be housed on a cart to allow for the imaging system to be moved around a hospital and within an operating theater. In some instances, the dedicated power supply may be plugged into a wall socket via a cable 2320. The cable may provide operating power to the imaging system and/or may charge the dedicated power supply of the imaging system. In some instances, the cable may be a retractable cable configured to retract flush against a surface upon actuation of a retraction mechanism of the imaging system. Systems and devices or components thereof of the disclosure provided herein, may be in optical, electrical, mechanical, opto-mechanical or any combination thereof communication between one another.

### Systems

### Imaging System

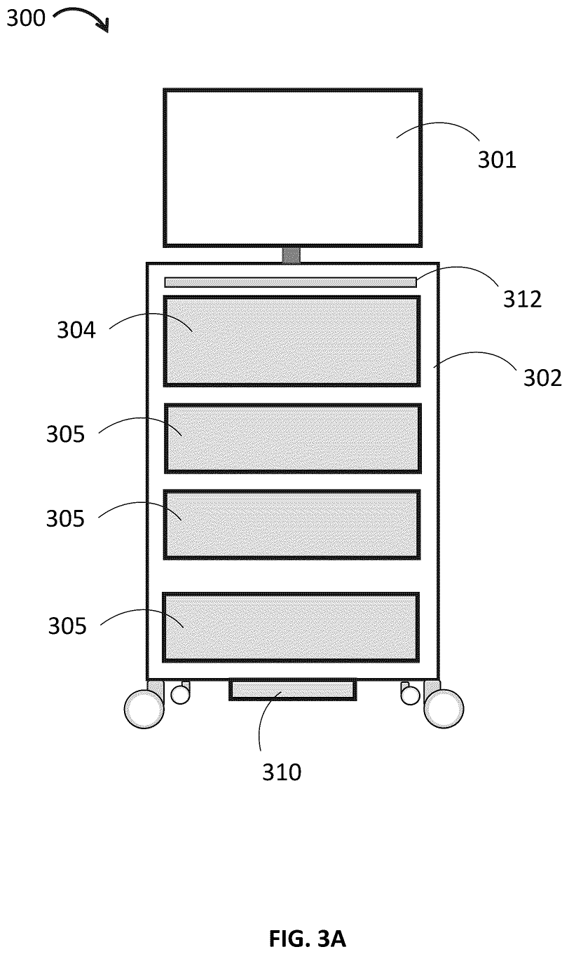

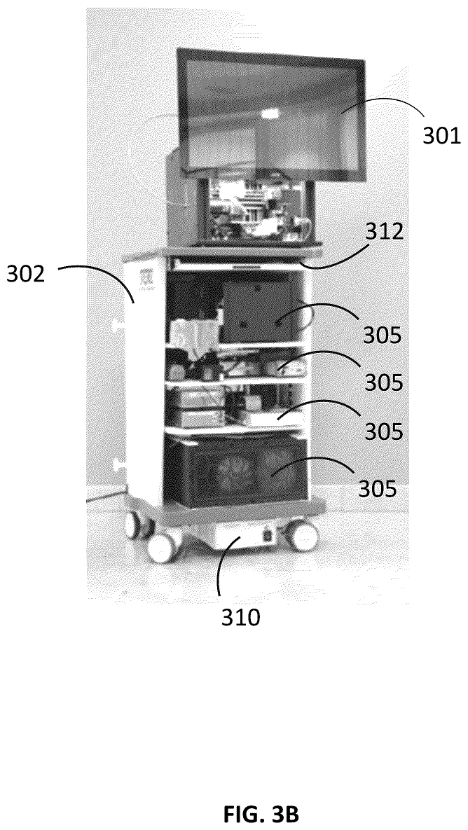

In some cases, the systems of the disclosure provided herein may comprise an imaging system 300, where the imaging system may comprise an imaging engine 304, system electronics 305, user-interface 301, processor, non-transitory computer readable storage medium including software, dedicated power supply 310 or any combination thereof, as seen in FIG. 3A. In some cases, the system may further comprise one or more user interactive devices 312 e.g., a mouse, keyboard, controller, foot pedal or any combination thereof. In some instances, the imaging system may be housed on a cart 302 that may permit the imaging system to be moved around a hospital, pathology lab, operating theater, or any combination thereof. In some instances, the non-transitory computer readable storage medium including software may comprise implementations of machine learning models that may analyze data generated by the imaging system.

FIG. 3B illustrates an example of an imaging system housed on cart described in the disclosure provided herein that may comprise an imaging engine, user-interface, processor, non-transitory computer readable storage medium including software, and dedicated power supply.

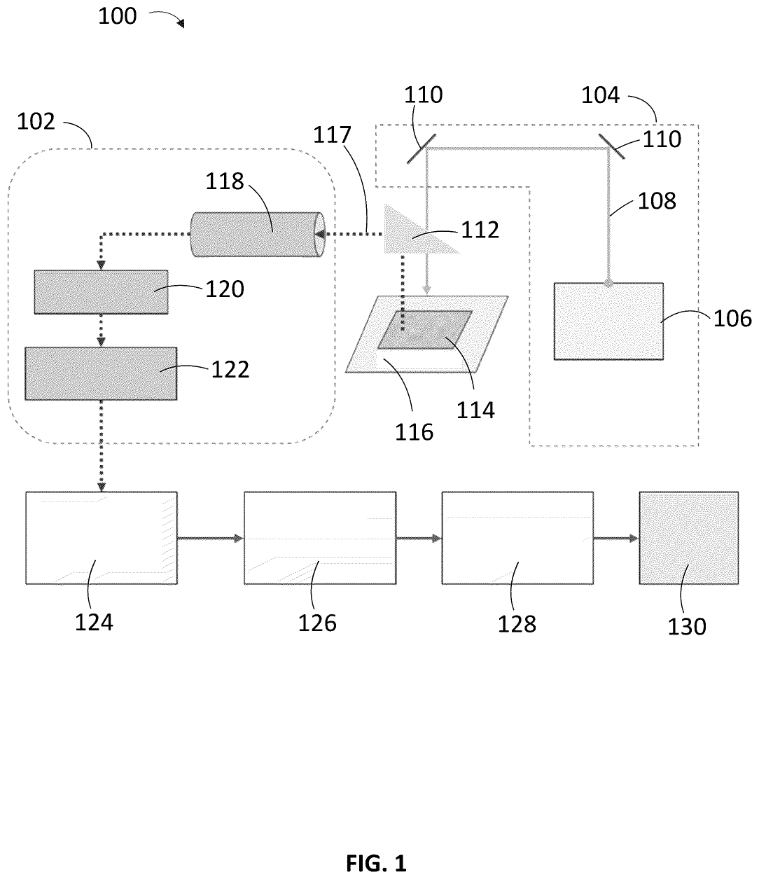

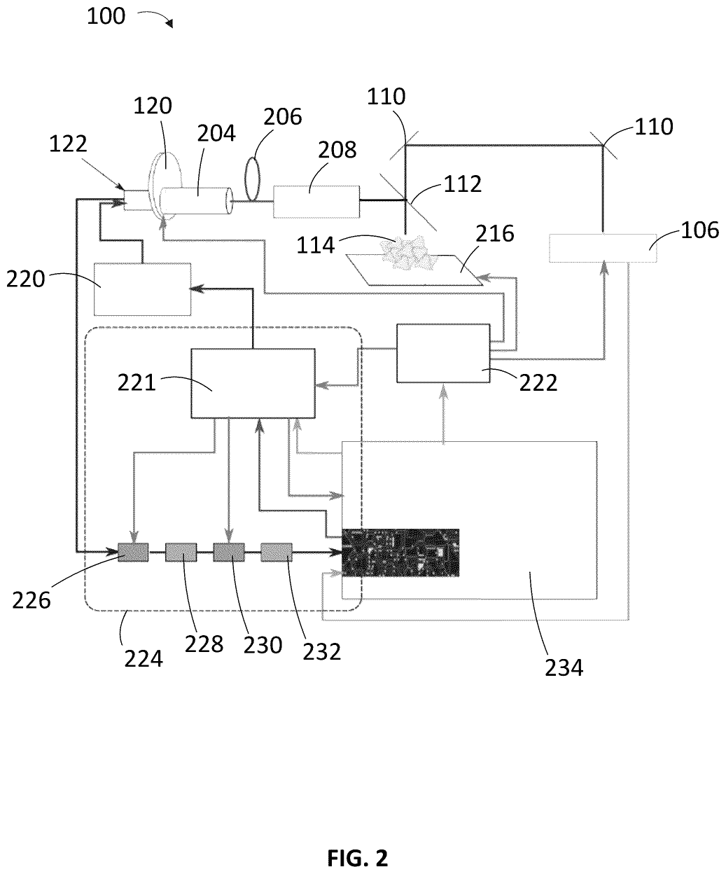

As seen in FIG. 1 and FIG. 2, the imaging system may comprise an imaging system 100 capable of detecting one or more fluorescent or autofluorescent signals from a sample 114 (e.g., a tissue sample). In some cases, the devices and systems shown in FIG. 1 and FIG. 2 may acquire one or more points of fluorescence or autofluorescence data across the entirety of a tissue sample. In some cases, the one or more points of fluorescence or autofluorescence data may comprise one or more fluorescent or multifluorescent lifetime data measurements. In some cases, the devices and systems described herein may process, classify, and false color the one or more points of fluorescence or autofluorescence data to display to the user or operator of the device and/or systems where the presence of a tissue or cells of interest may reside. In some cases, the tissue or cells of interest may comprise diseased tissues or cells. In some instances, the diseased tissues or cells may comprise cancerous tissues or cells.

The fluorescence imaging system may detect autofluorescence, endogenous fluorescence, exogenous fluorescence, fluorescence lifetime, or any combination thereof signal from the tissue sample excited by an excitation light source 106. In some cases, the endogenous fluorescence may be produced by one or more fluorophores. In some instances, the one or more endogenous fluorophores may comprise Flavin mononucleotide (FMN) riboflavin, Flavin adenine dinucleotide (FAD) riboflavin, lipopigments, endogenous porphyrin, free nicotinamide adenosine dinucleotide (NADH), bound NADH, pyridoxal phosphate-glutamate decarboxylase (PLP-GAD), or any combination thereof. In some cases, the exogenous fluorescence may be produced by exogenous fluorophores. In some instances, the exogenous fluorophores may comprise ICG-labeled chlorotoxin, ICG-labeled knottin, Cy5-labeled knottin, Cy7-labeled knottin, fluorescently-conjugated tumor-targeting antibody, fluorescently-labeled tumor-targeting moiety, or any combination thereof. The imaging system may comprise a laser excitation delivery sub-system 104, a signal collection sub-system 102, analog and/or digital signal processing element 124-128, a user interface 130, or any combination thereof.

In some instances, the imaging system may have an imaging acquisition rate of about 50 pixels/second to about 200 pixels/second. In some instances, the imaging system may have an imaging acquisition rate of about 50 pixels/second to about 60 pixels/second, about 50 pixels/second to about 70 pixels/second, about 50 pixels/second to about 80 pixels/second, about 50 pixels/second to about 90 pixels/second, about 50 pixels/second to about 100 pixels/second, about 50 pixels/second to about 150 pixels/second, about 50 pixels/second to about 200 pixels/second, about 60 pixels/second to about 70 pixels/second, about 60 pixels/second to about 80 pixels/second, about 60 pixels/second to about 90 pixels/second, about 60 pixels/second to about 100 pixels/second, about 60 pixels/second to about 150 pixels/second, about 60 pixels/second to about 200 pixels/second, about 70 pixels/second to about 80 pixels/second, about 70 pixels/second to about 90 pixels/second, about 70 pixels/second to about 100 pixels/second, about 70 pixels/second to about 150 pixels/second, about 70 pixels/second to about 200 pixels/second, about 80 pixels/second to about 90 pixels/second, about 80 pixels/second to about 100 pixels/second, about 80 pixels/second to about 150 pixels/second, about 80 pixels/second to about 200 pixels/second, about 90 pixels/second to about 100 pixels/second, about 90 pixels/second to about 150 pixels/second, about 90 pixels/second to about 200 pixels/second, about 100 pixels/second to about 150 pixels/second, about 100 pixels/second to about 200 pixels/second, or about 150 pixels/second to about 200 pixels/second. In some instances, the imaging system may have an imaging acquisition rate of about 50 pixels/second, about 60 pixels/second, about 70 pixels/second, about 80 pixels/second, about 90 pixels/second, about 100 pixels/second, about 150 pixels/second, or about 200 pixels/second. In some instances, the imaging system may have an imaging acquisition rate of at least about 50 pixels/second, about 60 pixels/second, about 70 pixels/second, about 80 pixels/second, about 90 pixels/second, about 100 pixels/second, or about 150 pixels/second. In some instances, the imaging system may have an imaging acquisition rate of at most about 60 pixels/second, about 70 pixels/second, about 80 pixels/second, about 90 pixels/second, about 100 pixels/second, about 150 pixels/second, or about 200 pixels/second.

In some cases, the laser excitation delivery sub-system 104 may comprise a one or more excitation optics 110, a light source 106, or any combination thereof. In some cases, the one or more excitation optics elements may comprise mirrors, optical attenuators, optical isolators, filters, lenses, iris apertures, acoustic optic modulator (AOM), or any combination thereof.

The light source 106 may be configured to generate an excitation light 108 comprising a pulse or beam of continuous light at a pre-determined excitation wavelength. The excitation light 108 generated by the light source 106 may comprise a pulse energy, a pulse frequency, a pulse with of about (ns), or any combination thereof.

In some cases, the excitation light may have a pulse energy of about 1 μJ/mm\hat{ }² to about 600 μJ/mm². In some instances, the excitation light may have a pulse energy of about 1 μJ/mm\hat{ }² to about 2 μJ/mm\hat{ }², about 1 μJ/mm\hat{ }² to about 5 μJ/mm\hat{ }², about 1 μJ/mm\hat{ }² to about 10 μJ/mm\hat{ }², about 1 μJ/mm\hat{ }² to about 20 μJ/mm\hat{ }², about 1 μJ/mm\hat{ }² to about 30 μJ/mm\hat{ }², about 1 μJ/mm\hat{ }² to about 40 μJ/mm\hat{ }², about 1 μJ/mm\hat{ }² to about 50 μJ/mm\hat{ }², about 1 μJ/mm\hat{ }² to about 60 μJ/mm\hat{ }², about 2 μJ/mm\hat{ }² to about 5 μJ/mm\hat{ }², about 2 μJ/mm\hat{ }² to about 10 μJ/mm\hat{ }², about 2 μJ/mm\hat{ }² to about 20 μJ/mm\hat{ }², about 2 μJ/mm\hat{ }² to about 30 μJ/mm\hat{ }², about 2 μJ/mm\hat{ }² to about 40 μJ/mm\hat{ }², about 2 μJ/mm\hat{ }² to about 50 μJ/mm\hat{ }², about 2 μJ/mm\hat{ }² to about 60 μJ/mm\hat{ }², about 5 μJ/mm\hat{ }² to about 10 μJ/mm\hat{ }², about 5 μJ/mm\hat{ }² to about 20 μJ/mm\hat{ }², about 5 μJ/mm\hat{ }² to about 30 μJ/mm\hat{ }², about 5 μJ/mm\hat{ }² to about 40 μJ/mm\hat{ }², about 5 μJ/mm\hat{ }² to about 50 μJ/mm\hat{ }², about 5 μJ/mm\hat{ }² to about 60 μJ/mm\hat{ }², about 10 μJ/mm\hat{ }² to about 20 μJ/mm\hat{ }², about 10 μJ/mm\hat{ }² to about 30 μJ/mm\hat{ }², about 10 μJ/mm\hat{ }² to about 40 μJ/mm\hat{ }², about 10 μJ/mm\hat{ }² to about 50 μJ/mm\hat{ }², about 10 μJ/mm\hat{ }² to about 60 μJ/mm\hat{ }², about 20 μJ/mm\hat{ }² to about 30 μJ/mm\hat{ }², about 20 μJ/mm\hat{ }² to about 40 μJ/mm\hat{ }², about 20 μJ/mm\hat{ }² to about 50 μJ/mm\hat{ }², about 20 μJ/mm\hat{ }² to about 60 μJ/mm\hat{ }², about 30 μJ/mm\hat{ }² to about 40 μJ/mm\hat{ }², about 30 μJ/mm\hat{ }² to about 50 μJ/mm\hat{ }², about 30 μJ/mm\hat{ }² to about 60 μJ/mm\hat{ }², about 40 μJ/mm\hat{ }² to about 50 μJ/mm\hat{ }², about 40 μJ/mm\hat{ }² to about 60 μJ/mm\hat{ }², or about 50 μJ/mm\hat{ }² to about 60 μJ/mm\hat{ }². In some embodiments, the excitation light may have a pulse energy of about 1 μJ/mm\hat{ }², about 2 μJ/mm\hat{ }², about 5 μJ/mm\hat{ }², about 10 μJ/mm\hat{ }², about 20 μJ/mm\hat{ }², about 30 μJ/mm\hat{ }², about 40 μJ/mm\hat{ }², about 50 μJ/mm\hat{ }², or about 60 μJ/mm\hat{ }². In some cases, the excitation light may have a pulse energy of at least about 1 μJ/mm\hat{ }², about 2 μJ/mm\hat{ }², about 5 μJ/mm\hat{ }², about 10 μJ/mm\hat{ }², about 20 μJ/mm\hat{ }², about 30 μJ/mm\hat{ }², about 40 μJ/mm\hat{ }², or about 50 μJ/mm\hat{ }². In some embodiments, the excitation light may comprise a pulse energy of at most about 2 μJ/mm\hat{ }², about 5 μJ/mm\hat{ }², about 10 μJ/mm\hat{ }², about 20 μJ/mm\hat{ }², about 30 μJ/mm\hat{ }², about 40 μJ/mm\hat{ }², about 50 μJ/mm\hat{ }², or about 60 μJ/mm\hat{ }².

In some cases, the excitation light may have a pulse frequency about 1 kilohertz (kHz) to about 10,000 kHz. In some cases, the excitation light may have a pulse frequency about 1 kHz to about 5 kHz, about 1 kHz to about 10 kHz, about 1 kHz to about 20 kHz, about 1 kHz to about 50 kHz, about 1 kHz to about 100 kHz, about 1 kHz to about 500 kHz, about 1 kHz to about 1,000 kHz, about 1 kHz to about 5,000 kHz, about 1 kHz to about 10,000 kHz, about 5 kHz to about 10 kHz, about 5 kHz to about 20 kHz, about 5 kHz to about 50 kHz, about 5 kHz to about 100 kHz, about 5 kHz to about 500 kHz, about 5 kHz to about 1,000 kHz, about 5 kHz to about 5,000 kHz, about 5 kHz to about 10,000 kHz, about 10 kHz to about 20 kHz, about 10 kHz to about 50 kHz, about 10 kHz to about 100 kHz, about 10 kHz to about 500 kHz, about 10 kHz to about 1,000 kHz, about 10 kHz to about 5,000 kHz, about 10 kHz to about 10,000 kHz, about 20 kHz to about 50 kHz, about 20 kHz to about 100 kHz, about 20 kHz to about 500 kHz, about 20 kHz to about 1,000 kHz, about 20 kHz to about 5,000 kHz, about 20 kHz to about 10,000 kHz, about 50 kHz to about 100 kHz, about 50 kHz to about 500 kHz, about 50 kHz to about 1,000 kHz, about 50 kHz to about 5,000 kHz, about 50 kHz to about 10,000 kHz, about 100 kHz to about 500 kHz, about 100 kHz to about 1,000 kHz, about 100 kHz to about 5,000 kHz, about 100 kHz to about 10,000 kHz, about 500 kHz to about 1,000 kHz, about 500 kHz to about 5,000 kHz, about 500 kHz to about 10,000 kHz, about 1,000 kHz to about 5,000 kHz, about 1,000 kHz to about 10,000 kHz, or about 5,000 kHz to about 10,000 kHz. In some cases, the excitation light may comprise a pulse frequency about 1 kHz, about 5 kHz, about 10 kHz, about 20 kHz, about 50 kHz, about 100 kHz, about 500 kHz, about 1,000 kHz, about 5,000 kHz, or about 10,000 kHz. In some cases, the excitation light may have a pulse frequency at least about 1 kHz, about 5 kHz, about 10 kHz, about 20 kHz, about 50 kHz, about 100 kHz, about 500 kHz, about 1,000 kHz, or about 5,000 kHz. In some cases, the excitation light may have a pulse frequency at most about 5 kHz, about 10 kHz, about 20 kHz, about 50 kHz, about 100 kHz, about 500 kHz, about 1,000 kHz, about 5,000 kHz, or about 10,000 kHz.

In some cases, the excitation light may have a pulse width of about 1 pico second (ps) to about 60,000 ps. In some cases, the excitation light may have a pulse width of about 1 ps to about 50 ps, about 1 ps to about 100 ps, about 1 ps to about 500 ps, about 1 ps to about 1,000 ps, about 1 ps to about 5,000 ps, about 1 ps to about 10,000 ps, about 1 ps to about 20,000 ps, about 1 ps to about 40,000 ps, about 1 ps to about 60,000 ps, about 50 ps to about 100 ps, about 50 ps to about 500 ps, about 50 ps to about 1,000 ps, about 50 ps to about 5,000 ps, about 50 ps to about 10,000 ps, about 50 ps to about 20,000 ps, about 50 ps to about 40,000 ps, about 50 ps to about 60,000 ps, about 100 ps to about 500 ps, about 100 ps to about 1,000 ps, about 100 ps to about 5,000 ps, about 100 ps to about 10,000 ps, about 100 ps to about 20,000 ps, about 100 ps to about 40,000 ps, about 100 ps to about 60,000 ps, about 500 ps to about 1,000 ps, about 500 ps to about 5,000 ps, about 500 ps to about 10,000 ps, about 500 ps to about 20,000 ps, about 500 ps to about 40,000 ps, about 500 ps to about 60,000 ps, about 1,000 ps to about 5,000 ps, about 1,000 ps to about 10,000 ps, about 1,000 ps to about 20,000 ps, about 1,000 ps to about 40,000 ps, about 1,000 ps to about 60,000 ps, about 5,000 ps to about 10,000 ps, about 5,000 ps to about 20,000 ps, about 5,000 ps to about 40,000 ps, about 5,000 ps to about 60,000 ps, about 10,000 ps to about 20,000 ps, about 10,000 ps to about 40,000 ps, about 10,000 ps to about 60,000 ps, about 20,000 ps to about 40,000 ps, about 20,000 ps to about 60,000 ps, or about 40,000 ps to about 60,000 ps. In some cases, the excitation light may have a pulse width of about 1 ps, about 50 ps, about 100 ps, about 500 ps, about 1,000 ps, about 5,000 ps, about 10,000 ps, about 20,000 ps, about 40,000 ps, or about 60,000 ps. In some cases, the excitation light may have a pulse width of at least about 1 ps, about 50 ps, about 100 ps, about 500 ps, about 1,000 ps, about 5,000 ps, about 10,000 ps, about 20,000 ps, or about 40,000 ps. In some cases, the excitation light may have a pulse width of at most about 50 ps, about 100 ps, about 500 ps, about 1,000 ps, about 5,000 ps, about 10,000 ps, about 20,000 ps, about 40,000 ps, or about 60,000 ps.

The light source 106 may comprise any number of light sources such as a pulsed laser, a continuous wave laser, a modulated laser, a tunable laser, an LED, or any combination thereof. The pre-determined excitation wavelength of the light source 106 may be in one or more of the ultraviolet spectra, the visible spectrum, the near infrared spectrum, and/or the infrared spectrum, for example within a range of about 300 nm to about 1100 nm. In

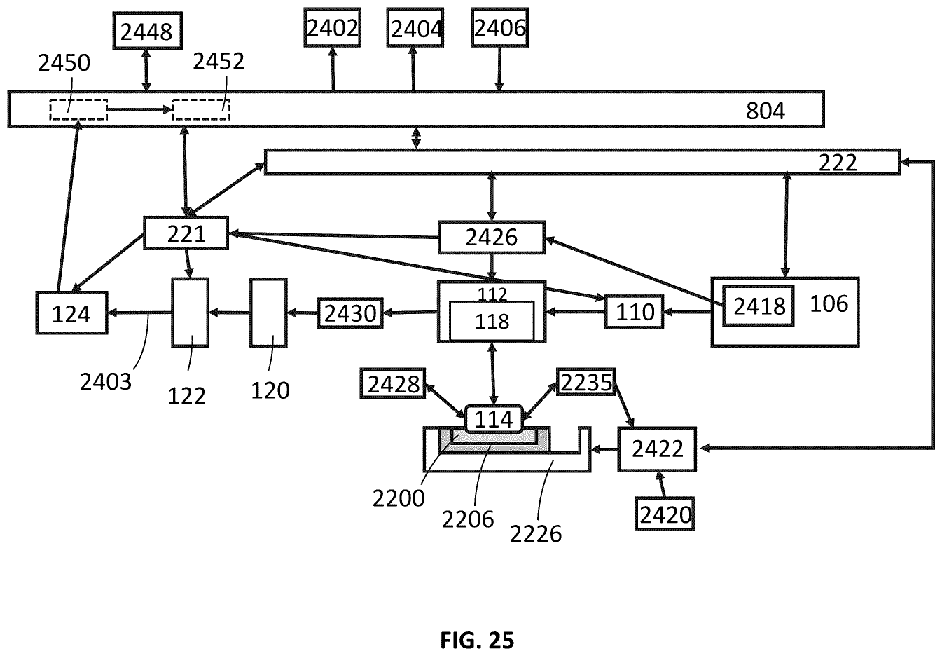

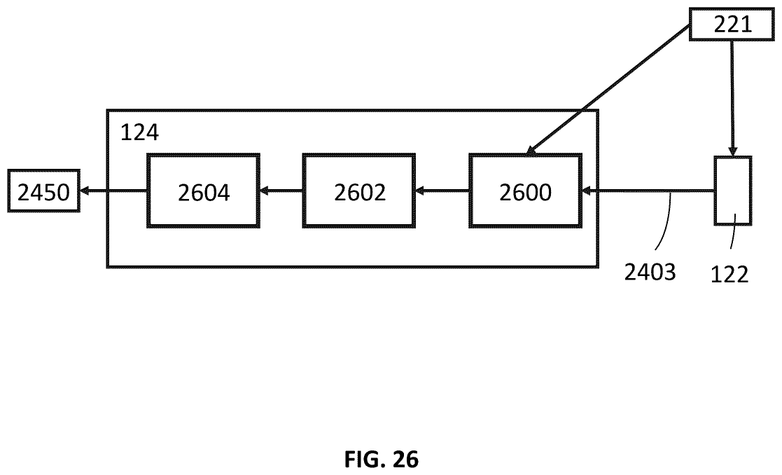

In some instances, the pulsed laser may be used as a master clock for timing one or more other imaging system components e.g., stage, a scanning controller 2426, gain controller 221, optical scanning element 112, data acquisition, or any combination thereof. In some cases, the pulsed laser clock signal may be generated internal and/or external to the light source 106 by a pulse controller 2418 and/or seed laser. In some cases, the pulse controller and/or seed laser may provide a synchronizing clock and/or trigger signal to the scanning controller 2426. In some instances, the light source may comprise a circular or square ring LED light source, where the light emitted from the one or more LEDS of the circular or square ring LED light source is within a visible spectrum. In some cases, the circular or square ring LED light source may be configured to illuminate the tissue sample to generate a diffuse visible light image detected by a camera and/or visible light sensor 2428, as seen in FIG. 25. In some cases, the brightness of the circular or square LED may be current controlled or pulse width modulation controlled. The brightness of the LED light source may be tuned to increase the signal to noise ratio of the visible light image captured by the camera and/or visible light sensor. In some instances, the camera may generate a live image (e.g., a video) of the tissue specimen that may be used as an overlay and/or to correlate the spatial position of fluorescence imaging data to a spatial position on the sample. In some cases, the camera may comprise a rolling shutter.

The pre-determined excitation wavelength of the light source 106 may be in a range of about 330 nm to about 360 nm, about 420 nm to about 450 nm, about 660 nm to about 720 nm, or about 750 nm to about 780 nm. For example, the light source 106 may emit a light pulse at about 355 nm. The light source 106 may emit a light pulse at about 700 nm or about 710 nm. The wavelength of the light source 106 may be chosen such that the sample 114 produces a responsive optical signal upon excitation with the light pulse. The wavelength of the light source may be chosen such that sample 114 produces a responsive optical signal without being damaged.

In some cases, the pulsed laser may comprise a pulsed fiber laser. In some instances, the pulsed fiber laser may comprise a master oscillator power amplifier (MOPA) laser configuration. The master oscillator power amplifier laser configuration may comprise one or more laser sub-system components e.g., a seed laser, fiber optic amplifier, harmonics module, or any combination thereof laser sub-system components. In some cases, the MOPA laser configuration may provide a form factor to enable bench top use of the imaging system.

In some instances, the pulsed fiber laser with a MOPA configuration may comprise a width of about 200 mm to about 500 mm. In some instances, the pulsed fiber laser with a MOPA configuration may comprise a width of about 200 mm to about 220 mm, about 200 mm to about 240 mm, about 200 mm to about 260 mm, about 200 mm to about 280 mm, about 200 mm to about 300 mm, about 200 mm to about 320 mm, about 200 mm to about 340 mm, about 200 mm to about 360 mm, about 200 mm to about 380 mm, about 200 mm to about 400 mm, about 200 mm to about 500 mm, about 220 mm to about 240 mm, about 220 mm to about 260 mm, about 220 mm to about 280 mm, about 220 mm to about 300 mm, about 220 mm to about 320 mm, about 220 mm to about 340 mm, about 220 mm to about 360 mm, about 220 mm to about 380 mm, about 220 mm to about 400 mm, about 220 mm to about 500 mm, about 240 mm to about 260 mm, about 240 mm to about 280 mm, about 240 mm to about 300 mm, about 240 mm to about 320 mm, about 240 mm to about 340 mm, about 240 mm to about 360 mm, about 240 mm to about 380 mm, about 240 mm to about 400 mm, about 240 mm to about 500 mm, about 260 mm to about 280 mm, about 260 mm to about 300 mm, about 260 mm to about 320 mm, about 260 mm to about 340 mm, about 260 mm to about 360 mm, about 260 mm to about 380 mm, about 260 mm to about 400 mm, about 260 mm to about 500 mm, about 280 mm to about 300 mm, about 280 mm to about 320 mm, about 280 mm to about 340 mm, about 280 mm to about 360 mm, about 280 mm to about 380 mm, about 280 mm to about 400 mm, about 280 mm to about 500 mm, about 300 mm to about 320 mm, about 300 mm to about 340 mm, about 300 mm to about 360 mm, about 300 mm to about 380 mm, about 300 mm to about 400 mm, about 300 mm to about 500 mm, about 320 mm to about 340 mm, about 320 mm to about 360 mm, about 320 mm to about 380 mm, about 320 mm to about 400 mm, about 320 mm to about 500 mm, about 340 mm to about 360 mm, about 340 mm to about 380 mm, about 340 mm to about 400 mm, about 340 mm to about 500 mm, about 360 mm to about 380 mm, about 360 mm to about 400 mm, about 360 mm to about 500 mm, about 380 mm to about 400 mm, about 380 mm to about 500 mm, or about 400 mm to about 500 mm. In some instances, the pulsed fiber laser with a MOPA configuration may comprise a width of about 200 mm, about 220 mm, about 240 mm, about 260 mm, about 280 mm, about 300 mm, about 320 mm, about 340 mm, about 360 mm, about 380 mm, about 400 mm, or about 500 mm. In some instances, the pulsed fiber laser with a MOPA configuration may comprise a width of at least about 200 mm, about 220 mm, about 240 mm, about 260 mm, about 280 mm, about 300 mm, about 320 mm, about 340 mm, about 360 mm, about 380 mm, or about 400 mm. In some instances, the pulsed fiber laser with a MOPA configuration may comprise a width of at most about 220 mm, about 240 mm, about 260 mm, about 280 mm, about 300 mm, about 320 mm, about 340 mm, about 360 mm, about 380 mm, about 400 mm, or about 500 mm.

In some instances, the pulsed fiber laser with a MOPA configuration may comprise a length of about 500 mm to about 800 mm. In some instances, the pulsed fiber laser with a MOPA configuration may comprise a length of about 500 mm to about 520 mm, about 500 mm to about 540 mm, about 500 mm to about 560 mm, about 500 mm to about 580 mm, about 500 mm to about 600 mm, about 500 mm to about 620 mm, about 500 mm to about 640 mm, about 500 mm to about 660 mm, about 500 mm to about 680 mm, about 500 mm to about 700 mm, about 500 mm to about 800 mm, about 520 mm to about 540 mm, about 520 mm to about 560 mm, about 520 mm to about 580 mm, about 520 mm to about 600 mm, about 520 mm to about 620 mm, about 520 mm to about 640 mm, about 520 mm to about 660 mm, about 520 mm to about 680 mm, about 520 mm to about 700 mm, about 520 mm to about 800 mm, about 540 mm to about 560 mm, about 540 mm to about 580 mm, about 540 mm to about 600 mm, about 540 mm to about 620 mm, about 540 mm to about 640 mm, about 540 mm to about 660 mm, about 540 mm to about 680 mm, about 540 mm to about 700 mm, about 540 mm to about 800 mm, about 560 mm to about 580 mm, about 560 mm to about 600 mm, about 560 mm to about 620 mm, about 560 mm to about 640 mm, about 560 mm to about 660 mm, about 560 mm to about 680 mm, about 560 mm to about 700 mm, about 560 mm to about 800 mm, about 580 mm to about 600 mm, about 580 mm to about 620 mm, about 580 mm to about 640 mm, about 580 mm to about 660 mm, about 580 mm to about 680 mm, about 580 mm to about 700 mm, about 580 mm to about 800 mm, about 600 mm to about 620 mm, about 600 mm to about 640 mm, about 600 mm to about 660 mm, about 600 mm to about 680 mm, about 600 mm to about 700 mm, about 600 mm to about 800 mm, about 620 mm to about 640 mm, about 620 mm to about 660 mm, about 620 mm to about 680 mm, about 620 mm to about 700 mm, about 620 mm to about 800 mm, about 640 mm to about 660 mm, about 640 mm to about 680 mm, about 640 mm to about 700 mm, about 640 mm to about 800 mm, about 660 mm to about 680 mm, about 660 mm to about 700 mm, about 660 mm to about 800 mm, about 680 mm to about 700 mm, about 680 mm to about 800 mm, or about 700 mm to about 800 mm. In some instances, the pulsed fiber laser with a MOPA configuration may comprise a length of about 500 mm, about 520 mm, about 540 mm, about 560 mm, about 580 mm, about 600 mm, about 620 mm, about 640 mm, about 660 mm, about 680 mm, about 700 mm, or about 800 mm. In some instances, the pulsed fiber laser with a MOPA configuration may comprise a length of at least about 500 mm, about 520 mm, about 540 mm, about 560 mm, about 580 mm, about 600 mm, about 620 mm, about 640 mm, about 660 mm, about 680 mm, or about 700 mm. In some instances, the pulsed fiber laser with a MOPA configuration may comprise a length of at most about 520 mm, about 540 mm, about 560 mm, about 580 mm, about 600 mm, about 620 mm, about 640 mm, about 660 mm, about 680 mm, about 700 mm, or about 800 mm.

In some instances, the pulsed fiber laser with a MOPA configuration may comprise a height of about 50 mm to about 100 mm. In some instances, the pulsed fiber laser with a MOPA configuration may comprise a height of about 50 mm to about 55 mm, about 50 mm to about 60 mm, about 50 mm to about 65 mm, about 50 mm to about 70 mm, about 50 mm to about 75 mm, about 50 mm to about 80 mm, about 50 mm to about 85 mm, about 50 mm to about 90 mm, about 50 mm to about 100 mm, about 55 mm to about 60 mm, about 55 mm to about 65 mm, about 55 mm to about 70 mm, about 55 mm to about 75 mm, about 55 mm to about 80 mm, about 55 mm to about 85 mm, about 55 mm to about 90 mm, about 55 mm to about 100 mm, about 60 mm to about 65 mm, about 60 mm to about 70 mm, about 60 mm to about 75 mm, about 60 mm to about 80 mm, about 60 mm to about 85 mm, about 60 mm to about 90 mm, about 60 mm to about 100 mm, about 65 mm to about 70 mm, about 65 mm to about 75 mm, about 65 mm to about 80 mm, about 65 mm to about 85 mm, about 65 mm to about 90 mm, about 65 mm to about 100 mm, about 70 mm to about 75 mm, about 70 mm to about 80 mm, about 70 mm to about 85 mm, about 70 mm to about 90 mm, about 70 mm to about 100 mm, about 75 mm to about 80 mm, about 75 mm to about 85 mm, about 75 mm to about 90 mm, about 75 mm to about 100 mm, about 80 mm to about 85 mm, about 80 mm to about 90 mm, about 80 mm to about 100 mm, about 85 mm to about 90 mm, about 85 mm to about 100 mm, or about 90 mm to about 100 mm. In some instances, the pulsed fiber laser with a MOPA configuration may comprise a height of about 50 mm, about 55 mm, about 60 mm, about 65 mm, about 70 mm, about 75 mm, about 80 mm, about 85 mm, about 90 mm, or about 100 mm. In some instances, the pulsed fiber laser with a MOPA configuration may comprise a height of at least about 50 mm, about 55 mm, about 60 mm, about 65 mm, about 70 mm, about 75 mm, about 80 mm, about 85 mm, or about 90 mm. In some instances, the pulsed fiber laser with a MOPA configuration may comprise a height of at most about 55 mm, about 60 mm, about 65 mm, about 70 mm, about 75 mm, about 80 mm, about 85 mm, about 90 mm, or about 100 mm.

In some cases, the MOPA laser configuration may provide a robust long life laser that may be continually run without a warmup period ahead of imaging that could reduce overall imaging time. In some instances, the MOPA laser configuration can reduce the overall laser cost compared to the cost of a solid state laser.

In some instances, the MOPA fiber laser may comprise a seed laser, where the seed laser may comprise an infrared (IR) pulsed laser, configured to continually output pulses from e.g., about 70 MHz to about 80 MHz repetition rate that is selected down to e.g., pulses up to about 500 kHz repetition rate or an excitation light pulse frequency as described elsewhere herein. In some instances, the infrared pulsed laser may comprise a pulse width of at least about 50 ps, or an excitation light pulse width, described elsewhere herein.

In some cases, the output wavelength of the infrared pulsed laser may comprise about 1064 nanometers (nm). In some instances, the infrared pulsed laser may comprise an output wavelength of about 1,000 nm to about 1,600 nm. In some instances, the infrared pulsed laser may comprise an output wavelength of about 1,000 nm to about 1,020 nm, about 1,000 nm to about 1,040 nm, about 1,000 nm to about 1,060 nm, about 1,000 nm to about 1,080 nm, about 1,000 nm to about 1,100 nm, about 1,000 nm to about 1,120 nm, about 1,000 nm to about 1,140 nm, about 1,000 nm to about 1,180 nm, about 1,000 nm to about 1,200 nm, about 1,000 nm to about 1,300 nm, about 1,000 nm to about 1,600 nm, about 1,020 nm to about 1,040 nm, about 1,020 nm to about 1,060 nm, about 1,020 nm to about 1,080 nm, about 1,020 nm to about 1,100 nm, about 1,020 nm to about 1,120 nm, about 1,020 nm to about 1,140 nm, about 1,020 nm to about 1,180 nm, about 1,020 nm to about 1,200 nm, about 1,020 nm to about 1,300 nm, about 1,020 nm to about 1,600 nm, about 1,040 nm to about 1,060 nm, about 1,040 nm to about 1,080 nm, about 1,040 nm to about 1,100 nm, about 1,040 nm to about 1,120 nm, about 1,040 nm to about 1,140 nm, about 1,040 nm to about 1,180 nm, about 1,040 nm to about 1,200 nm, about 1,040 nm to about 1,300 nm, about 1,040 nm to about 1,600 nm, about 1,060 nm to about 1,080 nm, about 1,060 nm to about 1,100 nm, about 1,060 nm to about 1,120 nm, about 1,060 nm to about 1,140 nm, about 1,060 nm to about 1,180 nm, about 1,060 nm to about 1,200 nm, about 1,060 nm to about 1,300 nm, about 1,060 nm to about 1,600 nm, about 1,080 nm to about 1,100 nm, about 1,080 nm to about 1,120 nm, about 1,080 nm to about 1,140 nm, about 1,080 nm to about 1,180 nm, about 1,080 nm to about 1,200 nm, about 1,080 nm to about 1,300 nm, about 1,080 nm to about 1,600 nm, about 1,100 nm to about 1,120 nm, about 1,100 nm to about 1,140 nm, about 1,100 nm to about 1,180 nm, about 1,100 nm to about 1,200 nm, about 1,100 nm to about 1,300 nm, about 1,100 nm to about 1,600 nm, about 1,120 nm to about 1,140 nm, about 1,120 nm to about 1,180 nm, about 1,120 nm to about 1,200 nm, about 1,120 nm to about 1,300 nm, about 1,120 nm to about 1,600 nm, about 1,140 nm to about 1,180 nm, about 1,140 nm to about 1,200 nm, about 1,140 nm to about 1,300 nm, about 1,140 nm to about 1,600 nm, about 1,180 nm to about 1,200 nm, about 1,180 nm to about 1,300 nm, about 1,180 nm to about 1,600 nm, about 1,200 nm to about 1,300 nm, about 1,200 nm to about 1,600 nm, or about 1,300 nm to about 1,600 nm. In some instances, the infrared pulsed laser may comprise an output wavelength of about 1,000 nm, about 1,020 nm, about 1,040 nm, about 1,060 nm, about 1,080 nm, about 1,100 nm, about 1,120 nm, about 1,140 nm, about 1,180 nm, about 1,200 nm, about 1,300 nm, or about 1,600 nm. In some instances, the infrared pulsed laser may comprise an output wavelength of at least about 1,000 nm, about 1,020 nm, about 1,040 nm, about 1,060 nm, about 1,080 nm, about 1,100 nm, about 1,120 nm, about 1,140 nm, about 1,180 nm, about 1,200 nm, or about 1,300 nm. In some instances, the infrared pulsed laser may comprise an output wavelength of at most about 1,020 nm, about 1,040 nm, about 1,060 nm, about 1,080 nm, about 1,100 nm, about 1,120 nm, about 1,140 nm, about 1,180 nm, about 1,200 nm, about 1,300 nm, or about 1,600 nm.

In some cases, the infrared pulsed laser may comprise an output power of about 1 W to about 20 W. In some cases, the infrared pulsed laser may comprise an output power of about 1 W to about 2 W, about 1 W to about 4 W, about 1 W to about 6 W, about 1 W to about 8 W, about 1 W to about 10 W, about 1 W to about 12 W, about 1 W to about 15 W, about 1 W to about 20 W, about 2 W to about 4 W, about 2 W to about 6 W, about 2 W to about 8 W, about 2 W to about 10 W, about 2 W to about 12 W, about 2 W to about 15 W, about 2 W to about 20 W, about 4 W to about 6 W, about 4 W to about 8 W, about 4 W to about 10 W, about 4 W to about 12 W, about 4 W to about 15 W, about 4 W to about 20 W, about 6 W to about 8 W, about 6 W to about 10 W, about 6 W to about 12 W, about 6 W to about 15 W, about 6 W to about 20 W, about 8 W to about 10 W, about 8 W to about 12 W, about 8 W to about 15 W, about 8 W to about 20 W, about 10 W to about 12 W, about 10 W to about 15 W, about 10 W to about 20 W, about 12 W to about 15 W, about 12 W to about 20 W, or about 15 W to about 20 W. In some cases, the infrared pulsed laser may comprise an output power of about 1 W, about 2 W, about 4 W, about 6 W, about 8 W, about 10 W, about 12 W, about 15 W, or about 20 W. In some cases, the infrared pulsed laser may comprise an output power of at least about 1 W, about 2 W, about 4 W, about 6 W, about 8 W, about 10 W, about 12 W, or about 15 W. In some cases, the infrared pulsed laser may comprise an output power of at most about 2 W, about 4 W, about 6 W, about 8 W, about 10 W, about 12 W, about 15 W, or about 20 W.

In some instances, the harmonics module of the MOPA fiber laser may convert the pulsed IR seed laser to a pulsed ultraviolet (UV) laser with spectral output (e.g., from about 300 nanometers (nm) to about 365 nm). In some instances, the harmonics module may comprise a crystal configured to convert the pulsed IR seed laser to UV pulses. In some instances, the crystal may comprise a finite life of up to about 10,000 hours of outputting UV pulses.

In some instances, the crystal may comprise a life of about 1,000 hours to about 30,000 hours. In some instances, the crystal may comprise a life of about 1,000 hours to about 2,000 hours, about 1,000 hours to about 5,000 hours, about 1,000 hours to about 10,000 hours, about 1,000 hours to about 15,000 hours, about 1,000 hours to about 20,000 hours, about 1,000 hours to about 25,000 hours, about 1,000 hours to about 30,000 hours, about 2,000 hours to about 5,000 hours, about 2,000 hours to about 10,000 hours, about 2,000 hours to about 15,000 hours, about 2,000 hours to about 20,000 hours, about 2,000 hours to about 25,000 hours, about 2,000 hours to about 30,000 hours, about 5,000 hours to about 10,000 hours, about 5,000 hours to about 15,000 hours, about 5,000 hours to about 20,000 hours, about 5,000 hours to about 25,000 hours, about 5,000 hours to about 30,000 hours, about 10,000 hours to about 15,000 hours, about 10,000 hours to about 20,000 hours, about 10,000 hours to about 25,000 hours, about 10,000 hours to about 30,000 hours, about 15,000 hours to about 20,000 hours, about 15,000 hours to about 25,000 hours, about 15,000 hours to about 30,000 hours, about 20,000 hours to about 25,000 hours, about 20,000 hours to about 30,000 hours, or about 25,000 hours to about 30,000 hours. In some instances, the crystal may comprise a life of about 1,000 hours, about 2,000 hours, about 5,000 hours, about 10,000 hours, about 15,000 hours, about 20,000 hours, about 25,000 hours, or about 30,000 hours. In some instances, the crystal may comprise a life of at least about 1,000 hours, about 2,000 hours, about 5,000 hours, about 10,000 hours, about 15,000 hours, about 20,000 hours, or about 25,000 hours. In some instances, the crystal may comprise a life of at most about 2,000 hours, about 5,000 hours, about 10,000 hours, about 15,000 hours, about 20,000 hours, about 25,000 hours, or about 30,000 hours.

In some cases, the UV spectral output of the pulsed UV laser may comprise at least about 1 nm, at least about 2 nm, at least about 3 nm, at least about 4 nm, at least about 5 mm, at least about 6 nm, at least about 7 nm, at least about 8 nm, at least about 9 nm, or at least about 10 nm bandwidth. In some cases, the pulsed UV laser may comprise a pulse width, pulse frequency, and/or pulse energy of the excitation light described elsewhere herein.

In some cases, the pulsed UV laser may comprise an output wavelength of about 300 nm to about 400 nm. In some cases, the pulsed UV laser may comprise an output wavelength of about 300 nm to about 310 nm, about 300 nm to about 320 nm, about 300 nm to about 330 nm, about 300 nm to about 340 nm, about 300 nm to about 350 nm, about 300 nm to about 360 nm, about 300 nm to about 370 nm, about 300 nm to about 380 nm, about 300 nm to about 390 nm, about 300 nm to about 400 nm, about 310 nm to about 320 nm, about 310 nm to about 330 nm, about 310 nm to about 340 nm, about 310 nm to about 350 nm, about 310 nm to about 360 nm, about 310 nm to about 370 nm, about 310 nm to about 380 nm, about 310 nm to about 390 nm, about 310 nm to about 400 nm, about 320 nm to about 330 nm, about 320 nm to about 340 nm, about 320 nm to about 350 nm, about 320 nm to about 360 nm, about 320 nm to about 370 nm, about 320 nm to about 380 nm, about 320 nm to about 390 nm, about 320 nm to about 400 nm, about 330 nm to about 340 nm, about 330 nm to about 350 nm, about 330 nm to about 360 nm, about 330 nm to about 370 nm, about 330 nm to about 380 nm, about 330 nm to about 390 nm, about 330 nm to about 400 nm, about 340 nm to about 350 nm, about 340 nm to about 360 nm, about 340 nm to about 370 nm, about 340 nm to about 380 nm, about 340 nm to about 390 nm, about 340 nm to about 400 nm, about 350 nm to about 360 nm, about 350 nm to about 370 nm, about 350 nm to about 380 nm, about 350 nm to about 390 nm, about 350 nm to about 400 nm, about 360 nm to about 370 nm, about 360 nm to about 380 nm, about 360 nm to about 390 nm, about 360 nm to about 400 nm, about 370 nm to about 380 nm, about 370 nm to about 390 nm, about 370 nm to about 400 nm, about 380 nm to about 390 nm, about 380 nm to about 400 nm, or about 390 nm to about 400 nm. In some cases, the pulsed UV laser may comprise an output wavelength of about 300 nm, about 310 nm, about 320 nm, about 330 nm, about 340 nm, about 350 nm, about 360 nm, about 370 nm, about 380 nm, about 390 nm, or about 400 nm. In some cases, the pulsed UV laser may comprise an output wavelength of at least about 300 nm, about 310 nm, about 320 nm, about 330 nm, about 340 nm, about 350 nm, about 360 nm, about 370 nm, about 380 nm, or about 390 nm. In some cases, the pulsed UV laser may comprise an output wavelength of at most about 310 nm, about 320 nm, about 330 nm, about 340 nm, about 350 nm, about 360 nm, about 370 nm, about 380 nm, about 390 nm, or about 400 nm.

Excitation by the light pulse may cause the sample 114 to produce a responsive optical signal which may be collected by the signal collection sub-system 102. In this way, a single excitation light pulse may be used to gather both time-resolved (fluorescence decay) information as well as wavelength-resolved (fluorescence intensity) information from the responsive optical signal in real-time or near real-time damaged by the light pulse. For example, ultraviolet light may be chosen to excite a wide range of fluorophores within the tissue sample and can be used to excite multiple fluorophores at the same time. Prolonged exposure to ultraviolet light, however, can cause cellular damage in at least some instances. Thus, in cases where exposure to ultraviolet light is a concern, near infrared or infrared light may be a safer alternative. An infrared light source may be configured to excite a similar range of fluorophores as ultraviolet light by using a two-photon (or multi-photon) technique. For example, an infrared light source may be configured to emit a plurality of light pulses in very quick succession such that two photons of the light pulses simultaneously radiate the sample 114. When two or more photons radiate the sample 114 at the same time, their energies may be added together, and the sample may produce a responsive optical signal similar to that which may be produced in response to radiation with ultraviolet light but with the potential safety risk reduced.

In some cases, the excitation light 108 of the light source 106 may be directed towards the sample 114 by a one or more excitation optics (110) and an optical scanning element 112, for example, an angled partially reflective mirror, dichroic mirror, hot mirror, cold mirror, one or more galvanic scanning mirrors, or any combination thereof. In some cases, the optical scanning element 112 may comprise a filter in the optical path of optical scanning element 112 prior to an objective and/or a scan lens, where the filter is configured to transmit e.g., the pulsed UV laser source, described elsewhere herein, and remove and/or reflect any autofluorescence generated by the interaction of the pulsed UV light source with any of the optical components of the imaging system disposed between the light source and the filter. In some cases, the optical signal transmission element 112 may direct an excitation beam 108 to the tissue sample and direct the emitted beam 117, that may result from the interaction of the tissue sample and excitation beam to the signal collection sub-system 102. In some cases, the optical signal transmission element 112 may comprise a slotted mirror beam splitter, dichroic mirror, beam splitter or any combination thereof. In some cases, the emitted beam 117 may comprise an autofluorescent, phosphorescent, fluorescence lifetime, endogenous fluorescent, exogenous fluorescent, or any combination thereof emission beam.

In some cases, the optical signal transmission element 112 may comprise a retroreflector optically coupled to the one or more excitation optics (110). The retroreflector may be mechanically coupled to the optical signal transmission element 112 chassis. In some instances, the retroreflector may extend the optical path length for the imaging system to achieve a depth of focus of at least about 5 mm, with a beam spot size of at least about 75 micrometers (μm), using a long focal length lens (effective focal length of at least about 10 mm). A depth of focus of at least about 5 mm, with a beam spot size of at least about 75 μm may provide an optimal spot size and correspondingly increased signal to noise of detected emitted fluorescence signal for tissue samples e.g., with varying height spatially across the tissue sample.

In some cases, the one or more excitation optics 110 provide the imaging system with a depth of focus of about 0.1 mm to about 100 mm. In some cases, the one or more excitation optics 110 may comprise a depth of focus of about 0.1 mm to about 0.5 mm, about 0.1 mm to about 1 mm, about 0.1 mm to about 5 mm, about 0.1 mm to about 10 mm, about 0.1 mm to about 20 mm, about 0.1 mm to about 30 mm, about 0.1 mm to about 40 mm, about 0.1 mm to about 50 mm, about 0.1 mm to about 70 mm, about 0.1 mm to about 80 mm, about 0.1 mm to about 100 mm, about 0.5 mm to about 1 mm, about 0.5 mm to about 5 mm, about 0.5 mm to about 10 mm, about 0.5 mm to about 20 mm, about 0.5 mm to about 30 mm, about 0.5 mm to about 40 mm, about 0.5 mm to about 50 mm, about 0.5 mm to about 70 mm, about 0.5 mm to about 80 mm, about 0.5 mm to about 100 mm, about 1 mm to about 5 mm, about 1 mm to about 10 mm, about 1 mm to about 20 mm, about 1 mm to about 30 mm, about 1 mm to about 40 mm, about 1 mm to about 50 mm, about 1 mm to about 70 mm, about 1 mm to about 80 mm, about 1 mm to about 100 mm, about 5 mm to about 10 mm, about 5 mm to about 20 mm, about 5 mm to about 30 mm, about 5 mm to about 40 mm, about 5 mm to about 50 mm, about 5 mm to about 70 mm, about 5 mm to about 80 mm, about 5 mm to about 100 mm, about 10 mm to about 20 mm, about 10 mm to about 30 mm, about 10 mm to about 40 mm, about 10 mm to about 50 mm, about 10 mm to about 70 mm, about 10 mm to about 80 mm, about 10 mm to about 100 mm, about 20 mm to about 30 mm, about 20 mm to about 40 mm, about 20 mm to about 50 mm, about 20 mm to about 70 mm, about 20 mm to about 80 mm, about 20 mm to about 100 mm, about 30 mm to about 40 mm, about 30 mm to about 50 mm, about 30 mm to about 70 mm, about 30 mm to about 80 mm, about 30 mm to about 100 mm, about 40 mm to about 50 mm, about 40 mm to about 70 mm, about 40 mm to about 80 mm, about 40 mm to about 100 mm, about 50 mm to about 70 mm, about 50 mm to about 80 mm, about 50 mm to about 100 mm, about 70 mm to about 80 mm, about 70 mm to about 100 mm, or about 80 mm to about 100 mm. In some cases, the one or more excitation optics 110 may comprise a depth of focus of about 0.1 mm, about 0.5 mm, about 1 mm, about 5 mm, about 10 mm, about 20 mm, about 30 mm, about 40 mm, about 50 mm, about 70 mm, about 80 mm, or about 100 mm. In some cases, the one or more excitation optics 110 may comprise a depth of focus of at least about 0.1 mm, about 0.5 mm, about 1 mm, about 5 mm, about 10 mm, about 20 mm, about 30 mm, about 40 mm, about 50 mm, about 70 mm, or about 80 mm. In some cases, the one or more excitation optics 110 may comprise a depth of focus of at most about 0.5 mm, about 1 mm, about 5 mm, about 10 mm, about 20 mm, about 30 mm, about 40 mm, about 50 mm, about 70 mm, about 80 mm, or about 100 mm.

In some cases, the retroreflector and/or the one or more excitation optics (110) may provide the imaging system with a beam spot size of about 60 μm to about 450 μm. In some cases, the retroreflector and/or the one or more excitation optics (110) may provide the imaging system with a beam spot size of about 60 μm to about 75 μm, about 60 μm to about 80 μm, about 60 μm to about 120 μm, about 60 μm to about 140 μm, about 60 μm to about 180 μm, about 60 μm to about 200 μm, about 60 μm to about 250 μm, about 60 μm to about 300 μm, about 60 μm to about 350 μm, about 60 μm to about 400 μm, about 60 μm to about 450 μm, about 75 μm to about 80 μm, about 75 μm to about 120 μm, about 75 μm to about 140 μm, about 75 μm to about 180 μm, about 75 μm to about 200 μm, about 75 μm to about 250 μm, about 75 μm to about 300 μm, about 75 μm to about 350 μm, about 75 μm to about 400 μm, about 75 μm to about 450 μm, about 80 μm to about 120 μm, about 80 μm to about 140 μm, about 80 μm to about 180 μm, about 80 μm to about 200 μm, about 80 μm to about 250 μm, about 80 μm to about 300 μm, about 80 μm to about 350 μm, about 80 μm to about 400 μm, about 80 μm to about 450 μm, about 120 μm to about 140 μm, about 120 μm to about 180 μm, about 120 μm to about 200 μm, about 120 μm to about 250 μm, about 120 μm to about 300 μm, about 120 μm to about 350 μm, about 120 μm to about 400 μm, about 120 μm to about 450 μm, about 140 μm to about 180 μm, about 140 μm to about 200 μm, about 140 μm to about 250 μm, about 140 μm to about 300 μm, about 140 μm to about 350 μm, about 140 μm to about 400 μm, about 140 μm to about 450 μm, about 180 μm to about 200 μm, about 180 μm to about 250 μm, about 180 μm to about 300 μm, about 180 μm to about 350 μm, about 180 μm to about 400 μm, about 180 μm to about 450 μm, about 200 μm to about 250 μm, about 200 μm to about 300 μm, about 200 μm to about 350 μm, about 200 μm to about 400 μm, about 200 μm to about 450 μm, about 250 μm to about 300 μm, about 250 μm to about 350 μm, about 250 μm to about 400 μm, about 250 μm to about 450 μm, about 300 μm to about 350 μm, about 300 μm to about 400 μm, about 300 μm to about 450 μm, about 350 μm to about 400 μm, about 350 μm to about 450 μm, or about 400 μm to about 450 μm. In some cases, the retroreflector and/or the one or more excitation optics (110) may provide the imaging system with a beam spot size of about 60 μm, about 75 μm, about 80 μm, about 120 μm, about 140 μm, about 180 μm, about 200 μm, about 250 μm, about 300 μm, about 350 μm, about 400 μm, or about 450 μm. In some cases, the retroreflector and/or the one or more excitation optics (110) may provide the imaging system with a beam spot size of at least about 60 μm, about 75 μm, about 80 μm, about 120 μm, about 140 μm, about 180 μm, about 200 μm, about 250 μm, about 300 μm, about 350 μm, or about 400 μm. In some cases, the retroreflector and/or the one or more excitation optics (110) may provide the imaging system with a beam spot size of at most about 75 μm, about 80 μm, about 120 μm, about 140 μm, about 180 μm, about 200 μm, about 250 μm, about 300 μm, about 350 μm, about 400 μm, or about 450 μm.

In some cases, the long focal lens may comprise a focal length of about 10 mm to about 1,000 mm. In some cases, the long focal lens may comprise a focal length of about 10 mm to about 50 mm, about 10 mm to about 100 mm, about 10 mm to about 150 mm, about 10 mm to about 200 mm, about 10 mm to about 250 mm, about 10 mm to about 300 mm, about 10 mm to about 400 mm, about 10 mm to about 500 mm, about 10 mm to about 700 mm, about 10 mm to about 800 mm, about 10 mm to about 1,000 mm, about 50 mm to about 100 mm, about 50 mm to about 150 mm, about 50 mm to about 200 mm, about 50 mm to about 250 mm, about 50 mm to about 300 mm, about 50 mm to about 400 mm, about 50 mm to about 500 mm, about 50 mm to about 700 mm, about 50 mm to about 800 mm, about 50 mm to about 1,000 mm, about 100 mm to about 150 mm, about 100 mm to about 200 mm, about 100 mm to about 250 mm, about 100 mm to about 300 mm, about 100 mm to about 400 mm, about 100 mm to about 500 mm, about 100 mm to about 700 mm, about 100 mm to about 800 mm, about 100 mm to about 1,000 mm, about 150 mm to about 200 mm, about 150 mm to about 250 mm, about 150 mm to about 300 mm, about 150 mm to about 400 mm, about 150 mm to about 500 mm, about 150 mm to about 700 mm, about 150 mm to about 800 mm, about 150 mm to about 1,000 mm, about 200 mm to about 250 mm, about 200 mm to about 300 mm, about 200 mm to about 400 mm, about 200 mm to about 500 mm, about 200 mm to about 700 mm, about 200 mm to about 800 mm, about 200 mm to about 1,000 mm, about 250 mm to about 300 mm, about 250 mm to about 400 mm, about 250 mm to about 500 mm, about 250 mm to about 700 mm, about 250 mm to about 800 mm, about 250 mm to about 1,000 mm, about 300 mm to about 400 mm, about 300 mm to about 500 mm, about 300 mm to about 700 mm, about 300 mm to about 800 mm, about 300 mm to about 1,000 mm, about 400 mm to about 500 mm, about 400 mm to about 700 mm, about 400 mm to about 800 mm, about 400 mm to about 1,000 mm, about 500 mm to about 700 mm, about 500 mm to about 800 mm, about 500 mm to about 1,000 mm, about 700 mm to about 800 mm, about 700 mm to about 1,000 mm, or about 800 mm to about 1,000 mm. In some cases, the long focal lens may comprise a focal length of about 10 mm, about 50 mm, about 100 mm, about 150 mm, about 200 mm, about 250 mm, about 300 mm, about 400 mm, about 500 mm, about 700 mm, about 800 mm, or about 1,000 mm. In some cases, the long focal lens may comprise a focal length of at least about 10 mm, about 50 mm, about 100 mm, about 150 mm, about 200 mm, about 250 mm, about 300 mm, about 400 mm, about 500 mm, about 700 mm, or about 800 mm. In some cases, the long focal lens may comprise a focal length of at most about 50 mm, about 100 mm, about 150 mm, about 200 mm, about 250 mm, about 300 mm, about 400 mm, about 500 mm, about 700 mm, about 800 mm, or about 1,000 mm.

In some cases, the sample 114 may be placed on a stage 116 that may translate the tissue sample such that imaging system may acquire imaging data for a plurality of positions on the tissue sample. The stage may comprise a removable and disposable tray where the sample 114 may be placed for analysis. In some instances, the disposable tray (i.e., carrier) may be constructed from Nylon 6,6, (polyamide) polymer, acrylonitrile butadiene styrene (ABS), natural off-white ABS, impact resistant ABS, black nylon, Celcon™, acetal copolymer, Hylex™, polycarbonate, Lexan™, black high-density polyethylene (HDPE), blue HDPE, green HDPE, orange HDPE, red HDPE, yellow HDPE, black HDPE, green HDPE, nitrile plastics, blue vinyl, brown vinyl, green vinyl, orange vinyl, pink vinyl, red vinyl, violate vinyl, white vinyl, ultra-high molecular weight (UHMW) polyethylene, blue UHMW polyethylene, black UHMW polyethylene, white UHMW polyethylene, off-white Nylon, wear resistant nylon, black wear resistant nylon, or polylactic acid.

In some instances, the stage may be configured to translate the sample 114 in one-dimension, two dimensions, or three-dimensions while the optical signal transmission element 112 remains stationary. In some cases, the optical signal transmission element 112, the one or more excitation optics 110, optical scanning element 112, wavelength splitting element 120, photomultiplier tube 122, one or more collection optics (204, 208), or any combination thereof, may be mounted on a stage and/or fixture that may be scanned across the tissue sample to acquire imaging data for a plurality of positions on the sample 114 while the sample 114 remains stationary. In some cases, both the sample 114 and the optical signal transmission element 112 may both move independent of one another. In some instances, the optical scanning element 112 may move independent of the excitation light 108. In some instances, the excitation light 108 may be in mechanical communication e.g., directly mounted to the optical scanning element 112, whereby the excitation light 108 beam may be incident onto the sample 114. In some instances, the stage may be configured to translate the optical signal transmission element 112 in one-dimension, two dimensions, or three-dimensions.

In some cases, the imaging system may comprise an imaging probe configured to couple to an opto-mechanical surface of the imaging system optically and/or electrically coupled to the imaging system components, described elsewhere herein. In some cases, the imaging system may couple the light source 106 to the imaging probe with the one or more excitation optics 110 (e.g., one or more lenses, collimators, cylindrical lenses, mirrors, acoustic optic modulators, etc.). In some cases, the imaging system optical scanning element 112 may translate to a position where the output of the optical scanning element 112 may couple (e.g., via a fold mirror, one or more stationary mirrors and/or lenses) the light source output into the imaging probe mounted to a surface of the imaging system. In some instances, the probe may comprise a handle held probe. The probe may comprise a fiber optic probe, where the probe may comprise one or more fibers and/or a fiber bundle. The probe may comprise a window and/or lens at the tip of the probe configured to deliver the light source excitation to a sample and/or collect the emitted fluorescent light of the sample. In some cases, the probe may direct the collected autofluorescent light emitted from the sample to the collection optics 118, a wavelength splitting element 120, and/or detector 122 (e.g., a PMT) to detect the collected autofluorescent signal of the sample.

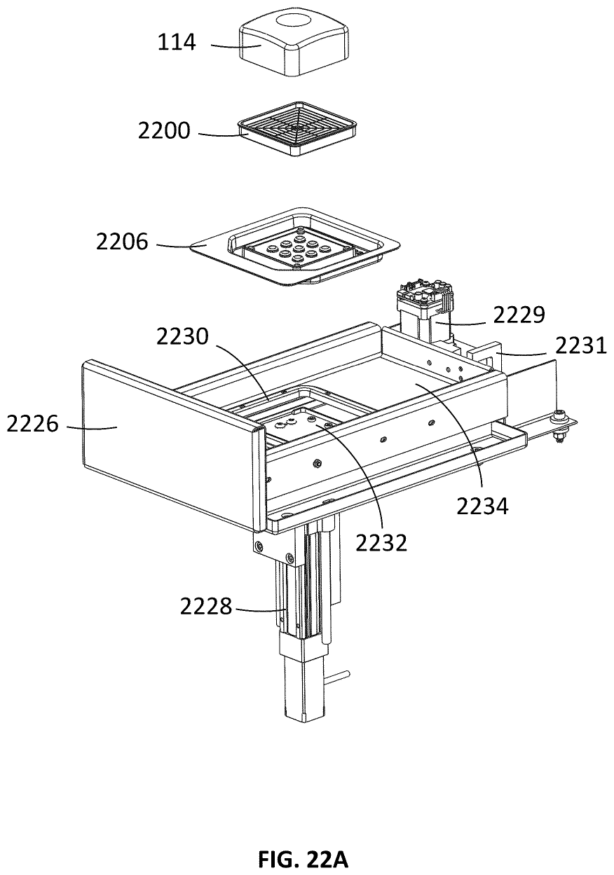

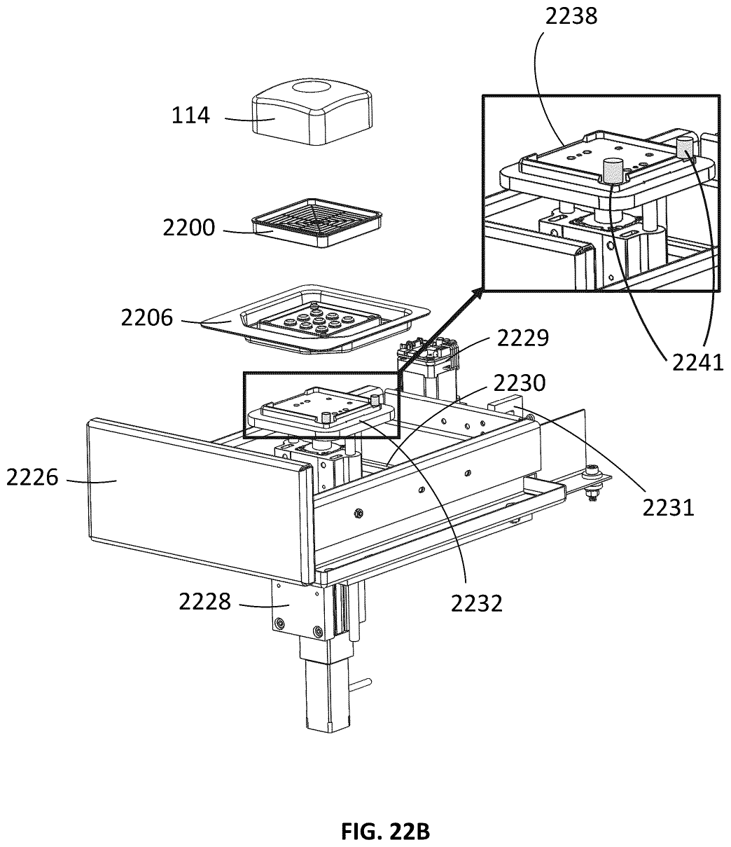

In some cases, the imaging system may comprise a drawer 2226, as seen in FIGS. 22A-22B, FIG. 23, FIGS. 24A and 24C, and FIG. 25, where the sample 114 may be placed by a user, physician, operating room medical personnel, or any combination of such individuals, for imaging. The drawer may comprise a mounting (e.g., cut out from the drawer) feature 2230 of to receive a barrier 2206. In some instances, the motion of the drawer 2226, e.g., opening and/or closing of the drawer may be controlled by a drawer controller 2422 electrically and/or operably coupled to a motor 2229 configured to open and/or close the drawer. In some cases, a user may manually override the control of the drawer's motion by the drawer controller e.g., in circumstances of immediate need to open the drawer. In some instances, the drawer controller 2422 may be configured to receive input from one or more drawer controls and/or drawer control interfaces 2420. In some cases, the drawer controls and/or drawer control interfaces may comprise: actuating and/or pressing a pedal, button 2306, switch or any combination thereof interfaces. The pedal may comprise a foot pedal that is a separated pedal from the imaging system operably connected to the imaging system via a cable and/or wireless interface. In some cases, the button 2306 and/or switch may be disposed on the imaging system and/or be provided in a button and/or switch box separate from the imaging system that is operably coupled to the imaging system via cable and/or wireless interface. In some cases, the drawer 2226 may be opened and/or closed by a voice command detected by a microphone of the imaging system electrically coupled to a processor of the imaging system. In some instances, other functionality of the imaging system e.g., start and/or stop imaging and/or scanning of the sample, may be actuated by voice commands. Voice commands may be used to initiate processing and/or analysis of fluorescent imaging data e.g., to display the last scan of the sample or execute a particular processing or analysis method on the fluorescence imaging data, described elsewhere herein. In some instances, the drawer 2226 may comprise a feature (e.g., a recessed edge 2319 when the drawer is closed that may allow a user of the imaging system to manually interact with the drawer and open and/or close the drawer 2226.

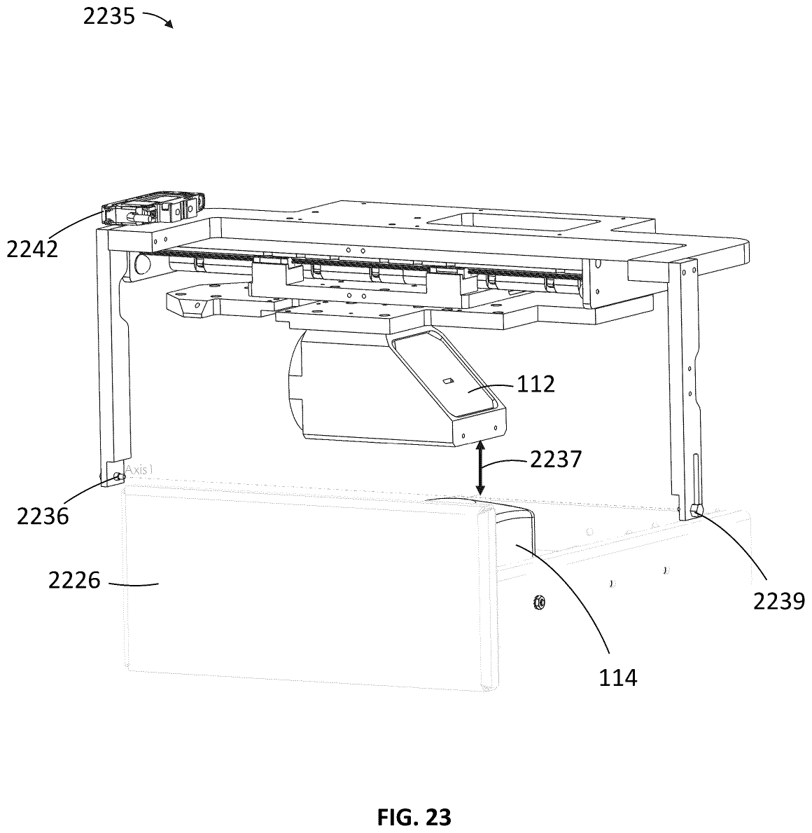

In some cases, the drawer controller 2422, may receive sample height information from the sample height sensor 2235, as seen in FIG. 23, described elsewhere herein. The information from the sample height sensor may be considered when the drawer controller determines whether the drawer may be safely opened without damaging the sample and/or other imaging system components.

In some instances, the drawer may be mechanically coupled to a motor 2229 configured to open and/or close the drawer 2226 when a user inputs a command to the imaging system, as described elsewhere herein, to open and/or close the drawer.

In some cases, the drawer 2226 may comprise a lock 2231 configured to lock the position of the drawer in place when the linear actuator 2228, described elsewhere herein, is elevated and/or extended. The lock may prevent a user from inadvertently opening the drawer while the light source is imaging the sample. The lock may be mechanically coupled to a bottom surface of a linear actuator coupling interface 2232 such that as the coupling interface of the linear actuator extends the lock 2231 may pivot into a latched locking position thereby restraining the motion of the drawer 2226. In some cases, the coupling interface of the linear actuator may comprise one or more kinematic feature(s) (2241, 2238) configured to mechanically couple the coupling interface of the linear actuator and the barrier kinematic features 2218A-2218C. In some cases, the linear actuator kinematic feature(s) (2241, 2238) may comprise one or more recessed 2238 and/or one or more protruding features 240 e.g., holes, slots, circular features, cylindrical features, button features, and/or other polygonal structural features. In some instances, the linear actuator kinematic feature(s) (2241, 2238) may comprise one or more chamfered surfaces configured to facilitate coupling between the linear actuator coupling interface and the barrier. In some cases, the linear actuator kinematic features(s) may compensate for manufacturing error of the one or more barrier to linear actuator kinematic features 2218A-2218C by neither over constraining nor under constraining the coupling between the linear actuator kinematic feature(s) and the barrier to linear actuator kinematic features.

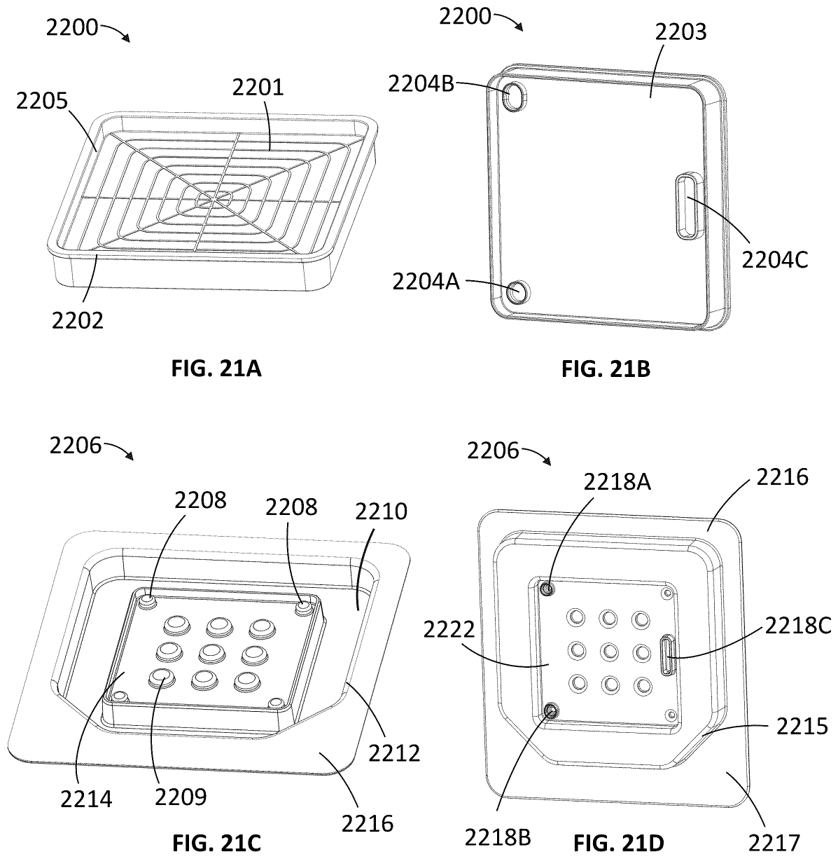

A barrier 2206, as seen in FIGS. 21C-21D and FIGS. 22A-22B, may comprise a geometric feature(s) (2210, 2212) configured to prevent liquid of a tissue sample from flowing to a compartment under the mounting feature 2230 of the drawer 2226. In some instances, the compartment under the mounting feature 2230 of the drawer 2226 may comprise imaging optics, system electronics, power supply, or any combination thereof, described elsewhere herein, that may be damaged by the liquid of the sample. In some instances, the barrier 2206 may comprise a flanged and/or lip feature 2216 where a surface of the flanged and/or lip feature of the barrier is configured to mate and seal an interface between the barrier 2206 and a surface of the drawer 2234 to prevent liquid of a sample from flowing into a compartment under the mounting feature 2230 of the drawer 2226. In some cases, the barrier 2206 geometric feature(s) (2210, 2212) may comprise e.g., a mound, lip, bump, moat, etc., disposed between a surface of the drawer 2234 and the barrier 2206 to prevent liquid of the sample from flowing from the barrier 2206 to the surface 2234 of the drawer and/or from flowing from the barrier 2206 into the compartment under the mounting feature 2230 of the drawer 2226. In some cases, the geometric feature(s) (2210, 2212) may comprise a recessed feature e.g., a moat disposed around the perimeter of the barrier to prevent liquid of the sample from flowing to a surface 2234 of the drawer and/or to prevent liquid of the sample from flowing to a compartment under the mounting feature 2230 of the drawer. In some instances, the geometric feature(s) (2210, 2212) may comprise a protruding feature 2212 (e.g., a mound, bump, raised edge, etc.) that prevents the flow of liquid of the tissue from the barrier 2206 to the surface 2234 of the drawer and/or from the barrier to the compartment under the mounting feature 2230 of the drawer 2226 by the height and/or shape of the protrusion. The barrier 2206 may comprise a carrier coupling surface 2214 comprising one or more barrier kinematic feature(s) 2208, shown in FIG. 21C, configured to couple to a carrier's one or more carrier kinematic feature(s) 2204A-2204C, shown in FIG. 21B, disposed on a carrier coupling surface 2203. In some cases, the one or more carrier kinematic feature(s) 2204A-2204C may compensate for manufacturing error of the one or more barrier kinematic feature(s) 2208 by neither over constraining nor under constraining the coupling between the one or more carrier kinematic features and the one or more barrier kinematic features. In some cases, the one or more barrier kinematic feature(s) 2208 may be positioned along a perimeter of a circle each spaced 120 degrees from one another. The one or more barrier kinematic feature(s) may comprise one or more recessed and/or one or more protruding features e.g., holes, slots, circular features, and/or other polygonal structural features. In some cases, the one or more barrier kinematic features. The coupling of the one or more barrier kinematic features and the one or more carrier kinematic features may isolate one or more degrees of freedom of the carrier 2200. In some cases, a single barrier may be used when imaging one or more samples (e.g., 5-10 samples) from a single patient. In some cases, the barrier 2206 may comprise one or more features 2209 e.g., one or more raised and/or protruding structures displayed in an array or discrete objects e.g., protruding shapes of a circle with a cross and/or line through the circle, configured to discourage or prevent the placement of a sample on the carrier coupling surface 2214.

In some cases, the barrier 2206 may comprise a structural feature 2217 e.g., an edge, lip, protruding edge and/or flange, that may provide an interface for a user to interact with the barrier 2206 when the barrier is placed in the mounting feature 2230 of the drawer 2226. In some cases, the barrier may comprise a directionality and/or phase structural features 2215 that limit, restricts, and/or constrains the orientation of the barrier with respect to the mounting feature 2230 of the drawer 2226

In some cases, the barrier 2206 may comprise a barrier to linear actuator coupling interface 2222, as seen in a bottom perspective view of the barrier shown in FIG. 21D. In some instances, the barrier to linear actuator coupling interface 2222 may comprise one or more barrier to linear actuator kinematic features 2218A-2218C configured to couple and/or mate with a coupling interface 2232 of a linear actuator 2228, motor, and/or piston configured to elevate the barrier 2206, carrier 2200, and the sample 114 to the optical scanning element 112 of the imaging system to image the sample. The one or more barrier to linear actuator kinematic features 2218 may comprise one or more recessed and/or one or more protruding features e.g., holes, slots, circular features, and/or other polygonal structural features. In some cases, the one or more barrier to linear actuator kinematic features may comprise a constraining shape e.g., a circle 2218A, an oval 2218B, and/or a slot 2218C, where the circle 2218A may be configured to constrain translation of the barrier, the oval 2218B may be configured to constrain rotation of the barrier, and where the slot 2218C is configured to constrain angle of the barrier linear actuator coupling surface 2222 with regards to a planar surface of the linear actuator coupling interface 2232.

In some cases, the barrier, carrier, and sample are elevated, lifted, and/or extended into the depth of field of the optical scanning element 112. In some instances, when the barrier 2206 and carrier 2200 are lifted and/or elevated normal to a surface of the drawer 2234, the drawer 2226 may lock in placed with the interference between the linear actuator 2228, motor, and/or piston in its engaged and lifted state and the mounting feature 2230 of the drawer 2226. In some cases, the linear actuator 2228, motor and/or piston in an extended, lifted, and/or elevated state during a power outage of the system may collapse and/or retract with the weight of the sample 114, carrier 2200, and/or barrier 2206 to a home state with the carrier 2200 and barrier 2206 in contact with mounting feature 2230 of the drawer 2226. In the home state, the system drawer may be opened and the sample may be removed.

A carrier 2200, as seen in FIGS. 21A-21B and FIGS. 22A-22B, may comprise one or more structural features 2201 e.g., one or more recessed and/or protruding structures, configured to align and secure the sample e.g., during transport from the surgical field to the imaging system. In some instances, the one or more structural features may comprise a lip and/or flange protrusion 2202 that extends outwardly from a central axis of the carrier 2200. In some cases, the lip and/or flange 2202 protrusion may provide a handle and/or grip for a user, physician, medical operating room personnel, nurse, or any combination of such individuals, to transport the carrier 2200 and sample 114 disposed on a surface of the carrier to the imaging system without contaminating the sterility of the sample. In some cases, the one or more structural features may comprise one or more sample alignment features 2201 (e.g., one or more concentric rings arranged as a centering target) that center the sample on the carrier. The centering of the sample may provide better than expected imaging system resolution (e.g., consistent optical scanning element spot size) across the sample. In some instances, the one or more structural features of the carrier may comprise a raised edge 2205 protruding normal to a surface of the carrier, where the raised edge may be configured to contain liquid of the sample from flowing over an outer edge surface of the carrier. The one or more structural features of the carrier may comprise one or more protruding and/or recessing features on a top surface of the carrier configured to prevent movement of the sample disposed on a surface of the carrier. The carrier 2200 may comprise a carrier to barrier coupling surface 2203 configured to mate with the carrier coupling surface 2214 of the barrier 2206. The carrier to barrier coupling surface 2203 may comprise one or more carrier kinematic feature(s) 2204A-2240C configured to mate with the one or more barrier kinematic feature(s) 2208. In some instances, the one or more carrier kinematic features may be positioned along a perimeter of a circle each spaced 120 degrees from one another. The one or more carrier kinematic feature(s) 2204A-2240C may comprise one or more recessed and/or one or more protruding features e.g., holes, slots, circular features, and/or other polygonal structural features. In some cases, the one or more carrier kinematic feature(s) 2204A-2240C may be configured to constrain one or more degrees of freedom of the carrier 2200 with respect to the barrier 2206. In some cases, the one or carrier kinematic features may comprise a constraining shape e.g., a circle 2204A, an oval 2204B, and/or a slot 2204C, where the circle 2204 may be configured to constrain translation of the barrier, the oval 2204 may be configured to constrain rotation of the barrier, and where the slot 2204C is configured to constrain angle of the barrier linear actuator coupling surface 2222 with regards to a planar surface of the linear actuator coupling interface 2232. Isolating the one or more degrees of freedom of the carrier 2200 may stabilize the carrier 2200 and prevent unwanted motion artifact generated by movement of the sample during imaging. By preventing motion artifact, the imaging performance may be improved by e.g., maintaining uniform image resolution across the sample and/or improving the co-registration of one or more scanned areas and/or segments of fluorescence imaging data of sample.

In some cases, the carrier may comprise a material that emits a fluorescence lifetime when excited with a light source, described elsewhere herein, where the fluorescence lifetime comprises an intensity and fluorescence lifetime range similar to the sample. In some cases, the fluorescence lifetime range is within at least about 5%, at least about 10%, at least about 20%, at least about 50%, or at least about 100% of the fluorescence lifetime range of the tissue.

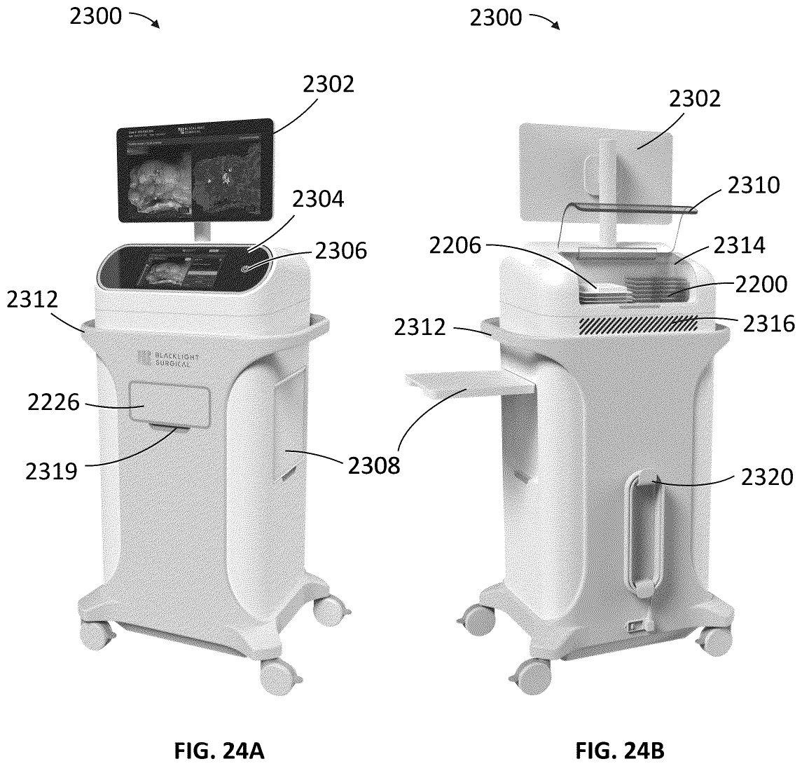

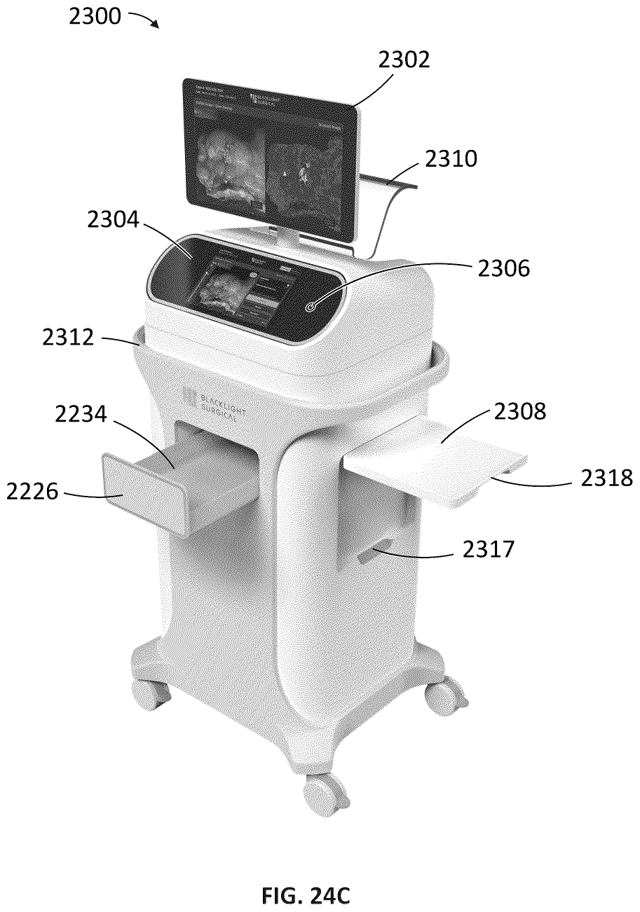

In some cases, the imaging system 2300 may comprise a compartment 2314 where carriers 2200 and/or barriers 2206 may be stored prior to use when imaging a sample, as seen in FIG. 24B. In some cases, the compartment 2314 may comprise shelving (e.g., vertical and/or horizontal), and/or sub compartments where the carrier 2200 and/or barriers 2206 may be stored. In some cases, the compartment may comprise a cover 2310, where the cover may comprise a material that is optically transparent to visible light such that a user, physician, medical operating room personnel, and/or nurse can visualize the presence of one or more carriers and/or one or more barriers prior to using the imaging system. The cover 2310 may maintain atmosphere, and/or temperature of a local environment surrounding the carriers 2200 and/or barriers 2206 to maintain the sterility and material properties of the stored carriers and/or barriers.

In some cases, the carrier and/or barrier may comprise a labeled e.g., a barcode, QR code, symbol or feature discernable by a visible light sensor (e.g., one or more photodiodes a single detector, in a one-dimensional sensor array, or a two-dimensional sensor array). In some cases, the carrier and/or barrier may comprise a material with a plurality of fluorescent lifetime and/or fluorescent intensity for authentication, calibration, and system-self test procedures. In some cases, the spatial location of the material with the plurality of the fluorescent lifetime and/or fluorescent intensity may be sensed and/or detected with respect to the location of visible features that may be imaged by a visible light camera of the imaging system. In some cases, the labeled carrier and/or barrier may be scanned and interpreted by a sensor of the imaging system operably connected to one or more processors. In some instances, the label of the carrier and/or barrier may provide information (e.g., material, calibration information for a given carriers and/or barriers, etc.) about the particular carrier and/or barrier. In some instances, the information may be stored in a cloud database and provided to the system when cross referenced with the label, fluorescence lifetime. fluorescence intensity, spatial geometric features, visible image, or any combination thereof features of the carrier and/or barrier when scanned. In some cases, the label, fluorescence lifetime, fluorescence intensity, spatial geometric features, visible image, or any combination features of the carrier and/or barrier may be used to determine the legitimacy and/or authenticate a carrier and/or barrier to prevent hazardous use of the imaging system and/or damage to a sample undergoing imaging.

In some cases, the carrier and/or barrier may comprise one or more features configured to calibrate and/or test the performance of the imaging system described elsewhere herein. In some cases, the carrier and/or barrier may comprise spatially varying material properties that when excited by a light source of the imaging system, described elsewhere herein, provide varying fluorescence lifetime imaging data.

In some instances, the fluorescence imaging system 2300 may comprise an extendible working surface 2308 mechanical coupled to an exterior surface of the fluorescence imaging system, as seen in FIGS. 24A-24C. The working surface 2308 may comprise a structural feature 2318 e.g., a cut away and/or a protrusion configured to provide a surface that a user may grasp and/or handle to extend the extendible working surface 2308 away from the imaging system body. In some instances, the imaging system may comprise a recessed feature 2317 configured to provide access to the structural feature 2318 of the extendible working surface 2308. The working surface may comprise a hinge coupled to the exterior surface of the fluorescence imaging system, where the hinge is configured to pivot and fasten the working surface from a collapsed and/or folded state (FIG. 24A) to a deployed and/or extended state (FIGS. 24B and 24C). In some instances, the working surface may comprise a sterilizable material (e.g., biocompatible inert plastic and/or polymer).

In some cases, the fluorescence imaging system may comprise a sample retrieval hatch configured to provide access to a sample when a system failure occurs (e.g., the drawer does not open to remove a sample). In some instances, the sample retrieval hatch may be disposed on a surface of the imaging system enclosure. In some instances, the sample retrieval hatch may comprise a door and/or surface that may be manually manipulated by a user, physician, operating room medical personnel, nurse, or any combination thereof individual, to access the sample. In some instances, the sample retrieval hatch may comprise a locking feature (e.g., a latch) that is configured to secure the sample retrieval hatch in a closed state when not manipulated by a user, physician, operating room medical personnel, nurse, or any combination thereof individuals.

In some cases, the imaging system (300, 2300) may comprise a sample height sensor 2235, as seen in FIG. 25, configured to iteratively translate along a first planar axis of a surface where a sample is disposed and/or a second axis normal to the planar surface containing the first axis to determine the presence of a sample in a field of view of the optical scanning element 112. The height of the sample determined by the sample height sensor may be used in determining the position of the optical scanning element 112 prior to scanning and/or imaging the sample. The position of the optical scanning element may be positioned such that the nominal depth of field of the optical scanning element is aligned with the highest point across the sample determined by the sample height sensor. In some instances, the nominal depth of field of the optical scanning element may comprise a distance of up to about 8.5 mm from the surface of the optical scanning element 112. In some instances, the sample height sensor may comprise a light source 2236 and a detector 2234, as seen in FIG. 23, where the presence of an object and/or a sample is determined when the detector 2239 does not detect the emitted light from the light source 2236 (i.e., the light source is impeded or obstructed by the object and/or sample). In some cases, the light source 2236 may comprise a fiber optic. In some cases, the light source 2236 may comprise an infrared light source, visible light source, or any combination thereof. In some cases, the light source may comprise a laser or a light emitting diode. The light source 2236 may comprise a collimated parallel beam light source. The detector 2239 may comprise one or more photodiodes, CMOS, CCD, or any combination thereof sensors. In some cases, the sample height sensor may comprise a controller 2242 configured to be electrically and/or optically in connection with the light source 2236, detector 2234, the device controller 222, and/or the computer system 804. In some cases, the controller 2242 may couple light from a light source within the controller to the light source 2236 via a fiber.

The sample height sensor may be disposed at an offset distance 2237 from a surface of the optical scanning element 112, as seen in FIG. 23. The offset distance 2237 of the sample height sensor from the surface of the optical scanning element 112 may allow for the sample height sensor to translate in about 10 mm step increments to determine the height of the sample (e.g., a tissue sample) without damaging the sample and/or the optical scanning element 112. The offset distance may allow for coarse movements of the sample along the second axis since there is a fixed clearance between the detection plane of the optical

In some cases, the sample height sensor may translate in step increments of about 0.1 mm to about 14 mm. In some cases, the sample height sensor may translate in step increments of about 0.1 mm to about 0.5 mm, about 0.1 mm to about 1 mm, about 0.1 mm to about 1.5 mm, about 0.1 mm to about 2 mm, about 0.1 mm to about 2.5 mm, about 0.1 mm to about 5 mm, about 0.1 mm to about 5.5 mm, about 0.1 mm to about 8 mm, about 0.1 mm to about 10 mm, about 0.1 mm to about 12 mm, about 0.1 mm to about 14 mm, about 0.5 mm to about 1 mm, about 0.5 mm to about 1.5 mm, about 0.5 mm to about 2 mm, about 0.5 mm to about 2.5 mm, about 0.5 mm to about 5 mm, about 0.5 mm to about 5.5 mm, about 0.5 mm to about 8 mm, about 0.5 mm to about 10 mm, about 0.5 mm to about 12 mm, about 0.5 mm to about 14 mm, about 1 mm to about 1.5 mm, about 1 mm to about 2 mm, about 1 mm to about 2.5 mm, about 1 mm to about 5 mm, about 1 mm to about 5.5 mm, about 1 mm to about 8 mm, about 1 mm to about 10 mm, about 1 mm to about 12 mm, about 1 mm to about 14 mm, about 1.5 mm to about 2 mm, about 1.5 mm to about 2.5 mm, about 1.5 mm to about 5 mm, about 1.5 mm to about 5.5 mm, about 1.5 mm to about 8 mm, about 1.5 mm to about 10 mm, about 1.5 mm to about 12 mm, about 1.5 mm to about 14 mm, about 2 mm to about 2.5 mm, about 2 mm to about 5 mm, about 2 mm to about 5.5 mm, about 2 mm to about 8 mm, about 2 mm to about 10 mm, about 2 mm to about 12 mm, about 2 mm to about 14 mm, about 2.5 mm to about 5 mm, about 2.5 mm to about 5.5 mm, about 2.5 mm to about 8 mm, about 2.5 mm to about 10 mm, about 2.5 mm to about 12 mm, about 2.5 mm to about 14 mm, about 5 mm to about 5.5 mm, about 5 mm to about 8 mm, about 5 mm to about 10 mm, about 5 mm to about 12 mm, about 5 mm to about 14 mm, about 5.5 mm to about 8 mm, about 5.5 mm to about 10 mm, about 5.5 mm to about 12 mm, about 5.5 mm to about 14 mm, about 8 mm to about 10 mm, about 8 mm to about 12 mm, about 8 mm to about 14 mm, about 10 mm to about 12 mm, about 10 mm to about 14 mm, or about 12 mm to about 14 mm. In some cases, the sample height sensor may translate in step increments of about 0.1 mm, about 0.5 mm, about 1 mm, about 1.5 mm, about 2 mm, about 2.5 mm, about 5 mm, about 5.5 mm, about 8 mm, about 10 mm, about 12 mm, or about 14 mm. In some cases, the sample height sensor may translate in step increments of at least about 0.1 mm, about 0.5 mm, about 1 mm, about 1.5 mm, about 2 mm, about 2.5 mm, about 5 mm, about 5.5 mm, about 8 mm, about 10 mm, or about 12 mm. In some cases, the sample height sensor may translate in step increments of at most about 0.5 mm, about 1 mm, about 1.5 mm, about 2 mm, about 2.5 mm, about 5 mm, about 5.5 mm, about 8 mm, about 10 mm, about 12 mm, or about 14 mm.

In some embodiments, the disclosure describes a method of determining a height of sample. In some cases, the method may comprise: (a) providing a sample on a surface; (b) translating a sample height sensor along a first axis parallel with the surface; and (c) translating the sample along a second axis normal to the surface when the sample height sensor detects a tissue obstruction or the absence thereof in a path between the sample height light source and detector. In some cases, prior to (b), the sample may be translated away or toward the sample height sensor along the second axis by at least about 1 mm, at least about 5 mm, at least about 10 mm, at least about 20 mm, at least about 30 mm, or at least about 40 mm. In some cases, steps (a)-(c) may be repeated one or more times. In some cases, (b)-(c) may be repeated one or more times. In some cases, between repeating steps (b)-(c) the sample is translated along the second axis by at least about 1 mm, at least about 5 mm, at least about 10 mm, at least about 20 mm, at least about 30 mm, or at least about 40 mm. In some instances, the translation of the sample may comprise translation of the sample along the second axis in a first direction and a second direction along the second axis, where the first direction and the second direction are inverse of each other. In some cases, the translation of the sample when repeating steps (b)-(c) of the method may alternate between the first direction and the second direction. In some cases, the translation of the sample when alternating direction between the first and second direction may comprise a first translated distance for the first direction and a second translated distance for the second direction, where the first translated distance is greater than the second translated distance. In some cases, the method may comprise (d) determining a height of the sample when the difference between a first translated distance and a second translated distance of the sample is less than about 0.1 mm, less than about 1 mm, less than about 2 mm, or less than about 5 mm. In some cases, the method may further comprise (e) setting a position of the sample along the second axis where the height of the sample corresponds to a working distance of the optical scanning element. The working distance may comprise the plane and/or point within the depth of field closest to the optical scanning element.

In some instances, the emitted beam 117 may be collected for further analysis by the signal collection sub-system 102. The signal collection sub-system may comprise a collection optics 118, a wavelength splitting element 120, a detector 122, or any combination thereof. The collection optics 118, as shown in FIG. 1B and FIG. 25, may comprise one or more lens and/or lens arrangements (208, 204), an optical fiber 206, a plurality of relay optics 2430 or any combination thereof. In some cases, the lens and/or lens arrangement configured to collect and/or relay the fluorescence light emitted by the same (208, 204) to the detector may comprise a dual achromatic doublet pair, an objective lens, a scan lens, or any combination thereof. In some instances, the plurality of relay optics 2430, as seen in FIG. 25, may comprise one or more optical elements configured to transmit and/or relay the autofluorescent light emitted from the sample collected by the collection optics 118 to the wavelength splitting element 120. In some cases, the collection. In some instances, the core size of the optical fiber 206 may enable image photons to be captured at varying depths of field.

In some cases, the dual achromatic doublet pair may have an outer diameter of about 1 in to about 10 in. In some cases, the dual achromatic doublet pair may have an outer diameter of about 1 in to about 1.5 in, about 1 in to about 2 in, about 1 in to about 2.5 in, about 1 in to about 3 in, about 1 in to about 3.5 in, about 1 in to about 4 in, about 1 in to about 5 in, about 1 in to about 6 in, about 1 in to about 8 in, about 1 in to about 9 in, about 1 in to about 10 in, about 1.5 in to about 2 in, about 1.5 in to about 2.5 in, about 1.5 in to about 3 in, about 1.5 in to about 3.5 in, about 1.5 in to about 4 in, about 1.5 in to about 5 in, about 1.5 in to about 6 in, about 1.5 in to about 8 in, about 1.5 in to about 9 in, about 1.5 in to about 10 in, about 2 in to about 2.5 in, about 2 in to about 3 in, about 2 in to about 3.5 in, about 2 in to about 4 in, about 2 in to about 5 in, about 2 in to about 6 in, about 2 in to about 8 in, about 2 in to about 9 in, about 2 in to about 10 in, about 2.5 in to about 3 in, about 2.5 in to about 3.5 in, about 2.5 in to about 4 in, about 2.5 in to about 5 in, about 2.5 in to about 6 in, about 2.5 in to about 8 in, about 2.5 in to about 9 in, about 2.5 in to about 10 in, about 3 in to about 3.5 in, about 3 in to about 4 in, about 3 in to about 5 in, about 3 in to about 6 in, about 3 in to about 8 in, about 3 in to about 9 in, about 3 in to about 10 in, about 3.5 in to about 4 in, about 3.5 in to about 5 in, about 3.5 in to about 6 in, about 3.5 in to about 8 in, about 3.5 in to about 9 in, about 3.5 in to about 10 in, about 4 in to about 5 in, about 4 in to about 6 in, about 4 in to about 8 in, about 4 in to about 9 in, about 4 in to about 10 in, about 5 in to about 6 in, about 5 in to about 8 in, about 5 in to about 9 in, about 5 in to about 10 in, about 6 in to about 8 in, about 6 in to about 9 in, about 6 in to about 10 in, about 8 in to about 9 in, about 8 in to about 10 in, or about 9 in to about 10 in. In some cases, the dual achromatic doublet pair may have an outer diameter of about 1 in, about 1.5 in, about 2 in, about 2.5 in, about 3 in, about 3.5 in, about 4 in, about 5 in, about 6 in, about 8 in, about 9 in, or about 10 in. In some cases, the dual achromatic doublet pair may have an outer diameter of at least about 1 in, about 1.5 in, about 2 in, about 2.5 in, about 3 in, about 3.5 in, about 4 in, about 5 in, about 6 in, about 8 in, or about 9 in. In some cases, the dual achromatic doublet pair may have an outer diameter of at most about 1.5 in, about 2 in, about 2.5 in, about 3 in, about 3.5 in, about 4 in, about 5 in, about 6 in, about 8 in, about 9 in, or about 10 in.

In some cases, the dual achromatic doublet pair may have an outer diameter of about 1 inch (in) to about 10 in. In some cases, the dual achromatic doublet pair may have an outer diameter of about 1 in to about 2 in, about 1 in to about 3 in, about 1 in to about 4 in, about 1 in to about 5 in, about 1 in to about 6 in, about 1 in to about 7 in, about 1 in to about 8 in, about 1 in to about 9 in, about 1 in to about 10 in, about 2 in to about 3 in, about 2 in to about 4 in, about 2 in to about 5 in, about 2 in to about 6 in, about 2 in to about 7 in, about 2 in to about 8 in, about 2 in to about 9 in, about 2 in to about 10 in, about 3 in to about 4 in, about 3 in to about 5 in, about 3 in to about 6 in, about 3 in to about 7 in, about 3 in to about 8 in, about 3 in to about 9 in, about 3 in to about 10 in, about 4 in to about 5 in, about 4 in to about 6 in, about 4 in to about 7 in, about 4 in to about 8 in, about 4 in to about 9 in, about 4 in to about 10 in, about 5 in to about 6 in, about 5 in to about 7 in, about 5 in to about 8 in, about 5 in to about 9 in, about 5 in to about 10 in, about 6 in to about 7 in, about 6 in to about 8 in, about 6 in to about 9 in, about 6 in to about 10 in, about 7 in to about 8 in, about 7 in to about 9 in, about 7 in to about 10 in, about 8 in to about 9 in, about 8 in to about 10 in, or about 9 in to about 10 in. In some cases, the dual achromatic doublet pair may have an outer diameter of about 1 in, about 2 in, about 3 in, about 4 in, about 5 in, about 6 in, about 7 in, about 8 in, about 9 in, or about 10 in. In some cases, the dual achromatic doublet pair may have an outer diameter of at least about 1 in, about 2 in, about 3 in, about 4 in, about 5 in, about 6 in, about 7 in, about 8 in, or about 9 in. In some cases, the dual achromatic doublet pair may have an outer diameter of at most about 2 in, about 3 in, about 4 in, about 5 in, about 6 in, about 7 in, about 8 in, about 9 in, or about 10 in.

In some cases, the collection optics may have a f-number of about 1 to about 12. In some cases, the collection optics may have a f-number of about 1 to about 2, about 1 to about 3, about 1 to about 4, about 1 to about 5, about 1 to about 6, about 1 to about 7, about 1 to about 8, about 1 to about 9, about 1 to about 10, about 1 to about 11, about 1 to about 12, about 2 to about 3, about 2 to about 4, about 2 to about 5, about 2 to about 6, about 2 to about 7, about 2 to about 8, about 2 to about 9, about 2 to about 10, about 2 to about 11, about 2 to about 12, about 3 to about 4, about 3 to about 5, about 3 to about 6, about 3 to about 7, about 3 to about 8, about 3 to about 9, about 3 to about 10, about 3 to about 11, about 3 to about 12, about 4 to about 5, about 4 to about 6, about 4 to about 7, about 4 to about 8, about 4 to about 9, about 4 to about 10, about 4 to about 11, about 4 to about 12, about 5 to about 6, about 5 to about 7, about 5 to about 8, about 5 to about 9, about 5 to about 10, about 5 to about 11, about 5 to about 12, about 6 to about 7, about 6 to about 8, about 6 to about 9, about 6 to about 10, about 6 to about 11, about 6 to about 12, about 7 to about 8, about 7 to about 9, about 7 to about 10, about 7 to about 11, about 7 to about 12, about 8 to about 9, about 8 to about 10, about 8 to about 11, about 8 to about 12, about 9 to about 10, about 9 to about 11, about 9 to about 12, about 10 to about 11, about 10 to about 12, or about 11 to about 12. In some cases, the collection optics may have a f-number of about 1, about 2, about 3, about 4, about 5, about 6, about 7, about 8, about 9, about 10, about 11, or about 12. In some cases, the collection optics may have a f-number of at least about 1, about 2, about 3, about 4, about 5, about 6, about 7, about 8, about 9, about 10, or about 11. In some cases, the collection optics may have a f-number of at most about 2, about 3, about 4, about 5, about 6, about 7, about 8, about 9, about 10, about 11, or about 12.

In some cases, the collection optics may have a f-number of about 1 to about 10. In some cases, the collection optics may have an f-number of about 1 to about 1.5, about 1 to about 2, about 1 to about 2.5, about 1 to about 3, about 1 to about 3.5, about 1 to about 4, about 1 to about 5, about 1 to about 6, about 1 to about 8, about 1 to about 9, about 1 to about 10, about 1.5 to about 2, about 1.5 to about 2.5, about 1.5 to about 3, about 1.5 to about 3.5, about 1.5 to about 4, about 1.5 to about 5, about 1.5 to about 6, about 1.5 to about 8, about 1.5 to about 9, about 1.5 to about 10, about 2 to about 2.5, about 2 to about 3, about 2 to about 3.5, about 2 to about 4, about 2 to about 5, about 2 to about 6, about 2 to about 8, about 2 to about 9, about 2 to about 10, about 2.5 to about 3, about 2.5 to about 3.5, about 2.5 to about 4, about 2.5 to about 5, about 2.5 to about 6, about 2.5 to about 8, about 2.5 to about 9, about 2.5 to about 10, about 3 to about 3.5, about 3 to about 4, about 3 to about 5, about 3 to about 6, about 3 to about 8, about 3 to about 9, about 3 to about 10, about 3.5 to about 4, about 3.5 to about 5, about 3.5 to about 6, about 3.5 to about 8, about 3.5 to about 9, about 3.5 to about 10, about 4 to about 5, about 4 to about 6, about 4 to about 8, about 4 to about 9, about 4 to about 10, about 5 to about 6, about 5 to about 8, about 5 to about 9, about 5 to about 10, about 6 to about 8, about 6 to about 9, about 6 to about 10, about 8 to about 9, about 8 to about 10, or about 9 to about 10. In some cases, the collection optics may have a f-number of about 1, about 1.5, about 2, about 2.5, about 3, about 3.5, about 4, about 5, about 6, about 8, about 9, or about 10. In some cases, the collection optics may have a f-number of at least about 1, about 1.5, about 2, about 2.5, about 3, about 3.5, about 4, about 5, about 6, about 8, or about 9. In some cases, the collection optics may have a f-number of at most about 1.5, about 2, about 2.5, about 3, about 3.5, about 4, about 5, about 6, about 8, about 9, or about 10.

In some instances, the one or more lens and/or lens arrangements (204, 208) and/or one or more lenses of the plurality of relay optics 2430 may comprise an outer diameter of about 10 mm to about 220 mm. In some instances, the one or more lens and/or lens arrangements (204, 208) and/or one or more lenses of the plurality of relay optics 2430 may comprise an outer diameter of about 10 mm to about 20 mm, about 10 mm to about 30 mm, about 10 mm to about 40 mm, about 10 mm to about 50 mm, about 10 mm to about 100 mm, about 10 mm to about 120 mm, about 10 mm to about 140 mm, about 10 mm to about 160 mm, about 10 mm to about 180 mm, about 10 mm to about 200 mm, about 10 mm to about 220 mm, about 20 mm to about 30 mm, about 20 mm to about 40 mm, about 20 mm to about 50 mm, about 20 mm to about 100 mm, about 20 mm to about 120 mm, about 20 mm to about 140 mm, about 20 mm to about 160 mm, about 20 mm to about 180 mm, about 20 mm to about 200 mm, about 20 mm to about 220 mm, about 30 mm to about 40 mm, about 30 mm to about 50 mm, about 30 mm to about 100 mm, about 30 mm to about 120 mm, about 30 mm to about 140 mm, about 30 mm to about 160 mm, about 30 mm to about 180 mm, about 30 mm to about 200 mm, about 30 mm to about 220 mm, about 40 mm to about 50 mm, about 40 mm to about 100 mm, about 40 mm to about 120 mm, about 40 mm to about 140 mm, about 40 mm to about 160 mm, about 40 mm to about 180 mm, about 40 mm to about 200 mm, about 40 mm to about 220 mm, about 50 mm to about 100 mm, about 50 mm to about 120 mm, about 50 mm to about 140 mm, about 50 mm to about 160 mm, about 50 mm to about 180 mm, about 50 mm to about 200 mm, about 50 mm to about 220 mm, about 100 mm to about 120 mm, about 100 mm to about 140 mm, about 100 mm to about 160 mm, about 100 mm to about 180 mm, about 100 mm to about 200 mm, about 100 mm to about 220 mm, about 120 mm to about 140 mm, about 120 mm to about 160 mm, about 120 mm to about 180 mm, about 120 mm to about 200 mm, about 120 mm to about 220 mm, about 140 mm to about 160 mm, about 140 mm to about 180 mm, about 140 mm to about 200 mm, about 140 mm to about 220 mm, about 160 mm to about 180 mm, about 160 mm to about 200 mm, about 160 mm to about 220 mm, about 180 mm to about 200 mm, about 180 mm to about 220 mm, or about 200 mm to about 220 mm. In some instances, the one or more lens and/or lens arrangements (204, 208) and/or one or more lenses of the plurality of relay optics 2430 may comprise an outer diameter of about 10 mm, about 20 mm, about 30 mm, about 40 mm, about 50 mm, about 100 mm, about 120 mm, about 140 mm, about 160 mm, about 180 mm, about 200 mm, or about 220 mm. In some instances, the one or more lens and/or lens arrangements (204, 208) and/or one or more lenses of the plurality of relay optics 2430 may comprise an outer diameter of at least about 10 mm, about 20 mm, about 30 mm, about 40 mm, about 50 mm, about 100 mm, about 120 mm, about 140 mm, about 160 mm, about 180 mm, or about 200 mm. In some instances, the one or more lens and/or lens arrangements (204, 208) and/or one or more lenses of the plurality of relay optics 2430 may comprise an outer diameter of at most about 20 mm, about 30 mm, about 40 mm, about 50 mm, about 100 mm, about 120 mm, about 140 mm, about 160 mm, about 180 mm, about 200 mm, or about 220 mm. In some cases, the collection optics 118 may collect and transmit the autofluorescent light emitted from the tissue sample to the wavelength splitting element 120 with angular spread of about 2 degrees to about 16 degrees. In some cases, the collection optics 118 may collect and transmit the autofluorescent light emitted from the tissue sample to the wavelength splitting element 120 with angular spread of about 2 degrees to about 4 degrees, about 2 degrees to about 6 degrees, about 2 degrees to about 8 degrees, about 2 degrees to about 10 degrees, about 2 degrees to about 12 degrees, about 2 degrees to about 14 degrees, about 2 degrees to about 16 degrees, about 4 degrees to about 6 degrees, about 4 degrees to about 8 degrees, about 4 degrees to about 10 degrees, about 4 degrees to about 12 degrees, about 4 degrees to about 14 degrees, about 4 degrees to about 16 degrees, about 6 degrees to about 8 degrees, about 6 degrees to about 10 degrees, about 6 degrees to about 12 degrees, about 6 degrees to about 14 degrees, about 6 degrees to about 16 degrees, about 8 degrees to about 10 degrees, about 8 degrees to about 12 degrees, about 8 degrees to about 14 degrees, about 8 degrees to about 16 degrees, about 10 degrees to about 12 degrees, about 10 degrees to about 14 degrees, about 10 degrees to about 16 degrees, about 12 degrees to about 14 degrees, about 12 degrees to about 16 degrees, or about 14 degrees to about 16 degrees. In some cases, the collection optics 118 may collect and transmit the autofluorescent light emitted from the tissue sample to the wavelength splitting element 120 with angular spread of about 2 degrees, about 4 degrees, about 6 degrees, about 8 degrees, about 10 degrees, about 12 degrees, about 14 degrees, or about 16 degrees. In some cases, the collection optics 118 may collect and transmit the autofluorescent light emitted from the tissue sample to the wavelength splitting element 120 with angular spread of at least about 2 degrees, about 4 degrees, about 6 degrees, about 8 degrees, about 10 degrees, about 12 degrees, or about 14 degrees. In some cases, the collection optics 118 may collect and transmit the autofluorescent light emitted from the tissue sample to the wavelength splitting element 120 with angular spread of at most about 4 degrees, about 6 degrees, about 8 degrees, about 10 degrees, about 12 degrees, about 14 degrees, or about 16 degrees.

In some cases, the collection optics 118 configured to capture the fluorescent light emitted from the tissue sample may comprise a numerical aperture of about 0.1 to about 0.4. In some cases, the collection optics 118 configured to capture the fluorescent light emitted from the tissue sample may comprise a numerical aperture of about 0.1 to about 0.12, about 0.1 to about 0.14, about 0.1 to about 0.18, about 0.1 to about 0.2, about 0.1 to about 0.22, about 0.1 to about 0.26, about 0.1 to about 0.28, about 0.1 to about 0.3, about 0.1 to about 0.34, about 0.1 to about 0.36, about 0.1 to about 0.4, about 0.12 to about 0.14, about 0.12 to about 0.18, about 0.12 to about 0.2, about 0.12 to about 0.22, about 0.12 to about 0.26, about 0.12 to about 0.28, about 0.12 to about 0.3, about 0.12 to about 0.34, about 0.12 to about 0.36, about 0.12 to about 0.4, about 0.14 to about 0.18, about 0.14 to about 0.2, about 0.14 to about 0.22, about 0.14 to about 0.26, about 0.14 to about 0.28, about 0.14 to about 0.3, about 0.14 to about 0.34, about 0.14 to about 0.36, about 0.14 to about 0.4, about 0.18 to about 0.2, about 0.18 to about 0.22, about 0.18 to about 0.26, about 0.18 to about 0.28, about 0.18 to about 0.3, about 0.18 to about 0.34, about 0.18 to about 0.36, about 0.18 to about 0.4, about 0.2 to about 0.22, about 0.2 to about 0.26, about 0.2 to about 0.28, about 0.2 to about 0.3, about 0.2 to about 0.34, about 0.2 to about 0.36, about 0.2 to about 0.4, about 0.22 to about 0.26, about 0.22 to about 0.28, about 0.22 to about 0.3, about 0.22 to about 0.34, about 0.22 to about 0.36, about 0.22 to about 0.4, about 0.26 to about 0.28, about 0.26 to about 0.3, about 0.26 to about 0.34, about 0.26 to about 0.36, about 0.26 to about 0.4, about 0.28 to about 0.3, about 0.28 to about 0.34, about 0.28 to about 0.36, about 0.28 to about 0.4, about 0.3 to about 0.34, about 0.3 to about 0.36, about 0.3 to about 0.4, about 0.34 to about 0.36, about 0.34 to about 0.4, or about 0.36 to about 0.4. In some cases, the collection optics 118 configured to capture the fluorescent light emitted from the tissue sample may comprise a numerical aperture of about 0.1, about 0.12, about 0.14, about 0.18, about 0.2, about 0.22, about 0.26, about 0.28, about 0.3, about 0.34, about 0.36, or about 0.4. In some cases, the collection optics 118 configured to capture the fluorescent light emitted from the tissue sample may comprise a numerical aperture of at least about 0.1, about 0.12, about 0.14, about 0.18, about 0.2, about 0.22, about 0.26, about 0.28, about 0.3, about 0.34, or about 0.36. In some cases, the collection optics 118 configured to capture the fluorescent light emitted from the tissue sample may comprise a numerical aperture of at most about 0.12, about 0.14, about 0.18, about 0.2, about 0.22, about 0.26, about 0.28, about 0.3, about 0.34, about 0.36, or about 0.4.

In some cases, the lens and/or lens arrangement (204, 208) and/or the plurality of relay optics 2430 may be configured to collect and/or relay the fluorescence light emitted by the sample to the PMT 122 with a beam spot of about 2 mm to about 14 mm. In some cases, the lens and/or lens arrangement (204, 208) and/or the plurality of relay optics 2430 may be configured to collect and/or relay the fluorescence light emitted by the sample to the PMT with a beam spot of about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 2 mm to about 11 mm, about 2 mm to about 12 mm, about 2 mm to about 14 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 3 mm to about 11 mm, about 3 mm to about 12 mm, about 3 mm to about 14 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 4 mm to about 11 mm, about 4 mm to about 12 mm, about 4 mm to about 14 mm, about 5 mm to about 6 mm, about 5 mm to about 7 mm, about 5 mm to about 8 mm, about 5 mm to about 9 mm, about 5 mm to about 10 mm, about 5 mm to about 11 mm, about 5 mm to about 12 mm, about 5 mm to about 14 mm, about 6 mm to about 7 mm, about 6 mm to about 8 mm, about 6 mm to about 9 mm, about 6 mm to about 10 mm, about 6 mm to about 11 mm, about 6 mm to about 12 mm, about 6 mm to about 14 mm, about 7 mm to about 8 mm, about 7 mm to about 9 mm, about 7 mm to about 10 mm, about 7 mm to about 11 mm, about 7 mm to about 12 mm, about 7 mm to about 14 mm, about 8 mm to about 9 mm, about 8 mm to about 10 mm, about 8 mm to about 11 mm, about 8 mm to about 12 mm, about 8 mm to about 14 mm, about 9 mm to about 10 mm, about 9 mm to about 11 mm, about 9 mm to about 12 mm, about 9 mm to about 14 mm, about 10 mm to about 11 mm, about 10 mm to about 12 mm, about 10 mm to about 14 mm, about 11 mm to about 12 mm, about 11 mm to about 14 mm, or about 12 mm to about 14 mm. In some cases, the lens and/or lens arrangement (204, 208) and/or the plurality of relay optics 2430 may be configured to collect and/or relay the fluorescence light emitted by the sample to the PMT with a beam spot of about 2 mm, about 3 mm, about 4 mm, about 5 mm, about 6 mm, about 7 mm, about 8 mm, about 9 mm, about 10 mm, about 11 mm, about 12 mm, or about 14 mm. In some cases, the lens and/or lens arrangement (204, 208) and/or the plurality of relay optics 2430 may be configured to collect and/or relay the fluorescence light emitted by the sample to the PMT with a beam spot of at least about 2 mm, about 3 mm, about 4 mm, about 5 mm, about 6 mm, about 7 mm, about 8 mm, about 9 mm, about 10 mm, about 11 mm, or about 12 mm. In some cases, the lens and/or lens arrangement (204, 208) and/or the plurality of relay optics 2430 may be configured to collect and/or relay the fluorescence light emitted by the sample to the PMT with a beam spot of at most about 3 mm, about 4 mm, about 5 mm, about 6 mm, about 7 mm, about 8 mm, about 9 mm, about 10 mm, about 11 mm, about 12 mm, or about 14 mm.

In some instances, the optical fiber 206 may comprise a length of about 0.3 meter (m) to about 10 m. In some instances, the optical fiber 206 may comprise a length of about 0.3 m to about 0.5 m, about 0.3 m to about 0.7 m, about 0.3 m to about 1 m, about 0.3 m to about 2 m, about 0.3 m to about 3 m, about 0.3 m to about 4 m, about 0.3 m to about 5 m, about 0.3 m to about 6 m, about 0.3 m to about 7 m, about 0.3 m to about 8 m, about 0.3 m to about 10 m, about 0.5 m to about 0.7 m, about 0.5 m to about 1 m, about 0.5 m to about 2 m, about 0.5 m to about 3 m, about 0.5 m to about 4 m, about 0.5 m to about 5 m, about 0.5 m to about 6 m, about 0.5 m to about 7 m, about 0.5 m to about 8 m, about 0.5 m to about 10 m, about 0.7 m to about 1 m, about 0.7 m to about 2 m, about 0.7 m to about 3 m, about 0.7 m to about 4 m, about 0.7 m to about 5 m, about 0.7 m to about 6 m, about 0.7 m to about 7 m, about 0.7 m to about 8 m, about 0.7 m to about 10 m, about 1 m to about 2 m, about 1 m to about 3 m, about 1 m to about 4 m, about 1 m to about 5 m, about 1 m to about 6 m, about 1 m to about 7 m, about 1 m to about 8 m, about 1 m to about 10 m, about 2 m to about 3 m, about 2 m to about 4 m, about 2 m to about 5 m, about 2 m to about 6 m, about 2 m to about 7 m, about 2 m to about 8 m, about 2 m to about 10 m, about 3 m to about 4 m, about 3 m to about 5 m, about 3 m to about 6 m, about 3 m to about 7 m, about 3 m to about 8 m, about 3 m to about 10 m, about 4 m to about 5 m, about 4 m to about 6 m, about 4 m to about 7 m, about 4 m to about 8 m, about 4 m to about 10 m, about 5 m to about 6 m, about 5 m to about 7 m, about 5 m to about 8 m, about 5 m to about 10 m, about 6 m to about 7 m, about 6 m to about 8 m, about 6 m to about 10 m, about 7 m to about 8 m, about 7 m to about 10 m, or about 8 m to about 10 m. In some instances, the optical fiber 206 may comprise a length of about 0.3 m, about 0.5 m, about 0.7 m, about 1 m, about 2 m, about 3 m, about 4 m, about 5 m, about 6 m, about 7 m, about 8 m, or about 10 m. In some instances, the optical fiber 206 may comprise a length of at least about 0.3 m, about 0.5 m, about 0.7 m, about 1 m, about 2 m, about 3 m, about 4 m, about 5 m, about 6 m, about 7 m, or about 8 m. In some instances, the optical fiber 206 may comprise a length of at most about 0.5 m, about 0.7 m, about 1 m, about 2 m, about 3 m, about 4 m, about 5 m, about 6 m, about 7 m, about 8 m, or about 10 m.

In some cases, the optical fiber 206 may comprise a core size of about 10 micrometers (μm) to about 10,000 μm. In some cases, the optical fiber 206 may comprise a core size of about 10 μm to about 20 μm, about 10 μm to about 50 μm, about 10 μm to about 100 μm, about 10 μm to about 500 μm, about 10 μm to about 1,000 μm, about 10 m to about 2,000 μm, about 10 μm to about 4,000 μm, about 10 m to about 6,000 μm, about 10 μm to about 8,000 μm, about 10 μm to about 10,000 μm, about 20 μm to about 50 μm, about 20 μm to about 100 μm, about 20 μm to about 500 μm, about 20 μm to about 1,000 μm, about 20 μm to about 2,000 μm, about 20 μm to about 4,000 μm, about 20 μm to about 6,000 μm, about 20 μm to about 8,000 μm, about 20 μm to about 10,000 μm, about 50 μm to about 100 μm, about 50 μm to about 500 μm, about 50 μm to about 1,000 μm, about 50 μm to about 2,000 μm, about 50 μm to about 4,000 μm, about 50 μm to about 6,000 μm, about 50 μm to about 8,000 μm, about 50 μm to about 10,000 μm, about 100 μm to about 500 μm, about 100 μm to about 1,000 μm, about 100 μm to about 2,000 μm, about 100 μm to about 4,000 μm, about 100 μm to about 6,000 μm, about 100 μm to about 8,000 μm, about 100 μm to about 10,000 μm, about 500 μm to about 1,000 μm, about 500 μm to about 2,000 μm, about 500 μm to about 4,000 μm, about 500 μm to about 6,000 μm, about 500 μm to about 8,000 μm, about 500 μm to about 10,000 μm, about 1,000 μm to about 2,000 μm, about 1,000 μm to about 4,000 μm, about 1,000 μm to about 6,000 μm, about 1,000 μm to about 8,000 μm, about 1,000 μm to about 10,000 μm, about 2,000 μm to about 4,000 μm, about 2,000 μm to about 6,000 μm, about 2,000 μm to about 8,000 μm, about 2,000 μm to about 10,000 μm, about 4,000 μm to about 6,000 μm, about 4,000 μm to about 8,000 μm, about 4,000 μm to about 10,000 μm, about 6,000 μm to about 8,000 μm, about 6,000 μm to about 10,000 μm, or about 8,000 μm to about 10,000 μm. In some cases, the optical fiber 206 may comprise a core size of about 10 μm, about 20 μm, about 50 μm, about 100 μm, about 500 μm, about 1,000 μm, about 2,000 μm, about 4,000 μm, about 6,000 μm, about 8,000 μm, or about 10,000 μm. In some cases, the optical fiber 206 may comprise a core size of at least about 10 μm, about 20 μm, about 50 μm, about 100 μm, about 500 μm, about 1,000 μm, about 2,000 μm, about 4,000 μm, about 6,000 μm, or about 8,000 μm. In some cases, the optical fiber 206 may comprise a core size of at most about 20 μm, about 50 μm, about 100 μm, about 500 μm, about 1,000 μm, about 2,000 μm, about 4,000 μm, about 6,000 μm, about 8,000 μm, or about 10,000 μm.

In some cases, the optical fiber 206 may provide a depth of field of about 0.01 mm to about 20 mm. In some cases, the optical fiber 206 may provide a depth of field of about 0.01 mm to about 0.1 mm, about 0.01 mm to about 1 mm, about 0.01 mm to about 5 mm, about 0.01 mm to about 7 mm, about 0.01 mm to about 9 mm, about 0.01 mm to about 12 mm, about 0.01 mm to about 14 mm, about 0.01 mm to about 16 mm, about 0.01 mm to about 18 mm, about 0.01 mm to about 20 mm, about 0.1 mm to about 1 mm, about 0.1 mm to about 5 mm, about 0.1 mm to about 7 mm, about 0.1 mm to about 9 mm, about 0.1 mm to about 12 mm, about 0.1 mm to about 14 mm, about 0.1 mm to about 16 mm, about 0.1 mm to about 18 mm, about 0.1 mm to about 20 mm, about 1 mm to about 5 mm, about 1 mm to about 7 mm, about 1 mm to about 9 mm, about 1 mm to about 12 mm, about 1 mm to about 14 mm, about 1 mm to about 16 mm, about 1 mm to about 18 mm, about 1 mm to about 20 mm, about 5 mm to about 7 mm, about 5 mm to about 9 mm, about 5 mm to about 12 mm, about 5 mm to about 14 mm, about 5 mm to about 16 mm, about 5 mm to about 18 mm, about 5 mm to about 20 mm, about 7 mm to about 9 mm, about 7 mm to about 12 mm, about 7 mm to about 14 mm, about 7 mm to about 16 mm, about 7 mm to about 18 mm, about 7 mm to about 20 mm, about 9 mm to about 12 mm, about 9 mm to about 14 mm, about 9 mm to about 16 mm, about 9 mm to about 18 mm, about 9 mm to about 20 mm, about 12 mm to about 14 mm, about 12 mm to about 16 mm, about 12 mm to about 18 mm, about 12 mm to about 20 mm, about 14 mm to about 16 mm, about 14 mm to about 18 mm, about 14 mm to about 20 mm, about 16 mm to about 18 mm, about 16 mm to about 20 mm, or about 18 mm to about 20 mm. In some cases, the optical fiber 206 may provide a depth of field of about 0.01 mm, about 0.1 mm, about 1 mm, about 5 mm, about 7 mm, about 9 mm, about 12 mm, about 14 mm, about 16 mm, about 18 mm, or about 20 mm. In some cases, the optical fiber 206 may provide a depth of field of at least about 0.01 mm, about 0.1 mm, about 1 mm, about 5 mm, about 7 mm, about 9 mm, about 12 mm, about 14 mm, about 16 mm, or about 18 mm. In some cases, the optical fiber 206 may provide a depth of field of at most about 0.1 mm, about 1 mm, about 5 mm, about 7 mm, about 9 mm, about 12 mm, about 14 mm, about 16 mm, about 18 mm, or about 20 mm.

In some cases, the optical fiber 206 may comprise a numerical aperture of about 0.12 to about 0.5. In some cases, the optical fiber 206 may comprise a numerical aperture of about 0.12 to about 0.2, about 0.12 to about 0.25, about 0.12 to about 0.3, about 0.12 to about 0.35, about 0.12 to about 0.4, about 0.12 to about 0.45, about 0.12 to about 0.5, about 0.2 to about 0.25, about 0.2 to about 0.3, about 0.2 to about 0.35, about 0.2 to about 0.4, about 0.2 to about 0.45, about 0.2 to about 0.5, about 0.25 to about 0.3, about 0.25 to about 0.35, about 0.25 to about 0.4, about 0.25 to about 0.45, about 0.25 to about 0.5, about 0.3 to about 0.35, about 0.3 to about 0.4, about 0.3 to about 0.45, about 0.3 to about 0.5, about 0.35 to about 0.4, about 0.35 to about 0.45, about 0.35 to about 0.5, about 0.4 to about 0.45, about 0.4 to about 0.5, or about 0.45 to about 0.5. In some cases, the optical fiber 206 may comprise a numerical aperture of about 0.12, about 0.2, about 0.25, about 0.3, about 0.35, about 0.4, about 0.45, or about 0.5.

In some cases, the optical fiber 206 may comprise a numerical aperture of at least about 0.12, about 0.2, about 0.25, about 0.3, about 0.35, about 0.4, or about 0.45. In some cases, the optical fiber 206 may comprise a numerical aperture of at most about 0.2, about 0.25, about 0.3, about 0.35, about 0.4, about 0.45, or about 0.5.

In some instances, the optical fiber 206 may comprise a single mode, polarization maintaining, photonic crystal, multi-mode, or any combination thereof fiber. In some instances, the collection optics may comprise one or more plano-convex, bi-convex, bi-concave, or plano-concave lenses. In some instances, the optical fiber 206 may comprise one or more fibers e.g., a fiber bundle. In some cases, the fiber bundle may comprise at least one fiber.

In some cases, the signal collection sub-system 102 may comprise a wavelength splitting element 120 which may split the emitted beam 117 into a plurality of beams in different wavelength ranges of interest. The wavelength splitting element 120 may comprise a filter wheel, such as a rotatable wheel of optical filters to allow only a certain wavelength range to pass therethrough at a given time, or demultiplexer, for example, comprising an arrangement of filters and mirrors to split the emitted beam 117 into wavelength ranges. In some cases, the filter wheel may be rotated continuously and may be rotated with a particular rate. In some cases, the filter wheel may be rotated at least 1 full and/or partial rotation of the filter wheel in at least about 1 second, at least about 2 seconds, at least about 3 seconds, at least about 4 seconds. In some instances, the filter wheel may be rotated such that each filter is placed within the path of the emitted fluorescence light of the sample for about two seconds. The wavelength splitting element 120 may comprise one or more filters with one or more emission cut-off wavelengths. The wavelength splitting element 120 may comprise one or more filters that may filter the emitted beam 117 to up to 1, 2, 3, 4, 5, 6, 7, 8, 9, 10, 12 or more emission channels. The emission channels may comprise wavelength ranges of about 365 nm to about 410 nm, about 410 nm to about 450 nm, about 450 nm to about 480 nm, about 500 nm to about 560 nm, about 560 nm to about 600 nm, and about 600 nm or greater. In some cases, the splitting element 120 may comprise a filter wheel which can rotate the plurality of filters as the imaging system is imaging the tissue sample to generate signal for each emission channel.

In some cases, a filter of the one or more filters may comprise an upper wavelength cut off and a lower wavelength cut off of the wavelength transmission band for the filter.

In some cases, a filter of the one or more filters may comprise an upper wavelength cut off of, at most about 400 nm, at most about 402 nm, at most about 404 nm, at most about 408 nm, at most about 410 nm, at most about 412 nm, at most about 414 nm, at most about 418 nm, at most about 420 nm, at most about 422 nm, at most about 424 nm, at most about 426 nm, at most about 428 nm, at most about 430 nm, at most about 432 nm, at most about 434 nm, at most about 436 nm, at most about 438 nm, at most about 440 nm, at most 444 nm, at most about 446 nm, at most about 448 nm, at most about 450 nm, at most about 452 nm, at most about 454 nm, at most about 456 nm, at most about 458 nm, at most about 460 nm, at most about 462 nm, at most about 464 nm, at most about 466, at most about 468 nm, at most about 470 nm, at most about 472 nm, at most about 474 nm, at most about 476 nm, of at most about 478 nm, at most about 480 nm, at most about 482 nm, at most about 484 nm, at most about 486 nm, at most about 488 nm, at most about 490 nm, at most about 492 nm, at most about 494 nm, at most about 496 nm, at most about 498 nm, at most about 500 nm, at most about 502 nm, at most about 504 nm, at most about 506 nm, at most about 508 nm, at most about 510 nm, at most about 512 nm, at most about 514 nm, at most about 516 nm, at most about 518 nm, at most about 520 nm, at most about 522 nm, at most about 524 nm, at most about 526 nm, at most about 528 nm, at most about 530 nm, at most about 532 nm, at most about 534 nm, at most about 536 nm, at most about 538 nm, at most about 540 nm, at most about 542 nm, at most about 544 nm, at most about 546 nm, at most about 548 nm, at most about 550 nm, at most about 552 nm, at most about 554 nm, at most about 580 nm, at most about 582 nm, at most about 584 nm, at most about 586 nm, at most about 588 nm, at most about 590 nm, at most about 592 nm, at most about 594 nm, at most about 596 nm, at most about 598 nm, at most about 600 nm, at most 602 nm, at most 604 nm, at most about 606 nm, at most about 608 nm, at most about 610 nm, at most about 612 nm, at most about 614 nm, at most about 616 nm, at most about 618 nm, or at most about 620 nm. In some cases, the one or more filters of the wavelength splitting element may comprise different upper wavelength cut off values, as described elsewhere herein.

In some instances, a filter of the one or more filters may comprise an lower wavelength cut off of, at least about 358 nm, at least about 360 nm, at least about 362 nm, at least about 364 nm, at least about 366 nm, at least about 368 nm, at least about 370 nm, at least about 372 nm, at least about 374 nm, at least about 376 nm, at least about 378 nm, at least about 380 nm, at least about 382 nm, at least about 384 nm, at least about 386 nm, at least about 388 nm, at least about 390 nm, at least about 392 nm, at least about 394 nm, at least about 396 nm, at least about 398 nm, at least about 400 nm, at least about 402 nm, at least about 404 nm, at least about 408 nm, at least about 410 nm, at least about 412 nm, at least about 414 nm, at least about 418 nm, at least about 420 nm, at least about 422 nm, at least about 424 nm, at least about 426 nm, at least about 428 nm, at least about 430 nm, at least about 432 nm, at least about 434 nm, at least about 436 nm, at least about 438 nm, at least about 440 nm, at least 444 nm, at least about 446 nm, at least about 448 nm, at least about 450 nm, at least about 452 nm, at least about 454 nm, at least about 456 nm, at least about 458 nm, at least about 460 nm, at least about 462 nm, at least about 464 nm, at least about 466, at least about 468 nm, at least about 470 nm, at least about 472 nm, at least about 474 nm, at least about 476 nm, of at least about 478 nm, at least about 480 nm, at least about 482 nm, at least about 484 nm, at least about 486 nm, at least about 488 nm, at least about 490 nm, at least about 492 nm, at least about 494 nm, at least about 496 nm, at least about 498 nm, at least about 500 nm, at least about 502 nm, at least about 504 nm, at least about 506 nm, at least about 508 nm, at least about 510 nm, at least about 512 nm, at least about 514 nm, at least about 516 nm, at least about 518 nm, at least about 520 nm, at least about 522 nm, at least about 524 nm, at least about 526 nm, at least about 528 nm, at least about 530 nm, at least about 532 nm, at least about 534 nm, at least about 536 nm, at least about 538 nm, at least about 540 nm, at least about 542 nm, at least about 544 nm, at least about 546 nm, at least about 548 nm, at least about 550 nm, at least about 552 nm, at least about 554 nm, at least about 580 nm, at least about 582 nm, at least about 584 nm, at least about 586 nm, at least about 588 nm, at least about 590 nm, at least about 592 nm, at least about 594 nm, at least about 596 nm, at least about 598 nm, at least about 600 nm, at least 602 nm, at least 604 nm, at least about 606 nm, at least about 608 nm, at least about 610 nm, at least about 612 nm, at least about 614 nm, at least about 616 nm, at least about 618 nm, or at least about 620 nm. In some cases, the one or more filters of the wavelength splitting element may each comprise different lower wavelength cut off values, as described elsewhere herein.

In some case, the filter wheel may comprise a plurality of spectral filters. Passing the emitted beam 117 sequentially through the spectral filters of the filter wheel to generate the spectral bands may impart a pre-determined time-delay between spectral bands generated by the different spectral filters. The filter wheel may comprise a plurality of encoders, each spectral filter being associated with at least one encoder. The filter wheel comprises a rotating filter wheel. The optical assembly may further comprise a mirror galvanometer to selectively focus the responsive optical signal to at least one spectral filter of the filter wheel.

In some cases, the spectral bands resulting from the emitted beam 117 traversing through one or more filters of the filter wheel may be in ranges of about 370 nm to about 900 nm. The spectral bands may be in ranges of about 365 nm or less, about 365 nm to about 410 nm, about 410 nm to about 450 nm, about 450 nm to about 480 nm, about 500 nm to about 560 nm, about 560 nm to about 600 nm, and about 600 nm or greater. The spectral bands may be in ranges of about 400 nm or less, about 415 nm to about 450 nm, about 455 nm to about 480 nm, and about 500 nm or greater.

In some instances, the emitted beam 117 may comprise one or more of a fluorescence spectrum, a Raman spectrum, an ultraviolet-visible spectrum, or an infrared spectrum.

In some instances, light source 106 may emit light pulse in the ultraviolet spectrum, the visible spectrum, the near infrared spectrum, or the infrared spectrum.

In some cases, the light source 106 may emit light a wavelength band in a range of about 300 nm to about 1100 nm, the light source 106 may emit light a wavelength band in a range of about 330 nm to about 360 nm, about 420 nm to about 450 nm, about 660 nm to about 720 nm, or about 750 nm to about 780 nm.

In some instances, the signal collection sub-system 102 may comprise a detector, where the detector may comprise a photomultiplier tube (PMT) 122, PIN detector, avalanche photodiode, or any combination thereof. The photomultiplier tube 122 may detect and convert the optical light energy of the emitted beam 117 to an electrical signal. The gain of the PMT may be adjusted by a voltage power supply 220 capable of providing a modular voltage output.

In some cases, the active area of the detector may be pi*(d^{A}2)/4, where d may comprise the diameter of the active area of the detector. In some cases, d, the diameter of the active area of the detector, may be about 50 μm to about 50,000 μm. In some cases d, the diameter of the active area of the detector may be about 50 μm to about 125 μm, about 50 μm to about 400 μm, about 50 μm to about 1,000 μm, about 50 μm to about 2,000 μm, about 50 μm to about 10,000 m, about 50 μm to about 12,000 μm, about 50 μm to about 20,000 μm, about 50 μm to about 30,000 μm, about 50 μm to about 45,000 μm, about 50 μm to about 50,000 μm, about 125 μm to about 400 μm, about 125 μm to about 1,000 μm, about 125 μm to about 2,000 μm, about 125 μm to about 10,000 μm, about 125 μm to about 12,000 μm, about 125 μm to about 20,000 μm, about 125 μm to about 30,000 m, about 125 μm to about 45,000 μm, about 125 μm to about 50,000 μm, about 400 μm to about 1,000 μm, about 400 μm to about 2,000 μm, about 400 μm to about 10,000 μm, about 400 μm to about 12,000 μm, about 400 μm to about 20,000 μm, about 400 μm to about 30,000 μm, about 400 μm to about 45,000 μm, about 400 μm to about 50,000 μm, about 1,000 μm to about 2,000 μm, about 1,000 μm to about 10,000 μm, about 1,000 μm to about 12,000 μm, about 1,000 μm to about 20,000 μm, about 1,000 μm to about 30,000 μm, about 1,000 μm to about 45,000 μm, about 1,000 μm to about 50,000 μm, about 2,000 μm to about 10,000 μm, about 2,000 μm to about 12,000 μm, about 2,000 μm to about 20,000 μm, about 2,000 μm to about 30,000 μm, about 2,000 μm to about 45,000 μm, about 2,000 μm to about 50,000 μm, about 10,000 μm to about 12,000 μm, about 10,000 μm to about 20,000 μm, about 10,000 μm to about 30,000 μm, about 10,000 μm to about 45,000 μm, about 10,000 μm to about 50,000 μm, about 12,000 μm to about 20,000 μm, about 12,000 μm to about 30,000 μm, about 12,000 μm to about 45,000 μm, about 12,000 μm to about 50,000 μm, about 20,000 μm to about 30,000 μm, about 20,000 μm to about 45,000 μm, about 20,000 μm to about 50,000 μm, about 30,000 μm to about 45,000 μm, about 30,000 μm to about 50,000 μm, or about 45,000 μm to about 50,000 μm. In some cases, d, the diameter of the active area of the detector may be about 50 μm, about 125 μm, about 400 μm, about 1,000 μm, about 2,000 μm, about 10,000 μm, about 12,000 μm, about 20,000 μm, about 30,000 μm, about 45,000 μm, or about 50,000 μm. In some cases, d, the diameter of the active area of the detector may be at least about 50 μm, about 125 μm, about 400 μm, about 1,000 μm, about 2,000 μm, about 10,000 μm, about 12,000 μm, about 20,000 μm, about 30,000 μm, or about 45,000 μm. In some cases, d, the diameter of the active area of the detector may be at least about 125 μm, about 400 μm, about 1,000 μm, about 2,000 μm, about 10,000 μm, about 12,000 μm, about 20,000 μm, about 30,000 μm, about 45,000 μm, or about 50,000 μm.

In some cases, the acceptable cone angle of the detector may be about −70 degrees to about 0 degrees. In some cases, the acceptable cone angle of the detector may be about 0 degrees to about −10 degrees, about 0 degrees to about −15 degrees, about 0 degrees to about −20 degrees, about 0 degrees to about −25 degrees, about 0 degrees to about −30 degrees, about 0 degrees to about −35 degrees, about 0 degrees to about −40 degrees, about 0 degrees to about −45 degrees, about 0 degrees to about −50 degrees, about 0 degrees to about −60 degrees, about 0 degrees to about −70 degrees, about −10 degrees to about −15 degrees, about −10 degrees to about −20 degrees, about −10 degrees to about −25 degrees, about −10 degrees to about −30 degrees, about −10 degrees to about −35 degrees, about −10 degrees to about −40 degrees, about −10 degrees to about −45 degrees, about −10 degrees to about −50 degrees, about −10 degrees to about −60 degrees, about −10 degrees to about −70 degrees, about −15 degrees to about −20 degrees, about −15 degrees to about −25 degrees, about −15 degrees to about −30 degrees, about −15 degrees to about −35 degrees, about −15 degrees to about −40 degrees, about −15 degrees to about −45 degrees, about −15 degrees to about −50 degrees, about −15 degrees to about −60 degrees, about −15 degrees to about −70 degrees, about −20 degrees to about −25 degrees, about −20 degrees to about −30 degrees, about −20 degrees to about −35 degrees, about −20 degrees to about −40 degrees, about −20 degrees to about −45 degrees, about −20 degrees to about −50 degrees, about −20 degrees to about −60 degrees, about −20 degrees to about −70 degrees, about −25 degrees to about −30 degrees, about −25 degrees to about −35 degrees, about −25 degrees to about −40 degrees, about −25 degrees to about −45 degrees, about −25 degrees to about −50 degrees, about −25 degrees to about −60 degrees, about −25 degrees to about −70 degrees, about −30 degrees to about −35 degrees, about −30 degrees to about −40 degrees, about −30 degrees to about −45 degrees, about −30 degrees to about −50 degrees, about −30 degrees to about −60 degrees, about −30 degrees to about −70 degrees, about −35 degrees to about −40 degrees, about −35 degrees to about −45 degrees, about −35 degrees to about −50 degrees, about −35 degrees to about −60 degrees, about −35 degrees to about −70 degrees, about −40 degrees to about −45 degrees, about −40 degrees to about −50 degrees, about −40 degrees to about −60 degrees, about −40 degrees to about −70 degrees, about −45 degrees to about −50 degrees, about −45 degrees to about −60 degrees, about −45 degrees to about −70 degrees, about −50 degrees to about −60 degrees, about −50 degrees to about −70 degrees, or about −60 degrees to about −70 degrees. In some cases, the acceptable cone angle of the detector may be about 0 degrees, about −10 degrees, about −15 degrees, about −20 degrees, about −25 degrees, about −30 degrees, about −35 degrees, about −40 degrees, about −45 degrees, about −50 degrees, about −60 degrees, or about −70 degrees. In some cases, the acceptable cone angle of the detector may be at least about 0 degrees, about −10 degrees, about −15 degrees, about −20 degrees, about −25 degrees, about −30 degrees, about −35 degrees, about −40 degrees, about −45 degrees, about −50 degrees, or about −60 degrees. In some cases, the acceptable cone angle of the detector may be at least about −10 degrees, about −15 degrees, about −20 degrees, about −25 degrees, about −30 degrees, about −35 degrees, about −40 degrees, about −45 degrees, about −50 degrees, about −60 degrees, or about −70 degrees.

In some cases, the acceptable cone angle of the detector may be about 0 degrees to about 70 degrees. In some cases, the acceptable cone angle of the detector may be about 0 degrees to about 10 degrees, about 0 degrees to about 15 degrees, about 0 degrees to about 20 degrees, about 0 degrees to about 25 degrees, about 0 degrees to about 30 degrees, about 0 degrees to about 35 degrees, about 0 degrees to about 40 degrees, about 0 degrees to about 45 degrees, about 0 degrees to about 50 degrees, about 0 degrees to about 60 degrees, about 0 degrees to about 70 degrees, about 10 degrees to about 15 degrees, about 10 degrees to about 20 degrees, about 10 degrees to about 25 degrees, about 10 degrees to about 30 degrees, about 10 degrees to about 35 degrees, about 10 degrees to about 40 degrees, about 10 degrees to about 45 degrees, about 10 degrees to about 50 degrees, about 10 degrees to about 60 degrees, about 10 degrees to about 70 degrees, about 15 degrees to about 20 degrees, about 15 degrees to about 25 degrees, about 15 degrees to about 30 degrees, about 15 degrees to about 35 degrees, about 15 degrees to about 40 degrees, about 15 degrees to about 45 degrees, about 15 degrees to about 50 degrees, about 15 degrees to about 60 degrees, about 15 degrees to about 70 degrees, about 20 degrees to about 25 degrees, about 20 degrees to about 30 degrees, about 20 degrees to about 35 degrees, about 20 degrees to about 40 degrees, about 20 degrees to about 45 degrees, about 20 degrees to about 50 degrees, about 20 degrees to about 60 degrees, about 20 degrees to about 70 degrees, about 25 degrees to about 30 degrees, about 25 degrees to about 35 degrees, about 25 degrees to about 40 degrees, about 25 degrees to about 45 degrees, about 25 degrees to about 50 degrees, about 25 degrees to about 60 degrees, about 25 degrees to about 70 degrees, about 30 degrees to about 35 degrees, about 30 degrees to about 40 degrees, about 30 degrees to about 45 degrees, about 30 degrees to about 50 degrees, about 30 degrees to about 60 degrees, about 30 degrees to about 70 degrees, about 35 degrees to about 40 degrees, about 35 degrees to about 45 degrees, about 35 degrees to about 50 degrees, about 35 degrees to about 60 degrees, about 35 degrees to about 70 degrees, about 40 degrees to about 45 degrees, about 40 degrees to about 50 degrees, about 40 degrees to about 60 degrees, about 40 degrees to about 70 degrees, about 45 degrees to about 50 degrees, about 45 degrees to about 60 degrees, about 45 degrees to about 70 degrees, about 50 degrees to about 60 degrees, about 50 degrees to about 70 degrees, or about 60 degrees to about 70 degrees. In some cases, the acceptable cone angle of the detector may be about 0 degrees, about 10 degrees, about 15 degrees, about 20 degrees, about 25 degrees, about 30 degrees, about 35 degrees, about 40 degrees, about 45 degrees, about 50 degrees, about 60 degrees, or about 70 degrees. In some cases, the acceptable cone angle of the detector may be at least about 0 degrees, about 10 degrees, about 15 degrees, about 20 degrees, about 25 degrees, about 30 degrees, about 35 degrees, about 40 degrees, about 45 degrees, about 50 degrees, or about 60 degrees. In some cases, the acceptable cone angle of the detector may be at least about 10 degrees, about 15 degrees, about 20 degrees, about 25 degrees, about 30 degrees, about 35 degrees, about 40 degrees, about 45 degrees, about 50 degrees, about 60 degrees, or about 70 degrees.

In some cases, the electrical signal of the photomultiplier tube may be processed and/or analyzed by the digital and/or analog signal processing elements 124-128. The digital and/or analog signal processing elements may comprise attenuation-amplification electronics 124, a digitizer (126, 234), system control electronics (128,221,222) or any combination thereof. In some cases, the attenuation-amplification electronics 124 may comprise at least two attenuators (226, 230), at least two pre-amplifiers (228, 232), a programmable attenuator 2600, a fixed attenuator 2604, an amplifier 2602, or any combination thereof. In some cases, the attenuation-amplification electronics 124 may comprise a programmable attenuator 2600, an amplifier 2602, a fixed attenuator 2604, or any combination thereof, which are electrically coupled to one another and/or to the digitizer 234. In some cases, the electrical connectors between the attenuation-amplification electronics 124 may comprise a connector configured to reduce connection distance and/or reduce radio frequency electrical signal reflection between a first component and/or connector and a second component and/or connector.

The programmable attenuator 2600 may comprise attenuation of about 1 dB to about 100 dB. The programmable attenuator 2600 may comprise attenuation of about 1 dB to about 5 dB, about 1 dB to about 10 dB, about 1 dB to about 15 dB, about 1 dB to about 20 dB, about 1 dB to about 30 dB, about 1 dB to about 50 dB, about 1 dB to about 60 dB, about 1 dB to about 70 dB, about 1 dB to about 80 dB, about 1 dB to about 90 dB, about 1 dB to about 100 dB, about 5 dB to about 10 dB, about 5 dB to about 15 dB, about 5 dB to about 20 dB, about 5 dB to about 30 dB, about 5 dB to about 50 dB, about 5 dB to about 60 dB, about 5 dB to about 70 dB, about 5 dB to about 80 dB, about 5 dB to about 90 dB, about 5 dB to about 100 dB, about 10 dB to about 15 dB, about 10 dB to about 20 dB, about 10 dB to about 30 dB, about 10 dB to about 50 dB, about 10 dB to about 60 dB, about 10 dB to about 70 dB, about 10 dB to about 80 dB, about 10 dB to about 90 dB, about 10 dB to about 100 dB, about 15 dB to about 20 dB, about 15 dB to about 30 dB, about 15 dB to about 50 dB, about 15 dB to about 60 dB, about 15 dB to about 70 dB, about 15 dB to about 80 dB, about 15 dB to about 90 dB, about 15 dB to about 100 dB, about 20 dB to about 30 dB, about 20 dB to about 50 dB, about 20 dB to about 60 dB, about 20 dB to about 70 dB, about 20 dB to about 80 dB, about 20 dB to about 90 dB, about 20 dB to about 100 dB, about 30 dB to about 50 dB, about 30 dB to about 60 dB, about 30 dB to about 70 dB, about 30 dB to about 80 dB, about 30 dB to about 90 dB, about 30 dB to about 100 dB, about 50 dB to about 60 dB, about 50 dB to about 70 dB, about 50 dB to about 80 dB, about 50 dB to about 90 dB, about 50 dB to about 100 dB, about 60 dB to about 70 dB, about 60 dB to about 80 dB, about 60 dB to about 90 dB, about 60 dB to about 100 dB, about 70 dB to about 80 dB, about 70 dB to about 90 dB, about 70 dB to about 100 dB, about 80 dB to about 90 dB, about 80 dB to about 100 dB, or about 90 dB to about 100 dB. The programmable attenuator 2600 may comprise attenuation of about 1 dB, about 5 dB, about 10 dB, about 15 dB, about 20 dB, about 30 dB, about 50 dB, about 60 dB, about 70 dB, about 80 dB, about 90 dB, or about 100 dB. The programmable attenuator 2600 may comprise attenuation of at least about 1 dB, about 5 dB, about 10 dB, about 15 dB, about 20 dB, about 30 dB, about 50 dB, about 60 dB, about 70 dB, about 80 dB, or about 90 dB. The programmable attenuator 2600 may comprise attenuation of at most about 5 dB, about 10 dB, about 15 dB, about 20 dB, about 30 dB, about 50 dB, about 60 dB, about 70 dB, about 80 dB, about 90 dB, or about 100 dB.

The programmable attenuator 2600 may comprise attenuation resolution of about 0.1 dB to about 30 dB. The programmable attenuator 2600 may comprise attenuation resolution of about 0.1 dB to about 0.25 dB, about 0.1 dB to about 0.3 dB, about 0.1 dB to about 0.5 dB, about 0.1 dB to about 1 dB, about 0.1 dB to about 1.5 dB, about 0.1 dB to about 2 dB, about 0.1 dB to about 3 dB, about 0.1 dB to about 5 dB, about 0.1 dB to about 10 dB, about 0.1 dB to about 20 dB, about 0.1 dB to about 30 dB, about 0.25 dB to about 0.3 dB, about 0.25 dB to about 0.5 dB, about 0.25 dB to about 1 dB, about 0.25 dB to about 1.5 dB, about 0.25 dB to about 2 dB, about 0.25 dB to about 3 dB, about 0.25 dB to about 5 dB, about 0.25 dB to about 10 dB, about 0.25 dB to about 20 dB, about 0.25 dB to about 30 dB, about 0.3 dB to about 0.5 dB, about 0.3 dB to about 1 dB, about 0.3 dB to about 1.5 dB, about 0.3 dB to about 2 dB, about 0.3 dB to about 3 dB, about 0.3 dB to about 5 dB, about 0.3 dB to about 10 dB, about 0.3 dB to about 20 dB, about 0.3 dB to about 30 dB, about 0.5 dB to about 1 dB, about 0.5 dB to about 1.5 dB, about 0.5 dB to about 2 dB, about 0.5 dB to about 3 dB, about 0.5 dB to about 5 dB, about 0.5 dB to about 10 dB, about 0.5 dB to about 20 dB, about 0.5 dB to about 30 dB, about 1 dB to about 1.5 dB, about 1 dB to about 2 dB, about 1 dB to about 3 dB, about 1 dB to about 5 dB, about 1 dB to about 10 dB, about 1 dB to about 20 dB, about 1 dB to about 30 dB, about 1.5 dB to about 2 dB, about 1.5 dB to about 3 dB, about 1.5 dB to about 5 dB, about 1.5 dB to about 10 dB, about 1.5 dB to about 20 dB, about 1.5 dB to about 30 dB, about 2 dB to about 3 dB, about 2 dB to about 5 dB, about 2 dB to about 10 dB, about 2 dB to about 20 dB, about 2 dB to about 30 dB, about 3 dB to about 5 dB, about 3 dB to about 10 dB, about 3 dB to about 20 dB, about 3 dB to about 30 dB, about 5 dB to about 10 dB, about 5 dB to about 20 dB, about 5 dB to about 30 dB, about 10 dB to about 20 dB, about 10 dB to about 30 dB, or about 20 dB to about 30 dB. The programmable attenuator 2600 may comprise attenuation resolution of about 0.1 dB, about 0.25 dB, about 0.3 dB, about 0.5 dB, about 1 dB, about 1.5 dB, about 2 dB, about 3 dB, about 5 dB, about 10 dB, about 20 dB, or about 30 dB. The programmable attenuator 2600 may comprise attenuation resolution of at least about 0.1 dB, about 0.25 dB, about 0.3 dB, about 0.5 dB, about 1 dB, about 1.5 dB, about 2 dB, about 3 dB, about 5 dB, about 10 dB, or about 20 dB. The programmable attenuator 2600 may comprise attenuation resolution of at most about 0.25 dB, about 0.3 dB, about 0.5 dB, about 1 dB, about 1.5 dB, about 2 dB, about 3 dB, about 5 dB, about 10 dB, about 20 dB, or about 30 dB.

The fixed attenuator 2604 may comprise an attenuation of about 0.1 dB to about 30 dB. The fixed attenuator 2604 may comprise an attenuation of about 0.1 dB to about 0.25 dB, about 0.1 dB to about 0.3 dB, about 0.1 dB to about 0.5 dB, about 0.1 dB to about 1 dB, about 0.1 dB to about 1.5 dB, about 0.1 dB to about 2 dB, about 0.1 dB to about 3 dB, about 0.1 dB to about 6 dB, about 0.1 dB to about 10 dB, about 0.1 dB to about 20 dB, about 0.1 dB to about 30 dB, about 0.25 dB to about 0.3 dB, about 0.25 dB to about 0.5 dB, about 0.25 dB to about 1 dB, about 0.25 dB to about 1.5 dB, about 0.25 dB to about 2 dB, about 0.25 dB to about 3 dB, about 0.25 dB to about 6 dB, about 0.25 dB to about 10 dB, about 0.25 dB to about 20 dB, about 0.25 dB to about 30 dB, about 0.3 dB to about 0.5 dB, about 0.3 dB to about 1 dB, about 0.3 dB to about 1.5 dB, about 0.3 dB to about 2 dB, about 0.3 dB to about 3 dB, about 0.3 dB to about 6 dB, about 0.3 dB to about 10 dB, about 0.3 dB to about 20 dB, about 0.3 dB to about 30 dB, about 0.5 dB to about 1 dB, about 0.5 dB to about 1.5 dB, about 0.5 dB to about 2 dB, about 0.5 dB to about 3 dB, about 0.5 dB to about 6 dB, about 0.5 dB to about 10 dB, about 0.5 dB to about 20 dB, about 0.5 dB to about 30 dB, about 1 dB to about 1.5 dB, about 1 dB to about 2 dB, about 1 dB to about 3 dB, about 1 dB to about 6 dB, about 1 dB to about 10 dB, about 1 dB to about 20 dB, about 1 dB to about 30 dB, about 1.5 dB to about 2 dB, about 1.5 dB to about 3 dB, about 1.5 dB to about 6 dB, about 1.5 dB to about 10 dB, about 1.5 dB to about 20 dB, about 1.5 dB to about 30 dB, about 2 dB to about 3 dB, about 2 dB to about 6 dB, about 2 dB to about 10 dB, about 2 dB to about 20 dB, about 2 dB to about 30 dB, about 3 dB to about 6 dB, about 3 dB to about 10 dB, about 3 dB to about 20 dB, about 3 dB to about 30 dB, about 6 dB to about 10 dB, about 6 dB to about 20 dB, about 6 dB to about 30 dB, about 10 dB to about 20 dB, about 10 dB to about 30 dB, or about 20 dB to about 30 dB. The fixed attenuator 2604 may comprise an attenuation of about 0.1 dB, about 0.25 dB, about 0.3 dB, about 0.5 dB, about 1 dB, about 1.5 dB, about 2 dB, about 3 dB, about 6 dB, about 10 dB, about 20 dB, or about 30 dB. The fixed attenuator 2604 may comprise an attenuation of at least about 0.1 dB, about 0.25 dB, about 0.3 dB, about 0.5 dB, about 1 dB, about 1.5 dB, about 2 dB, about 3 dB, about 6 dB, about 10 dB, or about 20 dB. The fixed attenuator 2604 may comprise an attenuation of at most about 0.25 dB, about 0.3 dB, about 0.5 dB, about 1 dB, about 1.5 dB, about 2 dB, about 3 dB, about 6 dB, about 10 dB, about 20 dB, or about 30 dB.

In some cases, the digitizer (126, 234) may comprise an analog to digital circuit (i.e., a DAC) configured to sample the analog electrical signal of the photomultiplier tube after amplification and attenuation, as described elsewhere herein. In some instances, the digitizer may comprise a positive one voltage to negative 1 volt input signal detection range. In some cases, the digitizer may comprise an input signal damage voltage threshold of positive three volts to negative three volts.

In some cases, the digitizer (126, 234) may be electrically coupled to a field programmable gate array (FPGA), graphical processing unit (GPU), solid state memory of the system, or any combination thereof electrical components of the imaging system. In some instances, the digitizer may transfer data directly to a FPGA or GPU without sending digitized data to a processor before sending data to the FPGA or GPU. In some cases, the FPGA and/or the GPU may pre-process 2450 the output signal from the attenuation-amplification electronics 124 prior to sending, transferring, and/or transmitting the fluorescence imaging data to a predictive model pipeline 2452, as shown in FIG. 25. In some cases, the predictive model pipeline 2452, may conduct or more processing methods on the fluorescence imaging data e.g., dimensionality reduction, feature engineering, classification, image processing, further signal pre-processing, or any combination thereof processing methods. In some instances, the predictive model pipeline may conduct the one or more processing methods on the fluorescence imaging data on the computer system 804, off-line in a cloud computing architecture 816, or a combination thereof. In some instances, the digitizer may convert the analog electrical signal of the photomultiplier tube to a digital signal and then transmit the digitized signal to a GPU for further signal processing (e.g., determining of fluorescence lifetime of the pulsed electrical signal of the photomultiplier tube). In some cases, the digitizer may convert the analog pulsed electrical signal provided by the photomultiplier tube to a digital signal and then transmit the digitized signal to a FPGA. The FPGA may be configured to detect the total optical energy detected by the photomultiplier tube. In some cases, the FPGA may be configured to measure the peak amplitude and/or the area under each pulse of the pulsed signal.

The signal processing conducted by the GPU and/or FPGA may comprise the steps of: aligning the detected pulsed signals of the electrical signal provided by the photomultiplier tube; filtering the aligned pulsed signal; averaging the pulsed signals; extracting the decay values and/or peak values from the averaged pulses; or any combination thereof signal processing steps.

In some instances, the digitizer may comprise an analog bandwidth of about 50 megahertz (MHz) to about 20,000 MHz. In some instances, the digitizer may comprise an analog bandwidth of about 50 MHz to about 100 MHz, about 50 MHz to about 500 MHz, about 50 MHz to about 700 MHz, about 50 MHz to about 1,000 MHz, about 50 MHz to about 2,000 MHz, about 50 MHz to about 4,000 MHz, about 50 MHz to about 6,000 MHz, about 50 MHz to about 8,000 MHz, about 50 MHz to about 9,000 MHz, about 50 MHz to about 10,000 MHz, about 50 MHz to about 20,000 MHz, about 100 MHz to about 500 MHz, about 100 MHz to about 700 MHz, about 100 MHz to about 1,000 MHz, about 100 MHz to about 2,000 MHz, about 100 MHz to about 4,000 MHz, about 100 MHz to about 6,000 MHz, about 100 MHz to about 8,000 MHz, about 100 MHz to about 9,000 MHz, about 100 MHz to about 10,000 MHz, about 100 MHz to about 20,000 MHz, about 500 MHz to about 700 MHz, about 500 MHz to about 1,000 MHz, about 500 MHz to about 2,000 MHz, about 500 MHz to about 4,000 MHz, about 500 MHz to about 6,000 MHz, about 500 MHz to about 8,000 MHz, about 500 MHz to about 9,000 MHz, about 500 MHz to about 10,000 MHz, about 500 MHz to about 20,000 MHz, about 700 MHz to about 1,000 MHz, about 700 MHz to about 2,000 MHz, about 700 MHz to about 4,000 MHz, about 700 MHz to about 6,000 MHz, about 700 MHz to about 8,000 MHz, about 700 MHz to about 9,000 MHz, about 700 MHz to about 10,000 MHz, about 700 MHz to about 20,000 MHz, about 1,000 MHz to about 2,000 MHz, about 1,000 MHz to about 4,000 MHz, about 1,000 MHz to about 6,000 MHz, about 1,000 MHz to about 8,000 MHz, about 1,000 MHz to about 9,000 MHz, about 1,000 MHz to about 10,000 MHz, about 1,000 MHz to about 20,000 MHz, about 2,000 MHz to about 4,000 MHz, about 2,000 MHz to about 6,000 MHz, about 2,000 MHz to about 8,000 MHz, about 2,000 MHz to about 9,000 MHz, about 2,000 MHz to about 10,000 MHz, about 2,000 MHz to about 20,000 MHz, about 4,000 MHz to about 6,000 MHz, about 4,000 MHz to about 8,000 MHz, about 4,000 MHz to about 9,000 MHz, about 4,000 MHz to about 10,000 MHz, about 4,000 MHz to about 20,000 MHz, about 6,000 MHz to about 8,000 MHz, about 6,000 MHz to about 9,000 MHz, about 6,000 MHz to about 10,000 MHz, about 6,000 MHz to about 20,000 MHz, about 8,000 MHz to about 9,000 MHz, about 8,000 MHz to about 10,000 MHz, about 8,000 MHz to about 20,000 MHz, about 9,000 MHz to about 10,000 MHz, about 9,000 MHz to about 20,000 MHz, or about 10,000 MHz to about 20,000 MHz. In some instances, the digitizer may comprise an analog bandwidth of about 50 MHz, about 100 MHz, about 500 MHz, about 700 MHz, about 1,000 MHz, about 2,000 MHz, about 4,000 MHz, about 6,000 MHz, about 8,000 MHz, about 9,000 MHz, about 10,000 MHz, or about 20,000 MHz. In some instances, the digitizer may comprise an analog bandwidth of at least about 50 MHz, about 100 MHz, about 500 MHz, about 700 MHz, about 1,000 MHz, about 2,000 MHz, about 4,000 MHz, about 6,000 MHz, about 8,000 MHz, about 9,000 MHz, or about 10,000 MHz. In some instances, the digitizer may comprise an analog bandwidth of at least about 100 MHz, about 500 MHz, about 700 MHz, about 1,000 MHz, about 2,000 MHz, about 4,000 MHz, about 6,000 MHz, about 8,000 MHz, about 9,000 MHz, about 10,000 MHz, or about 20,000 MHz.

In some instances, the digitizer may a sampling rate of about 50 mega samples per second (Ms/s) to about 20,000 Ms/s. In some instances, the digitizer may a sampling rate of about 50 Ms/s to about 100 Ms/s, about 50 Ms/s to about 500 Ms/s, about 50 Ms/s to about 700 Ms/s, about 50 Ms/s to about 1,000 Ms/s, about 50 Ms/s to about 2,000 Ms/s, about 50 Ms/s to about 4,000 Ms/s, about 50 Ms/s to about 6,000 Ms/s, about 50 Ms/s to about 8,000 Ms/s, about 50 Ms/s to about 9,000 Ms/s, about 50 Ms/s to about 10,000 Ms/s, about 50 Ms/s to about 20,000 Ms/s, about 100 Ms/s to about 500 Ms/s, about 100 Ms/s to about 700 Ms/s, about 100 Ms/s to about 1,000 Ms/s, about 100 Ms/s to about 2,000 Ms/s, about 100 Ms/s to about 4,000 Ms/s, about 100 Ms/s to about 6,000 Ms/s, about 100 Ms/s to about 8,000 Ms/s, about 100 Ms/s to about 9,000 Ms/s, about 100 Ms/s to about 10,000 Ms/s, about 100 Ms/s to about 20,000 Ms/s, about 500 Ms/s to about 700 Ms/s, about 500 Ms/s to about 1,000 Ms/s, about 500 Ms/s to about 2,000 Ms/s, about 500 Ms/s to about 4,000 Ms/s, about 500 Ms/s to about 6,000 Ms/s, about 500 Ms/s to about 8,000 Ms/s, about 500 Ms/s to about 9,000 Ms/s, about 500 Ms/s to about 10,000 Ms/s, about 500 Ms/s to about 20,000 Ms/s, about 700 Ms/s to about 1,000 Ms/s, about 700 Ms/s to about 2,000 Ms/s, about 700 Ms/s to about 4,000 Ms/s, about 700 Ms/s to about 6,000 Ms/s, about 700 Ms/s to about 8,000 Ms/s, about 700 Ms/s to about 9,000 Ms/s, about 700 Ms/s to about 10,000 Ms/s, about 700 Ms/s to about 20,000 Ms/s, about 1,000 Ms/s to about 2,000 Ms/s, about 1,000 Ms/s to about 4,000 Ms/s, about 1,000 Ms/s to about 6,000 Ms/s, about 1,000 Ms/s to about 8,000 Ms/s, about 1,000 Ms/s to about 9,000 Ms/s, about 1,000 Ms/s to about 10,000 Ms/s, about 1,000 Ms/s to about 20,000 Ms/s, about 2,000 Ms/s to about 4,000 Ms/s, about 2,000 Ms/s to about 6,000 Ms/s, about 2,000 Ms/s to about 8,000 Ms/s, about 2,000 Ms/s to about 9,000 Ms/s, about 2,000 Ms/s to about 10,000 Ms/s, about 2,000 Ms/s to about 20,000 Ms/s, about 4,000 Ms/s to about 6,000 Ms/s, about 4,000 Ms/s to about 8,000 Ms/s, about 4,000 Ms/s to about 9,000 Ms/s, about 4,000 Ms/s to about 10,000 Ms/s, about 4,000 Ms/s to about 20,000 Ms/s, about 6,000 Ms/s to about 8,000 Ms/s, about 6,000 Ms/s to about 9,000 Ms/s, about 6,000 Ms/s to about 10,000 Ms/s, about 6,000 Ms/s to about 20,000 Ms/s, about 8,000 Ms/s to about 9,000 Ms/s, about 8,000 Ms/s to about 10,000 Ms/s, about 8,000 Ms/s to about 20,000 Ms/s, about 9,000 Ms/s to about 10,000 Ms/s, about 9,000 Ms/s to about 20,000 Ms/s, or about 10,000 Ms/s to about 20,000 Ms/s. In some instances, the digitizer may a sampling rate of about 50 Ms/s, about 100 Ms/s, about 500 Ms/s, about 700 Ms/s, about 1,000 Ms/s, about 2,000 Ms/s, about 4,000 Ms/s, about 6,000 Ms/s, about 8,000 Ms/s, about 9,000 Ms/s, about 10,000 Ms/s, or about 20,000 Ms/s. In some instances, the digitizer may a sampling rate of at least about 50 Ms/s, about 100 Ms/s, about 500 Ms/s, about 700 Ms/s, about 1,000 Ms/s, about 2,000 Ms/s, about 4,000 Ms/s, about 6,000 Ms/s, about 8,000 Ms/s, about 9,000 Ms/s, or about 10,000 Ms/s. In some instances, the digitizer may a sampling rate of at least about 100 Ms/s, about 500 Ms/s, about 700 Ms/s, about 1,000 Ms/s, about 2,000 Ms/s, about 4,000 Ms/s, about 6,000 Ms/s, about 8,000 Ms/s, about 9,000 Ms/s, about 10,000 Ms/s, or about 20,000 Ms/s.

In some cases, the at least two pre-amplifiers (228, 232) and/or the amplifier 2602 may comprise a frequency response of about 8 kilohertz (kHz) to about 3,000,000 kHz. In some cases, the at least two pre-amplifiers (228, 232) and/or the amplifier 2602 may comprise a frequency response of about 8 kHz to about 100 kHz, about 8 kHz to about 1,000 kHz, about 8 kHz to about 10,000 kHz, about 8 kHz to about 50,000 kHz, about 8 kHz to about 100,000 kHz, about 8 kHz to about 150,000 kHz, about 8 kHz to about 250,000 kHz, about 8 kHz to about 500,000 kHz, about 8 kHz to about 1,000,000 kHz, about 8 kHz to about 2,000,000 kHz, about 8 kHz to about 3,000,000 kHz, about 100 kHz to about 1,000 kHz, about 100 kHz to about 10,000 kHz, about 100 kHz to about 50,000 kHz, about 100 kHz to about 100,000 kHz, about 100 kHz to about 150,000 kHz, about 100 kHz to about 250,000 kHz, about 100 kHz to about 500,000 kHz, about 100 kHz to about 1,000,000 kHz, about 100 kHz to about 2,000,000 kHz, about 100 kHz to about 3,000,000 kHz, about 1,000 kHz to about 10,000 kHz, about 1,000 kHz to about 50,000 kHz, about 1,000 kHz to about 100,000 kHz, about 1,000 kHz to about 150,000 kHz, about 1,000 kHz to about 250,000 kHz, about 1,000 kHz to about 500,000 kHz, about 1,000 kHz to about 1,000,000 kHz, about 1,000 kHz to about 2,000,000 kHz, about 1,000 kHz to about 3,000,000 kHz, about 10,000 kHz to about 50,000 kHz, about 10,000 kHz to about 100,000 kHz, about 10,000 kHz to about 150,000 kHz, about 10,000 kHz to about 250,000 kHz, about 10,000 kHz to about 500,000 kHz, about 10,000 kHz to about 1,000,000 kHz, about 10,000 kHz to about 2,000,000 kHz, about 10,000 kHz to about 3,000,000 kHz, about 50,000 kHz to about 100,000 kHz, about 50,000 kHz to about 150,000 kHz, about 50,000 kHz to about 250,000 kHz, about 50,000 kHz to about 500,000 kHz, about 50,000 kHz to about 1,000,000 kHz, about 50,000 kHz to about 2,000,000 kHz, about 50,000 kHz to about 3,000,000 kHz, about 100,000 kHz to about 150,000 kHz, about 100,000 kHz to about 250,000 kHz, about 100,000 kHz to about 500,000 kHz, about 100,000 kHz to about 1,000,000 kHz, about 100,000 kHz to about 2,000,000 kHz, about 100,000 kHz to about 3,000,000 kHz, about 150,000 kHz to about 250,000 kHz, about 150,000 kHz to about 500,000 kHz, about 150,000 kHz to about 1,000,000 kHz, about 150,000 kHz to about 2,000,000 kHz, about 150,000 kHz to about 3,000,000 kHz, about 250,000 kHz to about 500,000 kHz, about 250,000 kHz to about 1,000,000 kHz, about 250,000 kHz to about 2,000,000 kHz, about 250,000 kHz to about 3,000,000 kHz, about 500,000 kHz to about 1,000,000 kHz, about 500,000 kHz to about 2,000,000 kHz, about 500,000 kHz to about 3,000,000 kHz, about 1,000,000 kHz to about 2,000,000 kHz, about 1,000,000 kHz to about 3,000,000 kHz, or about 2,000,000 kHz to about 3,000,000 kHz. In some cases, the at least two pre-amplifiers (228, 232) and/or the amplifier 2602 may comprise a frequency response of about 8 kHz, about 100 kHz, about 1,000 kHz, about 10,000 kHz, about 50,000 kHz, about 100,000 kHz, about 150,000 kHz, about 250,000 kHz, about 500,000 kHz, about 1,000,000 kHz, about 2,000,000 kHz, or about 3,000,000 kHz. In some cases, the at least two pre-amplifiers (228, 232) and/or the amplifier 2602 may comprise a frequency response of at least about 8 kHz, about 100 kHz, about 1,000 kHz, about 10,000 kHz, about 50,000 kHz, about 100,000 kHz, about 150,000 kHz, about 250,000 kHz, about 500,000 kHz, about 1,000,000 kHz, or about 2,000,000 kHz. In some cases, the at least two pre-amplifiers (228, 232) and/or the amplifier 2602 may comprise a frequency response of at least about 100 kHz, about 1,000 kHz, about 10,000 kHz, about 50,000 kHz, about 100,000 kHz, about 150,000 kHz, about 250,000 kHz, about 500,000 kHz, about 1,000,000 kHz, about 2,000,000 kHz, or about 3,000,000 kHz.

In some cases, the at least two pre-amplifiers (228, 232) and/or the amplifier 2602 may comprise a gain of about 2 dB to about 60 dB. In some cases, the at least two pre-amplifiers (228, 232) and/or the amplifier 2602 may comprise a gain of about 2 dB to about 4 dB, about 2 dB to about 6 dB, about 2 dB to about 8 dB, about 2 dB to about 10 dB, about 2 dB to about 12 dB, about 2 dB to about 15 dB, about 2 dB to about 20 dB, about 2 dB to about 30 dB, about 2 dB to about 40 dB, about 2 dB to about 50 dB, about 2 dB to about 60 dB, about 4 dB to about 6 dB, about 4 dB to about 8 dB, about 4 dB to about 10 dB, about 4 dB to about 12 dB, about 4 dB to about 15 dB, about 4 dB to about 20 dB, about 4 dB to about 30 dB, about 4 dB to about 40 dB, about 4 dB to about 50 dB, about 4 dB to about 60 dB, about 6 dB to about 8 dB, about 6 dB to about 10 dB, about 6 dB to about 12 dB, about 6 dB to about 15 dB, about 6 dB to about 20 dB, about 6 dB to about 30 dB, about 6 dB to about 40 dB, about 6 dB to about 50 dB, about 6 dB to about 60 dB, about 8 dB to about 10 dB, about 8 dB to about 12 dB, about 8 dB to about 15 dB, about 8 dB to about 20 dB, about 8 dB to about 30 dB, about 8 dB to about 40 dB, about 8 dB to about 50 dB, about 8 dB to about 60 dB, about 10 dB to about 12 dB, about 10 dB to about 15 dB, about 10 dB to about 20 dB, about 10 dB to about 30 dB, about 10 dB to about 40 dB, about 10 dB to about 50 dB, about 10 dB to about 60 dB, about 12 dB to about 15 dB, about 12 dB to about 20 dB, about 12 dB to about 30 dB, about 12 dB to about 40 dB, about 12 dB to about 50 dB, about 12 dB to about 60 dB, about 15 dB to about 20 dB, about 15 dB to about 30 dB, about 15 dB to about 40 dB, about 15 dB to about 50 dB, about 15 dB to about 60 dB, about 20 dB to about 30 dB, about 20 dB to about 40 dB, about 20 dB to about 50 dB, about 20 dB to about 60 dB, about 30 dB to about 40 dB, about 30 dB to about 50 dB, about 30 dB to about 60 dB, about 40 dB to about 50 dB, about 40 dB to about 60 dB, or about 50 dB to about 60 dB. In some cases, the at least two pre-amplifiers (228, 232) and/or the amplifier 2602 may comprise a gain of about 2 dB, about 4 dB, about 6 dB, about 8 dB, about 10 dB, about 12 dB, about 15 dB, about 20 dB, about 30 dB, about 40 dB, about 50 dB, or about 60 dB. In some cases, the at least two pre-amplifiers (228, 232) and/or the amplifier 2602 may comprise a gain of at least about 2 dB, about 4 dB, about 6 dB, about 8 dB, about 10 dB, about 12 dB, about 15 dB, about 20 dB, about 30 dB, about 40 dB, or about 50 dB. In some cases, the at least two pre-amplifiers (228, 232) and/or the amplifier 2602 may comprise a gain of at most about 4 dB, about 6 dB, about 8 dB, about 10 dB, about 12 dB, about 15 dB, about 20 dB, about 30 dB, about 40 dB, about 50 dB, or about 60 dB.

In some cases, the thermal noise of the at least two pre-amplifiers (228, 232) and/or the amplifier 2602 may comprise a thermal noise of about 0.01 dB to about 6 dB. In some cases, the thermal noise of the at least two pre-amplifiers (228, 232) and/or the amplifier 2602 may comprise a thermal noise of about 0.01 dB to about 0.05 dB, about 0.01 dB to about 0.07 dB, about 0.01 dB to about 0.1 dB, about 0.01 dB to about 0.25 dB, about 0.01 dB to about 0.5 dB, about 0.01 dB to about 1 dB, about 0.01 dB to about 2 dB, about 0.01 dB to about 3 dB, about 0.01 dB to about 4 dB, about 0.01 dB to about 5 dB, about 0.01 dB to about 6 dB, about 0.05 dB to about 0.07 dB, about 0.05 dB to about 0.1 dB, about 0.05 dB to about 0.25 dB, about 0.05 dB to about 0.5 dB, about 0.05 dB to about 1 dB, about 0.05 dB to about 2 dB, about 0.05 dB to about 3 dB, about 0.05 dB to about 4 dB, about 0.05 dB to about 5 dB, about 0.05 dB to about 6 dB, about 0.07 dB to about 0.1 dB, about 0.07 dB to about 0.25 dB, about 0.07 dB to about 0.5 dB, about 0.07 dB to about 1 dB, about 0.07 dB to about 2 dB, about 0.07 dB to about 3 dB, about 0.07 dB to about 4 dB, about 0.07 dB to about 5 dB, about 0.07 dB to about 6 dB, about 0.1 dB to about 0.25 dB, about 0.1 dB to about 0.5 dB, about 0.1 dB to about 1 dB, about 0.1 dB to about 2 dB, about 0.1 dB to about 3 dB, about 0.1 dB to about 4 dB, about 0.1 dB to about 5 dB, about 0.1 dB to about 6 dB, about 0.25 dB to about 0.5 dB, about 0.25 dB to about 1 dB, about 0.25 dB to about 2 dB, about 0.25 dB to about 3 dB, about 0.25 dB to about 4 dB, about 0.25 dB to about 5 dB, about 0.25 dB to about 6 dB, about 0.5 dB to about 1 dB, about 0.5 dB to about 2 dB, about 0.5 dB to about 3 dB, about 0.5 dB to about 4 dB, about 0.5 dB to about 5 dB, about 0.5 dB to about 6 dB, about 1 dB to about 2 dB, about 1 dB to about 3 dB, about 1 dB to about 4 dB, about 1 dB to about 5 dB, about 1 dB to about 6 dB, about 2 dB to about 3 dB, about 2 dB to about 4 dB, about 2 dB to about 5 dB, about 2 dB to about 6 dB, about 3 dB to about 4 dB, about 3 dB to about 5 dB, about 3 dB to about 6 dB, about 4 dB to about 5 dB, about 4 dB to about 6 dB, or about 5 dB to about 6 dB. In some cases, the thermal noise of the at least two pre-amplifiers (228, 232) and/or the amplifier 2602 may comprise a thermal noise of about 0.01 dB, about 0.05 dB, about 0.07 dB, about 0.1 dB, about 0.25 dB, about 0.5 dB, about 1 dB, about 2 dB, about 3 dB, about 4 dB, about 5 dB, or about 6 dB. In some cases, the thermal noise of the at least two pre-amplifiers (228, 232) and/or the amplifier 2602 may comprise a thermal noise of at least about 0.01 dB, about 0.05 dB, about 0.07 dB, about 0.1 dB, about 0.25 dB, about 0.5 dB, about 1 dB, about 2 dB, about 3 dB, about 4 dB, or about 5 dB. In some cases, the thermal noise of the at least two pre-amplifiers (228, 232) and/or the amplifier 2602 may comprise a thermal noise of at most about 0.05 dB, about 0.07 dB, about 0.1 dB, about 0.25 dB, about 0.5 dB, about 1 dB, about 2 dB, about 3 dB, about 4 dB, about 5 dB, or about 6 dB.

In some instances, the detected optical signal from the tissue sample may vary depending on the molecule of interest excited. The detected optical signal may, for example, saturate the detectable range of optical signals of the PMT in the case for a highly responsive, or highly fluorescent molecule in the tissue sample or may not be detectable against the noise floor of the PMT for a less responsive, or less fluorescent molecule in the tissue sample. A fluorophore for example emits a fluorescence spectrum with an intensity based on the quantum efficiency and/or absorption of the excitation light used to excite it. Depending on the conditions in which the fluorophore exists, the intensity of the fluorophore may differ. For example, a fluorophore in a tissue sample may have a different intensity than the same fluorophore in a blood sample or when isolated due to the differences in its surroundings. In order to properly record the fluorescence spectrum, the gain of a detector (e.g., a PMT) may be adjusted such that high fluorescence emission does not saturate the signal and low fluorescence emission does not reduce the signal to noise ratio. This may be achieved by rapidly changing the voltage of the voltage power supply 220 (i.e., slew rate) of the PMT 122.

In some cases, the slew rate of the voltage power supply may be about 1 V/μs to about 1,000 V/μs. In some cases, the slew rate of the voltage power supply may be about 1 V/μs to about 5 V/μs, about 1 V/μs to about 10 V/μs, about 1 V/μs to about 25 V/μs, about 1 V/μs to about 50 V/μs, about 1 V/μs to about 100 V/μs, about 1 V/μs to about 200 V/μs, about 1 V/μs to about 400 V/μs, about 1 V/μs to about 800 V/μs, about 1 V/μs to about 1,000 V/μs, about 5 V/μs to about 10 V/μs, about 5 V/μs to about 25 V/μs, about 5 V/μs to about 50 V/μs, about 5 V/μs to about 100 V/μs, about 5 V/μs to about 200 V/μs, about 5 V/μs to about 400 V/μs, about 5 V/μs to about 800 V/μs, about 5 V/μs to about 1,000 V/μs, about 10 V/μs to about 25 V/μs, about 10 V/μs to about 50 V/μs, about 10 V/μs to about 100 V/μs, about 10 V/μs to about 200 V/μs, about 10 V/μs to about 400 V/μs, about 10 V/μs to about 800 V/μs, about 10 V/μs to about 1,000 V/μs, about 25 V/μs to about 50 V/μs, about 25 V/μs to about 100 V/μs, about 25 V/μs to about 200 V/μs, about 25 V/μs to about 400 V/μs, about 25 V/μs to about 800 V/μs, about 25 V/μs to about 1,000 V/μs, about 50 V/μs to about 100 V/μs, about 50 V/μs to about 200 V/μs, about 50 V/μs to about 400 V/μs, about 50 V/μs to about 800 V/μs, about 50 V/μs to about 1,000 V/μs, about 100 V/μs to about 200 V/μs, about 100 V/μs to about 400 V/μs, about 100 V/μs to about 800 V/μs, about 100 V/μs to about 1,000 V/μs, about 200 V/μs to about 400 V/μs, about 200 V/μs to about 800 V/μs, about 200 V/μs to about 1,000 V/μs, about 400 V/μs to about 800 V/μs, about 400 V/μs to about 1,000 V/μs, or about 800 V/μs to about 1,000 V/μs. In some cases, the slew rate of the voltage power supply may be about 1 V/μs, about 5 V/μs, about 10 V/μs, about 25 V/μs, about 50 V/μs, about 100 V/μs, about 200 V/μs, about 400 V/μs, about 800 V/μs, or about 1,000 V/μs. In some cases, the slew rate of the voltage power supply may be at least about 1 V/μs, about 5 V/μs, about 10 V/μs, about 25 V/μs, about 50 V/μs, about 100 V/μs, about 200 V/μs, about 400 V/μs, or about 800 V/μs. In some cases, the slew rate of the voltage power supply may be at least about 5 V/μs, about 10 V/μs, about 25 V/μs, about 50 V/μs, about 100 V/μs, about 200 V/μs, about 400 V/μs, about 800 V/μs, or about 1,000 V/μs.

In some instances, the frequency response of the voltage power supply may comprise about 1 kHz to about 1,000 kHz. In some instances, the frequency response of the voltage power supply may comprise about 1 kHz to about 5 kHz, about 1 kHz to about 10 kHz, about 1 kHz to about 25 kHz, about 1 kHz to about 50 kHz, about 1 kHz to about 100 kHz, about 1 kHz to about 200 kHz, about 1 kHz to about 400 kHz, about 1 kHz to about 800 kHz, about 1 kHz to about 1,000 kHz, about 5 kHz to about 10 kHz, about 5 kHz to about 25 kHz, about 5 kHz to about 50 kHz, about 5 kHz to about 100 kHz, about 5 kHz to about 200 kHz, about 5 kHz to about 400 kHz, about 5 kHz to about 800 kHz, about 5 kHz to about 1,000 kHz, about 10 kHz to about 25 kHz, about 10 kHz to about 50 kHz, about 10 kHz to about 100 kHz, about 10 kHz to about 200 kHz, about 10 kHz to about 400 kHz, about 10 kHz to about 800 kHz, about 10 kHz to about 1,000 kHz, about 25 kHz to about 50 kHz, about 25 kHz to about 100 kHz, about 25 kHz to about 200 kHz, about 25 kHz to about 400 kHz, about 25 kHz to about 800 kHz, about 25 kHz to about 1,000 kHz, about 50 kHz to about 100 kHz, about 50 kHz to about 200 kHz, about 50 kHz to about 400 kHz, about 50 kHz to about 800 kHz, about 50 kHz to about 1,000 kHz, about 100 kHz to about 200 kHz, about 100 kHz to about 400 kHz, about 100 kHz to about 800 kHz, about 100 kHz to about 1,000 kHz, about 200 kHz to about 400 kHz, about 200 kHz to about 800 kHz, about 200 kHz to about 1,000 kHz, about 400 kHz to about 800 kHz, about 400 kHz to about 1,000 kHz, or about 800 kHz to about 1,000 kHz. In some instances, the frequency response of the voltage power supply may comprise about 1 kHz, about 5 kHz, about 10 kHz, about 25 kHz, about 50 kHz, about 100 kHz, about 200 kHz, about 400 kHz, about 800 kHz, or about 1,000 kHz. In some instances, the frequency response of the voltage power supply may comprise at least about 1 kHz, about 5 kHz, about 10 kHz, about 25 kHz, about 50 kHz, about 100 kHz, about 200 kHz, about 400 kHz, or about 800 kHz. In some instances, the frequency response of the voltage power supply may comprise at least about 5 kHz, about 10 kHz, about 25 kHz, about 50 kHz, about 100 kHz, about 200 kHz, about 400 kHz, about 800 kHz, or about 1,000 kHz.

In some instances, the voltage of the voltage power supply may be adjusted at a rate to achieve imaging scan durations at up to about 1 minute with at least about two-fold, at least three-fold, or at least four-fold increases in imaging resolution of the fluorescence imaging system.

In some instances, the voltage power supply may output a voltage of about −5,000 volts (V) to about 3,000 V. In some instances, the voltage power supply may output a voltage of about −5,000 V to about −3,000 V, about −5,000 V to about −1,000 V, about −5,000 V to about −500 V, about −5,000 V to about 0 V, about −5,000 V to about 100 V, about −5,000 V to about 200 V, about −5,000 V to about 400 V, about −5,000 V to about 800 V, about −5,000 V to about 1,000 V, about −5,000 V to about 2,000 V, about −5,000 V to about 3,000 V, about −3,000 V to about −1,000 V, about −3,000 V to about −500 V, about −3,000 V to about 0 V, about −3,000 V to about 100 V, about −3,000 V to about 200 V, about −3,000 V to about 400 V, about −3,000 V to about 800 V, about −3,000 V to about 1,000 V, about −3,000 V to about 2,000 V, about −3,000 V to about 3,000 V, about −1,000 V to about −500 V, about −1,000 V to about 0 V, about −1,000 V to about 100 V, about −1,000 V to about 200 V, about −1,000 V to about 400 V, about −1,000 V to about 800 V, about −1,000 V to about 1,000 V, about −1,000 V to about 2,000 V, about −1,000 V to about 3,000 V, about −500 V to about 0 V, about −500 V to about 100 V, about −500 V to about 200 V, about −500 V to about 400 V, about −500 V to about 800 V, about −500 V to about 1,000 V, about −500 V to about 2,000 V, about −500 V to about 3,000 V, about 0 V to about 100 V, about 0 V to about 200 V, about 0 V to about 400 V, about 0 V to about 800 V, about 0 V to about 1,000 V, about 0 V to about 2,000 V, about 0 V to about 3,000 V, about 100 V to about 200 V, about 100 V to about 400 V, about 100 V to about 800 V, about 100 V to about 1,000 V, about 100 V to about 2,000 V, about 100 V to about 3,000 V, about 200 V to about 400 V, about 200 V to about 800 V, about 200 V to about 1,000 V, about 200 V to about 2,000 V, about 200 V to about 3,000 V, about 400 V to about 800 V, about 400 V to about 1,000 V, about 400 V to about 2,000 V, about 400 V to about 3,000 V, about 800 V to about 1,000 V, about 800 V to about 2,000 V, about 800 V to about 3,000 V, about 1,000 V to about 2,000 V, about 1,000 V to about 3,000 V, or about 2,000 V to about 3,000 V. In some instances, the voltage power supply may output a voltage of about −5,000 V, about −3,000 V, about −1,000 V, about −500 V, about 0 V, about 100 V, about 200 V, about 400 V, about 800 V, about 1,000 V, about 2,000 V, or about 3,000 V. In some instances, the voltage power supply may output a voltage of at least about −5,000 V, about −3,000 V, about −1,000 V, about −500 V, about 0 V, about 100 V, about 200 V, about 400 V, about 800 V, about 1,000 V, or about 2,000 V. In some instances, the voltage power supply may output a voltage of at least about −3,000 V, about −1,000 V, about −500 V, about 0 V, about 100 V, about 200 V, about 400 V, about 800 V, about 1,000 V, about 2,000 V, or about 3,000 V. In some cases, the voltage of the voltage power supply 220 may be controlled by a gain controller 221 or by the FPGA. In some cases, the gain controller may comprise a STM32 chip set. The gain controller 221 may control the at least two attenuators (226, 230) through transistor-transistor-logical (TTL). The gain controller 221 by controlling at least two attenuators (226,230), may decrease or increase the PMT 122 voltage detected and recorded by the digitizer (126, 234). In some cases, the gain controller 221 may be receive input from the digitizer (126, 234) over a universal serial bus (USB) interface. In some instances, the gain controller 221 may supply an input signal to the digitizer (126, 234). In some cases, the gain controller 221 may control the gain of a programmable attenuator 2600. In some instances, the gain controller 221 may provide a control input to and/or receive a control signal from an acoustic optic modular of the one or more excitation optics 110. In some cases, the gain controller may receive input signals and/or provide signals to the computer system 804.

In some cases, the signal to noise ratio (SNR) of the detected electrical signal of the photomultiplier may be increased by placing a cable 2403 configured to transmit radio frequency (RF) electrical signal e.g., a rigid or flexible coaxial cable, in between the PMT 122 and the attenuation-amplification electronics 124. In some cases, the cable 2403 may provide a RF delay of RF signal reflections that result from amplifying, attenuating, and detecting the electrical signal of the photomultiplier tube. The length of the cable 2403 may comprise a length of at least about 1 meter, at least about 2 meters, at least about 3 meters, or at least about 4 meters. The RF cable 2403 may convey the signal as well as the various sources of noise (e.g., thermal, shot, circuit, etc.) to the attenuation-amplification electronics 124. RF cable may permit the motion of the PMT 122 with respect to the position of the attenuation-amplification electronics 124. The length of the cable 2403 may be configured to prevent RF signal reflections from interfering with the detected electrical signal of the photomultiplier tube thereby increasing the signal to noise detection of the electrical signal of the photomultiplier tube. The RF cable may improve the SNR of detecting an electrical signal of the photomultiplier tube by at least about 5%, at least about 10%, at least about 15%, at least about 20%, at least about 30%, at least about 40%, at least about 50%, at least about 60%, at least about 70%, at least about 80%, at least about 90%, at least about 95%, at least about 98%, or at least about 99% compared to a system's SNR without the RF cable when detecting an electrical signal of a photomultiplier tube. In some cases, a rigid cable may be implemented in the fluorescence imaging system in place of a flexible (e.g., coiled) cable to maintain a compact system form factor. In some instances, the rigid cable may provide better than expected improvements to SNR compared to the flexible cable that is commonly used. The RF cable may provide better expected results of improvements to signal to noise in view of the length dependent signal attenuation of the cable (e.g., about ldB-3 dB loss per Im at 3 GHz).

In some cases, the intensity of fluorescent light emitted from the tissue sample may be decreased by an acoustic optic modulator (AOM). The AOM may be controlled by the gain controller 221 to reduce an intensity of the fluorescent signal at the PMT when the fluorescent signal intensity exceeds and/or is below the detectable range of the PMT. In some instances, the AOM may be placed in between the light source 106 and the collection optics 118 of the optical scanning element 112. The AOM may reduce the intensity of the fluorescent light emitted from the tissue sample by re-directing fluorescent light emitted from the tissue sample by an oscillating optical component at an angle from the optical detection axis of the PMT 122. In some cases, the AOM may be electrically coupled and/or controlled by a FPGA connected to a DAC. In some instances, the FPGA connected to the DAC may provide an analog signal to an AOM driver that then actuates the AOM. In some cases, the AOM may be used to modulate the intensity of fluorescent light emitted from the tissue sample between a first area of the tissue sample and a second area of the tissue sample, where the first area and the second area of the tissue sample may or may not overlap. The AOM may comprise two functions: (1) if the fluorescence intensity is beyond the detectable range of the PMT, the AOM may reduce the fluorescence intensity by modulating the output light of the light source; and/or (2) adjust the fluorescence intensity incident on the PMT dynamically with respect to the altering gain of the PMT.

As an example of the gain system, in some cases, the tissue sample may be excited with a plurality of light pulses and the recorded data may be averaged and analyzed to determine if the signal from the tissue sample is too high or too low. The voltage supplied to the PMT 122 from the voltage power supply 220 may then be adjusted by the gain controller 221 based on the measurement feedback from the digitizer 234 and system software. In some cases, the variable RF attenuator may be adjusted and/or controlled by the gain controller 221 when the signal exceeds and/or is below the detectable range of the digitizer 234. The gain controller 221 may adjust the output voltage of the voltage power supply 220 of the PMT 122 through an analog electrical communication protocol. Such adjustments may be done manually or automatically, for example by a processor and/or FPGA located on the gain controller 221. Such adjustments may be done iteratively until the desired signal level and/or signal-to-noise ratio is reached. The data may be recorded once the desired signal level and/or signal to noise ratio is reached.

In some cases, the system control electronics (128, 221, 222) may comprise a device controller 222. The device controller 222 (e.g., the micro-controller) may control or synchronize events of the movement of the stage 216, the position of a filter of the filter wheel 120 exposed to the collected emitted beam 117, operating parameters of the light source 106, the gain controller 221, or any combination thereof. In some cases, the operating parameters of the light source may comprise controlling the light source 106 output power, pulse width, pulse frequency, or any combination thereof. In some cases, the device controller 222 may receive input and/or provide an output to the digitizer (126, 234), scanning controller 2426, gain controller 221, drawer controller 2422, light source 106, computer system 804 and/or computer system processor 810, or any combination thereof. In some instances, the device controller 222 may receive universal serial bus (USB) input from the digitizer (126, 234).

In some cases, the fluorescence imaging system (300, 2300) may comprise one or more airflow features 2316 configured to intake and/or direct airflow from an external surface in through an enclosure of the system and/or out of the imaging system enclosure. In some instances, the one or more airflow features may comprise one or more filters configured to filter particles in the environment and/or atmosphere external to the imaging system enclosure prior to being introduced into the imaging system enclosure.

In some instances, the one or more filters may filter particles from an external atmosphere prior to directing and/or assisting in the transfer of the atmosphere (e.g., the air fluid atmosphere external to the system) into the enclosure of the imaging system. The particles that are filtered from the atmosphere if not filtered may adhere, settle and/or land on one or more surfaces of optical and/or electronic components of the imaging system and damage the components hindering their performance. In some instances, the filter may prevent particles from landing on one or more surfaces of optical components exposed to high pulse energy from a light source, described elsewhere herein, that may ionize the particle and damage the optical component.

In some instances, the one or more airflow features 2316 may be configured to direct the flow of air from an atmosphere or environment external to the imaging system enclosure into the enclosure to maintain temperature of the imaging system components, as seen in FIG. 24B. Maintaining an operating temperature for the one or more imaging system components may permit the one or more imaging system components to operate at a peak efficiency e.g., a laser cooled to an operating temperate 28-35 degrees Celsius maintains nominal laser operation with respect to laser output power, repetition rate, and/or constant laser output spectral characteristics compared to laser operating outside of the operating temperature range. In some instances, the one or more airflow features may comprise airflow intake features e.g., a vent, a slot, and/or an opening otherwise disposed on the surface of the imaging system in fluid communication with an atmosphere or environment external to the imaging system and an environment and/or atmosphere of an enclosure or internal to the imaging system. In some instances, the one or more features may comprise one or more baffle(s) configured to direct and/or transport the flow of external environment and/or atmosphere around imaging system components within the enclosure of the imaging system. In some instances, the airflow intake features and/or the baffles may be positioned adjacent to the light source (e.g., laser), described elsewhere herein, to direct airflow from an atmosphere and/or environment external to the imaging system towards the light source to maintain the operating temperature of the laser. In some instances, the light source may comprise a heat sink in contact with one or more surfaces of the light source, where the heat sink is configured to dissipate heat across a surface area that is greater than a surface area of the light source to assist in maintaining the operating temperature of the light source. In some instances, the airflow intake features may be disposed on top surface and/or a surface at the peak height of the imaging system and where an airflow outflow vent i.e., an exhaust is disposed at the bottom or the lowest height of the imaging system with respect to a level surface that the imaging system is maintained on. By disposing airflow intake features at the top surface and/or a surface at the peak height of the imaging system and exhaust at the bottom may limit dispersing of potential contaminants present in the exhaust into a sterile surgical field surrounding the imaging system in an operating room setting of using the imaging system.

In some embodiments, the fluorescence imaging system (300, 2300) may comprise a handle 2312 that allows one or more users of the fluorescence imaging system to transport the imaging system mounted on one or more wheels (e.g., casters). The one or more wheels of the system may comprise a material that allows the fluorescence imaging system (300, 2300) to be transported over uneven surfaces without damaged or miss aligning the one or more optical components of the fluorescence imaging system.

In some cases, internal LEDs and/or light sources of electrical, opto-mechanical, and/or mechanical components internal to the imaging system may be covered and our blocked from transmitting light to the other components of the fluorescence imaging system. The LEDs and/or light sources of the electrical, opto-mechanical, and/or mechanical components may be covered and/or blocked from transmitting light to the other components of the fluorescence imaging system to improve the signal to noise ratio of detected fluorescence signal by a detector (e.g., photomultiplier tube) by reducing background light of the LEDs and/or light sources of the electrical, opto-mechanical, and/or mechanical internal system components from entering the optical detection path of the imaging system. In some cases, the LEDs and/or light sources of the electrical, opto-mechanical, and/or mechanical components internal to the imaging system may be covered with black optical tape or weather strips. In some cases, orifices and/or openings between an interior surface of the imaging system and an exterior surface of the imaging system may be block and/or sealed to prevent stray light from the surrounding environment around the imaging system from entering the optical detection path of the imaging system. The blocked orifices and/or openings of the imaging system may increase the signal to noise ratio of detecting fluorescence signal by a detector by reducing background light provided by the imaging system's surrounding environment.

Computer Systems andMachine Learning Models

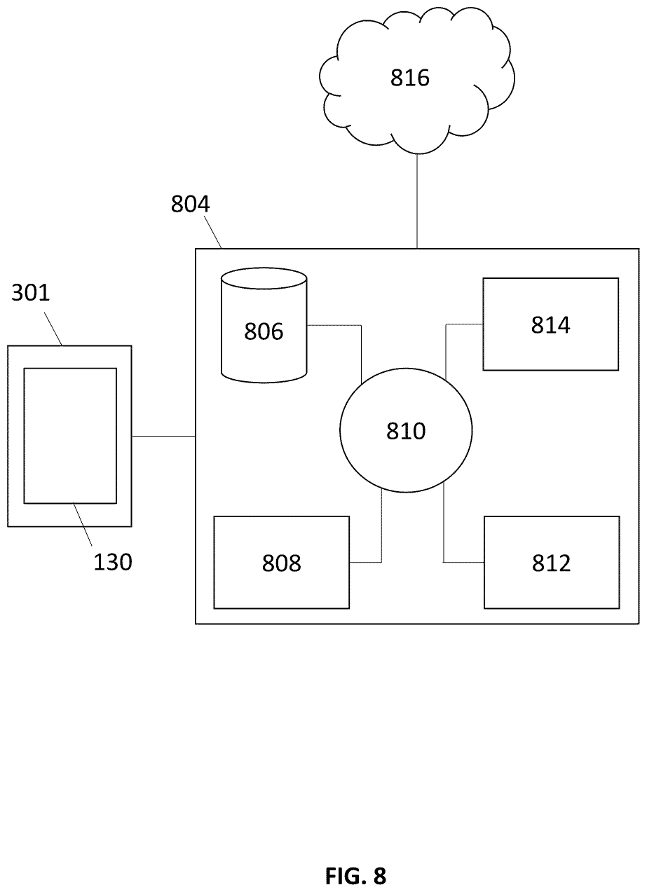

In some embodiments, the systems disclosed herein may comprise a computer system 804 suitable for implementing machine learning models configured to analyze the fluorescent data generated by the imaging system described elsewhere herein, as seen in FIG. 8. In some cases, the machine learning models may analyze, extract, condense, reduce, predict, classify, or any combination thereof operations conducted on acquired data. In some cases, the fluorescent data may comprise autofluorescent data, fluorescence lifetime data or any combination thereof. In some cases, the acquired data may comprise a plurality of autofluorescence or fluorescence lifetime images of a tissue sample.

In some embodiments, the systems disclosed herein may implement a machine learning algorithm configured to classify one or more autofluorescent or fluorescent lifetime characteristics signals to determine the presence or lack thereof cancer in a tissue sample. In some cases, the machine learning classification module may include performing the classification of cancer for each individual signal collection channel or all channels together. The machine learning model may comprise a classification module that may take the features collected/extracted from a signal preprocessing step and classify the features. In some cases, the features may be extracted without a signal preprocessing step.

In some cases, machine learning algorithms may need to extract and draw relationships between features as conventional statistical techniques may not be sufficient. In some cases, machine learning algorithms may be used in conjunction with conventional statistical techniques. In some cases, conventional statistical techniques may provide the machine learning algorithm with preprocessed features.

In some embodiments, the plurality of features may be classified into any number of categories. One or more images generated by the systems described elsewhere herein may be classified as cancer or non-cancerous images. In some cases, the plurality of features may be classified into between 1 to 20 categories. Individual categories may also be divided into sub-categories.

In some embodiments, a human may select, and discard features prior/during machine learning classification. In some cases, a computer may select and discard features. In some cases, the features may be discarded based on a threshold value.

In some embodiments, any number of features may be classified by the machine learning algorithm. The machine learning algorithm may classify at least 10 features. In some cases, the plurality of features may include between about 10 features to 200 features. In some cases, the plurality of features may include between about 10 features to 100 features. In some cases, the plurality of features may include between about 10 features to 50 features. In some embodiments, the machine learning algorithm may be, for example, an unsupervised learning algorithm, supervised learning algorithm, or a combination thereof. The unsupervised learning algorithm may be, for example, clustering, hierarchical clustering, k-means, mixture models, DBSCAN, OPTICS algorithm, anomaly detection, local outlier factor, neural networks, autoencoders, deep belief nets, hebbian learning, generative adversarial networks, self-organizing map, expectation-maximization algorithm (EM), method of moments, blind signal separation techniques, principal component analysis, independent component analysis, non-negative matrix factorization, singular value decomposition, or a combination thereof. The supervised learning algorithm may be, for example, support vector machines, linear regression, logistic regression, linear discriminant analysis, decision trees, k-nearest neighbor algorithm, neural networks, similarity learning, or a combination thereof. In some embodiments, the machine learning algorithm may comprise a deep neural network (DNN). The deep neural network may comprise a convolutional neural network (CNN). The CNN may be, for example, U-Net, ImageNet, LeNet-5, AlexNet, ZFNet, GoogleNet, VGGNet, ResNet18 or ResNet, etc. Other neural networks may be, for example, deep feed forward neural network, recurrent neural network, LSTM (Long Short Term Memory), GRU (Gated Recurrent Unit), Auto Encoder, variational autoencoder, adversarial autoencoder, denoising auto encoder, sparse auto encoder, boltzmann machine, RBM (Restricted BM), deep belief network, generative adversarial network (GAN), deep residual network, capsule network, or attention/transformer networks, etc.

In some instances, the machine learning model may comprise clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof.

In some cases, the machine learning algorithm may include ensemble learning algorithms such as bagging, boosting and stacking. The machine learning algorithm may be individually applied to the plurality of features extracted for each channel, such that each channel may have a separate iteration of the machine learning algorithm or applied to the plurality of features extracted from all channels or a subset of channels at once.

In some embodiments, the systems may apply one or more machine learning algorithms. In some embodiments, the method may apply one or more one machine learning algorithms per channel.

The machine learning classification module may comprise any number of machine learning algorithms. In some embodiments, the random forest machine learning algorithm may be an ensemble of bagged decision trees. In some cases, the ensemble of bagged decision trees may classify each temporal data segment for each channel as (1) cancer positive or (2) cancer negative. The ensemble may be at least about 1, 2, 3, 4, 5, 10, 20, 30, 40, 50, 60, 70, 80, 90, 100, 120, 140, 160, 180, 200, 250, 500, 1000 or more bagged decision trees. The ensemble may be at least about 1000, 500, 250, 200, 180, 160, 140, 120, 100, 90, 80, 70, 60, 50, 40, 30, 20, 10, 5, 4, 3, 2 or less bagged decision trees. The ensemble may be from about 1 to 1000, 1 to 500, 1 to 200, 1 to 100, or 1 to 10 bagged decision trees.

In some embodiments, the method may include applying a machine learning classifier to any number of channels. The method may include applying a machine learning classifier to at least about 1, 2, 3, 4, 5, 6, 7, 8, 9, 10, 15, 20, 25, 50, 100, 500, 1000 or more channels. The method may include applying a machine learning classifier to at least about 1000, 500, 100, 50, 25, 20, 15, 10, 9, 8, 7, 6, 5, 4, 3, 2 or less channels. The method may include applying a machine learning classifier from about 1 to 1000, 1 to 100, 1 to 25, or 1 to 5 channels.

In some cases, the plurality of autofluorescence or fluorescent lifetime signals may be collected over a plurality of channels. The machine learning algorithm may be individually applied to the plurality of features extracted for each channel, such that each channel has a separate iteration of the machine learning algorithm or applied to the plurality of features extracted from all channels or a subset of channels at once. Each channel may have at least about 1, 2, 5, 10, 25, 50, or more machine learning algorithms applied. Each channel may have at least about 50, 25, 10, 5, 2, or fewer machine learning algorithms applied.

In some embodiments, the method may include applying a machine learning classifier to a subset of channels. The subset of channels may be at least about 1%, 5%, 10%, 20%, 30%, 40%, 50% or more of the total set of channels. The subset of channels may be at least about 50%, 40%, 30%, 20%, 10%, 5%, 1% or less of the total set of channels. The subset of channels may be from about 1% to 50%, 1% to 40%, 1% to 30%, 1% to 20%, 1% to 10%, or 1% to 5% of the total set of channels.

In some embodiments, the machine learning algorithm may have a variety of parameters. The variety of parameters may be, for example, learning rate, minibatch size, number of epochs to train for, momentum, learning weight decay, or neural network layers etc.

In some embodiments, the learning rate may be between about 0.00001 to 0.1.

In some embodiments, the minibatch size may be at between about 16 to 128.

In some embodiments, the neural network may comprise neural network layers. The neural network may have at least about 2 to 1000 or more neural network layers.

In some embodiments, the number of epochs to train for may be at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, 250, 500, 1000, 10000, or more.

In some embodiments, the momentum may be at least about 0.1, 0.2, 0.3, 0.4, 0.5, 0.6, 0.7, 0.8, 0.9 or more. In some embodiments, the momentum may be at least about 0.9, 0.8, 0.7, 0.6, 0.5, 0.4, 0.3, 0.2, 0.1, or less.

In some embodiments, learning weight decay may be at least about 0.00001, 0.0001, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, or more. In some embodiments, the learning weight decay may be at least about 0.1, 0.09, 0.08, 0.07, 0.06, 0.05, 0.04, 0.03, 0.02, 0.01, 0.009, 0.008, 0.007, 0.006, 0.005, 0.004, 0.003, 0.002, 0.001, 0.0001, 0.00001, or less.

In some embodiments, the machine learning algorithm may use a loss function. The loss function may be, for example, regression losses, mean absolute error, mean bias error, hinge loss, Adam optimizer and/or cross entropy.

In some embodiments, the parameters of the machine learning algorithm may be adjusted with the aid of a human and/or computer system.

In some embodiments, the machine learning algorithm may prioritize certain features. The machine learning algorithm may prioritize features that may be more relevant for detecting strokes. The feature may be more relevant for detecting strokes if the feature is classified more often than another feature. In some cases, the features may be prioritized using a weighting system. In some cases, the features may be prioritized on probability statistics based on the frequency and/or quantity of occurrence of the feature. The machine learning algorithm may prioritize features with the aid of a human and/or computer system.

In some embodiments, one or more of the features may be used with machine learning or conventional statistical techniques to determine if a segment is likely to contain artifacts. The identified artifacts may be a result of optical misalignment, movement of sample during image acquisition, laser power instability, laser pulse frequency jitter, or any combination thereof or movement, subject movement, subject eye movement or blinking, subject chewing, subject muscle tensing, subject electrocardiographic artifact, etc. In some cases, movement sensors or other sensors may be used as an additional input to the artifact rejection module. In some cases, the identified artifacts can be rejected from being used in cancer classification. In some cases, the identified artifacts can be reduced, cancelled, or eliminated and the remaining regions of the tissue sample may still be processed for cancer classification.

In some cases, the machine learning algorithm may prioritize certain features to reduce calculation costs, save processing power, save processing time, increase reliability, or decrease random access memory usage, etc.

The computer system 804 may comprise a central processing unit (CPU, also “processor” and “computer processor” herein) 810, which may be a single core or multi core processor, or a plurality of processor for parallel processing. The computer system 804 may further comprise memory or memory locations 808 (e.g., random-access memory, read-only memory, flash memory), electronic storage unit 806 (e.g., hard disk), communications interface 814 (e.g., network adapter) for communicating with one or more other devices, and peripheral devices 812, such as cache, other memory, data storage and/or electronic display adapters. The memory 808, storage unit 806, interface 814, and peripheral devices (e.g., mouse, keyboard, etc.) 312 may be in communication with the CPU 810 through a communication bus (solid lines), such as a motherboard. The storage unit 806 may be a data storage unit (or a data repository) for storing data. The computer system 804 may be operatively coupled to a computer network (“network”) 816 with the aid of the communication interface 814. The network 816 may be the Internet, an internet and/or extranet, or an intranet (e.g., intranet of the imaging system) and/or extranet that is in communication with the Internet. In some cases, the sub-system components e.g., a processor, controller, optical scanning element driver, light source, or any combination thereof, may be electrically in communication with one another via ethernet CAT-5, CAT-6, CAT-7 cables. The network 816 may, in some case, be a telecommunication and/or data network. The network 816 may include one or more computer servers, which may enable distributed computing, such as cloud computing. The network 816, in some cases with the aid of the computer system 804, may implement a peer-to-peer network, which may enable devices coupled to the computer system 804 to behave as a client or a server.

The CPU 810 may execute a sequence of machine-readable instructions, which may be embodied in a program or software. The instructions may be directed to the CPU 810, which may subsequently program or otherwise configured the CPU 810 to acquire data and/or process data produced by the imaging system described elsewhere herein.

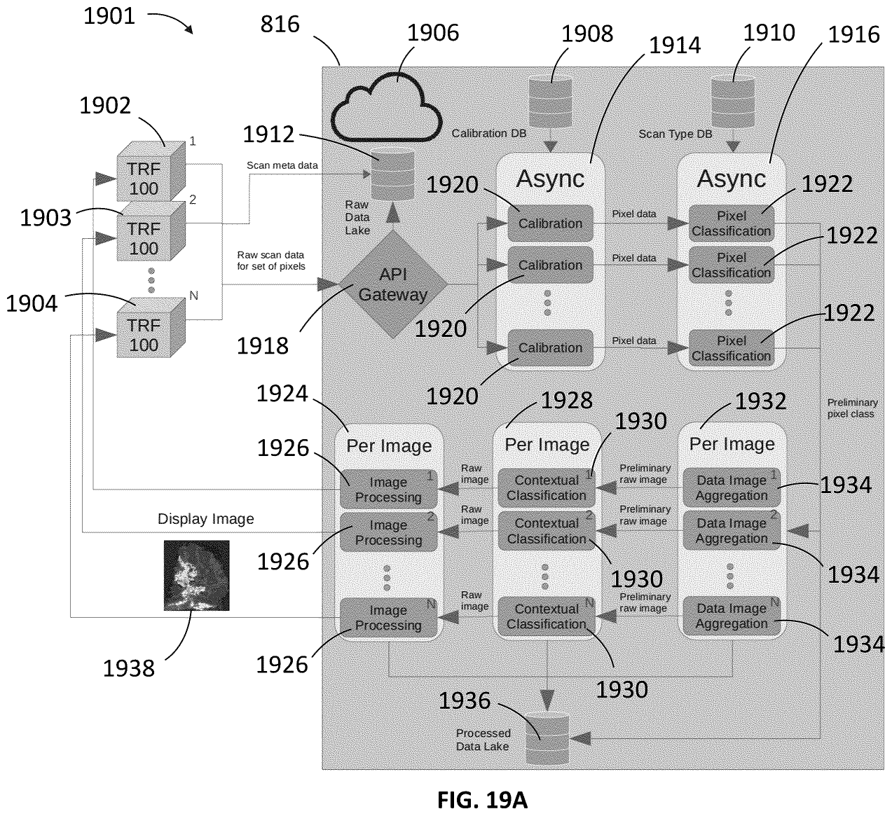

In some embodiments, the computer system 804 central processing unit may execute machine executable or machine-readable code may be provided in the form of software to transfer data generated by the imaging system to a network and/or cloud 816 for further processing, classification, data clustering, or any combination thereof. In some instances, the data may comprise individual image pixel data where an image is comprised of one or more pixels. In some cases, the pixel data may comprise autofluorescent data, fluorescence lifetime data or any combination thereof data obtained by an imaging system. In some cases, the data may comprise a plurality of autofluorescence or fluorescence lifetime decay curves. In some cases, the data transfer of the data generated by the imaging system to the network 816 may comprise a workflow 1901, as seen in FIG. 19A. In some cases, one or more imaging systems (1902, 1903, 1904) may acquire image data and transmit data over a network and/or cloud 816 to a data server for raw image data 1912 and/or transmit data over a network and/or cloud 816 to an API gateway 1918. In some cases, the API gateway 1918, may comprise a one or more functions that may act upon the data for processing. In some cases, the data received at the API gateway 1918 may be acted upon by a user or operator of an imaging system (1902, 1903, 1994) process data acquired after an acquisition or in an asynchronous aspect. In some cases, an asynchronous aspect may comprise acquiring data in with a data acquisition rate of at least 30 pixels/second and simultaneously transmitting data to the API gateway 1918 or raw data server 1912. In some cases, the API gateway 1918 may direct data towards one or more processing steps. In some cases, the one or more processing steps may comprise calibration 1914, pixel classification 1916, data image aggregation 1932, contextual classification 1928, image processing 1924, or any combination thereof.

In some cases, the processing step of calibration and pixel classification may be completed in an asynchronous or synchronous data transfer configuration. In some cases, the calibration processing step 1914 may correct for any system specific calibration that is referenced from a machine specific data header included with each data point. In some cases, the calibration processing step 1914 may comprise one or more calibration processes 1920 that may comprise a data processing action for one or more imaging systems (1902, 1903, 1904). In some instances, the one or more calibrations processes 1920 may comprise the step of locating calibration in a calibration database 1908 and applying the calibration to the one or more calibration processes 1920. After the calibration processes 1920 the calibrated data from the one or more systems may then classified asynchronously or synchronously with the pixel classification process 1916.

The pixel classification process 1916 may comprise one or more parallel pixel classification processes 1922 that are configured to identify the tissue or sub-tissue classification of given stream of the pixel data of one or more pixels. In some cases, the pixel classification process 1916 may determine the pixel classification of at least one pixel based on the pixel data. In some cases, the scan type database 1910 may comprise one or more tissue type classification sub processes 1922 for one or more set of classifiers 2006 configured to classify pixel data into a tissue type. In some cases, the tissue type may comprise cancerous tissue, healthy tissue, fat, muscle, cancerous tissue soaked in formalin, healthy tissue soaked in formalin, fat tissue soaked in formalin, muscle tissue soaked in formalin, or any combination thereof. In some cases, the pixel classification module may comprise one or more tissue type classification sub-processes 1922, as seen in FIG. 19B. In some cases, the one or more classification sub processes 1922 may comprise at least one preprocessing pipeline 2004, at least one classifier 2006, or any combination thereof. In some cases, the at least one preprocessing pipeline 2004, may comprise a z-score pixel data manipulation, pixel data outlier filtering data outliers, or any combination thereof. In some cases, a z-score pixel data manipulation may comprise normalizing the at least one-pixel data to a gaussian distribution. In some instances, the various preprocessing pipelines may increase the signal to noise ratio for the pixel data against a background noise signal. In some cases, the at least one classifier 2006 may comprise a support vector machine (SVM), k-means clustering, neural-network, linear regression, non-linear regression, random forest, or any combination thereof classifier. In some cases, the classifiers 2006 may each classify the tissue or tissue subtype by one or more-pixel data features. In some cases, the one or more pixel data features may comprise one or more sub-samples of the one or more fluorescence or autofluorescent decay emissions of a given pixel data, Laguerre coefficients of the one or more fluorescence or autofluorescence decay emissions of a given pixel data, the raw lifetime data of the one or more fluorescence or autofluorescence decay emissions of a given pixel data, or any combination thereof. In some instances, the classifiers 2006 of each classification sub processes may provide a probability that the pixel data may be classified as one of the tissue types dictated by the scan type database 1910. In some cases, the probability may comprise a value from about 0 to about 1. In some cases, the probability generated for each classifier 2006 may be weighted by a value stored within the scan type database 1910 and correlated to each classifier 2006. In some instances, the pixel classification process may arrive at the pixel classification tissue type 2022 by calculating an index of the maximum argument 2020 of all the weighted probabilities of each classifier 2006. In some instances, the index may comprise an indicator for which tissue type classification sub process 1922 yielded the highest probability amongst all tissue type classification sub processes 1922.

In some cases, the pixel classification tissue type 2022 may then be stored in a processed data server 1936 for further processing and analysis. In some instances, the pixel classification tissue type 2022 may then arrive at the data image aggregation process 1932. In some cases, the data image aggregation process 1932 may comprise one or more sub-image data aggregation processes 1934, where each sub-image data aggregation process 1934 may aggregate pixel data of one or more imaging systems (1902, 1903, 1904) in parallel. In some cases, each sub-image data aggregation process 1934 may combine one or more pixel data locations and the corresponding pixel classification tissue type 2022 into a matrix. The matrix for each sub-image data aggregation process 1934 may be stored in the processed data server 1936 for further processing and analysis. In some cases, the aggregated pixel classification tissue type matrix may then be sent to a contextual classification process 1928 for further processing.

In some instances, the contextual classification process may comprise one or more sub-contextual classification processes 1930, where each sub-contextual classification process1930 may contextually classify one or more pixel classification tissue type 2022 of one or more imaging systems (1902, 1903, 1904) in parallel. In some cases, the sub-contextual classification processes 1930 may determine the classification of one or more neighboring local pixel's classification tissue type 2022 (e.g., adjacent pixels or within a defined neighborhood) based on at least in part on the classification tissue type 2022 distribution of pixels within the local neighborhood. The contextual classifications for each sub-contextual classification process 1930 may be stored in the processed data server 1936 for further processing and analysis. In some cases, the contextually classified pixel data may then be sent to an image processing process 1924 to generate a representative false colored image indicating the pixel classification tissue type 2022 of all of the pixels in an image dataset.

In some cases, the contextually classified pixel data may be converted to a false colored image 1938 indicating the pixel classification tissue type 2022 of each pixel by an image processing process 1924. The image processing process 1924 may comprise one or more sub-image processing processes 1926 that are configured to process images of one or more imaging systems (1902, 1903, 1904) pixel data in parallel. In some cases, the sub-image processing processes 1926 may interpolate pixel classification tissue type 2022 between tissues to generate a high-resolution image from a low-resolution image. In some cases, the sub-image processing processes 1926 may also overlay a false color map to spatially distinguish the varying pixel classification tissue type 2022 for each pixel in an image dataset. In some instances, the processed image datasets of the one or more sub-image processing processes 1926 may be stored in the processed data server 1936 for further processing and analysis. In some cases, the processed image dataset 1938 of the one or more sub-image processing processes 1926 may then be displayed on the one or more imaging systems (1902, 1903, 1904) where image pixel data originated from.

In some embodiments, the CPU 810 may be part of a circuit, such as an integrated circuit. One or more other components of the system 804 may be included in the circuit. In some cases, the circuit is an application specific integrated circuit (ASIC).

The storage unit 806 may store files, such as drivers, libraries, and saved programs. The storage unit 806 may store acquired autofluorescent data, fluorescent lifetime data, or any combination thereof data. The computer system 804, in some cases may include one or more additional data storage units that are external to the computer system 804, such as located on a remote server that is in communication with the computer system 804 through an intranet or the internet. In some cases, the computer system may comprise a communication channel 2448 configured to obtain and/or transfer acquired autofluorescent data, fluorescent lifetime data, or any combination thereof data. In some instances, the communication channel may provide an input and/or output interface of the computer system configured to allow a remote serve, and/or cloud based serve to push updates (e.g., operating system parameters) to the imaging system. In some instances, the communication channel 2448 may provide a user remote access to the system. In some cases, the communication channel may provide a data link between the imaging system hardware to a memory of the computer system 804 for further processing. In some cases, the communication channel 2448 may be used to stream autofluorescent data and/or fluorescent lifetime data obtained with the imaging system, and a data container (e.g., virtualization of memory and computing power) to classify the autofluorescent data and/or fluorescent lifetime data, as described elsewhere herein. In some instances, the data container may be located locally on the computer system 806 and/or located in the cloud 816. In some cases, the data container may be a data container that allows management and hosting of one or more data containers.

Methods as described herein may be implemented by way of machine (e.g., computer processor) executable code stored on an electronic storage location of the computer device 804, such as, for example, on the memory 808 or electronic storage unit 806. The machine executable or machine-readable code may be provided in the form of software. During use, the code may be executed by the processor 810. In some instances, the code may be retrieved from the storage unit 806 and stored on the memory 808 for ready access by the processor 810. In some instances, the electronic storage unit 806 may be precluded, and machine-executable instructions are stored on memory 808.

The code may be pre-compiled and configured for use with a machine having a processor adapted to execute the code or may be compiled during runtime. The code may be supplied in a programming language that may be selected to enable the code to be executed in a pre-complied or as-compiled fashion.

Aspects of the systems and methods provided herein, such as the computer system 804, may be embodied in programming. Various aspects of the technology may be thought of a “product” or “articles of manufacture” typically in the form of a machine (or processor) executable code and/or associated data that is carried on or embodied in a type of machine readable medium. Machine-executable code may be stored on an electronic storage unit, such memory (e.g., read-only memory, random-access memory, flash memory) or a hard disk. “Storage” type media may include any or all of the tangible memory of a computer, processor the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, term such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media may include, for example, optical or magnetic disks, such as any of the storage devices in any computer(s) or the like, such as may be used to implement the databases, etc. Volatile storage media include dynamic memory, such as main memory of such a computer platform. Tangible transmission media includes coaxial cables; copper wire and fiber optics, including the wires that comprise a bus within a computer device. Carrier-wave transmission media may take the form of electric or electromagnetic signals, or acoustic or light waves such as those generated during radio frequency (RF) and infrared (IR) data communications. Common forms of computer-readable media therefor include for example: a floppy disk, a flexible disk, hard disk, magnetic tape, any other magnetic medium, a CD-ROM, DVD or DVD-ROM, any other optical medium, punch cards paper tape, any other physical storage medium with pattern of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one more instruction to a processor for execution.

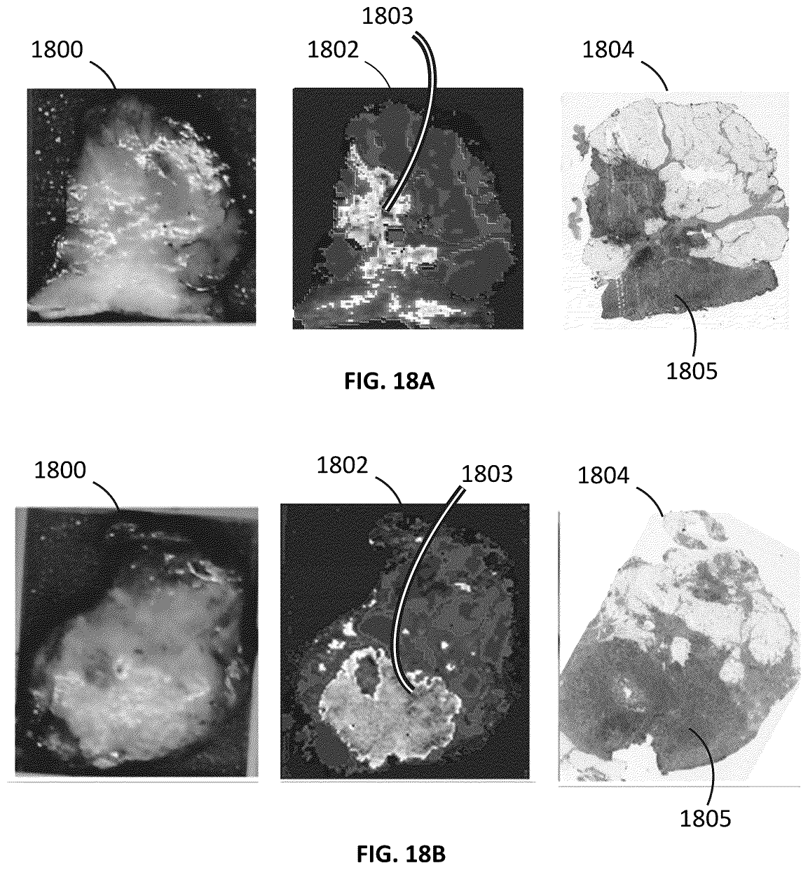

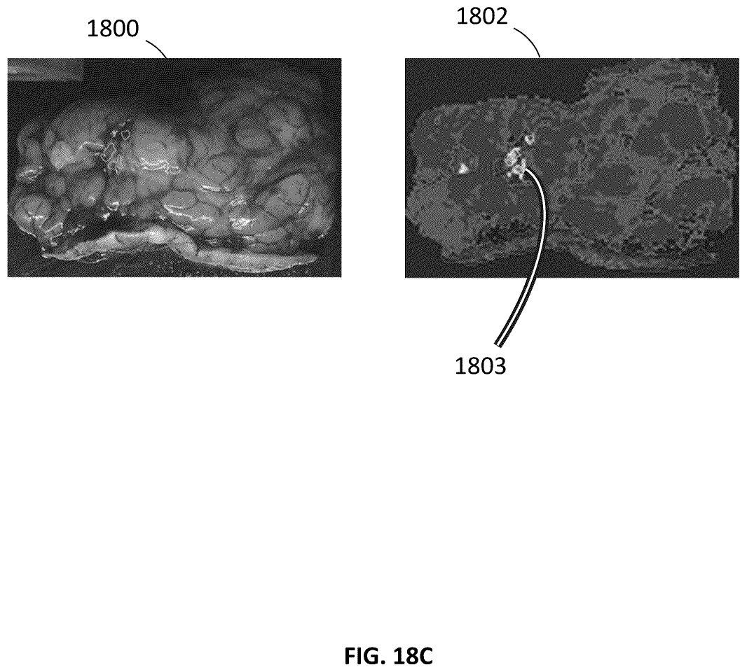

The computer system may include or be in communication with an electronic display 301 that comprises a user interface (UI) 130 for viewing raw autofluorescence data, raw fluorescence lifetime data, autofluorescent images 1802, fluorescence lifetime image 1802, visible light images 1800, or any combination thereof, as seen in FIGS. 18A-18C. In some cases, the computer system may transmit and/or relays system data via an electronic display operator 2402 that displays the data on the UI 130 of the display 301. In some cases, the computer system 804 may transmit system control information (e.g., system operating parameters) via a control operator 2404 that displays the system control information on the imaging system UI 130 control. In some instances, user interaction with the system with use of e.g., a touch screen, keyboard, and/or mouse may be transmitted to the computer system through a user interaction control operator 2406. In some cases, the autofluorescent or fluorescence lifetime images 1802 may provide visualization of suspected cancer 1803 that may not be visualized in the visible light image 1800. After processing and classifying the pixel image data acquired by the systems of the disclosure described elsewhere herein, the image data may be false colored 1802 to indicate the one or more classification of tissue type. In some cases, the false colored image may be false colored by one or more colors of the visible spectrum (e.g., red, green, blue, yellow, purple, orange, etc.). As can be seen in FIGS. 18A-C, corresponding histopathology images 1804, showing delineation of the cancerous tissue 1805 of the tissue sample correspond to the cancer morphology 1803 shown in the autofluorescent or fluorescence lifetime images 1802. In some cases, the UI 130 may also comprise a plurality of control buttons, slides, radio buttons, dialogs, or any combination thereof to control the operation of the imaging system.

### User Interface

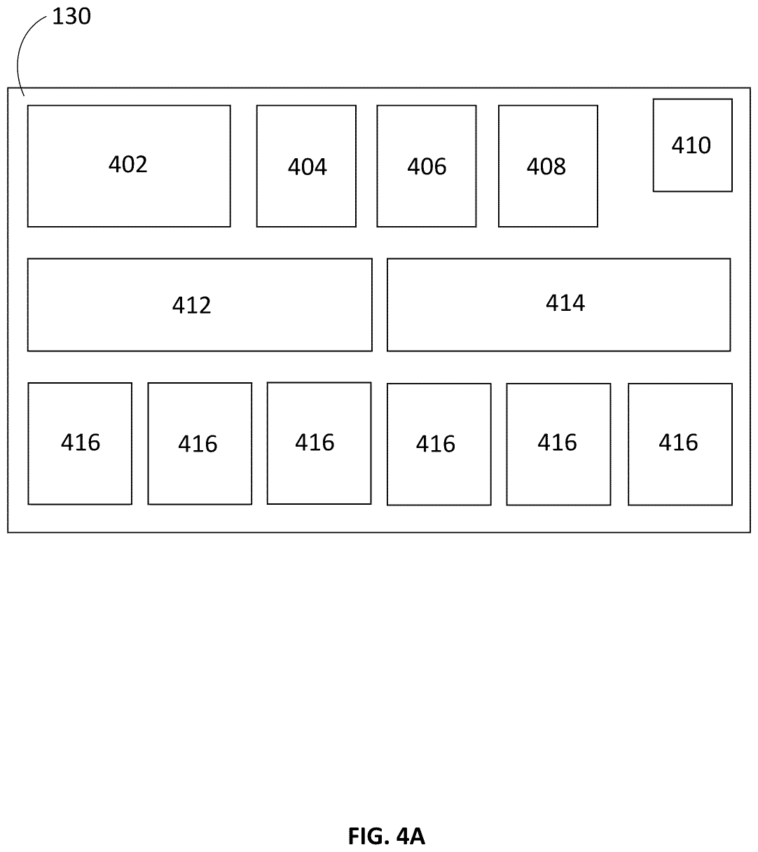

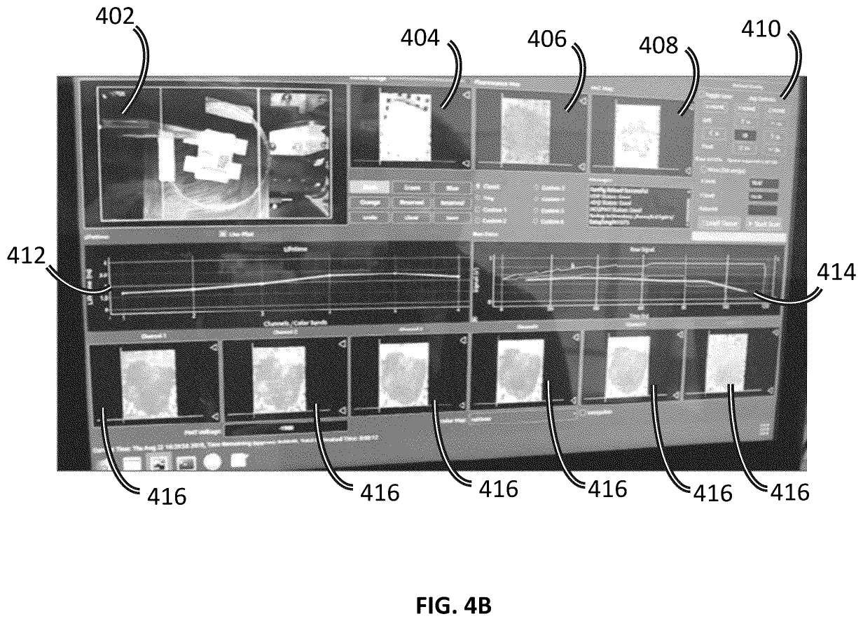

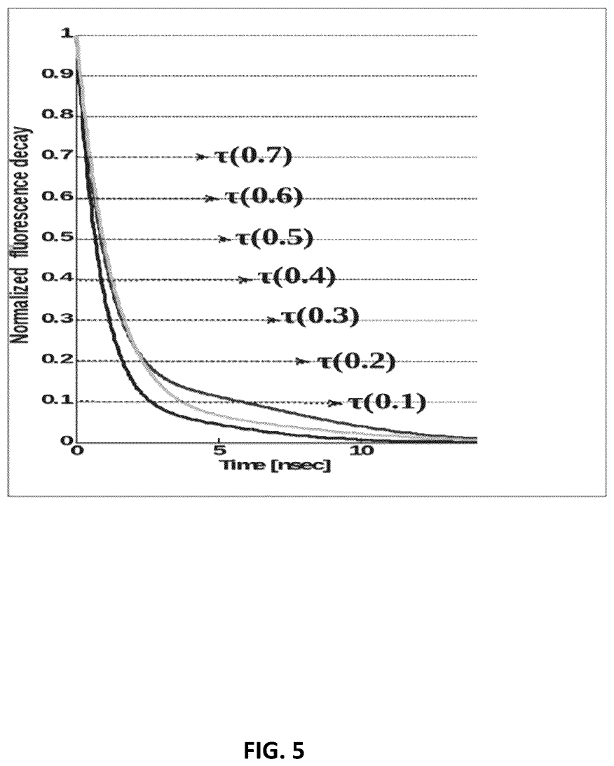

Aspects of the systems of disclosure provided herein may comprise a user interface 301, as seen in FIG. 4A-4B. The UI 130 may comprise an image display such as a flat-screen panel or a touch-screen display. The UI 130 may permit visualization of the data acquired from the tissue sample. The user-interface may provide actionable information for health care personnel to guide surgical dissection or resection of a patient's cancer. In some cases, the user-interface 130 may display visible light video (402, 404) or visible light still images of the tissue sample being imaged. In some cases, the user-interface may comprise a view indicating the average fluorescence lifetime for each acquisition channel of the plurality of acquisition channels 412. In some cases, the user-interface may comprise a view that indicates the raw fluorescence lifetime data (e.g., FIG. 5) of each acquisition channel of the plurality of acquisition channels 414. In some instances, the user-interface 130, may comprise a plurality of views of the spatial distribution of the acquired fluorescence lifetime of each respective channel 416. In some cases, the user-interface may display a fluorescence map 406 representing a combined or averaged image of the spatial distribution of fluorescence lifetime for a plurality of points across the tissue sample. The user-interface may comprise a view displaying an image of the tissue sample being imaged overlaid with the PMT intensity signal 408.

In some embodiments, the user-interface 130 may comprise functional buttons, switches, editable dialogue boxes, slides, radio button, or any combination thereof. In some instances, the user-interface may comprise one or more displays that allow the user to configure device parameters e.g., scanning speed, manual scanning position of the stage, resolution, or any combination thereof. The user-interface may comprise functional buttons that may toggle between varying overlay signal processing false color maps that may indicate to a user a region of the tissue sample that may have cancer. In some cases, the user-interface may comprise functional buttons that enable scanning, stop scanning, emergency stop scanning, pause scanning, resume scanning, or any combination thereof.

In some embodiments, the user-interface 130 may comprise a touch screen interface permitting a user to tap on the screen to select operations and/or may be manipulated or interacted with a keyboard and/or mouse. In some cases, the touch screen interface may be displayed on one or more monitors and/or displays (301, 2304, 2302), as seen in FIGS. 3A-3B and FIGS. 24A-24C. In some cases, the touch screen monitor 2304 and/or display (301, 2302) may be disposed at arm level of a user, physician, operating room medical personnel, nurse, or any combination thereof individuals, for ergonomic use of such a touch screen monitor and/or display. In some instances, the imaging system may comprise one or more monitors and/or displays configured to display raw, processed, analyzed, or any combination thereof categories of fluorescence imaging data to a user, physician (e.g., the operating physician), operating room medical personnel, nurse, or any combination thereof individuals. In some cases, the one or monitors (301, 2302) may comprise a mechanism to adjust the tilt, three-dimensional position, and/or rotation of the monitor and/or display.

In some cases, the imaging system may comprise one or more test and/or calibration phantoms and/or targets that may be analyzed upon imaging system initialization, calibration and/or startup. In some instances, the one or more test and/or calibration phantoms and/or targets may comprise fluorescence intensity imaging resolution targets, fluorescence lifetime imaging resolution targets, one or more vials of dye with known fluorescence lifetime measurements, or any combination thereof test and/or calibration phantoms and/or targets. In some instances, the one or more test and/or calibration phantoms and/or targets may be embedded within the imaging system. In some instances, the one or more vials of dye with known fluorescence lifetime may be used to test the imaging system's impulse response function, accuracy, and/or precision of lifetime measurements. In some cases, the fluorescence intensity imaging resolution target may comprise a material, as described elsewhere herein, e.g., a polymer (e.g., plastic) with a known fluorescence lifetime overlaid with a metal coating configured to reflect the provided excitation light source to spatially isolate the regions of fluorescence lifetime measurements. By spatially isolating one or more regions of varying fluorescence intensity of the calibration phantom and/or target, the emitted fluorescence signal intensity may be measured and considered for future system optical alignment adjustments and/or for software compensation (e.g., compensating for fluorescence decay curve measurement, spatial alignment of the scan and/or visible image, adjustment of the performance parameters associated with the galvanic scanning mirror(s) and/or motorized stages, or adjust the auto gain performance parameters). The parameters associated with the galvanic scanning mirror(s) and/or motorized stage may comprise resolution, speed, step size, acceleration profiles, etc. or any combination thereof. The auto gain performance parameters may comprise the weight and amount of PMT gain, AOM attenuation, RF attenuation, or time characteristics associated with the auto gain performance parameters. In some cases, the fluorescence lifetime imaging resolution target may comprise a first material with a first lifetime overlaid and/or inlaid with geometric shapes (e.g., a triangle or polygonal shape with straight edge(s)) of a second polymer material with a second lifetime. By imaging the fluorescence lifetime imaging resolution target, the boundary between the first material and the second material may be measured and used for system calibration and/or adjustment (e.g., compensating for measurement of fluorescence lifetime signal, spatial alignment of the scan and/or visible image, adjustment of the performance parameters associated with the galvanic scanning mirror(s) and/or motorized stages, or adjust the auto gain performance parameters).

In some cases, fluorescence intensity imaging resolution target and/or the fluorescence lifetime imaging resolution target may comprise a material overlaid with a transmissive spatial and/or resolution target (e.g., USAF-1951) that is metal coated except for the regions of the resolution target features. The metal coated areas may comprise varying levels of optical attenuation. In some instances, the fluorescence intensity imaging resolution target may comprise a material with spatially varying fluorescence lifetime and/or intensity. Such a resolution target may permit the imaging system light source to transmit through the resolution target and excite the material underneath the line target thereby providing spatial fluorescence emission in well-defined patterns. The well-defined patterns of fluorescence emission may be analyzed and taken into consideration when calibrating and/or adjusting system parameters to improve system performance, as described elsewhere herein. In some cases, the phantoms and/or targets may be integrated within the imaging system to simplify user operation of the system. In some instances, the phantoms and/or targets may be used during system power on self-test (POST) and built in self-test (BIST).

### Methods

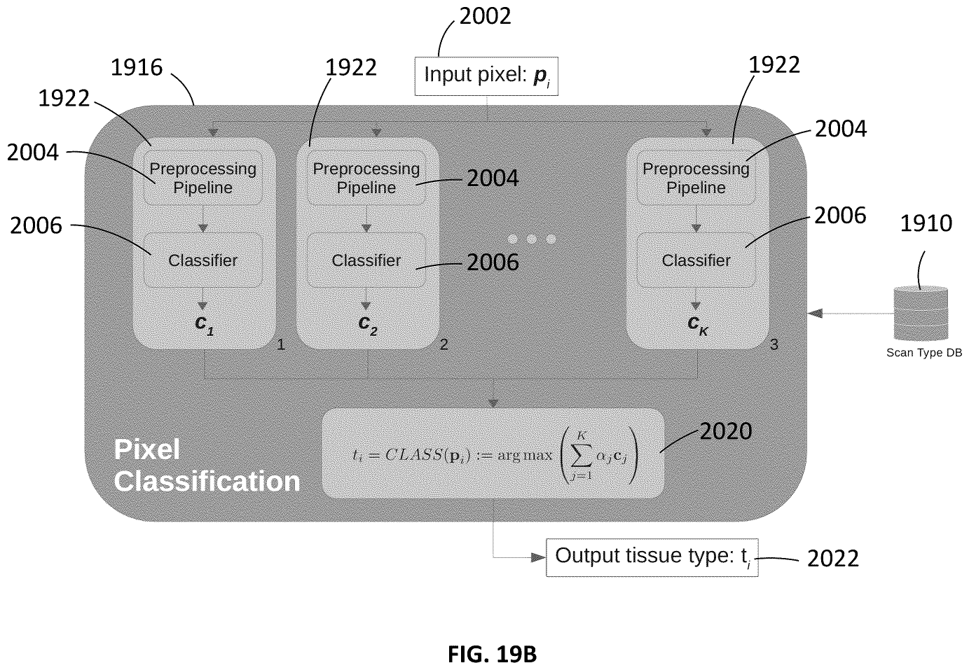

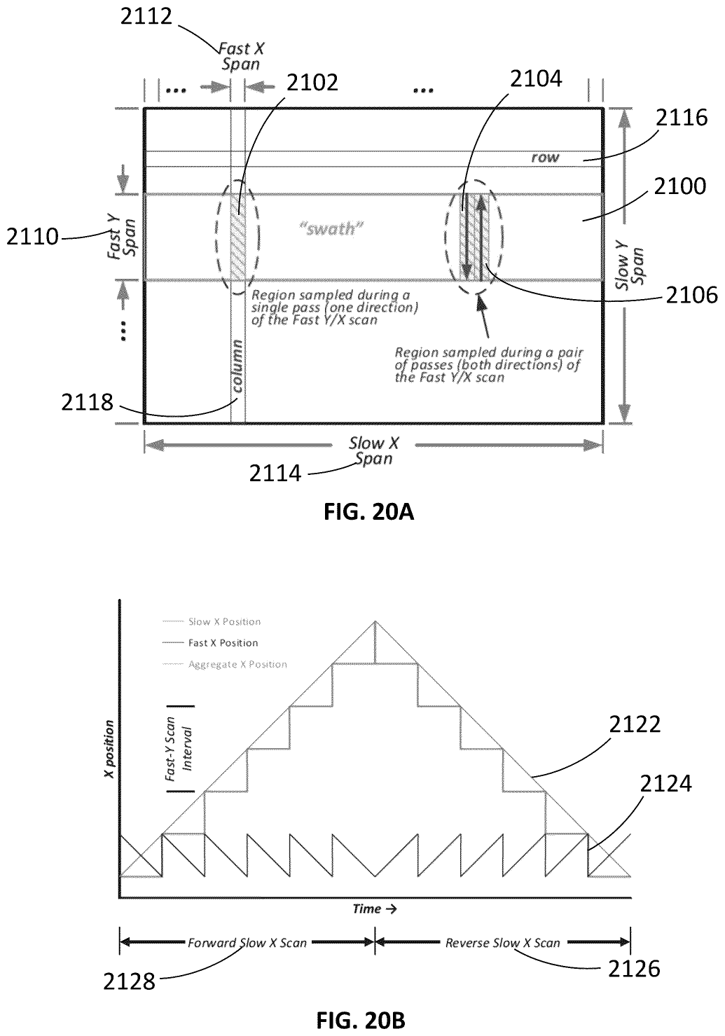

Aspects of the disclosure provided herein may comprise a scanning method for imaging tissue samples for identifying or characterizing the presence or lack thereof cancer in the tissue samples, as described elsewhere herein. The scanning method may provide better than expected results with regards to reduced imaging time, imaging resolution (i.e., high-speed high numerical aperture imaging), reducing imaging noise, and/or facilitating reconstruction of imaging data. The scanning method may reduce imaging time by continually scanning an area 2100 (i.e., a swath) and/or strip 2116 of data comprises of one or more segments 2118 (i.e., columns) with a width 2112 of data across a sample, as shown in FIG. 20A, instead of completing a scan of a first area of a sample then translating the optical scanning element 112 to a second area of a sample, where the first area and the second area of the sample do not overlap. In some cases, an emission channel of the one or more emission channels, described elsewhere herein, may be utilized to collect fluorescence emission from a light source scanned across the area 2100, i.e., swath and/or strip 2116 scanned across the sample. In some instances, the scanning of one or more additional area 2100, swaths, and/or strips 2116 may repeated to collect fluorescence emission for one or more of the other emission channels. By collecting data for a single emission channel, the voltage of gain of the detector (e.g., a PMT) may remain at a constant value that increases the signal to noise ratio and/or imaging resolution of the fluorescence emission detected in an emission channel of the one or more emission channels. In some cases, the signal to noise ratio and imaging resolution may be increase by at least about 5%, at least about 10%, at least about 20%, at least about 30%, at least about 40%, at least about 50%, at least about 60%, at least about 70%, at least about 80%, at least about 90%, or at least about 95% compared to a scanning method that does not utilize the scanning method described herein. In some cases, the scanning method may reduce the scanning time otherwise required to start and stop the motion of the optical scanning element 112. In some embodiments the scanning time may be reduced by the scanning method by at least about 5%, at least about 10%, at least about 20%, at least about 30%, at least about 40%, at least about 50%, at least about 60%, at least about 70%, at least about 80%, at least about 90%, or at least about 95% compared to a scanning method that does not utilize the scanning method described herein. Additionally, the scanning method may reduce noise introduced into the imaging data by mechanical jitter or motion artifact caused by starting and stopping motion of the optical scanning element 112. In some cases, the scanning method may reduce noise introduced into the imaging data by at least about 5%, at least about 10%, at least about 20%, at least about 30%, at least about 40%, at least about 50%, at least about 60%, at least about 70%, at least about 80%, at least about 90%, or at least about 95% compared to a scanning method that does not utilize the scanning method described herein. In some cases, the scanning method, by scanning area sections across the length of the sample (i.e., swaths and/or strips of data) may facilitate co-registration of the areas, swaths, and/or strips of data scanned and collected across the sample compared to plethora localized discrete areas scanned in traditional mosaic scanning methods. The scanning method by scanning and collecting data of strips, swaths, and/or areas of data may reduce the number of data points for co-registrations as well as the complexity of the data interfaces.

In some cases, the total scan area of a sample may comprise about 1 mm² to about 6,400 mm². In some cases, the total scan area of a sample may comprise about 1 mm² to about 50 mm², about 1 mm² to about 100 mm², about 1 mm² to about 200 mm², about 1 mm² to about 400 mm², about 1 mm² to about 600 mm², about 1 mm² to about 800 mm², about 1 mm² to about 1,000 mm², about 1 mm² to about 1,200 mm², about 1 mm² to about 1,600 mm², about 1 mm² to about 3,200 mm², about 1 mm² to about 6,400 mm², about 50 mm² to about 100 mm², about 50 mm² to about 200 mm², about 50 mm² to about 400 mm², about 50 mm² to about 600 mm², about 50 mm² to about 800 mm², about 50 mm² to about 1,000 mm², about 50 mm² to about 1,200 mm², about 50 mm² to about 1,600 mm², about 50 mm² to about 3,200 mm², about 50 mm² to about 6,400 mm², about 100 mm² to about 200 mm², about 100 mm² to about 400 mm², about 100 mm² to about 600 mm², about 100 mm² to about 800 mm², about 100 mm² to about 1,000 mm², about 100 mm² to about 1,200 mm², about 100 mm² to about 1,600 mm², about 100 mm² to about 3,200 mm², about 100 mm² to about 6,400 mm², about 200 mm² to about 400 mm², about 200 mm² to about 600 mm², about 200 mm² to about 800 mm², about 200 mm² to about 1,000 mm², about 200 mm² to about 1,200 mm², about 200 mm² to about 1,600 mm², about 200 mm² to about 3,200 mm², about 200 mm² to about 6,400 mm², about 400 mm² to about 600 mm², about 400 mm² to about 800 mm², about 400 mm² to about 1,000 mm², about 400 mm² to about 1,200 mm², about 400 mm² to about 1,600 mm², about 400 mm² to about 3,200 mm², about 400 mm² to about 6,400 mm², about 600 mm² to about 800 mm², about 600 mm² to about 1,000 mm², about 600 mm² to about 1,200 mm², about 600 mm² to about 1,600 mm², about 600 mm² to about 3,200 mm², about 600 mm² to about 6,400 mm², about 800 mm² to about 1,000 mm², about 800 mm² to about 1,200 mm², about 800 mm² to about 1,600 mm², about 800 mm² to about 3,200 mm², about 800 mm² to about 6,400 mm², about 1,000 mm² to about 1,200 mm², about 1,000 mm² to about 1,600 mm², about 1,000 mm² to about 3,200 mm², about 1,000 mm² to about 6,400 mm², about 1,200 mm² to about 1,600 mm², about 1,200 mm² to about 3,200 mm², about 1,200 mm² to about 6,400 mm², about 1,600 mm² to about 3,200 mm², about 1,600 mm² to about 6,400 mm², or about 3,200 mm² to about 6,400 mm². In some cases, the total scan area of a sample may comprise about 1 mm², about 50 mm², about 100 mm², about 200 mm², about 400 mm², about 600 mm², about 800 mm², about 1,000 mm², about 1,200 mm², about 1,600 mm², about 3,200 mm², or about 6,400 mm². In some cases, the total scan area of a sample may comprise at least about 1 mm², about 50 mm², about 100 mm², about 200 mm², about 400 mm², about 600 mm², about 800 mm², about 1,000 mm², about 1,200 mm², about 1,600 mm², or about 3,200 mm². In some cases, the total scan area of a sample may comprise at most about 50 mm², about 100 mm², about 200 mm², about 400 mm², about 600 mm², about 800 mm², about 1,000 mm², about 1,200 mm², about 1,600 mm², about 3,200 mm², or about 6,400 mm².

The scanning method for imaging samples for identifying or characterizing the presence or lack thereof cancer in samples may comprise: (a) translating a light source (e.g., as described elsewhere herein) emitted from an optical scanning element with a first mirror along a first axis 2110 across a sample 2102; (b) translating the optical scanning element along a second axis 2114 perpendicular to the first axis 2110; and (c) actuating a second mirror to compensate for the motion of the optical scanning element along the second axis. In some embodiments, the compensation may maintain the position of the light source along the axis. In some instances, the compensation may permit smearing of the light source along the second axis.

In some cases, a scan length along the first axis may comprise a length about 2 pixels to about 2,200 pixels. In some cases, a scan length along the first axis may comprise a length about 2 pixels to about 10 pixels, about 2 pixels to about 25 pixels, about 2 pixels to about 50 pixels, about 2 pixels to about 100 pixels, about 2 pixels to about 200 pixels, about 2 pixels to about 300 pixels, about 2 pixels to about 400 pixels, about 2 pixels to about 500 pixels, about 2 pixels to about 1,000 pixels, about 2 pixels to about 2,000 pixels, about 2 pixels to about 2,200 pixels, about 10 pixels to about 25 pixels, about 10 pixels to about 50 pixels, about 10 pixels to about 100 pixels, about 10 pixels to about 200 pixels, about 10 pixels to about 300 pixels, about 10 pixels to about 400 pixels, about 10 pixels to about 500 pixels, about 10 pixels to about 1,000 pixels, about 10 pixels to about 2,000 pixels, about 10 pixels to about 2,200 pixels, about 25 pixels to about 50 pixels, about 25 pixels to about 100 pixels, about 25 pixels to about 200 pixels, about 25 pixels to about 300 pixels, about 25 pixels to about 400 pixels, about 25 pixels to about 500 pixels, about 25 pixels to about 1,000 pixels, about 25 pixels to about 2,000 pixels, about 25 pixels to about 2,200 pixels, about 50 pixels to about 100 pixels, about 50 pixels to about 200 pixels, about 50 pixels to about 300 pixels, about 50 pixels to about 400 pixels, about 50 pixels to about 500 pixels, about 50 pixels to about 1,000 pixels, about 50 pixels to about 2,000 pixels, about 50 pixels to about 2,200 pixels, about 100 pixels to about 200 pixels, about 100 pixels to about 300 pixels, about 100 pixels to about 400 pixels, about 100 pixels to about 500 pixels, about 100 pixels to about 1,000 pixels, about 100 pixels to about 2,000 pixels, about 100 pixels to about 2,200 pixels, about 200 pixels to about 300 pixels, about 200 pixels to about 400 pixels, about 200 pixels to about 500 pixels, about 200 pixels to about 1,000 pixels, about 200 pixels to about 2,000 pixels, about 200 pixels to about 2,200 pixels, about 300 pixels to about 400 pixels, about 300 pixels to about 500 pixels, about 300 pixels to about 1,000 pixels, about 300 pixels to about 2,000 pixels, about 300 pixels to about 2,200 pixels, about 400 pixels to about 500 pixels, about 400 pixels to about 1,000 pixels, about 400 pixels to about 2,000 pixels, about 400 pixels to about 2,200 pixels, about 500 pixels to about 1,000 pixels, about 500 pixels to about 2,000 pixels, about 500 pixels to about 2,200 pixels, about 1,000 pixels to about 2,000 pixels, about 1,000 pixels to about 2,200 pixels, or about 2,000 pixels to about 2,200 pixels. In some cases, a scan length along the first axis may comprise a length about 2 pixels, about 10 pixels, about 25 pixels, about 50 pixels, about 100 pixels, about 200 pixels, about 300 pixels, about 400 pixels, about 500 pixels, about 1,000 pixels, about 2,000 pixels, or about 2,200 pixels. In some cases, a scan length along the first axis may comprise a length at least about 2 pixels, about 10 pixels, about 25 pixels, about 50 pixels, about 100 pixels, about 200 pixels, about 300 pixels, about 400 pixels, about 500 pixels, about 1,000 pixels, or about 2,000 pixels. In some cases, a scan length along the first axis may comprise a length at most about 10 pixels, about 25 pixels, about 50 pixels, about 100 pixels, about 200 pixels, about 300 pixels, about 400 pixels, about 500 pixels, about 1,000 pixels, about 2,000 pixels, or about 2,200 pixels.

In some cases, the scan length along the first axis may comprise a length of about 0.01 mm to about 300 mm. In some cases, the scan length along the first axis may comprise a length of about 0.01 mm to about 0.1 mm, about 0.01 mm to about 0.5 mm, about 0.01 mm to about 1 mm, about 0.01 mm to about 5 mm, about 0.01 mm to about 10 mm, about 0.01 mm to about 50 mm, about 0.01 mm to about 100 mm, about 0.01 mm to about 150 mm, about 0.01 mm to about 200 mm, about 0.01 mm to about 250 mm, about 0.01 mm to about 300 mm, about 0.1 mm to about 0.5 mm, about 0.1 mm to about 1 mm, about 0.1 mm to about 5 mm, about 0.1 mm to about 10 mm, about 0.1 mm to about 50 mm, about 0.1 mm to about 100 mm, about 0.1 mm to about 150 mm, about 0.1 mm to about 200 mm, about 0.1 mm to about 250 mm, about 0.1 mm to about 300 mm, about 0.5 mm to about 1 mm, about 0.5 mm to about 5 mm, about 0.5 mm to about 10 mm, about 0.5 mm to about 50 mm, about 0.5 mm to about 100 mm, about 0.5 mm to about 150 mm, about 0.5 mm to about 200 mm, about 0.5 mm to about 250 mm, about 0.5 mm to about 300 mm, about 1 mm to about 5 mm, about 1 mm to about 10 mm, about 1 mm to about 50 mm, about 1 mm to about 100 mm, about 1 mm to about 150 mm, about 1 mm to about 200 mm, about 1 mm to about 250 mm, about 1 mm to about 300 mm, about 5 mm to about 10 mm, about 5 mm to about 50 mm, about 5 mm to about 100 mm, about 5 mm to about 150 mm, about 5 mm to about 200 mm, about 5 mm to about 250 mm, about 5 mm to about 300 mm, about 10 mm to about 50 mm, about 10 mm to about 100 mm, about 10 mm to about 150 mm, about 10 mm to about 200 mm, about 10 mm to about 250 mm, about 10 mm to about 300 mm, about 50 mm to about 100 mm, about 50 mm to about 150 mm, about 50 mm to about 200 mm, about 50 mm to about 250 mm, about 50 mm to about 300 mm, about 100 mm to about 150 mm, about 100 mm to about 200 mm, about 100 mm to about 250 mm, about 100 mm to about 300 mm, about 150 mm to about 200 mm, about 150 mm to about 250 mm, about 150 mm to about 300 mm, about 200 mm to about 250 mm, about 200 mm to about 300 mm, or about 250 mm to about 300 mm. In some cases, the scan length along the first axis may comprise a length of about 0.01 mm, about 0.1 mm, about 0.5 mm, about 1 mm, about 5 mm, about 10 mm, about 50 mm, about 100 mm, about 150 mm, about 200 mm, about 250 mm, or about 300 mm. In some cases, the scan length along the first axis may comprise a length of at least about 0.01 mm, about 0.1 mm, about 0.5 mm, about 1 mm, about 5 mm, about 10 mm, about 50 mm, about 100 mm, about 150 mm, about 200 mm, or about 250 mm. In some cases, the scan length along the first axis may comprise a length of at most about 0.1 mm, about 0.5 mm, about 1 mm, about 5 mm, about 10 mm, about 50 mm, about 100 mm, about 150 mm, about 200 mm, about 250 mm, or about 300 mm.

In some cases, the scan length along the second axis may comprise a length of about 0.01 mm to about 300 mm. In some cases, the scan length along the first axis may comprise a length of about 0.01 mm to about 0.1 mm, about 0.01 mm to about 0.5 mm, about 0.01 mm to about 1 mm, about 0.01 mm to about 5 mm, about 0.01 mm to about 10 mm, about 0.01 mm to about 50 mm, about 0.01 mm to about 100 mm, about 0.01 mm to about 150 mm, about 0.01 mm to about 200 mm, about 0.01 mm to about 250 mm, about 0.01 mm to about 300 mm, about 0.1 mm to about 0.5 mm, about 0.1 mm to about 1 mm, about 0.1 mm to about 5 mm, about 0.1 mm to about 10 mm, about 0.1 mm to about 50 mm, about 0.1 mm to about 100 mm, about 0.1 mm to about 150 mm, about 0.1 mm to about 200 mm, about 0.1 mm to about 250 mm, about 0.1 mm to about 300 mm, about 0.5 mm to about 1 mm, about 0.5 mm to about 5 mm, about 0.5 mm to about 10 mm, about 0.5 mm to about 50 mm, about 0.5 mm to about 100 mm, about 0.5 mm to about 150 mm, about 0.5 mm to about 200 mm, about 0.5 mm to about 250 mm, about 0.5 mm to about 300 mm, about 1 mm to about 5 mm, about 1 mm to about 10 mm, about 1 mm to about 50 mm, about 1 mm to about 100 mm, about 1 mm to about 150 mm, about 1 mm to about 200 mm, about 1 mm to about 250 mm, about 1 mm to about 300 mm, about 5 mm to about 10 mm, about 5 mm to about 50 mm, about 5 mm to about 100 mm, about 5 mm to about 150 mm, about 5 mm to about 200 mm, about 5 mm to about 250 mm, about 5 mm to about 300 mm, about 10 mm to about 50 mm, about 10 mm to about 100 mm, about 10 mm to about 150 mm, about 10 mm to about 200 mm, about 10 mm to about 250 mm, about 10 mm to about 300 mm, about 50 mm to about 100 mm, about 50 mm to about 150 mm, about 50 mm to about 200 mm, about 50 mm to about 250 mm, about 50 mm to about 300 mm, about 100 mm to about 150 mm, about 100 mm to about 200 mm, about 100 mm to about 250 mm, about 100 mm to about 300 mm, about 150 mm to about 200 mm, about 150 mm to about 250 mm, about 150 mm to about 300 mm, about 200 mm to about 250 mm, about 200 mm to about 300 mm, or about 250 mm to about 300 mm. In some cases, the scan length along the second axis may comprise a length of about 0.01 mm, about 0.1 mm, about 0.5 mm, about 1 mm, about 5 mm, about 10 mm, about 50 mm, about 100 mm, about 150 mm, about 200 mm, about 250 mm, or about 300 mm. In some cases, the scan length along the second axis may comprise a length of at least about 0.01 mm, about 0.1 mm, about 0.5 mm, about 1 mm, about 5 mm, about 10 mm, about 50 mm, about 100 mm, about 150 mm, about 200 mm, or about 250 mm. In some cases, the scan length along the second axis may comprise a length of at most about 0.1 mm, about 0.5 mm, about 1 mm, about 5 mm, about 10 mm, about 50 mm, about 100 mm, about 150 mm, about 200 mm, about 250 mm, or about 300 mm.

In some cases, the scanning method may comprise repeating steps (a)-(c) one or more times as the optical scanning element translates along the second axis 2114 in a first direction. In some cases when steps (a)-(c) are repeated in the first direction 2128 along the second axis, the light source may be translated along the first axis in a first direction 2104 or a second direction 2106 where the first direction and the second direction are inverse. In some cases, the scanning method may comprise repeating steps (a)-(c) as the optical scanning element translates along the second axis in a second direction 2126 inverse to the first direction 2128 along the second axis. In some cases when steps (a)-(c) are repeated in the second direction along the second axis, the light source may be translated along the first axis in a first direction 2104 or a second direction 2106 where the first direction and the second direction are inverse of each other. In some instances, the first mirror, second mirror, and/or the optical scanning element may be provided a motion control waveform that drives the motion of the respective component. In some cases, the first mirror may be provided a first waveform 2124, where the first waveform may comprise a sawtooth, triangle, or parabolic waveform. In some cases, the second mirror may be provided a second waveform 2122, where the second waveform may comprise a linear waveform. In some cases, the second waveform may comprise a waveform that compensates for a period of motion of the first mirror when the first mirror is transitioning between translating in a first and second direction along the first axis. In some instances, the optical scanning element may be provided a third waveform where the third waveform may comprise a linear waveform. In some cases, the first waveform, second waveform, and/or the third waveform may be generated and/or provided to the scanning optical element by a field programmable gate array (FPGA).

In some cases, scanning methods provided herein may comprise super resolution (e.g., imaging beyond the diffraction limit of light) scanning. In some cases, one or more pulses of a pulsed light source, described elsewhere herein, may be provided to a sample across a pixel. In some cases, the pixel comprises a length and/or width of at least about 125 μm, or a pixel value described elsewhere herein. In some cases, at least about 32 pulses of the light source may be provided when imaging a single pixel of data of the sample. In some instances, a pulse of the one or more pulses may cover at least about 3.9 μm of the length and/or width of a pixel. In some cases, super resolution scanning may be achieved by aggregating and/or averaging (e.g., a moving average) the emitted fluorescence imaging data of the sample over one or more pulses across the pixel. In some instances, at least about 1 pulse, at least about 2 pulses, at least about 3 pulses, at least about 4 pulses, at least about 5 pulses, at least about 6 pulses, at least about 7 pulses, at least about 8 pulses, at least about 9 pulses, at least about 10 pulses, at least about 11 pulses, at least about 12 pulses, at least about 13 pulses, at least about 14 pulses, at least about 15 pulses, at least about 16 pulses, at least about 18 pulses, at least about 19 pulses, at least about 20 pulses, at least about 21 pulses, at least about 22 pulses, at least about 23 pulses, at least about 24 pulses, at least about 25 pulses, at least about 26 pulses, at least about 27 pulses, at least about 28 pulses, at least about 29 pulses at least about 30 pulses, at least about 31 pulses, or at least about 32 pulses may be averaged across the pixel. In some cases, the fluorescence imaging data of the one or more pulses may be process by moving averaging, filtering, convolution, ND convolution to image features at a distance less than the diffraction limit of the imaging system and/or the light source. In some cases, super resolution scanning may be completed along the first axis and/or the second axis of the scanning method described elsewhere herein.

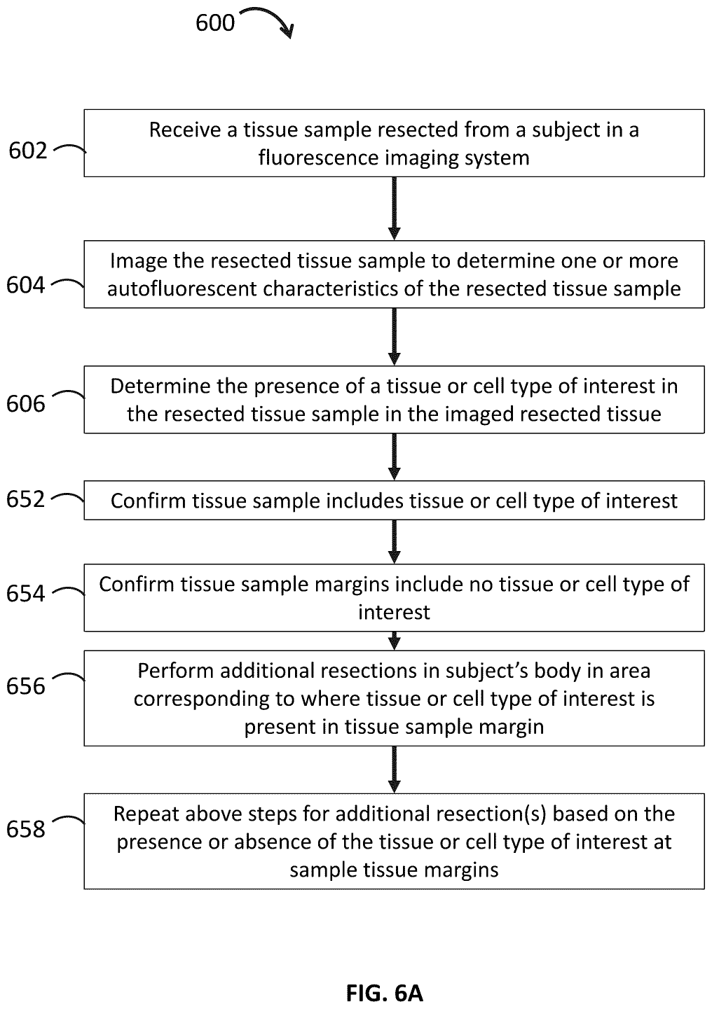

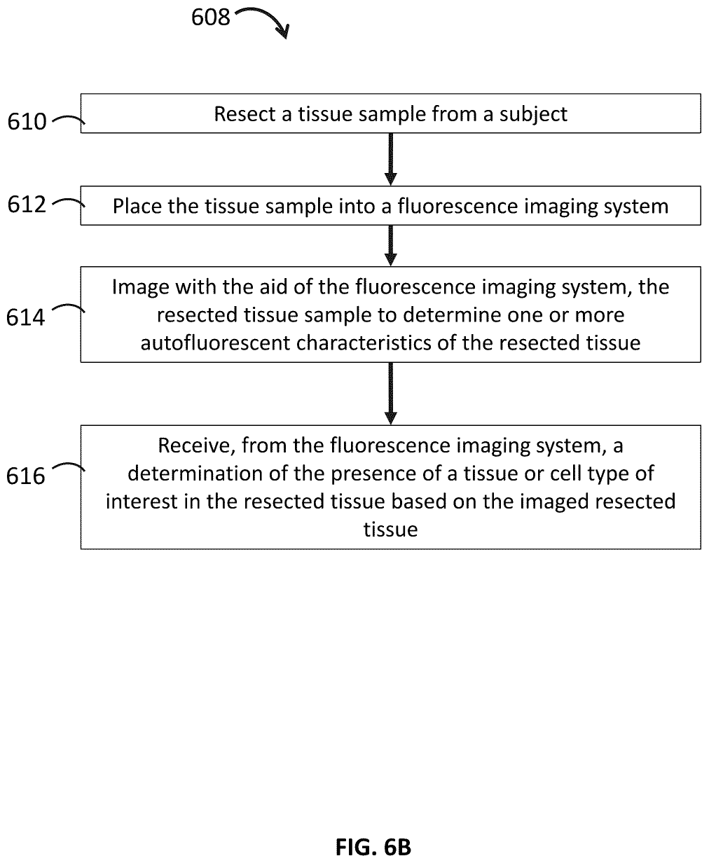

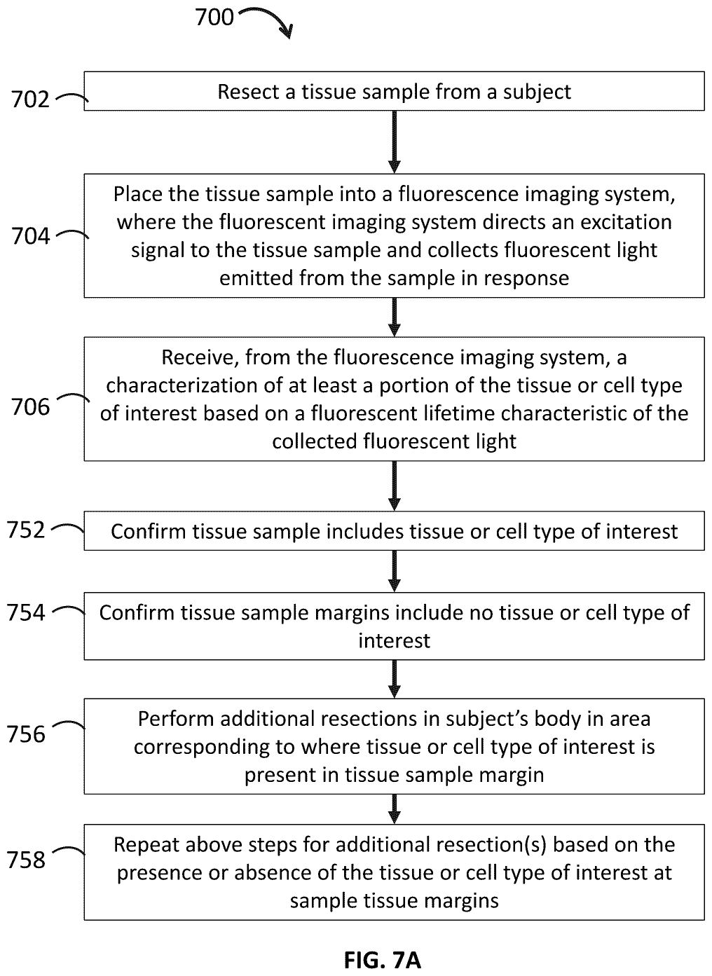

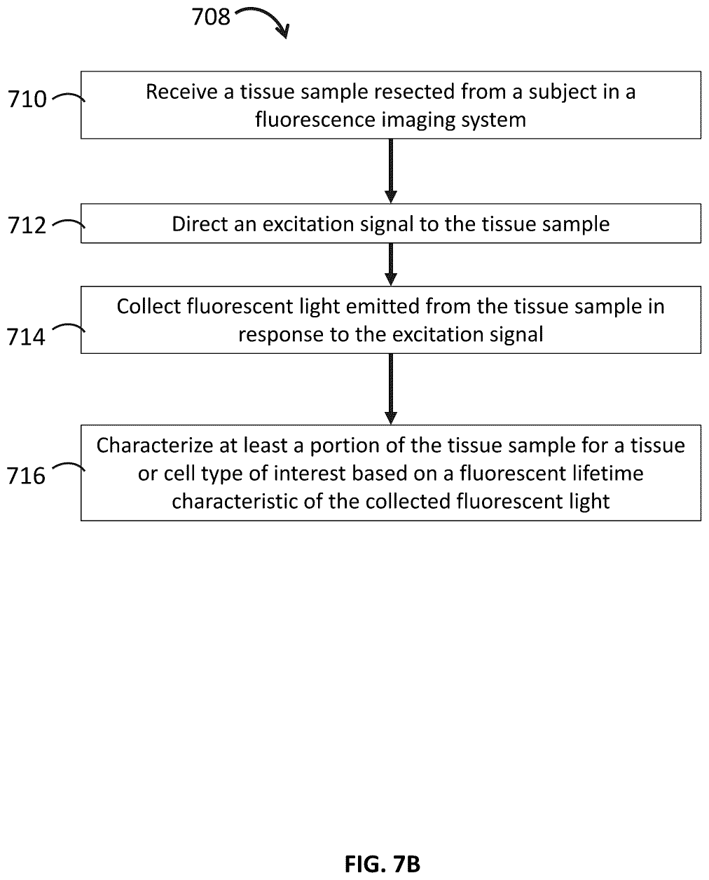

Aspects of the disclosure provided herein may comprise methods for imaging tissue samples for identifying or characterizing the presence or lack thereof cancer in the tissue samples (600, 608, 700, 708), as seen in FIGS. 6A-6B and FIGS. 7A-7B. In some instances, the tissue samples may comprise a resected tissue sample or biopsy obtained during surgical resection of a tumor. In some instances, the methods provided herein may analyze the tissue sample margins to identify margins that may comprise cancer to further inform or guide the surgical dissection of the tumor. In some cases, the methods provided herein may be completed on the systems described elsewhere herein.

In some embodiments, the methods may comprise a method for determining the presence of disease in a tissue sample by autofluorescent characteristics of the resected tissue sample 600, as seen in FIG. 6A. In some cases, the method may comprise the steps of: (a) receiving a tissue sample resected from a subject in a fluorescence imaging system 602; (b) imaging the resected tissue sample to determine one or more autofluorescent characteristics of the resected tissue sample 604; and (c) determining the presence of a tissue or cell type of interest in the resected tissue sample in the imaged resected tissue 606. In some cases, the method may further comprise the steps of: (i) confirming tissue sample includes a tissue or cell type of interest 652, (ii) confirming that margins of tissue sample includes no tissue or cell type of interest 654, (iii) performing additional resection in body of the subject in area corresponding to where tissue or a cell type of interest is present in the margin of the sample 656, and (iv) repeating above steps for additional resection(s) based on the presence or absence of a tissue or cell type of interest at sample tissue margins 658. In some cases, the tissue or cell type of interest may comprise diseased tissues or cells. In some instances, the diseased tissues or cells may comprise cancerous tissues or cells. In some cases, the subject may be suffering from or suspected of suffering from a disease. In some instances, the disease may be cancer.

In some cases, the resected tissue sample may comprise a tissue sample that has not been stained and/or not dyed prior to imaging. In some instances, the resected tissue sample may comprise a tissue sample that has been stained and/or dyed. In some instances, the one or more autofluorescent characteristics may comprise an autofluorescence lifetime characteristic. In some cases, the autofluorescence lifetime characteristic may comprise a plurality of fluorescent exponential decay characteristics of a plurality of regions of the resected tissue sample. In some cases, the disease may comprise cancer. In some instances, the tissue sample may comprise colon tissue, breast tissue, prostate tissue, skin tissue, vasculature tissue, or any combination thereof. In some cases, the step of determining the presence of disease in the resected tissue (i.e., step (c) 606), may comprise characterizing one or more margins in the resected tissue sample as diseased or non-diseased.

In some instances, the fluorescence imaging system may comprise a pulsed fluorescence light source. In some cases, the method may further comprise the step of informing a surgeon to resect a second tissue sample from the subject. In some instances, informing may comprise sound, visual display, or any combination thereof directed towards to the surgeon. In some cases, steps (b) 604 and (c) 606 may be completed in near real-time, for example, in up to 1, 2, 3, 4, 5, 6, 7, 8, 9, 10, 15, 20, 25, 30, or more than 30 minute(s). In some instances, determining the presence of disease in the tissue sample (i.e., step (c) 606) may be completed by a probability-based model. For example, the fluorescence map 406 displayed may be color-coded to indicate the probabilities of regions of the tissue being cancerous. The probability based model may comprise clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. After a surgical procedure, the tissue sample may be characterized using other techniques, including and this secondary characterization may be provided along with the first, near-real time characterization as training data to the probability-based model, allowing the probability-based model to improve over time and

In some embodiments, the methods of the disclosure provided herein may comprise a method for determining the presence of disease in a resected tissue sample in an operating theater 608, as seen in FIG. 6B. In some cases, the method may comprise the steps of: (a) resecting a tissue sample from a subject 610; (b) placing the tissue sample into a fluorescence imaging system 612; (c) imaging, with the aid of the fluorescence imaging system, the resected tissue sample to determine one or more autofluorescent characteristics of the resected tissue sample 614; and (d) receiving, from the fluorescence imaging system, a determination of the presence of a tissue or cell type of interest in the resected tissue sample based on the resected tissue. In some cases, the tissue or cell type of interest may comprise diseased tissues or cells. In some instances, the diseased tissues or cells may comprise cancerous tissues or cells. In some cases, the subject may be suffering from or suspected of suffering from a disease. In some instances, the disease may be cancer. In some cases, the resected tissue sample may comprise a tissue sample that has not been stained prior to imaging. In some instances, the one or more autofluorescent characteristics may comprise an autofluorescence lifetime characteristic. In some cases, the autofluorescence lifetime characteristic may comprise a plurality of fluorescent exponential decay characteristics of a plurality of regions of the resected tissue sample. In some cases, the disease may comprise cancer. In some instances, the tissue sample may comprise colon tissue, breast tissue, prostate tissue, skin tissue, vasculature tissue, or any combination thereof. In some cases, the step of determining the presence of disease in the resected tissue (i.e., step (c) 606), may comprise characterizing one or more margins in the resected tissue sample as diseased or non-diseased. In some instances, the fluorescence imaging system may comprise a pulsed fluorescence light source. In some cases, the method may further comprise the step of informing a surgeon to resect a second tissue sample from the subject. In some instances, informing may comprise sound, visual display, or any combination thereof directed towards to the surgeon. In some cases, steps (b) 604 and (c) 606 may be completed in near real-time, or up to 1, 2, 3, 4, 5, 6, 7, 8, 9, or 10 minutes. In some instances, determining the presence of disease in the tissue sample (i.e., step (c) 606) may be completed by a probability-based model. The probability based model may comprise clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof.

Although the above steps show method 600 in accordance with embodiments, a person of ordinary skill in the art will recognize many variations based on the teaching described herein. The steps may be completed in a different order. Steps may be added or omitted. Some of the steps may comprise sub-steps. Many of the steps may be repeated as often as beneficial.

One or more of the steps of method 600 may be performed with circuitry as described herein, for example, one or more of the processor or logic circuitry such as programmable array logic for a field programmable gate array. The circuitry may be programmed to provide one or more of the steps of the method 600, and the program may comprise program instructions stored on a computer readable memory or programmed steps of the logic circuitry such as the programmable array logic or the field programmable gate array, for example.

In some embodiments, the methods of the disclosure provided herein may comprise a method for determining the presence of disease in a tissue sample in an operative theater by fluorescence lifetime imaging 700, as seen in FIG. 7A. In some cases, the method may comprise the steps of: (a) resecting a tissue sample from a subject 702; (b) placing the tissue sample into a fluorescence imaging system, where the fluorescent imaging system directs an excitation signal to the tissue sample and collects fluorescent light emitted from the sample in response 704; and (c) receiving, from the fluorescence imaging system, a characterization of at least a portion of the tissue sample for a tissue or cell type of interest based on a fluorescent lifetime characteristic of the collected fluorescent light 706. In some instances, the method may further comprise the steps of: (i) confirming tissue sample includes the tissue or cell type of interest 752, (ii) confirming that margins of tissue sample does not include the tissue or cell type of interest754, (iii) performing additional resection in body of the subject in area corresponding to where the tissue or cell type of interest is present in the margin of the sample 756, and (iv) repeating above steps for additional resection based on the presence or absence of the tissue or cell type of interest at sample tissue margins 758. In some cases, the tissue or cell type of interest may comprise diseased tissues or cells. In some instances, the diseased tissues or cells may comprise cancerous tissues or cells. In some cases, the subject may be suffering from or suspected of suffering from a disease. In some instances, the disease may be cancer.

In some cases, the resected tissue sample may comprise a tissue sample that has not been stained prior to imaging. In some cases, the fluorescence lifetime characteristic may comprise a plurality of fluorescent exponential decay characteristics of a plurality of regions of the resected tissue sample. In some cases, the disease may comprise cancer. In some instances, the tissue sample may comprise colon tissue, breast tissue, prostate tissue, skin tissue, vasculature tissue, or any combination thereof. In some cases, the characterization of at least a portion of the tissue sample may comprise characterizing one or more margins in the resected tissue sample as diseased or non-diseased. In some instances, the fluorescence imaging system may comprise a pulsed fluorescence light source. In some cases, the method may further comprise the step of informing a surgeon to resect a second tissue sample from the subject. In some instances, informing may comprise sound, visual display, or any combination thereof directed towards to the surgeon. In some cases, steps (b) 704 and (c) 706 may be completed in up to 5 minutes. In some instances, the characterization of at least a portion of the tissue sample may be completed by a probability-based model. The probability based model may comprise clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof.

In some embodiments, the methods of the disclosure provided herein may comprise a method for determining the presence of disease in a tissue sample intraoperatively or post operatively 708, as seen in FIG. 7B. In some cases, the method may comprise the steps of: (a) receiving a tissue sample resected from a subject in a fluorescence imaging system 710; (b) directing an excitation signal to the tissue sample 712; (c) collecting fluorescent light emitted from the tissue sample in response to the excitation signal 714; and (d) characterizing at least a portion of the tissue sample for a tissue or cell type of interest based on a fluorescent lifetime characteristic of the collected fluorescent light 716. In some cases, the tissue or cell type of interest may comprise diseased tissues or cells. In some instances, the diseased tissues or cells may comprise cancerous tissues or cells. In some cases, the subject may be suffering from or suspected of suffering from a disease. In some instances, the disease may be cancer. In some instances, the method may further comprise the steps of: (i) confirming tissue sample includes cancerous tissue 752, (ii) confirming that margins of tissue sample include no cancerous tissue 754, (iii) performing additional resection in body of the subject in area corresponding to where cancerous tissue is present in the margin of the sample 756, and (iv) repeating above steps for additional resection based on the presence or lack thereof cancer on the margin or tissue sample 758. In some cases, the tissue sample resected from a subject may comprise a tissue sample that has not been stained prior to imaging. In some cases, the fluorescence lifetime characteristic may comprise a plurality of fluorescent exponential decay characteristics of a plurality of regions of the resected tissue sample. In some cases, the disease may comprise cancer. In some instances, the tissue sample resected from the subject may comprise colon tissue, breast tissue, prostate tissue, skin tissue, vasculature tissue, or any combination thereof. In some cases, the characterization of at least a portion of the tissue sample may comprise characterizing one or more margins in the resected tissue sample as diseased or non-diseased. In some instances, the fluorescence imaging system may comprise a pulsed fluorescence light source. In some cases, the method may further comprise the step of informing a surgeon to resect a second tissue sample from the subject. In some instances, informing may comprise sound, visual display, or any combination thereof directed towards to the surgeon. In some cases, steps (b) 712 to (d) 716 may be completed in up to 5 minutes. In some instances, the characterization of at least a portion of the tissue sample may be completed by a probability-based model. The probability based model may comprise clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof.

Although the above steps show method 700 in accordance with embodiments, a person of ordinary skill in the art will recognize many variations based on the teaching described herein. The steps may be completed in a different order. Steps may be added or omitted. Some of the steps may comprise sub-steps. Many of the steps may be repeated as often as beneficial.

One or more of the steps of method 700 may be performed with circuitry as described herein, for example, one or more of the processor or logic circuitry such as programmable array logic for a field programmable gate array. The circuitry may be programmed to provide one or more of the steps of the method 700, and the program may comprise program instructions stored on a computer readable memory or programmed steps of the logic circuitry such as the programmable array logic or the field programmable gate array, for example.

In some cases, the device and systems of the method described herein may be used in a plurality of use environments and use cases. In some instances, the devices and systems described elsewhere herein may be configured to be used in a hospital office, corridor of the surgical operating room, surgical operating room, hospital service center, or any combination thereof. In some cases, the devices and systems may comprise one or more operations that may be implemented by a medical technician, nurse (e.g., surgical nurse and/or operating room nurse), surgeon, physician, physician assistant, service technician (e.g., hospital or BLS), or any combination thereof.

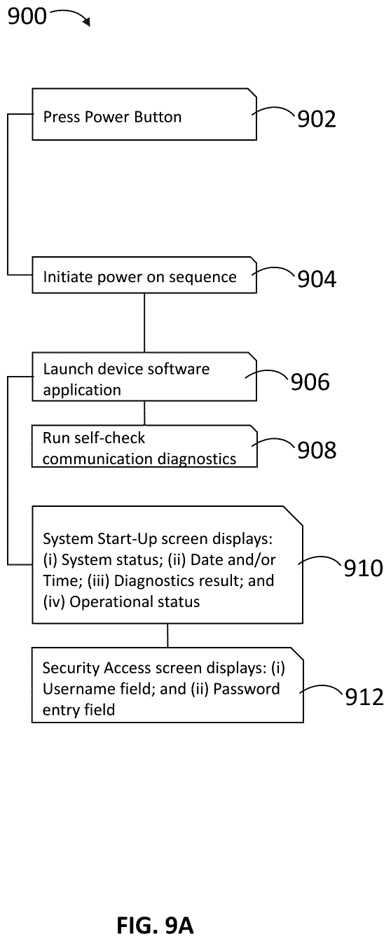

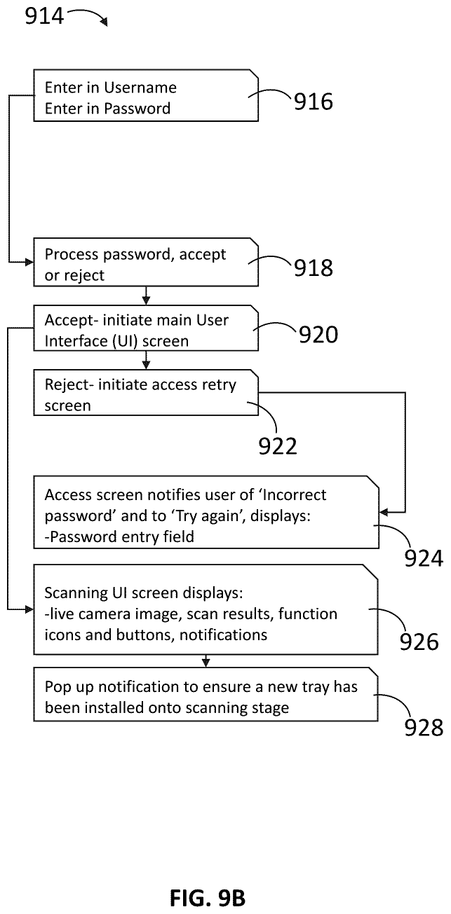

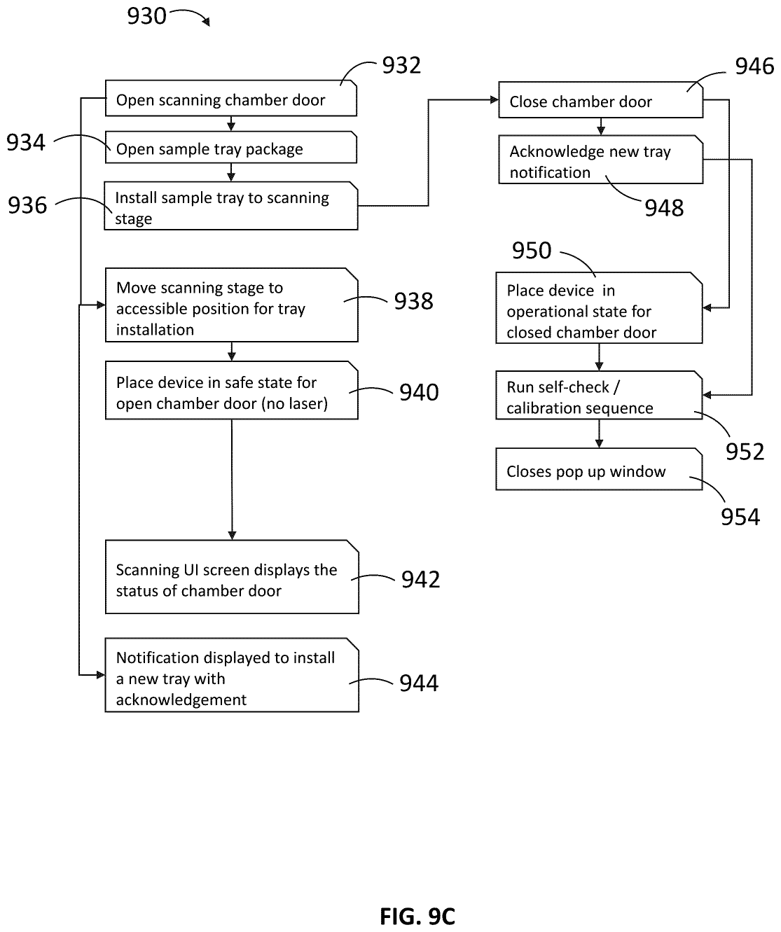

In some instances, the systems and devices used in the hospital office and/or corridor of the surgical operating may comprise one or more operations comprising: system setup and or prep (FIGS. 9A-9C), time-out, chamber cleaning, system shutdown, device transport, or any combination thereof. In some instances, the operations of system setup and or preparation (also referred to herein as “prep”), time-out, chamber cleaning, and system shutdown may be completed by a medical technical and/or a nurse. In some instances, the operation of device transport may be completed by a medical technical.

In some instances, the systems and devices used in the surgical operating room may comprise one or more operations comprising: sample prep and or placement, sample scan, results review, sample(s) removal, or any combination thereof. In some cases, the operations of sample prep and/or placement, sample scan, sample removal, or any combination thereof, may be completed by a nurse. In some instances, the operations of sample scan, results review, or any combination thereof, may be completed by a surgeon, physician, physician assistant, or any combination thereof.

In some cases, the systems and devices used in the hospital service center may comprise the operation of service and or maintenance. In some cases, the operation of service and or maintenance may be completed by a service technician from the hospital or the manufacturer of the system.

In some instances, the power on operation 900, as seen in FIG. 9A, may comprise one or more user actions, device actions, and information displayed to one or more users. In some cases, the tray installation operation may be conducted by a nurse, or a medical technician. In some cases, the power on operation may comprise user actions of pressing the power button 902. In some instances, the device actions may comprise: initiating a power on sequence 904 launching a device software application 906 and running a self-check communication diagnostic 908. In some instances, the power on operation may display information may comprise a system start-up screen 910 displaying: system status, date and/or time, diagnostic results, and operational status. In some cases, the display information may comprise a security access screen 912 displaying: a username field; and a password entry field. In some cases, the system start-up screen 910 may be presented to a user prior to the security access screen 912.

In some instances, the password authorization operation 914, as seen in FIG. 9B, may comprise one or more user actions, device actions, and information displayed to one or more users. In some cases, the tray installation operation may be conducted by a nurse, or a medical technician. In some cases, the password authorization operation may comprise user actions entering a user and/or a password 916. In some instances, the device actions may comprise: processing the password, accepting the password, and initiating main user interface screen 920, rejecting the password and initiating access to retry screen 922, or any combination thereof. In some cases, the device action of accepting the password may provide a display of a scanning UI screen 926 comprising: a live camera image, scan results, function icons and buttons, notifications, or any combination thereof. In some cases, the UI screen 926 may provide an information display pop up notification to ensure a new tray has been installed onto the scanning stage 928.

In some instances, the tray installation operation 930, as seen in FIG. 9C, may comprise one or more user actions, device actions, and information displayed to one or more users. In some cases, the tray installation operation may be conducted by a nurse, or a medical technician.

In some cases, the tray installation operation may comprise user actions of opening the scanning chamber door 932, opening the sample tray package 934, installing the sample tray onto scanning stage 936, closing the chamber door 946, acknowledging a new tray notification 948, or any combination thereof. By opening the scanning chamber door, the device may complete the device action of moving the scanning stage to an accessible position to install a tray 938. The user action of opening the scanning chamber door 932 may display a notification to install a new tray with an acknowledgement option to select 944. As the device moves the scanning stage to an accessible position the device may then go into a safe state where the device laser is not lasing 940. After the device goes into safe state 940 the device may display a scanning UI screen that displays the status of the chamber door 942. In some cases, the status of the chamber door may be closed or open. In some cases, as the user closes the chamber door 946 and acknowledges a new tray notification 948, the device may change to an operational state for a closed chamber 950. In the operational state, the device may perform a self-check calibration sequence 952, and close pop-up windows 954.

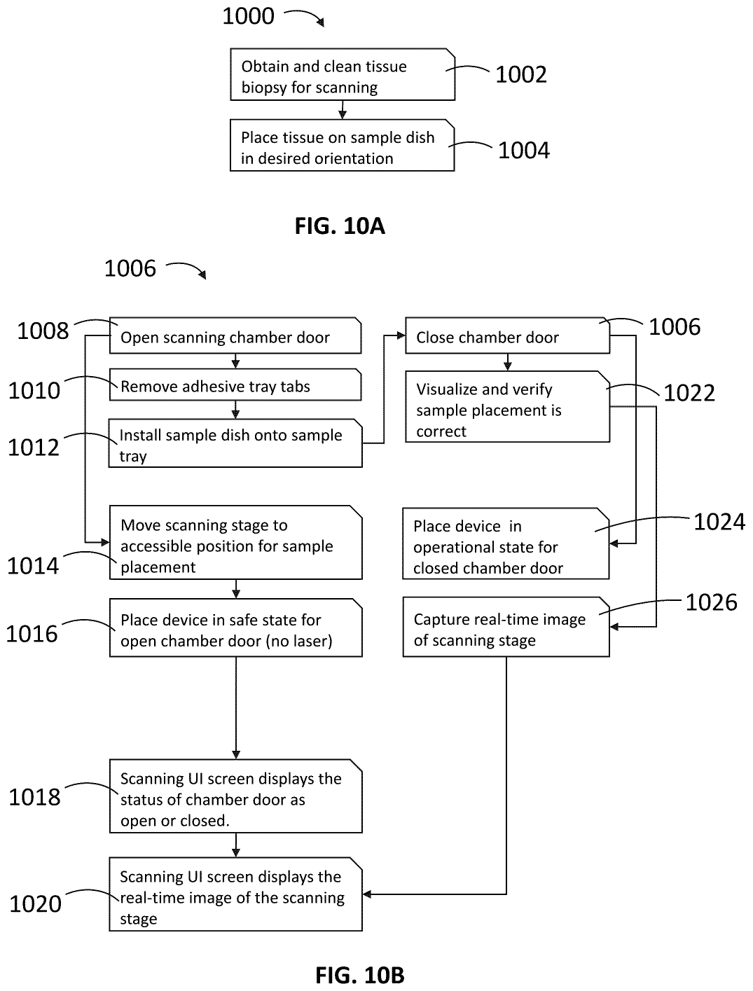

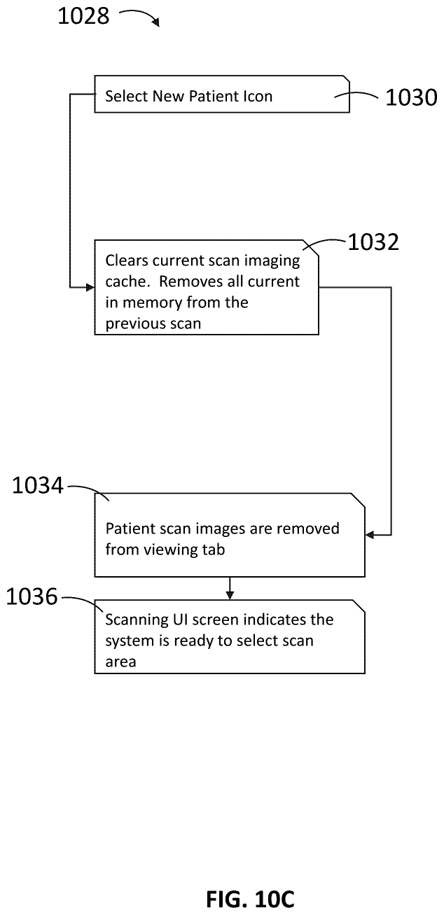

In some instances, the preparing tissue samples operation 1000, as seen in FIG. 10A, may comprise the user actions of obtaining and cleaning a tissue biopsy for scanning 1002, placing tissue on a sample dish in a desired orientation, 1004 or any combination thereof. In some cases, the preparing tissue samples operation may be conducted by a nurse. In some cases, the product labeling may provide guidelines for tissue prep requirements and specific sample dish requirements (e.g., brand, size, etc.).

In some instances, the sample placement operation 1006, as seen in FIG. 10B, may comprise one or more user actions, device actions, and information displayed to one or more users. In some cases, the sample placement operation may be conducted by a nurse. In some cases, the sample placement operation may comprise user actions of opening the scanning chamber door 1008, removing adhesive tray tabs of the sample tray 1010, installing the sample dish onto the sample tray 1012, placing the sample on the sample dish, closing the chamber door 1006, visualizing and verifying the correct sample placement 1022, or any combination thereof. In response to opening the scanning chamber door, the device may execute one or more device actions, comprising: moving the scanning stage to an accessible position for sample placement 1014, placing the device into safe state where the device laser is not lasing 1016. In some instances, closing the chamber door may change the device to an operational state for a closed chamber 1024. In some instances, the user action of closing the chamber door and visualizing and verifying correct sample placement may then lead to a device action of capturing a real-time image of the scanning stage. As a result of the device actions, the device may output display information comprising: a scanning UI screen displaying the status of chamber door as open or closed 1018, a scanning UI screen displaying the real-time image of the scanning stage 1020, or any combination thereof.

In some instances, the new patient selection operation 1028, as seen in FIG. 10C, may comprise one or more user actions, device actions, and information displayed to one or more users. In some cases, the new patient selection operation may be conducted by a nurse. In some cases, the new patient selection operation may comprise user actions of selecting the new patient icon 1030. In response to selecting the new patient icon, the device may execute a device action of clearing current scan imaging cache 1032. In some cases, clearing current scan imaging cache may remove all current memory from previous scans. In some instances, the device action of clearing current scan imaging cache may output display information comprising: a notification that patient scan images are removed from the viewing tab 1034, a scanning UI screen that indicates the system is ready to select a scan area 1036, or any combination thereof.

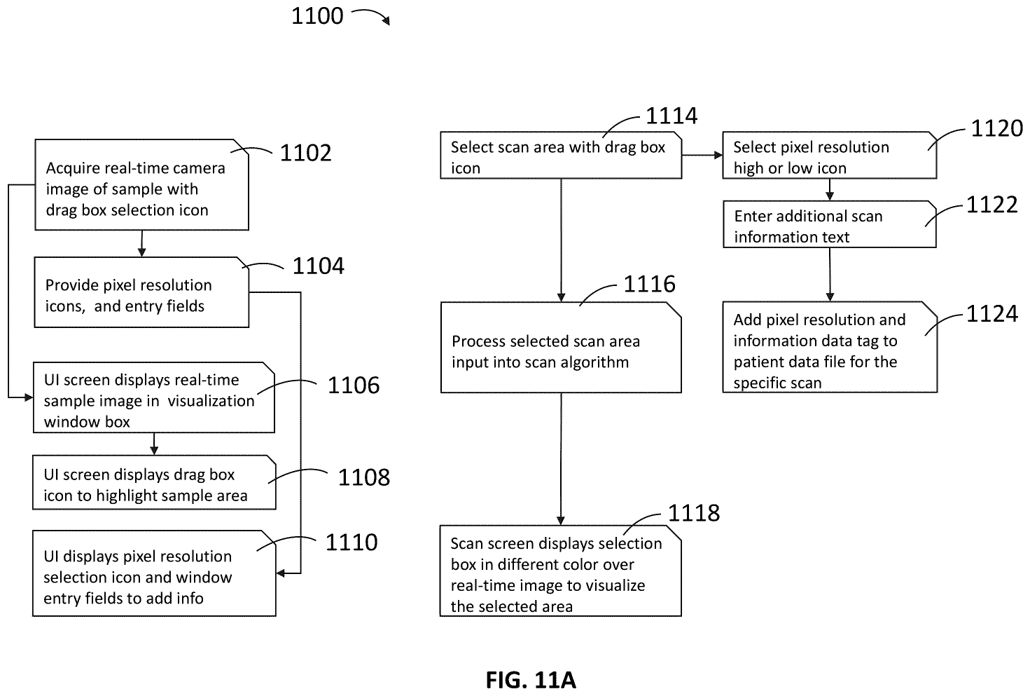

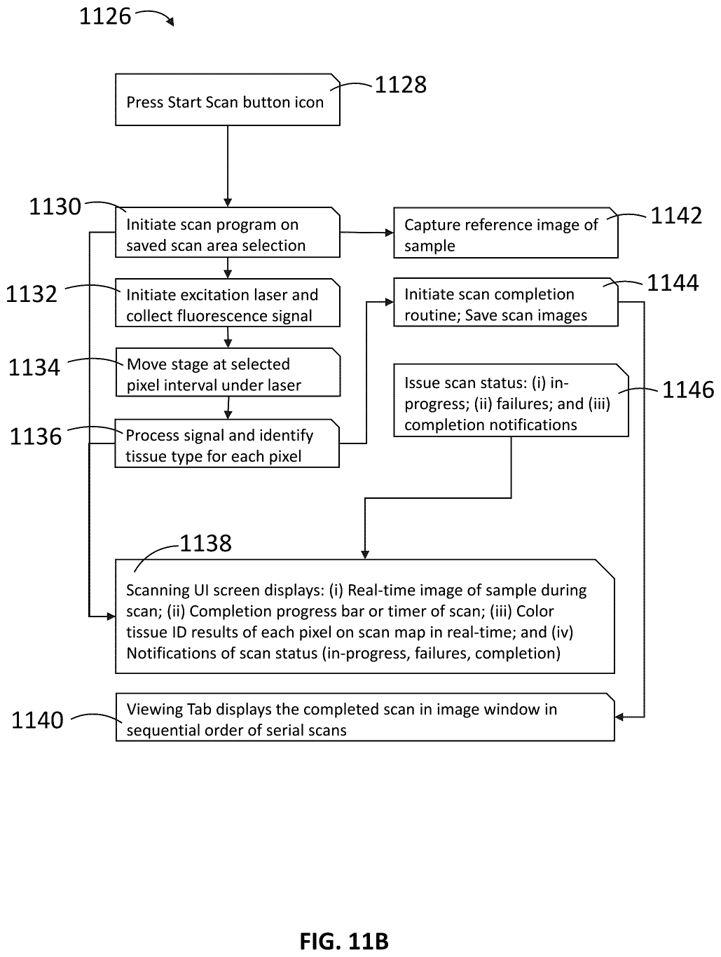

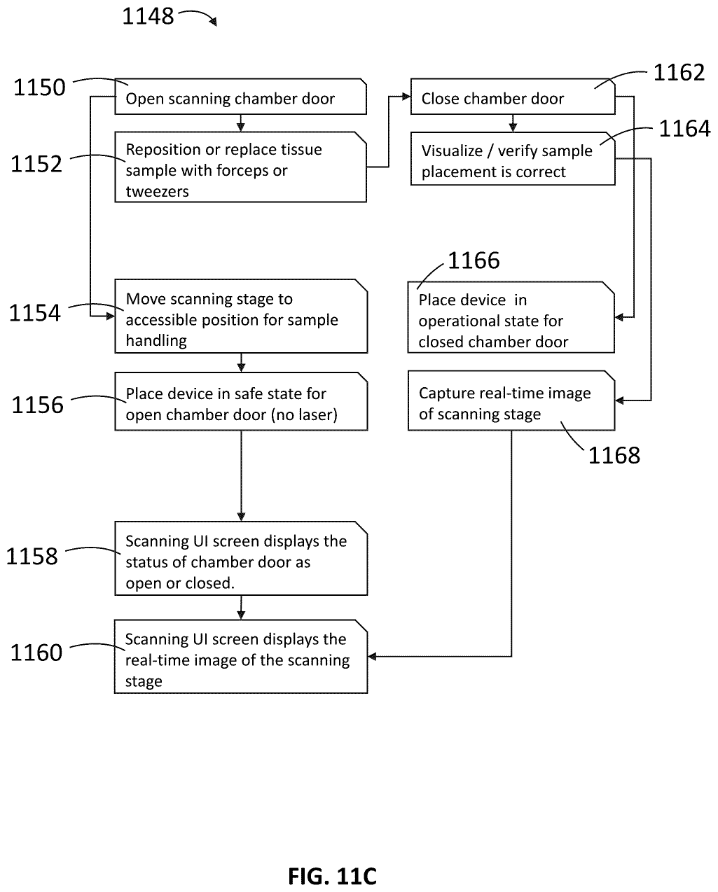

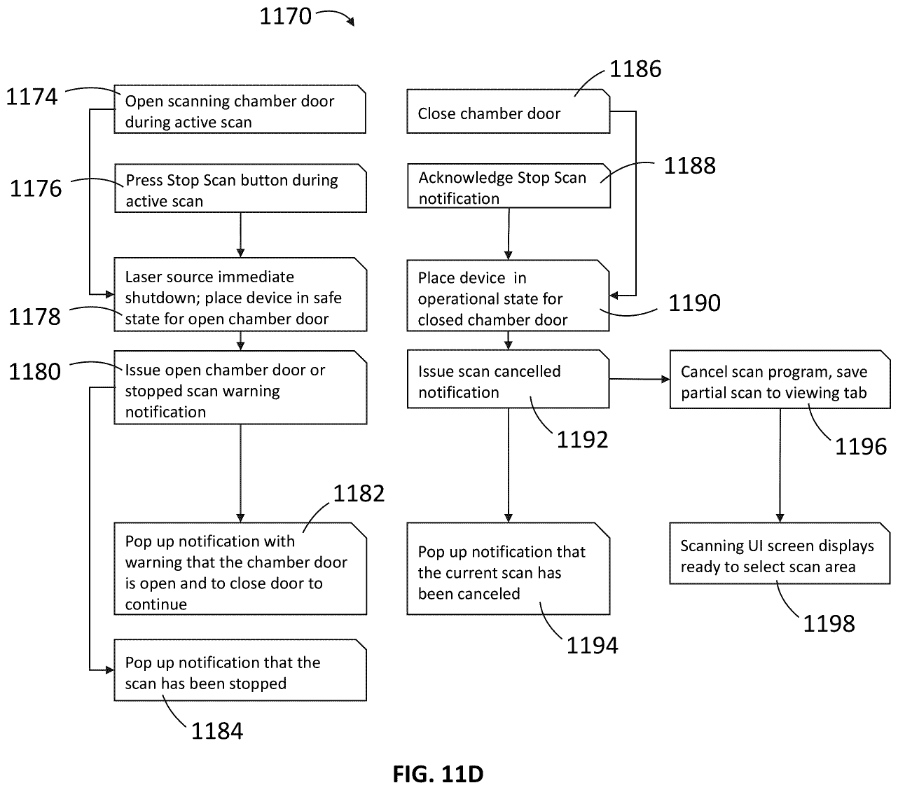

In some instances, the scan area selection operation 1100, as seen in FIG. 11A, may comprise one or more user actions, device actions, and information displayed to one or more users. In some cases, the scan area selection operation may be conducted by the nurse or surgeon, physician, or physician's assistant. In some cases, the scan area selection operation may comprise user actions of selecting a scan area with a drag box icon 1114, selecting pixel resolution 1120, entering additional scan information text 1122, or any combination thereof. In some cases, pixel resolution may comprise a high and low setting. In response to selecting a scan area with a drag box, the device may execute a device actions of process selected scan area input into a scan algorithm 1116. In response to selecting a scan area with a drag box 1114, entering additional scan information text 1122 and selecting a pixel resolution 1120, the device may execute a device action of adding pixel resolution and information data tag to patient data file for the specific scan 1124. In some instances, the device action of processing the selected scan area input into a scan algorithm 1116 may output display information comprising a scan screen display selection box in different colors over real-time images to visualize the selected scan area 1118. In some cases, in response to selecting a scan area with a drag box, the device may execute one or more actions, comprising: acquiring real-time white light image of the sample 1102, providing pixel resolution icons and entry fields 1104, or any combination thereof. In some instances, the device action of acquiring a real-time white light image of the sample may output display information comprising a UI screen displaying real-time white light image in visualization window box 1106, a UI screen display drag box icon to highlight sample areas 1108, or any combination thereof. In some instances, the device action of providing pixel resolution icons and entry fields may output display information comprising a UI display pixel resolution selection icon and window entry fields to add information 1110.

In some instances, the sample scan operation 1126, as seen in FIG. 11B, may comprise one or more user actions, device actions, and information displayed to one or more users. In some cases, the sample scan operation may be conducted by the nurse or surgeon, physician, or physician's assistant. In some cases, the sample scan operation may comprise user actions of pressing the start scan button icon 1128. In response to pressing the start scan button icon, the device may execute one or more device actions, comprising: initiating a scan program on saved scan area selections 1130, capturing a reference image of the sample 1142, initiating excitation laser and collecting fluorescence signal 1132, moving the stage at selected pixel intervals under the laser 1134, processing signal and identifying tissue type for each pixel 1136, initiating a scan completion routine and saving scan images 1144, issue scan status 1146, or any combination thereof. In some cases, the scan status may comprise: in progress, failure, or completion of scan. In response to issuing scan status, initiating the scan program on saved scan area 1130, or processing signal and identifying tissue type of each pixel 1136, the device may output display information comprising a scanning UI screen display 1138 comprising: a real-time image of the sample during a scan, completion progress bar or timer of scan, color tissue ID results of each pixel on a scan map in real-time, notification of scan status, or any combination thereof. In response to initiating scan completion routine and saving the scan images 1144, the device may output display information comprising a viewing tab display of the completed scan in an image window sequentially in order of serial scans 1140.

In some instances, the sample reposition and/or replacement operation 1148, as seen in FIG. tIC, may comprise one or more user actions, device actions, and information displayed to one or more users. In some cases, the sample reposition and/or replacement operations may be conducted by the nurse or surgeon, physician, or physician's assistant. In some cases, the sample scan operation may comprise user actions of: opening the scanning chamber door 1150, repositioning or replacing tissue samples with forceps or tweezers 1152, closing the chamber door 1162, visualizing and/or verifying sample placement is correct 1164, or any combination thereof. In response to opening the scanning chamber door 1150, the device may execute one or more device actions, comprising: moving the scanning stage to an accessible position for sample handling 1154, placing the device into safe state where the device laser is not lasing 1156, or any combination thereof. In response to closing the chamber door 1162 and/or visualizing and/or verifying correct sample placement 1164 the device may execute one or more device actions, comprising: placing the device in an operational state 1166, capturing real-time images of a scanning stage 1168, or any combination thereof. In response to placing the device in a safe state for opening the chamber door, the device may output display information comprising a scanning UI screen displaying the status of the chamber door as open or close 1158, a scanning UI screen displaying the real-time image of the scanning stage 1160, or any combination thereof. In response to placing the capturing a real-time image of the scanning stage 1168, the device may output display information comprising a scanning UI screen displaying the real-time image of the scanning stage 1160.

In some instances, the scan interruption operation 1170, as seen in FIG. 11D, may comprise one or more user actions, device actions, and information displayed to one or more users. In some cases, the scan interruption operations may be conducted by the nurse or surgeon, physician, or physician's assistant. In some cases, the scan interruption operation may comprise user actions of: opening the scanning chamber door during an active scan 1174, pressing stop scan button during an active scan 1176, closing the chamber door 1186, acknowledging a stop scan notification 1188, or any combination thereof. In response to opening the scanning chamber door during an active scan 1174 and/or pressing stop scan button during an active scan 1176, the device may execute one or more device actions, comprising: shutting down the laser source and placing the device in a safe state for an open chamber door 1178, issuing an open chamber door or stopped scan warning notification 1180, or any combination thereof. In response to closing the chamber door 1186 and/or acknowledging a stop scan notification 1188, the device may execute one or more device actions, comprising: placing device in an operational state for a closed chamber door 1190, issuing a scan called notification 1192, canceling scan program and saving a partial scan to the view tab 1196, or any combination thereof. In response to issuing an open chamber door or stop scan warning notification, the device may output display information comprising a pop up notification with warning that the chamber door is open and to close the door to continue 1182, a pop up notification that the scan has been stopped 1184, or any combination thereof. In response to canceling the scan program and saving a partial scan to the viewing tab the device may output display information comprising a scanning UI screen displaying ready to select scan area 1198. In response to issuing a scan cancelled notification 1192 the device may output display information comprising a pop-up notification that current scan has been canceled 1194.

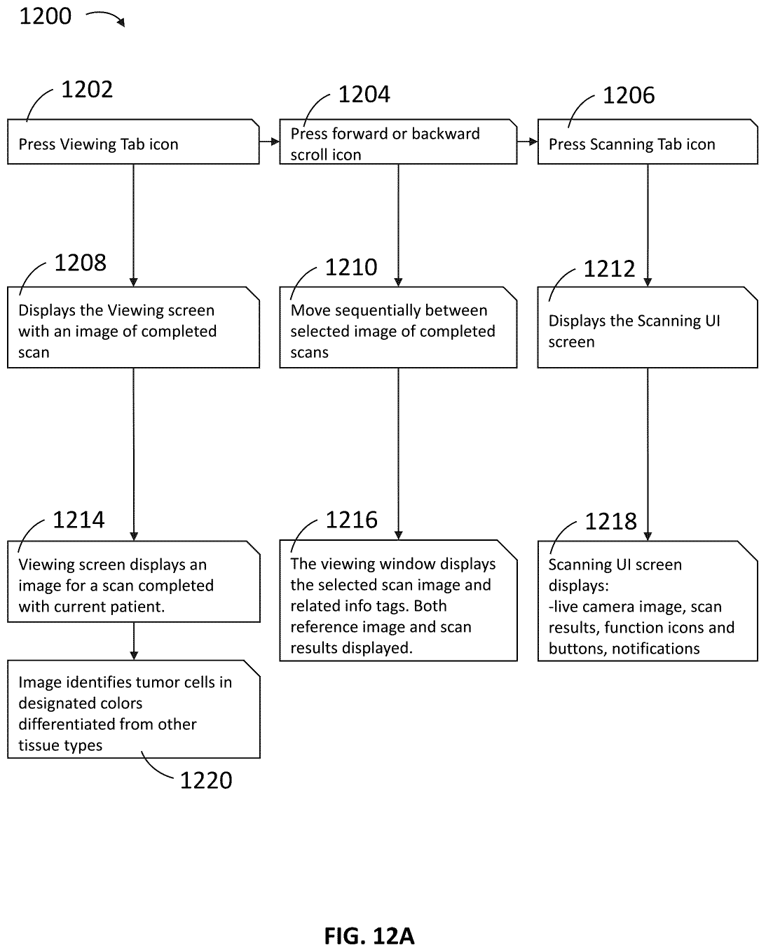

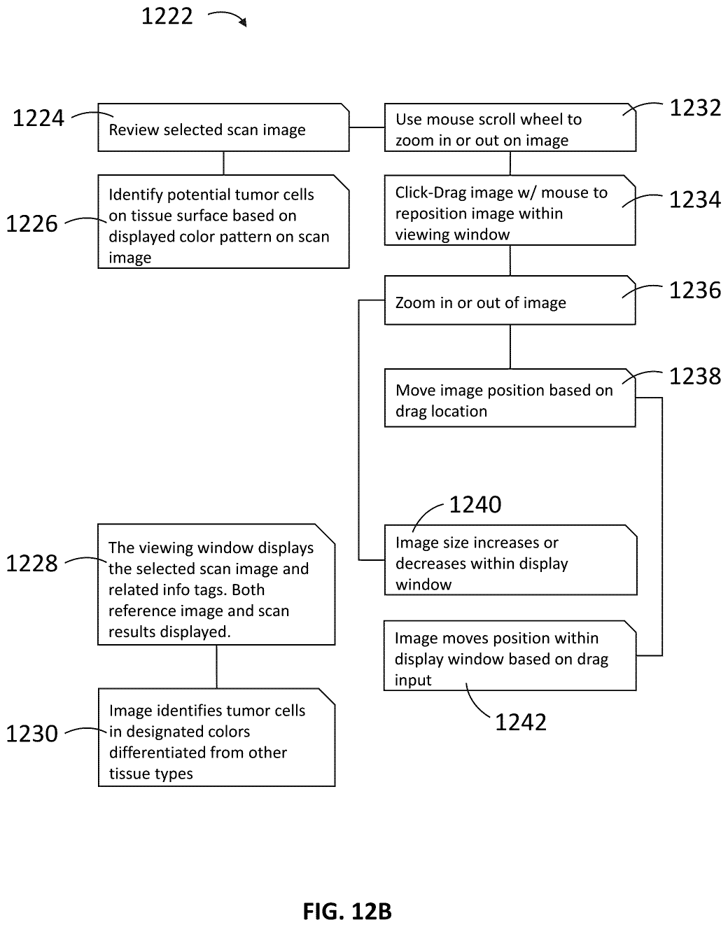

In some instances, the scan results selection operation 1200, as seen in FIG. 12A, may comprise one or more user actions, device actions, and information displayed to one or more users. In some cases, the scan results selection operations may be conducted by the nurse or surgeon, physician, or physician's assistant. In some cases, the scan results selection operation may comprise user actions of: pressing the viewing tab icon 1202, pressing forward or backward 1204 on the scroll icon, pressing the scanning tab icon 1206, or any combination thereof. In response to pressing the viewing tab icon 1202, the device may execute a device action, comprising displaying the viewing screen with an image of the completed scan 1208. In response to pressing forward or backward on the scroll icon 1204, the device may execute a device action, comprising: moving sequentially between selected images of a completed scan 1210. In response to pressing the scanning tab icon 1206, the device may execute a device action, comprising displaying the scanning UI screen 1212. In response to displaying the viewing screen with an image of a completed scan the device may output display information comprising: a viewing screen displaying an image for a scan completed with the current patient 1214, an image identifying tumor cells in designated colors differentiated from other tissue types 1220, or any combination thereof. In response to moving sequentially between selected images of a completed scan 1210, the device may output display information comprising a viewing window displaying the selected scan image and related info tags 1216. In some cases, both reference image and scan results may be displayed in the viewing window. In response to issuing displaying the scanning UI screen 1212 the device may output display information comprising a scanning UI screen display 1218 comprising: a live camera image, scan results, function icons and buttons, notifications, or any combination thereof.

In some instances, the scan review operation 1222, as seen in FIG. 12B, may comprise one or more user actions, device actions, and information displayed to one or more users. In some cases, the scan review operation may be conducted by a surgeon, physician, or physician's assistant. In some cases, the scan results selection operation may comprise user actions of: reviewing selected scan images 1224, identifying potential tumor cells on the tissue surface based on displayed color patterns on the scan image 1226, using a mouse scroll wheel to zoom in or out on an image 1232, clicking and dragging an image with a mouse to reposition the image within a viewing window 1234, or any combination thereof. In response to clicking and dragging an image with a mouse to reposition the image within a viewing window 1234, the device may execute one or more device actions, comprising: zooming in or out of an image 1236, moving an image position based on a drag location 1238, or any combination thereof. In response to moving an image position based on a drag location, the device may output display information comprising image moves positioned within a display window based on drag input 1242. In response to zooming in or out of an image, the device may output display information comprising image size increasing or decreasing with the display window 1240. In some cases, the device may output display information of a viewing window displaying the selected scan image and/or the reference image and related info tags 1228. In some cases, the device may output display information of an image that identifies tumor cells in designated colors differentiated from other tissue types 1230.

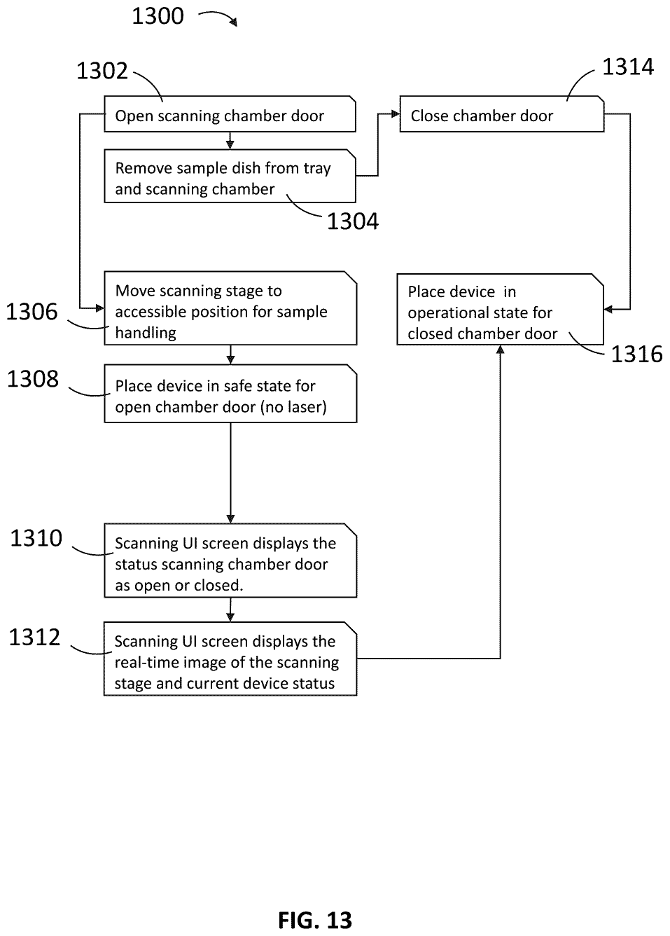

In some instances, the scan removal operation 1300, as seen in FIG. 13, may comprise one or more user actions, device actions, and information displayed to one or more users. In some cases, the scan removal operation may be conducted by a nurse. In some cases, the scan results selection operation may comprise user actions of: opening a scanning chamber door 1302, removing a sample dish from try and scanning chamber 1304, closing the chamber door 1314, or any combination thereof. In response to opening the scanning chamber door 1302, the device may execute one or more device actions, comprising: moving the scanning stage to an accessible position for sample handling 1306, placing the device into a safe state where the device laser is not lasing 1308, or any combination thereof. In response to closing the chamber door 1314, the device may execute a device action, comprising placing the device in an operational state for closed chamber door 1316. In response to placing the device into a safe state where the device laser is not lasing 1308, the device may output display information comprising a scanning UI screen displaying the status scanning chamber door as open or closed 1310. In response to placing the device in an operational state for a close chamber door, the device may output display information comprising a scanning UI screen displaying the real-time image of the scanning stage and current device status 1312.

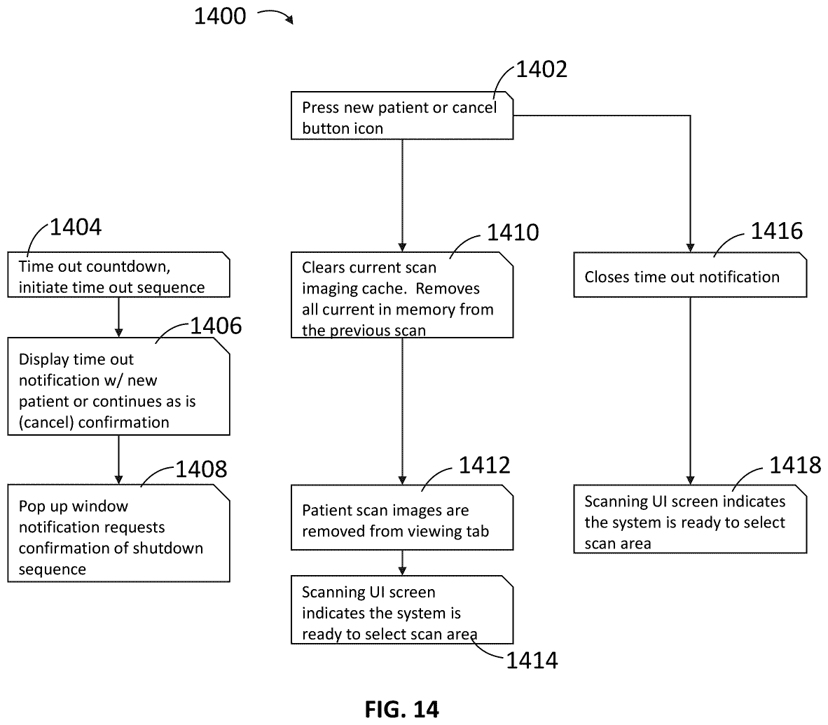

In some instances, the patient time out operation 1400, as seen in FIG. 14, may comprise one or more user actions, device actions, and information displayed to one or more users. In some cases, the patient time out operation may be conducted by a nurse or a medical technical. In some cases, the patient time out operation may comprise user actions of pressing a new patient or a cancel button icon 1402. In response to pressing a new patient or a cancel button icon, the device may execute one or more device actions, comprising: clearing the current scan imaging cache 1410, or closing time out notifications 1416. In some cases, clearing the current scan imaging cache may comprise removing all current memory from previous scans. In some cases, the device may comprise device actions of initiating time out countdown and time out sequence 1404, displaying time out notification with new patient or continuing with a current patient scan with a cancel confirmation 1406, or any combination thereof. In response to displaying a time out notification with new patient or continuing with a current patient scan with a cancel confirmation, the device may output display information comprising a pop-up window notification request confirming a shutdown sequence 1408. In response to clearing the current scan imaging cache 1410, the device may output display information of patient scan images removed from the viewing tab 1412, a scanning UI screen indicating the system is ready to select a scan area 1414, or any combination thereof. In response to closing a time out notification, the device may output display information of a scanning UI screen indicating the system is ready to select a scan area 1418.

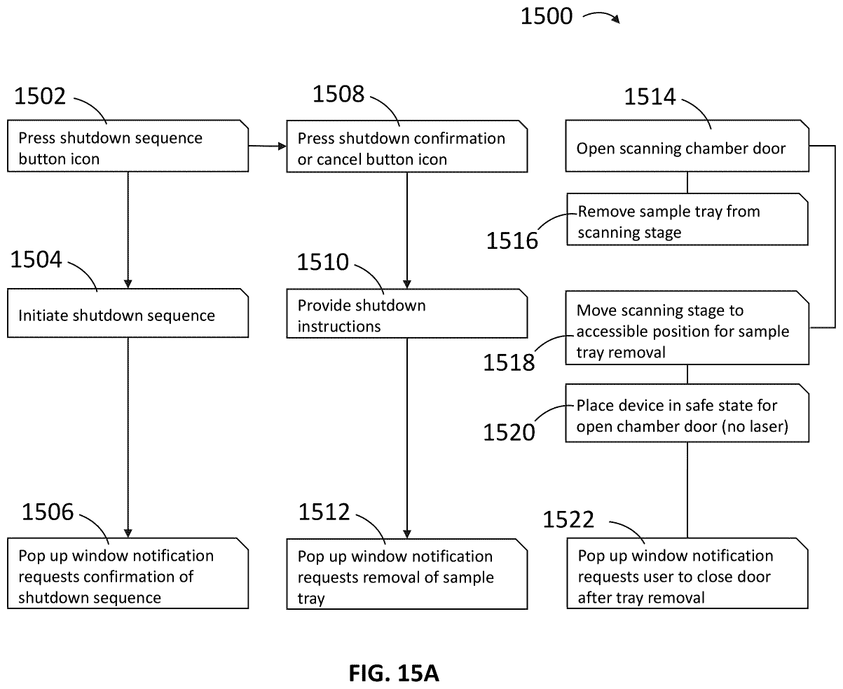

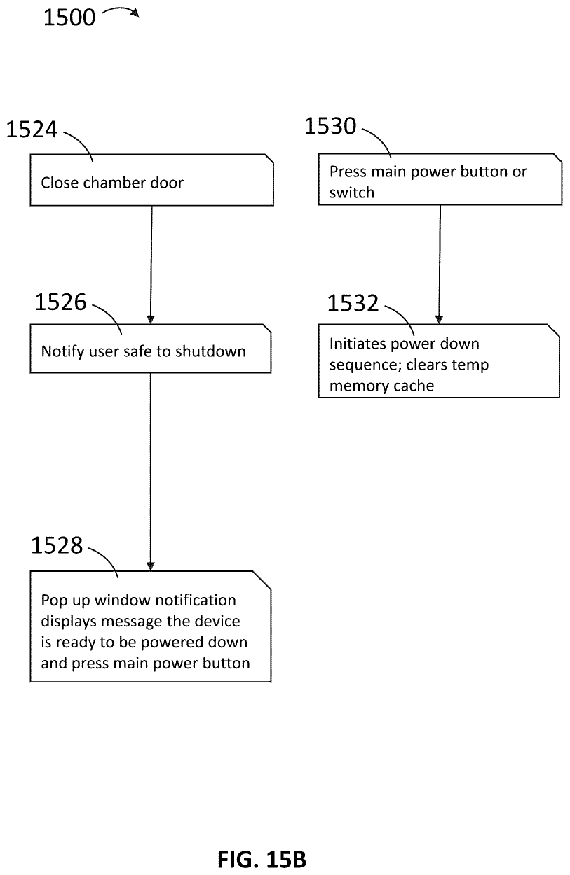

In some instances, the device shutdown operation 1500, as seen in FIGS. 15A-15B, may comprise one or more user actions, device actions, and information displayed to one or more users. In some cases, the device shutdown operation may be conducted by a nurse or a medical technical. In some cases, the device shutdown operation may comprise user actions of: pressing a shutdown sequence button icon 1502, pressing a shutdown confirmation or cancel button icon 1508, opening the scanning chamber door 1514, removing the sample tray from the scanning stage 1516, closing the chamber door 1524, pressing main power button or switch on the device 1530, or any combination thereof. In response to pressing a shutdown sequence button icon 1502, the device may execute a device action, comprising initiating a shutdown sequence 1504. In response to pressing a shutdown confirmation or cancel button icon 1508, the device may execute a device action, comprising providing shutdown instructions 1510. In response to opening a scanning chamber door, the device may execute one or more device actions, comprising: moving a scanning stage to an accessible position for sample tray removal 1518, and/or placing the device into a safe state where the device laser is not lasing 1520. In response to closing the chamber door 1524, the device may execute a device action, comprising notifying a user that it is safe to shut down the device 1526. In response to pressing the main power button or switch 1530, the device may execute a device action, comprising initiating a power down sequence 1532. In some cases, the power down sequence may comprise clearing temporary memory cache. In response to initiating a shutdown sequence 1504, the device may output display information comprising a pop-up window notification requesting confirmation of the shutdown sequence 1506. In response to providing shutdown instructions 1510, the device may output display information of a pop-up window notification requesting removal of the sample tray 1512. In response to placing the device into a safe state where the device laser is not lasing 1520, the device may output display information comprising a pop-up window notification requesting user(s) to close the door after tray removal 1522. In response to notifying the user that it is safe to shutdown 1526, the device may output display information comprising a pop-up window notification displaying messages that the device is ready to be powered down instructing the user to press the main power button 1528.

In some cases, the system may perform one or more safety checks to confirm the position of one or more system components e.g., linear actuator 2228 configured to elevate and/or lift the carrier, barrier and/or sample; the tissue sample height sensor (2236, 2239, 2242); and/or the optical scanning element 112. The safety checks may prevent the one or more system components from colliding with each other thereby damaging the components and/or damaging the tissue sample. In some instances, upon system start up, the software of the system may perform the one or more safety checks in a loop as a part of the calibration and start-up procedures.

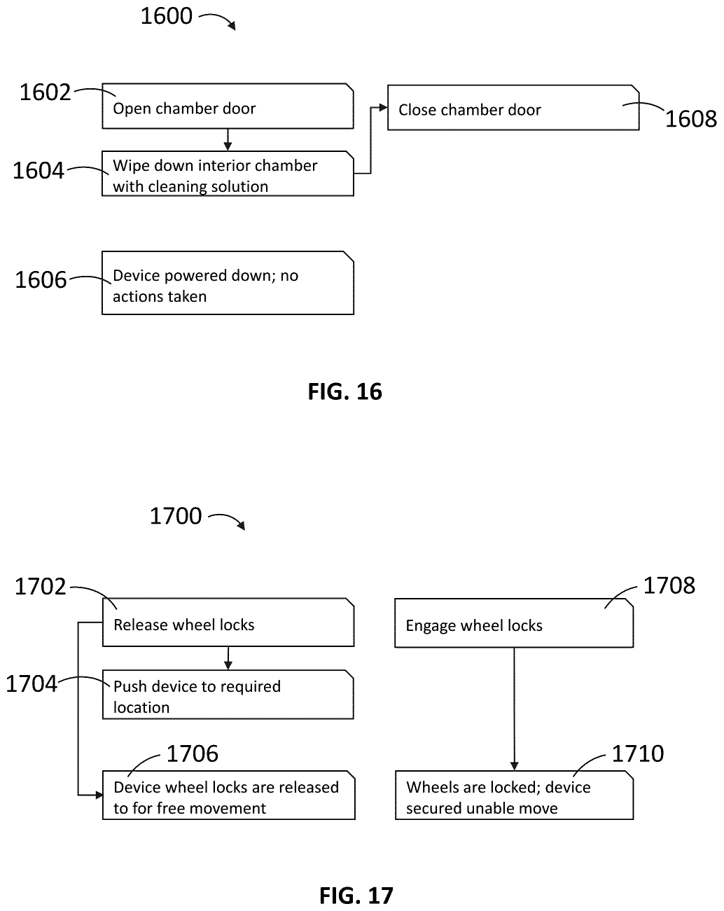

In some instances, the chamber cleaning operation 1600, as seen in FIG. 16, may comprise one or more user actions. In some cases, the chamber cleaning operation may be conducted by a medical technical. In some cases, the chamber cleaning operation may comprise user actions of: opening the chamber door 1602, wiping down the interior chamber with a cleaning solution 1604, closing the chamber door 1608, or any combination thereof. In some cases, for the cleaning operation to proceed the device may be shut down and therefore, the system may not execute device actions. In some instances, the device product labeling may provide guidelines for cleaning the canning chamber with recommended cleaning solutions.

In some instances, the device transport operation 1700, as seen in FIG. 17, may comprise one or more user actions and device actions. In some cases, the device transport operation may be conducted by a medical technical. In some cases, the device transport operation may comprise user actions of: releasing wheel locks 1702, pushing device to required location 1704, engaging wheel locks 1708, or any combination thereof. In response to releasing the wheel locks, the device may execute a device action comprising, releasing device wheel locks permitting free movement of the device 1706. In response to engaging the wheel locks 1708, the device may execute a device action comprising locking the wheels thereby securing the device in place inhibiting the device from moving 1710. In some cases, the product label of the device may comprise guidelines to transport the device and instructions to release and engage wheel locks.

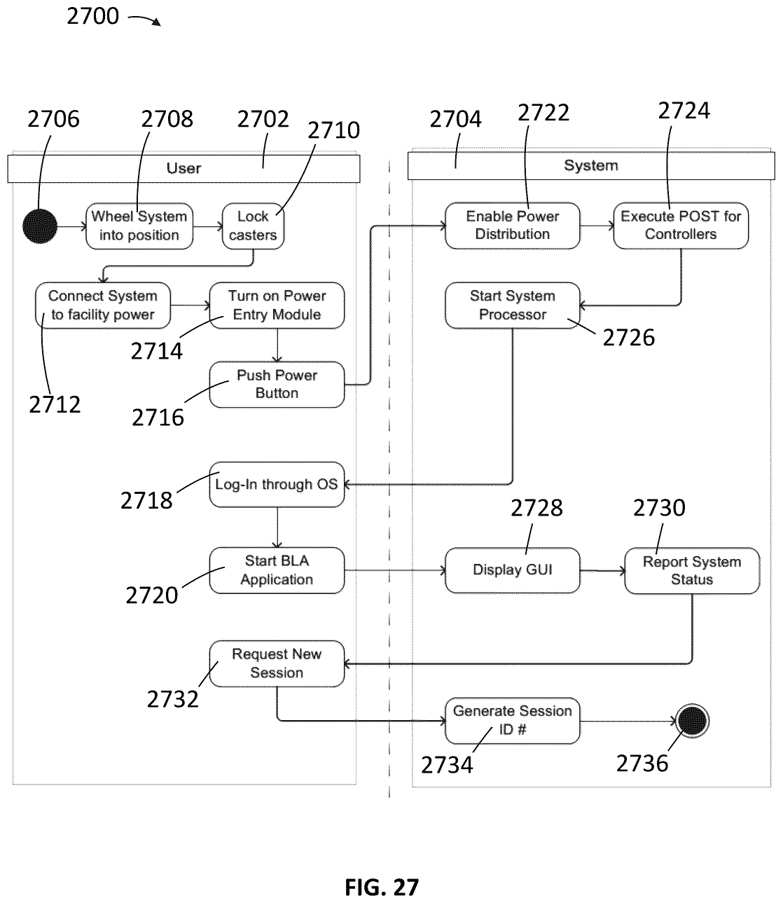

In some aspects, the system transport and startup operation 2700, as seen in FIG. 27, may comprise one or more user actions 2702 and imaging system actions 2704. In some cases, the system transport and startup operation may comprise a starting action 2706 and an ending action 2736. In some cases, the system transport and startup operation may comprise the user and/or system actions of: wheeling the imaging system into position (e.g., in an operating room and/or a histopathology lab) 2708; locking the casters of the imaging system to prevent unwanted movement of the imaging system 2710; connecting the imaging system to facility (e.g., a hospital operating room) power 2712; turning on the system dedicated power supply by changing a state of a switch of the system dedicated power supply 2714; pressing a system power on user interface (e.g., a power button and/or switch) 2716; enabling imaging system power distribution to all imaging system components 2722; executing power on self-test (POST) for the one or more imaging system controllers (e.g., scanning controller, drawer controller, device controller, gain controller, etc.) 2724; starting imagining system processor 2726; prompting a user with a log in dialog box through the imaging system operating system 2718; starting the image acquisition and control software 2720; displaying a graphical user interface of the software to a user 2728; reporting the status of the system through one or more visual indicators of system parameters and/or status 2730; receiving a request for a new imaging session from the user 2732; generating a system identification number for the new imaging session or any combination thereof actions.

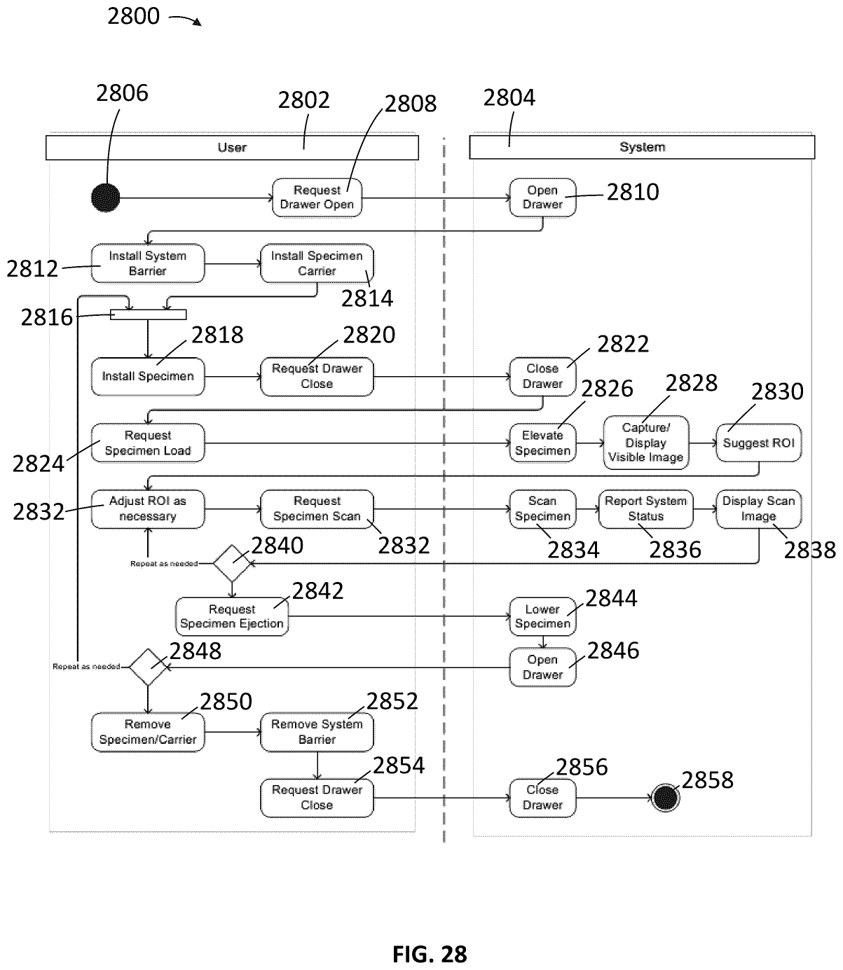

In some aspects, the imaging operation 2800 for imaging a sample placed on a carrier and barrier within a fluorescence imaging system, as seen in FIG. 28, may comprise one or more user actions 2802 and imaging system actions 2804. In some cases, the system transport and startup operation may comprise a starting action 2806 and an ending action 2858. In some cases, imaging operation may comprise the user and/or system actions of: requesting via an imaging system user interaction interface with a mouse, keyboard, voice command, and/or touchscreen input, a system drawer to open 2808; opening of the imaging system drawer 2810; placing and/or installing a barrier into the drawer mated feature for the barrier 2812; placing and/or installing a carrier onto the barrier (via the one or more carrier and/or barrier kinematic features, described elsewhere herein) 2814; placing the sample on the carrier 2818; requesting via an imaging system user interaction interface with a mouse, keyboard, voice command, and/or touchscreen input, the system drawer to close 2820; closing the imaging system drawer 2822; requesting via an imaging system user interface with a mouse, keyboard, voice command and/or touchscreen input for the imaging system to load the sample 2824; elevating and/or raising the tissue sample with a linear actuator to a depth of focus of the scanning optical element of the imaging system 2826, imaging and/or capturing a visible light image of the sample 2828; determining a region of interest of the sample and providing the region of interest via a display overlay to the user 2830 adjusting the region of interest of the sample to scan with one or more user input user interfaces e.g., a mouse, keyboard, voice command, and/or touch screen interface 2832; request the imaging system to perform a scan and/or image the sample 2832; scanning the sample 2834; reporting imaging system status of scan in progress and/or scan completed to a user via a display indicator of the user interface 2836; displaying one or more images of the sample generated during scanning 2838; providing an option to a user to repeat the scan of the sample with option to adjust the region of interest of the scan 2840; repeating actions 2832-2838; requesting via an imaging system user interface with a mouse, keyboard, voice command, and/or touchscreen input to eject the sample from the imaging system 2842; lowering the sample via the linear actuator 2844; opening the drawer 2846; removing the sample and/or carrier and placing a different sample on a different carrier and repeating 2816-2848 or removing 2850 the sample and the carrier from the imaging system; removing the barrier from the imaging system 2852; requesting via an imaging system user interface with a mouse, keyboard, voice command, and/or touchscreen input for the imaging system to close the drawer 2854; closing the imaging system drawer 2856 or any combination thereof action.

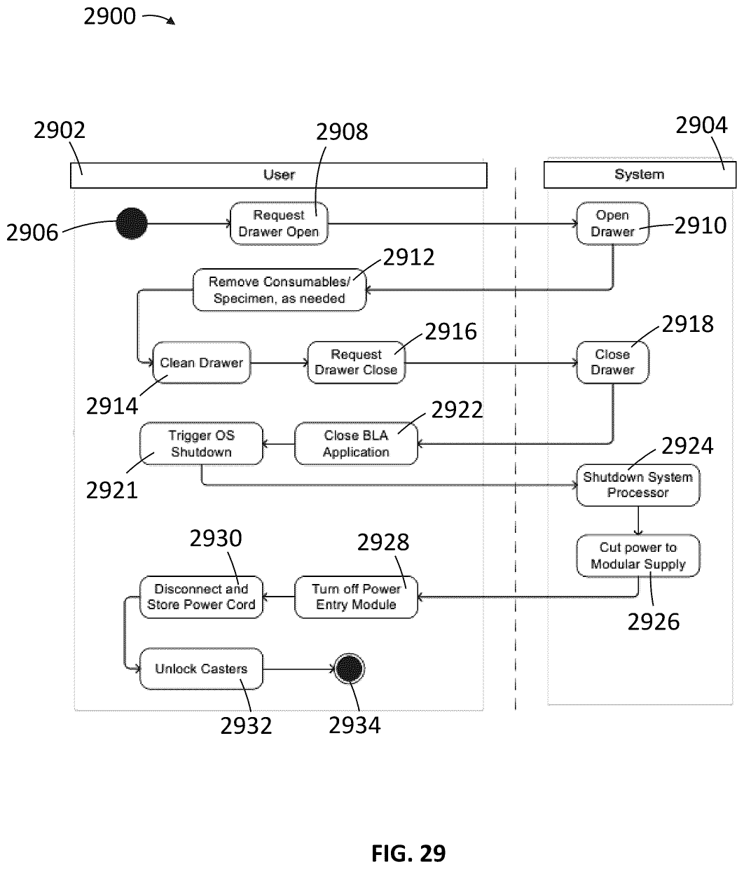

In some aspects, the cleaning and system shut down operation(s) 2900, as seen in FIG. 29, may comprise one or more user actions 2902 and imaging system actions 2904. In some cases, the cleaning and system shut down operations may comprise a starting action 2906 and an ending action 2934. In some cases, cleaning and system shut down operation(s) may comprise the user and/or system actions of: requesting with a user interface of a mouse, keyboard, voice command, and/or touch screen user interface, the opening of the imaging system drawer 2908; opening the system drawer 2910; removing the carrier and/or barrier consumables from the imaging system 2912; cleaning the drawer 2914; requesting with a user interface of a mouse, keyboard, voice command, and/or touch screen user interface, the imaging system to close the drawer 2916; closing the imaging system drawer 2918; closing the imaging system software and/or imaging application 2922; shutting down the imaging system operating system 2921; shutting down the imaging system process 2924; disconnecting power to the imaging system's dedicated power supply 2926; actuating a switch of the imaging system's dedicated power supply to turn off the power supply 2928; disconnecting the power cable from a wall socket 2930; unlocking the casters of the imaging system 2932 or any combination thereof action.

In some aspects, the disclosure provided herein describes a method of correlating fluorescence image data to standardized medical classification and/or diagnostic information. In some instances, the standardized medical information may comprise histopathological sectioning, staining, and/or review by a pathologist under one or more magnifications of review or observation of the histology slide. In some cases, correlating and/or labeling fluorescence data to standardized medical classification and/or diagnostic information may improve the classification accuracy of a machine learning models (e.g., rendering a correct classification of tissue or cell when provided unknown fluorescence image data). The accuracy of machine learning models in classifying fluorescence image data may be improved by at least about 5%, at least about 10%, at least about 20%, at least about 30%, at least about 40%, at least about 50%, at least about 60%, at least about 70%, at least about 80%, at least about 90%, or at least about 99% compared to machine learning models that are not trained with fluorescence image data correlated to standardized medical classification and/or diagnostics.

In some cases, the method of correlating fluorescence image data to standardized medical classification and/or diagnostic information may comprise: providing a biological sample; cutting the sample with a blade at a distance from a surface of the sample thereby generating a cut portion of the sample; analyzing the cut portion of the sample to determine a dataset of standardized medical classification and/or diagnostic information; and correlating a corresponding fluorescence image data of the cut portion of the sample to the spatial dataset of standardized medical classification and/or diagnostic information. In some cases, the distance from a surface of the sample that the blade cuts the sample may be determined by a parameter of the depth of focus of an imaging system (e.g., a fluorescence imaging system) described elsewhere herein. In some cases, the standardized medical classification and/or diagnostic information may comprise a clinical classification (e.g., healthy, non-cancerous disease, or cancerous) of one or more regions of the cut sample determined by a pathologist and/or other trained machine vision classification models and/or algorithm. In some instances, the method may comprise processing the cut biological sample with one or more histopathologic stains (e.g., hematoxylin and eosin, masons trichome, immunohistochemistry, or any combination thereof) prior to analysis and classification.

In some instances, the biological sample may be provided in a cassette where the cassette may comprise a metal plate with a surface in contact with the biological sample. The metal place surface in contact with the biological sample may comprise one or more holes that flatten a surface of the biological sample against the surface of the metal plate. In some instances, the biological sample may be provided in liquid formalin and the one or more holes of the metal plate may allow for the liquid formalin to appropriate reach the surface of the biological sample in contact with the metal plate. In some cases, the one or more holes of the metal place surface may permit the biological sample to lay flat compared to a metal plate without the one or more holes.

Although the above steps show each of the methods or sets of operations 900, 914, 930, 1000, 1006, 1028, 1100, 1126, 1148, 1170, 1200, 1222, 1300, 1400, 1500, 1600, 1700, 2700, 2800, and 2900 in accordance with embodiments, a person of ordinary skill in the art will recognize many variations based on the teaching described herein. The steps may be completed in a different order. Steps may be added or omitted. Some of the steps may comprise sub-steps. Many of the steps may be repeated as often as beneficial.

One or more of the steps of each of the methods or sets of operations 900, 914, 930, 1000, 1006, 1028, 1100, 1126, 1148, 1170, 1200, 1222, 1300, 1400, 1500, 1600, 1700, 2700, 2800, and 2900 may be performed with circuitry as described herein, for example, one or more of the processor or logic circuitry such as programmable array logic for a field programmable gate array. The circuitry may be programmed to provide one or more of the steps of each of the methods or sets of operations 900, 914, 930, 1000, 1006, 1028, 1100, 1126, 1148, 1170, 1200, 1222, 1300, 1400, 1500, 1600, 1700, 2700, 2800, and 2900, and the program may comprise program instructions stored on a computer readable memory or programmed steps of the logic circuitry such as the programmable array logic or the field programmable gate array, for example.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative, or quantitative and qualitative determinations. Assessing can be relative or absolute. “Detecting the presence of” can include determining the amount of something present in addition to determining whether it is present or absent depending on the context.

The terms “subject,” “individual,” or “patient” are often used interchangeably herein. A “subject” can be a biological entity containing expressed genetic materials. The biological entity can be a plant, animal, or microorganism, including, for example, bacteria, viruses, fungi, and protozoa. The subject can be tissues, cells and their progeny of a biological entity obtained in vivo or cultured in vitro. The subject can be a mammal. The mammal can be a human. The subject may be diagnosed or suspected of being at high risk for a disease. In some cases, the subject is not necessarily diagnosed or suspected of being at high risk for the disease.

The term “in vivo” is used to describe an event that takes place in a subject's body.

The term “ex vivo” is used to describe an event that takes place outside of a subject's body. An ex vivo assay is not performed on a subject. Rather, it is performed upon a sample separate from a subject. An example of an ex vivo assay performed on a sample is an “in vitro” assay.

The term “in vitro” is used to describe an event that takes places contained in a container for holding laboratory reagent such that it is separated from the biological source from which the material is obtained. In vitro assays can encompass cell-based assays in which living or dead cells are employed. In vitro assays can also encompass a cell-free assay in which no intact cells are employed.

As used herein, the term “about” a number refers to that number plus or minus 10% of that number. The term “about” a range refers to that range minus 10% of its lowest value and plus 10% of its greatest value.

Use of absolute or sequential terms, for example, “will,” “will not,” “shall,” “shall not,” “must,” “must not,” “first,” “initially,” “next,” “subsequently,” “before,” “after,” “lastly,” and “finally,” are not meant to limit scope of the present embodiments disclosed herein but as exemplary.

Any systems, methods, software, compositions, and platforms described herein are modular and not limited to sequential steps. Accordingly, terms such as “first” and “second” do not necessarily imply priority, order of importance, or order of acts.

As used herein, the terms “treatment” or “treating” are used in reference to a pharmaceutical or other intervention regimen for obtaining beneficial or desired results in the recipient. Beneficial or desired results include but are not limited to a therapeutic benefit and/or a prophylactic benefit. A therapeutic benefit may refer to eradication or amelioration of symptoms or of an underlying disorder being treated. Also, a therapeutic benefit can be achieved with the eradication or amelioration of one or more of the physiological symptoms associated with the underlying disorder such that an improvement is observed in the subject, notwithstanding that the subject may still be afflicted with the underlying disorder. A prophylactic effect includes delaying, preventing, or eliminating the appearance of a disease or condition, delaying, or eliminating the onset of symptoms of a disease or condition, slowing, halting, or reversing the progression of a disease or condition, or any combination thereof. For prophylactic benefit, a subject at risk of developing a particular disease, or to a subject reporting one or more of the physiological symptoms of a disease may undergo treatment, even though a diagnosis of this disease may not have been made.

The section headings used herein are for organizational purposes only and are not to be construed as limiting the subject matter described.

### EMBODIMENTS

Numbered embodiment 1 comprises a device for determining the presence of tissue or cell type of interest in a resected tissue sample, the device comprising: a surface to receive a tissue sample resected from a subject; a light source configured to emit an excitation signal; an optical assembly in optical communication with the light source to direct the excitation signal to the tissue sample received on the surface and collect autofluorescent light emitted from the tissue sample in response; a detector in optical communication with the optical assembly configured to capture the autofluorescent light emitted from the tissue sample; and a processor in communication with the detector to generate at least one image of the autofluorescence light emitted from the tissue sample. Numbered embodiment 2 comprises the device of embodiment 1 where the subject is suffering from or suspected of suffering from a disease. Numbered embodiment 3 comprises the device of embodiment 1 or embodiment 2 where the tissue or cell type of interest comprise diseased tissues or cells. Numbered embodiment 4 comprises the device of any one of embodiments 1-3, where the diseased tissues or cells comprise cancerous tissues or cells. Numbered embodiment 5 comprises the device of any one of embodiments 1-4, where the processor is configured to determine the presence of disease in the resected tissue sample based on the generated at least one image. Numbered embodiment 6 comprises the device of any one of embodiments 1-5, where the processor is configured to determine the presence of disease in the resected tissue sample based on one or more autofluorescent characteristics of the generated at least one image. Numbered embodiment 7 comprises the device of any one of embodiments 1-6, where the one or more autofluorescent characteristics comprise an autofluorescence lifetime characteristic. Numbered embodiment 8 comprises the device of any one of embodiments 1-7, where the autofluorescence lifetime characteristic comprises a plurality of fluorescent exponential decay characteristics of a plurality of regions the resected tissue. Numbered embodiment 9 comprises the device of any one of embodiments 1-8, where the processor is configured to use a probability model to determine the presence of the disease in the tissue sample based on autofluorescent light emitted from the tissue sample. Numbered embodiment 10 comprises the device of any one of embodiments 1-9, where the processor is configured to determine the presence of disease in a plurality of margins of the resected tissue sample based on the generated at least one image. Numbered embodiment 11 comprises the device of any one of embodiments 1-10, further comprising a mechanical stage. Numbered embodiment 12 comprises the device of any one of embodiments 1-11, further comprising a controller in electrical communication with the mechanical stage, detector, and the light source to operably control the mechanical stage, detector, and the light source. Numbered embodiment 13 comprises the device of any one of embodiments 1-12, where the mechanical stage is coupled to the surface or the light source. Numbered embodiment 14 comprises the device of any one of embodiments 1-13, where the mechanical stage is configured to move in three-dimensions. Numbered embodiment 15 comprises the device of any one of embodiments 1-14, further comprising a scanning element coupled to the optical assembly to scan the excitation signal across a plurality of locations on the tissue sample. Numbered embodiment 16 comprises the device of any one of embodiments 1-15, where the resected tissue sample has not been stained prior to imaging. Numbered embodiment 17 comprises the device of any one of embodiments 1-16, where the tissue sample has been exposed to a cross-linking agent prior to imaging. Numbered embodiment 18 comprises the device of any one of embodiments 1-17, where the tissue sample comprises breast tissue. Numbered embodiment 19 comprises the device of any one of embodiments 1-18, where the surface comprises a disposable tray. Numbered embodiment 20 comprises the device of any one of embodiments 1-19, where the disposable tray comprises a tissue sample carrier, and where the tissue sample carrier is configured to mechanically couple to a tissue sample barrier. Numbered embodiment 21 comprises the device of any one of embodiments 1-20, where the tissue sample carrier, and the tissue sample barrier mechanically couple to fix at least two degrees of freedom of the tissue sample carrier. Numbered embodiment 22 comprises the device of any one of embodiments 1-21, where the disposable tray is sterile. Numbered embodiment 23 comprises the device of any one of embodiments 1−22, where the light source is a pulsed laser. Numbered embodiment 24 comprises the device of any one of embodiments 1-23, where the pulsed laser is a Q-switched laser. Numbered embodiment 25 comprises the device of any one of embodiments 1-24, where the pulsed laser is a two-photon laser. Numbered embodiment 26 comprises the device of any one of embodiments 1-25, where the pulsed laser is a fiber laser. Numbered embodiment 27 comprises the device of any one of embodiments 1-26, where the pulsed laser emits a wavelength of about 300 nanometers (nm) to about 400 nm. Numbered embodiment 28 comprises the device of any one of embodiments 1-27, where the pulsed laser comprises a pulse energy of about 1 microjoule (μJ) to about 3μJ. Numbered embodiment 29 comprises the device of any one of embodiments 1-28, where the pulsed laser comprises a pulse rate of about 10 kilohertz (kHz) to about 50 kHz. Numbered embodiment 30 comprises the device of any one of embodiments 1-29, where the optical assembly comprises a partially reflective mirror, a plurality of optical elements, where the plurality of optical elements comprises one or more of plano-convex, bi-convex, bi-concave, plano-concave, or any combination thereof lenses. Numbered embodiment 31 comprises the device of any one of embodiments 1-30, where the plurality of optical elements comprises fused silica optics. Numbered embodiment 32 comprises the device of any one of embodiments 1-31, where the detector comprises one or more photo-multiplier tubes. Numbered embodiment 33 comprises the device of any one of embodiments 1-32, where the detector comprises one or more dichroic filters. Numbered embodiment 34 comprises the device of any one of embodiments 1-33, further comprising one or more amplifiers electrically coupled to the detector, configured to amplify an electrical signal generated when the detector detects the autofluorescent light emitted from the tissue sample. Numbered embodiment 35 comprises the device of any one of embodiments 1-34, where the one or more amplifiers comprise a programmable attenuator, radio frequency amplifier, fixed attenuator, or any combination thereof. Numbered embodiment 36 comprises the device of any one of embodiments 1-35, where the processor comprises a field programmable gate array (FPGA).

Numbered embodiment 37 comprises a method for determining the presence of a tissue or cell type of interest in a tissue sample, the method comprising: receiving a tissue sample resected from a subject in a fluorescence imaging system; imaging the resected tissue sample to determine one or more autofluorescent characteristics of the resected tissue sample; and determining the presence of the tissue or cell type of interest in the resected tissue sample based on the imaged resected tissue. Numbered embodiment 38 comprises the method of embodiment 37, where the resected tissue sample has not been stained prior to imaging. Numbered embodiment 39 comprises the method of embodiment 37 or embodiment 38, where the resected tissue sample has been exposed to a cross-linking agent prior to imaging. Numbered embodiment 40 comprises the method of any one of embodiments 37-39, where the one or more autofluorescent characteristics comprise an autofluorescence lifetime characteristic. Numbered embodiment 41 comprises the method of any one of embodiments 37-40, where the autofluorescence lifetime characteristic comprises a plurality of fluorescent exponential decay characteristics of a plurality of regions of the resected tissue sample. Numbered embodiment 42 comprises the method of any one of embodiments 37-41, where the tissue or cell type of interest comprise diseased tissues or cells. Numbered embodiment 43 comprises the method of any one of embodiments 37-42, where the diseased tissues or cells comprise cancerous tissues or cells. Numbered embodiment 44 comprises the method of any one of embodiments 37-43, where the tissue sample comprises tissue from colon, breast, prostate, skin, vasculature, or any combination thereof. Numbered embodiment 45 comprises the method of any one of embodiments 37-44, where determining the presence of disease in the resected tissue comprises characterizing one or more margins in the resected tissue sample as diseased or non-diseased. Numbered embodiment 46 comprises the method of any one of embodiments 37-45, where the fluorescence imaging system comprises a pulsed fluorescence light source. Numbered embodiment 47 comprises the method of any one of embodiments 37−46, where imaging comprises detecting autofluorescent light emitted from the tissue sample in response to the pulsed fluorescence light source providing an excitation signal to the tissue sample. Numbered embodiment 48 comprises the method of any one of embodiments 37-47, where the pulsed fluorescence light source is a pulsed fiber laser fluorescence light source. Numbered embodiment 49 comprises the method of any one of embodiments 37-48, further comprising informing a surgeon to resect a second tissue sample from the subject. Numbered embodiment 50 comprises the method of any one of embodiments 37-49, where informing comprises sound, visual display, or any combination thereof directed towards the surgeon. Numbered embodiment 51 comprises the method of any one of embodiments 37-50, where steps (b) and (c) are completed in up to 5 minutes. Numbered embodiment 52 comprises the method of any one of embodiments 37-51, where determining the presence of disease in the tissue sample is completed by a probability-based model. Numbered embodiment 53 comprises the method of any one of embodiments 37-52, where the probability-based model comprises clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. Numbered embodiment 54 comprises the method of any one of embodiments 37-53, where subject is suffering from or suspected of suffering from a disease. Numbered embodiment 55 comprises the method of any one of embodiments 37-54, where the tissue sample is placed on a surface of a tissue sample carrier of the fluorescence imaging system prior to imaging. Numbered embodiment 56 comprises the method of any one of embodiments 37-55, where the tissue sample carrier is configured to mechanically coupled to a tissue sample barrier. Numbered embodiment 57 comprises the method of any one of embodiments 37-56, where the tissue sample carrier and the tissue sample barrier mechanically couple to fix at least two degrees of freedom of the tissue sample carrier.

Numbered embodiment 58 comprises a method for determining the presence of a tissue or cell type of interest in a tissue sample, the method comprising: resecting a tissue sample from a subject; placing the tissue sample into a fluorescence imaging system; imaging, with the aid of the fluorescence imaging system, the resected tissue sample to determine one or more autofluorescent characteristics of the resected tissue sample; and receiving, from the fluorescence imaging system, a determination of the presence of the tissue or cell type of interest in the resected tissue sample based on the imaged resected tissue. Numbered embodiment 59 comprises the method of embodiment 58, where the resected tissue sample has not been stained prior to imaging. Numbered embodiment 60 comprises the method of embodiment 58 or embodiment 59, where the tissue sample has been exposed to a cross-linking agent prior to imaging. Numbered embodiment 61 comprises the method of any one of embodiments 58-60, where the one or more autofluorescent characteristics comprise an autofluorescence lifetime characteristic. Numbered embodiment 62 comprises the method of any one of embodiments 58-61, where the autofluorescence lifetime characteristic comprises a plurality of fluorescent exponential decay characteristics of a plurality of regions of the resected tissue sample. Numbered embodiment 63 comprises the method of any one of embodiments 58-62, where the tissue or cell type of interest comprise diseased tissues or cells. Numbered embodiment 64 comprises the method of any one of embodiments 58-63, where the diseased tissues or cells comprise cancerous tissues or cells. Numbered embodiment 65 comprises the method of any one of embodiments 58-64, where the tissue sample comprises tissue from colon, breast, prostate, skin, vasculature, or any combination thereof. Numbered embodiment 66 comprises the method of any one of embodiments 58-65, where the determination of the presence of disease in the resected tissue comprises a characterization of one or more margins in the resected tissue sample as diseased or non-diseased. Numbered embodiment 67 comprises the method of any one of embodiments 58-66, where the fluorescence imaging system comprises a pulsed fluorescence light source. Numbered embodiment 68 comprises the method of any one of embodiments 58-67, where the pulsed fluorescence light source comprises a pulsed fiber laser. Numbered embodiment 69 comprises the method of any one of embodiments 58-68, where imaging comprises detecting autofluorescent light emitted from the tissue sample in response to the pulsed fluorescence light source providing an excitation signal to the tissue sample. Numbered embodiment 70 comprises the method of any one of embodiments 58-69, further comprising informing a surgeon to resect a second tissue sample from the subject. Numbered embodiment 71 comprises the method of any one of embodiments 58-69, where informing comprises sound, visual display, or any combination thereof directed towards the surgeon. Numbered embodiment 72 comprises the method of any one of embodiments 58-71, where steps (c) and (d) are completed in up to 5 minutes. Numbered embodiment 73 comprises the method of any one of embodiments 58-72, where the determination of the presence of disease in the tissue sample is completed by a probability-based model. Numbered embodiment 74 comprises the method of any one of embodiments 58-73, where the probability-based model comprises clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. Numbered embodiment 75 comprises the method of any one of embodiments 58-74, where the subject is suffering from or suspected of suffering from a disease. Numbered embodiment 76 comprises the method of any one of embodiments 58-75, where the tissue sample is placed on a surface of a tissue sample carrier of the fluorescence imaging system prior to imaging. Numbered embodiment 77 comprises the method of any one of embodiments 58-76, where the tissue sample carrier is configured to mechanically coupled to a tissue sample barrier. Numbered embodiment 78 comprises the method of any one of embodiments 58-77, where the tissue sample carrier and the tissue sample barrier mechanically couple to fix at least two degrees of freedom of the tissue sample carrier.

Numbered embodiment 79 comprises a device for determining the presence of a tissue or cell type of interest in a resected tissue sample, the device comprising: a surface to receive a tissue sample resected from a subject; a light source configured to emit an excitation signal; an optical assembly in optical communication with the light source to direct the excitation signal to the tissue sample received on the surface and collect fluorescent light emitted from the tissue sample in response; a detector in optical communication with the optical assembly configured to collect the fluorescent light emitted from the tissue sample; and a processor in communication with the detector to characterize at least a portion of the tissue sample for the tissue or cell type of interest based on a fluorescent lifetime characteristic of the collected fluorescent light. Numbered embodiment 80 comprises the device of embodiment 79, where the processor is configured to determine a presence of disease in the resected tissue sample based on a generated at least one image of the fluorescent light emitted from the tissue sample. Numbered embodiment 81 comprises the device of embodiment 79 or embodiment 80, where the fluorescent lifetime characteristic comprises a plurality of fluorescent exponential decay characteristics of a plurality of regions of the resected tissue. Numbered embodiment 82 comprises the device of any one of embodiments 79-81, where the processor is configured to use a probability model to determine the presence of the disease in the tissue sample based on the fluorescent light emitted from the tissue sample. Numbered embodiment 83 comprises the device of any one of embodiments 79-82, where the processor is configured to determine the presence of the disease in a plurality of margins of the resected tissue sample based on the generated at least one image. Numbered embodiment 84 comprises the device of any one of embodiments 79-83, further comprising a mechanical stage. Numbered embodiment 85 comprises the device of any one of embodiments 79-84, further comprising a controller in electrical communication with the mechanical stage, detector, and the light source to operably control the mechanical stage, detector, and the light source. Numbered embodiment 86 comprises the device of any one of embodiments 79-85, where the mechanical stage is coupled to the surface or the light source. Numbered embodiment 87 comprises the device of any one of embodiments 79-86, where the mechanical stage is configured to move in three-dimensions. Numbered embodiment 88 comprises the device of any one of embodiments 79-87, further comprising a scanning element coupled to the optical assembly to scan the excitation signal across a plurality of locations on the tissue sample. Numbered embodiment 89 comprises the device of any one of embodiments 79-88, where the resected tissue sample has not been stained prior to imaging. Numbered embodiment 90 comprises the device of any one of embodiments 79-89, where the tissue sample has been exposed to a cross-linking agent prior to imaging. Numbered embodiment 91 comprises the device of any one of embodiments 79-90, where the tissue sample comprises breast tissue. Numbered embodiment 92 comprises the device of any one of embodiments 79-91, where the tissue or cell type of interest comprises diseased tissues or cells. Numbered embodiment 93 comprises the device of any one of embodiments 79-92, where the diseased tissues or cells comprise cancerous tissues or cells. Numbered embodiment 94 comprises the device of any one of embodiments 79-93, where the surface comprises a disposable tray. Numbered embodiment 95 comprises the device of any one of embodiments 79-94, where the disposable tray is sterile. Numbered embodiment 96 comprises the device of any one of embodiments 79-95, where the light source is a pulsed laser. Numbered embodiment 97 comprises the device of any one of embodiments 79-96, where the pulsed laser is a Q-switched laser. Numbered embodiment 98 comprises the device of any one of embodiments 79-97, where the pulsed laser is a two-photon laser. Numbered embodiment 99 comprises the device of any one of embodiments 79-98, where the pulsed laser is a fiber laser. Numbered embodiment 100 comprises the device of any one of embodiments 79-99, where the pulsed laser emits a wavelength of about 300 nanometers (nm) to about 400 nm. Numbered embodiment 101 comprises the device of any one of embodiments 79-100, where the pulsed laser comprises a pulse energy of about 1 microjoule (μJ) to about 3μJ. Numbered embodiment 102 comprises the device of any one of embodiments 79-101, where the pulsed laser comprises a pulse rate of about 10 kilohertz (kHz) to about 50 kHz. Numbered embodiment 103 comprises the device of any one of embodiments 79-102, where the optical assembly comprises a partially reflective mirror, a plurality of optical elements, wherein the plurality of optical elements comprises one or more of plano-convex, bi-convex, bi-concave, plano-concave, or any combination thereof lenses. Numbered embodiment 104 comprises the device of any one of embodiments 79-103, where the plurality of optical elements comprises fused silica optics. Numbered embodiment 105 comprises the device of any one of embodiments 79-104, where the detector comprises one or more photo-multiplier tubes. Numbered embodiment 106 comprises the device of any one of embodiments 79-105, where the detector comprises one or more dichroic filters. Numbered embodiment 107 comprises the device of any one of embodiments 79-106, further comprising one or more amplifiers electrically coupled to the detector, configured to amplify an electrical signal generated when the detector detects the fluorescent light emitted from the tissue sample. Numbered embodiment 108 comprises the device of any one of embodiments 79-107, where the one or more amplifiers comprise a programmable attenuator, radio frequency amplifier, fixed attenuator, or any combination thereof. Numbered embodiment 109 comprises the device of any one of embodiments 79-108, where the processor comprises a field programmable gate array (FPGA). Numbered embodiment 110 comprises the device of any one of embodiments 79-109, where the subject is suffering from or suspected of suffering from a disease.

Numbered embodiment 111 comprises a method for determining the presence of a tissue or cell type of interest in a tissue sample, the method comprising: receiving a tissue sample resected from a subject in a fluorescence imaging system; directing an excitation signal to the tissue sample; collecting fluorescent light emitted from the tissue sample in response to the excitation signal; and characterizing at least a portion of the tissue sample for the tissue or cell type of interest based on a fluorescent lifetime characteristic of the collected fluorescent light. Numbered embodiment 112 comprises the method of embodiment 111, where the resected tissue sample has not been stained prior to imaging. Numbered embodiment 113 comprises the method of embodiment 111 or embodiment 112, where the tissue sample has been exposed to a cross-linking agent prior to imaging. Numbered embodiment 114 comprises the method of any one of embodiments 111-113, where the fluorescent lifetime characteristic comprises a plurality of fluorescent exponential decay characteristics of a plurality of regions of the resected tissue sample. Numbered embodiment 115 comprises the method of any one of embodiments 111-114, where the tissue or cell type of interest comprise diseased tissues or cells. Numbered embodiment 116 comprises the method of any one of embodiments 111-115, where the diseased tissues or cells comprise cancerous tissues or cells. Numbered embodiment 117 comprises the method of any one of embodiments 111-116, where the tissue sample comprises tissue from colon, breast, prostate, skin, vasculature, or any combination thereof. Numbered embodiment 118 comprises the method of any one of embodiments 111-117, where the characterizing comprises characterizing one or more margins in the resected tissue sample as diseased or non-diseased. Numbered embodiment 119 comprises the method of any one of embodiments 111-118, where the fluorescence imaging system comprises a pulsed fluorescence light source. Numbered embodiment 120 comprises the method of any one of embodiments 111-119, where the pulsed fluorescence light source comprises a pulsed fiber laser. Numbered embodiment 121 comprises the method of any one of embodiments 111-120, where collecting comprises detecting fluorescent light emitted from the tissue sample in response to the pulsed fluorescence light source providing the excitation signal to the tissue sample. Numbered embodiment 122 comprises the method of any one of embodiments 111−121, further comprising informing a surgeon to resect a second tissue sample from the subject. Numbered embodiment 123 comprises the method of any one of embodiments 111-122, where informing comprises sound, visual display, or any combination thereof directed towards the surgeon. Numbered embodiment 124 comprises the method of any one of embodiments 111-123, where steps (c) and (d) are completed in up to 5 minutes. Numbered embodiment 125 comprises the method of any one of embodiments 111-124, where characterization is completed by a probability-based model. Numbered embodiment 126 comprises the method of any one of embodiments 111-125, where the probability-based model comprises clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. Numbered embodiment 127 comprises the method of any one of embodiments 111-126, where the subject is suffering from or suspected of suffering from a disease. Numbered embodiment 128 comprises the method of any one of embodiments 111-127, where the tissue sample is placed on a surface of a tissue sample carrier of the fluorescence prior to directing the excitation signal to the tissue sample. Numbered embodiment 129 comprises the method of any one of embodiments 111-128, where the tissue sample carrier is configured to mechanically coupled to a tissue sample barrier. Numbered embodiment 130 comprises the method of any one of embodiments 111-129, where the tissue sample carrier and the tissue sample barrier mechanically couple to fix at least two degrees of freedom of the tissue sample carrier.

Numbered embodiment 131 comprises a method for determining the presence of a tissue or cell type of interest in a tissue sample, the method comprising: resecting a tissue sample from a subject; placing the tissue sample into a fluorescence imaging system, wherein the fluorescent imaging system directs an excitation signal to the tissue sample and collects fluorescent light emitted from the sample in response; and receiving, from the fluorescence imaging system, a characterization of at least a portion of the tissue sample for the tissue or cell type of interest based on a fluorescent lifetime characteristic of the collected fluorescent light. Numbered embodiment 132 comprises the method of embodiment 131, where the resected tissue sample has not been stained prior to imaging. Numbered embodiment 133 comprises the method of embodiment 131 or embodiment 132, where the tissue sample has been exposed to a cross-linking agent prior to placing the tissue sample into the fluorescence imaging system. Numbered embodiment 134 comprises the method of any one of embodiments 131-133, where the fluorescent lifetime characteristic comprises a plurality of fluorescent exponential decay characteristics of a plurality of regions of the resected tissue sample. Numbered embodiment 135 comprises the method of any one of embodiments 131-134, where the tissue or cell type of interest comprise diseased tissues or cells. Numbered embodiment 136 comprises the method of any one of embodiments 131-135, where the diseased tissues or cells comprise cancerous tissues or cells. Numbered embodiment 137 comprises the method of any one of embodiments 131-136, where the tissue sample comprises tissue from colon, breast, prostate, skin, vasculature, or any combination thereof. Numbered embodiment 138 comprises the method of any one of embodiments 131-137, where the characterization comprises a characterization of one or more margins in the resected tissue sample as diseased or non-diseased. Numbered embodiment 139 comprises the method of any one of embodiments 131-138, where the fluorescence imaging system comprises a pulsed fluorescence light source. Numbered embodiment 140 comprises the method of any one of embodiments 131-139, where the pulsed fluorescence light source comprises a pulsed fiber laser. Numbered embodiment 141 comprises the method of any one of embodiments 131-140, where receiving comprises detecting fluorescent light emitted from the tissue sample in response to the pulsed fluorescence light source providing the excitation signal to the tissue sample. Numbered embodiment 142 comprises the method of any one of embodiments 131-141, further comprising informing a surgeon to resect a second tissue sample from the subject. Numbered embodiment 143 comprises the method of any one of embodiments 131-142, where informing comprises sound, visual display, or any combination thereof directed towards the surgeon. Numbered embodiment 144 comprises the method of any one of embodiments 131-143, where steps (b) and (c) are completed in up to 5 minutes. Numbered embodiment 145 comprises the method of any one of embodiments 131-144, where characterization is completed by a probability-based model. Numbered embodiment 146 comprises the method of any one of embodiments 131−145, where the probability-based model comprises clustering, scalar vector machines, kernel SVM, linear discriminant analysis, Quadratic discriminant analysis, neighborhood component analysis, manifold learning, convolutional neural networks, reinforcement learning, random forest, Naive Bayes, gaussian mixtures, Hidden Markov model, Monte Carlo, restrict Boltzmann machine, linear regression, or any combination thereof. Numbered embodiment 147 comprises the method of any one of embodiments 131-146, where the subject is suffering from or suspected of suffering from a disease. Numbered embodiment 148 comprises the method of any one of embodiments 131-147, where the tissue sample is placed on a surface of a tissue sample carrier of the fluorescence prior to placing the tissue sample into the fluorescence imaging system. Numbered embodiment 149 comprises the method of any one of embodiments 131-148, where the tissue sample carrier is configured to mechanically coupled to a tissue sample barrier. Numbered embodiment 150 comprises the method of any one of embodiments 131-149, where the tissue sample carrier and the tissue sample barrier mechanically couple to fix at least two degrees of freedom of the tissue sample carrier.

1.-151. (canceled)

152. A device for determining the presence of tissue or cell type in a tissue sample, the device comprising:
(a) a stage coupled to a surface to receive a tissue sample resected from a subject;
(b) a light source configured to emit an excitation signal;
(c) an optical assembly in optical communication with the light source to direct the excitation signal to the tissue sample received on the surface and collect autofluorescent light emitted from the tissue sample in response;
(d) a detector in optical communication with the optical assembly configured to capture the autofluorescent light emitted from the tissue sample; and
(e) a processor in communication with the detector to generate at least one image of the autofluorescence light emitted from the tissue sample.

153. The device of claim 152, wherein the surface comprises a surface of a tissue sample carrier, and wherein the tissue sample carrier comprises an alignment feature.

154. The device of claim 153, wherein the tissue sample carrier comprises one or more protruding or recessed features to prevent movement of the tissue sample.

155. The device of claim 153, further comprising a barrier coupled to the tissue sample carrier, wherein the barrier comprises one or more kinematic features to couple or mate with the tissue sample carrier.

156. The device of claim 155, wherein the surface comprises a surface of a drawer.

157. The device of claim 156, wherein the barrier comprises a flanged or lip feature to seal an interface between the barrier and the surface of the drawer.

158. The device of claim 157, wherein the stage comprises a linear actuator that lifts the surface with the tissue sample towards the optical assembly.

159. The device of claim 158, wherein the drawer comprises a lock, and wherein when the linear actuator lifts the surface with the tissue sample, the drawer is locked in place by the lock.

160. The device of claim 152, further comprising a stage coupled to the light source.

161. The device of claim 152, further comprising a programmable attenuator electrically coupled to the detector.

162. A method for determining a presence of tissue or cell type in a tissue sample, the method comprising:
receiving a tissue sample resected from a subject on a surface coupled to a stage;
imaging the resected tissue sample to determine one or more autofluorescent characteristics of the resected tissue sample; and
determining the presence of the tissue or cell type in the resected tissue sample based on at least the one or more autofluorescent characteristics.

163. The method of claim 162, wherein the surface comprises a surface of a tissue sample carrier, and wherein the tissue sample carrier comprises an alignment feature.

164. The method of claim 163, wherein the tissue sample carrier comprises one or more protruding or recessed features to prevent movement of the tissue sample.

165. The method of claim 163, further comprising a barrier coupled to the tissue sample carrier, wherein the barrier comprises one or more kinematic features to couple or mate with the tissue sample carrier.

166. The method of claim 165, wherein the surface comprises a surface of a drawer.

167. The method of claim 166, wherein the barrier comprises a flanged or lip feature to seal an interface between the barrier and the surface of the drawer.

168. The method of claim 167, wherein the stage comprises a linear actuator that lifts the surface with the tissue sample towards the optical assembly.

169. The method of claim 168, wherein the drawer comprises a lock, and wherein when the linear actuator lifts the surface with the tissue sample, the drawer is locked in place by the lock.

170. The method of claim 162, wherein imaging comprises providing an excitation signal of a light source to the resected tissue sample, and wherein the light source is coupled to a stage.

171. The method of claim 170, wherein imaging comprises detecting autofluorescent light emitted from the resected tissue sample in response to the excitation signal of the light source with a detector, and wherein a programmable attenuator is electrically coupled to the detector.
